(19) United States
(12) Patent Application Publication
(10) Pub. No.: US 2026/0289991 A1
(43) Pub. Date: Sep. 24, 2026

(54) SYMBOLIC MACHINE LEARNING ARCHITECTURE

(71) Applicant: 3M INNOVATIVE PROPERTIES COMPANY, St. Paul, MN (US)

(72) Inventors: Brian E. Brooks, St. Paul, MN (US); Arun Krishnadas, Woodbury, MN (US); Anders J. Vaage, Stillwater, MN (US); Glenn E. Casner, Woodbury, MN (US); Nitin Krishnamurthy Hansoge, Woodbury, MN (US); Omar Knio, Woodbury, MN (US)

(21) Appl. No.: 19/574,196

(22) Filed: Mar. 20, 2026

Related U.S. Application Data
(60) Provisional application No. 63/775,893, filed on Mar. 21, 2025.
(60) Provisional application No. 63/801,802, filed on May 7, 2025.
(60) Provisional application No. 63/830,852, filed on Jun. 26, 2025.
(60) Provisional application No. 63/889,011, filed on Sep. 26, 2025.
(60) Provisional application No. 63/916,246, filed on Nov. 12, 2025.
(60) Provisional application No. 63/964,281, filed on Jan. 20, 2026.

(51) Int. Cl. G06V 10/82; G06N 3/042; G06N 3/08

(52) U.S. Cl. CPC G06V 10/82; G06N 3/042; G06N 3/08

(57) ABSTRACT

A symbolic machine learning system can include a symbolic representation generator, an inference component, and an interface component. The symbolic representation generator can repeatedly receive inputs associated with observed objects and computes a symbolic memory network representative of associations involving the observed objects. The inference component can repeatedly perturb components, operations, or parameters of the symbolic representation generator and computes a causal model of effects of the perturbations. The interface component can output signals generated based on the causal model and concerning the associations involving the observed objects.

### CROSS-REFERENCE TO RELATED APPLICATIONS

The present application claims priority under 35 U.S.C. § 119 to U.S. Provisional Patent Application No. 63/964,281, filed on Jan. 20, 2026, U.S. Provisional Patent Application No. 63/916,246, filed on Nov. 12, 2025, U.S. Provisional Patent Application No. 63/889,011, filed on Sep. 26, 2025, U.S. Provisional Patent Application No. 63/830,852, filed on Jun. 26, 2025, U.S. Provisional Patent Application No. 63/801,802, filed on May 7, 2025, and U.S. Provisional Patent Application No. 63/775,893, filed on Mar. 21, 2025. The entire contents of these applications are incorporated herein by reference for all purposes.

### TECHNICAL FIELD

This disclosure relates to the field of artificial intelligence and machine learning including, without limitation, systems and methods using a symbolic machine learning architecture.

### BACKGROUND

The current state-of-the-art in artificial intelligence (AI) relies on large language models (LLMs). LLMs are fundamentally statistical in nature, designed to predict the next likely token in a sequence based on context and pre-training. LLMs are constructed using deep neural networks comprising hundreds of layers of “neurons” with billions of configurable weights. Each neuron in such networks processes inputs through weighted connections, and the overall network is tuned through extensive pre-training, typically using backpropagation—a brute-force method that demands billions of iterations. This pre-training phase is essential to configure the billions of weights required for effective model performance. As a result, LLMs require massive pre-training datasets and compute, necessitating significant investment in data centers and cloud infrastructure.

### SUMMARY OF THE DISCLOSURE

In contrast to statistical methods like LLMs, the inventors here disclose systems and methods for artificial intelligence and machine learning, including artificial general intelligence, that are based on successfully modeling human cognition.

For over 70 years, the AI community has been skeptical of attempts to model how human minds work, instead embracing “brute-force” statistical methods (like LLMs) that leverage the continually falling cost per unit of computation predicted by Moore's law. As recounted in Rich Sutton's influential essay, “The Bitter Lesson,” at various tasks including playing games like Chess and Go, speech recognition, and computer vision, the AI community initially tried and failed with human-knowledge approaches before turning with disappointment to brute-force computational methods. See Richard S. Sutton, The Bitter Lesson, http://www.incompleteideas.net/IncIdeas/BitterLesson.html (Mar. 13, 2019). These historical failures convinced the AI community that human-knowledge approaches are “tremendously, irredeemably complex” and thus not worth pursuing. Id.

Facing the long-unsolved problems with human-knowledge approaches and tempted by Moore's law's prediction of continually falling per-unit compute costs, the AI community instead has turned en masse to statistical computation methods. Moore's law, first proposed in 1965 and then revised in 1975 by Intel's co-founder Gordon Moore, is the empirical observation that the number of transistor units in an integrated circuit doubles about every two years without increasing the overall cost of the integrated circuit. Gordon E. Moore, Cramming More Components onto Integrated Circuits, Electronics Magazine, Vol. 38, Iss. 8, at 114-117 (Apr. 19, 1965); Gordon E. Moore, Progress in Digital Integrated Electronics, IEEE International Electron Devices Meeting, Technical Digest at 11-13 (1975). This trend of falling per-unit compute costs has significantly influenced technological advancements over the past decades including, in the field of AI, increasing reliance on simpler systems that can scale with computational power over more complex systems that attempt to model human cognition.

Today, generative AI companies have wholeheartedly embraced the perceived benefits of Moore's law by relying on statistical computation methods, particularly large language models (LLMs). Generative AI companies pre-train LLMs on vast datasets of text from which the LLMs derive statistical information reflecting the relationships between different words and the grammatical rules governing speech patterns and language. Then, LLMs generate responses to user queries using probabilistic modeling—that is, by predicting the most likely next word (or “token”) based on the statistical patterns learned during pre-training.

LLMs' reliance on scaling up computational power creates its own problems. LLMs are typically implemented using deep neural networks, which can comprise hundreds of layers of neurons, each layer comprising tens of thousands of individual neurons. Each neuron in the network can receive inputs from thousands to tens of thousands of neurons in the previous layer(s), weighting each of the inputs individually before summing them to generate an output. Thus, a deep neural network implementation of an LLM can include millions of neurons, with millions if not billions of associated weights, each of which must be configured in the pre-training process. LLM pre-training often uses a technique called backpropagation (shorthand for “backward propagation of errors”), which further leverages scaling up of a basic computation. Backpropagation involves calculating the gradient of a loss function with respect to each weight in the network and iteratively (sometimes over billions of iterations) updating the weights to minimize the loss function. Accordingly, pre-training and operating an LLM for inferencing requires massive cloud infrastructure. This creates its own assortment of problems, as the general public is increasingly discovering—rising energy costs, environmental pollution, datacenters displacing residential communities, job layoffs to fund data-center capital expenditure, privacy concerns from compiling gigantic datasets for pre-training LLMs, increased water usage, and more.

In this disclosure, the inventors challenge the preconceived notion that human-knowledge approaches are irredeemably complex and thus not worth pursuing. They set out a novel and innovative combination of components that successfully models human cognition while taming its complexities. Unlike LLMs, which operate at a sub-symbolic level—e.g., on pieces of words called “tokens”—the inventors' approach operates at the symbolic level. The system can identify objects, functionalities of objects, and relationships between objects that are meaningful with respect to a particular task. In some embodiments, the system can perform role-based relational reasoning (e.g., generating inferences based on object roles in addition to, or as alternative to, object features, or the like). In some embodiments, the system can generalize its understanding of object functionalities and relationships to other objects and contexts, as human minds innately do. In this manner, the inventors' model not only solves the long-felt problems with human-knowledge approaches but also overcomes drawbacks of statistical computational models. As a working example, inventors demonstrate their model's ability to learn on-the-fly—as humans do—how to play the game of Breakout© without pre-training. The model, in some embodiments, utilizes approximately 5,000 times less compute than an equivalent statistical model would, with corresponding decrease in memory and energy consumption.

### EXEMPLARY EMBODIMENTS

The disclosed embodiments include a first system that receives information about observed objects. The system can improve upon conventional machine learning systems by reducing the resources required to achieve suitable performance of a task. For example, as described herein, the system can massively reduce the memory and compute required to play the AI benchmark video game Breakout©. This improvement can arise, as described herein, from the direct and/or indirect interaction or integration of a symbolic representation generator and an inference component. The symbolic representation generator can compute a symbolic memory network representative of associations involving the observed objects. The inference component can perform experiments upon the symbolic representation generator and/or the generated symbolic memory network. The experiments performed by the inference component can affect how the structure of the symbolic memory network develops over time. As described and shown herein, a result of this experimentation can be a symbolic memory network that accurately represents the associations involving objects in the environment. In some embodiments, the system can provide commands to take actions in the environment based on this symbolic memory network. Furthermore, unlike conventional systems with discrete training and inference phases, the system can integrate learning through experimentation and interacting in the environment. As may be appreciated, different system instances can therefore be personalized or customized to the particular environments in which they are deployed. For example, two instances configured to manage interactions with two different users may develop different symbolic memory networks.

In particular, the first system can perform operations for receiving information about observed objects. The system can include a symbolic representation generator. The symbolic representation generator can repeatedly receive inputs associated with observed objects and compute a symbolic memory network representative of associations involving the observed objects. The system can further include an inference component, which can repeatedly perturb components, operations, or parameters of the symbolic representation generator and compute a causal model of effects of the perturbations. The system can further include an interface component, which can output signals generated based on the causal model and concerning the associations involving the observed objects.

An additional or alternative implementation of the first system can perform operations for receiving information about observed objects and how the observed objects change state. The system can include means for computing a symbolic memory network representative of associations between observed objects and their states using repeatedly received inputs associated with the observed objects. The system can further include means for computing a causal model of effects of the perturbations on the symbolic memory network by repeatedly perturbing the symbolic memory network. The system can further include interface means for outputting signals concerning the associations involving the observed objects.

The disclosed embodiments include a second machine learning system for modifying states of objects in relation to a reward signal. The system can be a symbolic connectionist system. The reward signal can concern associations involving the observed objects (e.g., causal relationships between objects). The symbolic connectionist system can improve upon conventional machine learning systems by learning to maximize or minimize the reward signal using less memory and compute resources than the conventional systems. This improvement can arise, as described herein, from the direct and/or indirect interaction of a symbolic representation generator and an inference component. The symbolic representation generator can compute a symbolic memory network representative of the associations involving observed objects. The inference component can monitor the symbolic memory network and determine causal relationships among the observed objects. This computation and monitoring can be performed as the states of the observed objects.

In particular, the second system can perform operations for modifying states of objects in relation to a reward signal. The system can be a symbolic connectionist system. The system can include a symbolic representation generator and an inference component. The symbolic representation generator can repeatedly receive pixel information associated with observed objects and compute, as states of the observed objects change over time, a symbolic memory network representative of associations involving the observed objects. The inference component can monitor the symbolic memory network and determine, as the states of the observed objects change over time, causal relationships among the observed objects. The inference component can further provide commands causing additional changes in the states of one or more of the observed objects. These additional changes can maximize or minimize reward signals concerning the associations involving the observed objects.

An additional or alternative implementation of the second system can perform operations for modifying states of observed objects in relation to a reward signal. The system can include means for computing a symbolic memory network representative of associations involving the observed objects based on repeatedly received pixel information associated with the observed objects. The system can further include means for analyzing the symbolic memory network, computing a causal model of the associations of the observed objects, and providing commands causing additional changes in the states of one or more of the observed objects. The computation of the symbolic memory network and the analysis of the symbolic memory network, computation of the causal model, and provision of the commands, can be performed as the states of the observed objects change. The additional changes resulting from the provided commands can maximize or minimize reward signals concerning the associations involving the observed objects.

The disclosed embodiments include a third machine learning system for updating symbolic memory networks that represent associations of objects observed in an environment. As described herein, such symbolic memory networks can be used in a system that improves upon conventional machine learning systems by reducing the memory and compute resources required for suitable performance of tasks. The symbolic memory networks can encode associations between objects observed in a scene. An inference component can develop causal effect estimates concerning causal relationships between these objects. The causal effect estimates can affect the commands provided to the environment, affecting in turn the input obtained from the environment and thereby guiding the development of the symbolic memory network. Furthermore, the commands can be selected based on the causal effect estimates, thereby causing the suitable performance of the task.

In particular, the third system can perform operations for updating symbolic memory networks that represent associations of objects observed in an environment. The system can receive visual data inputs associated with a first scene having first objects. Each first object can have a state defined by first scene attributes of the first object. The system can further receive a reward signal associated with a first state of at least one of the first objects. The system can update a first symbolic memory network representative of associations involving the first objects. The system can update the first symbolic memory network representative by applying the visual data inputs associated with the first scene to a symbolic representation generator. The system can receive visual data inputs associated with a second scene having second objects, one of the second objects being one of the first objects. The second scene attributes of the one of the second objects can differ from the first scene attributes of the one of the second objects. The system can update a second symbolic memory network representative of associations involving the second objects. The system can update the second symbolic memory network by applying the visual data inputs associated with the second scene to the symbolic representation generator. The system can develop, using an inference component and the first and second symbolic memory networks, causal effect estimates concerning causal relationships in the second scene. The system can output, based on the causal effect estimates, a command to modify the second scene attributes of the one of the second objects.

The disclosed embodiments include a fourth system for generating, using self-supervised learning, a symbolic memory network that corresponds to an environment. As described and demonstrated herein, the system can improve upon conventional machine learning systems by reducing the memory and compute resources required for suitable performance of tasks. The system can develop the symbolic memory network through a process of experimentation using a causal model. This self-supervised experimentation can involve a feedback loop of perturbing the symbolic memory network based on the causal model and updating the causal model based on the determined results of perturbing the symbolic memory network. This feedback process can improve the granularity and fidelity of the causal representations stored in the symbolic memory network.

In particular, the fourth system can perform operations for generating a symbolic memory network corresponding to an environment using self-supervised learning. The system can determine an experiment based on a causal model of the symbolic memory network. The system may then perform the experiment by perturbing the symbolic memory network and obtain, while perturbing the symbolic memory network, input data concerning the environment. The system can determine an experimental result based on the input data and can update the causal model based on the experimental result.

The disclosed embodiments include a fifth system for generating, using self-supervised learning, a symbolic memory network corresponding to an environment. The symbolic memory network can include a continuous-valued relationship binding two units. A parameter of the relationship can determine whether the relationship approximates a metric or categorical relationship. The system can experimentally perturb this parameter and observe the results of this perturbation on performance metrics (e.g., task performance, predictive accuracy, rewards, or the like). The results can inform a causal model, enabling the system to support metric properties without sacrificing relational compositionality or symbolic generalization. The causal model can drive interactions with the environment, affecting the input obtained from the environment and guiding the development of the symbolic memory network. In this manner, the system can improve upon conventional machine learning systems by applying metric precision selectively (thus, for example, reducing the number of distributed units required to span a dimension and corresponding computational or memory overhead) and reducing the need for hardcoded heuristics.

In particular, the fifth system can perform operations for generating a symbolic memory network corresponding to an environment using self-supervised learning, the symbolic memory network including a continuous-valued relationship binding two units. The system can control, based on a causal model, a parameter of the continuous-valued relationship in the symbolic memory network. The system can obtain, while perturbing the parameter, input data concerning the environment, determine an experimental result based on the input data, and update the causal model of the symbolic memory network based at least in part on the experimental result.

The disclosed embodiments include a sixth system for generating, using self-supervised learning, a symbolic memory network corresponding to an environment and including localist units associated with salience data. This salience data may indicate that an object, object attribute, or relationship may have causal significance. As described herein, a symbolic representation generator can compute the symbolic memory network using input obtained from the environment. An inference component can experiment upon the symbolic memory network to develop a causal model of associations between observed objects in the environment. The causal model can drive interactions with the environment, affecting the input obtained from the environment and guiding the development of the symbolic memory network. As described and demonstrated herein, this architecture can improve upon conventional machine learning systems by reducing the memory and compute resources required for suitable performance of tasks. Furthermore, the inference component can focus experimentation on localist units of the symbolic memory network based on this associated salience data. Focusing experimentation may reduce the amount of experimentation required to develop the causal model, thereby reducing the computational requirements of the overall system and providing a technical improvement over conventional systems.

In particular, the sixth system can perform operations for generating a symbolic memory network corresponding to an environment using self-supervised learning, the symbolic memory network including at least one localist unit associated with salience data. The system can perturb, based on a causal model including the salience data, at least one of an activation level of the localist unit, a weight of a mapping between the localist unit and another localist unit in the symbolic memory network, or an inhibition level between the localist unit and a corresponding set of localist units in the symbolic memory network. The system can obtain, during the perturbation, input data concerning the environment, determine an experimental result based on the input data, and update the causal model based on the experimental result.

The disclosed embodiments include a seventh system for symbolic machine learning. The system can be a causal monitoring system. As described herein, an improved machine learning architecture can include the causal monitoring system, which can repeatedly perform experiments in a self-supervised fashion upon a symbolic memory network generated by a symbolic representation generator using input obtained from an environment. These experiments can include perturbing the symbolic memory network based on an estimated effect of the perturbation, obtaining an experimental result, and updating the estimated effect of the perturbation based on the experimental result. In this manner, through self-supervised experimentation, the system can influence the computation of the symbolic memory network. As described and demonstrated herein, this architecture can improve upon conventional machine learning systems by reducing the memory and compute resources required for suitable performance of tasks.

In particular, the seventh system can perform operations for causal monitoring for symbolic machine learning. The system can determine, for a first experimental unit, a first treatment set including a first perturbation of a symbolic memory network. The system can determine the first treatment set based on a first state of the symbolic memory network and an estimated effect of the first perturbation of the symbolic memory network. This first state can be dependent on input obtained by the symbolic representation generator from the environment. The system can apply the first treatment set. Application of the first treatment set can include the first perturbation of the symbolic memory network. The system can update, based on a first set of experimental units including the first experimental unit, the estimated effect of the first perturbation of the symbolic memory network to form an updated estimated effect.

The disclosed embodiments include an eighth system for generating a symbolic memory network. As described herein, an improved machine learning architecture can include a symbolic representation generator that computes a symbolic memory network using input data obtained from an environment and perturbation data obtained from an inference component. The perturbation data can specify at least one operation, parameter, or component perturbation of the symbolic representation generator. An inference component configured to monitor the symbolic representation generator can generate the perturbation data based on a state of the symbolic memory network. In this manner, the inference component can guide the development of the symbolic memory network. In some embodiments, in addition to perturbing the symbolic representation generator, the inference component can generate and provide an analog for storage in the symbolic memory network. As described and demonstrated herein, this architecture can improve upon conventional machine learning systems by reducing the memory and compute resources required for suitable performance of tasks.

In particular, the eighth system can perform operations for generating a symbolic memory network. The system can provide or expose a state of a symbolic memory network to at least an inference component to enable generation of perturbation data. The symbolic representation generating system can obtain input data from an environment and the perturbation data from the inference component. The symbolic representation generating system can update the state of the symbolic memory network using the input data and the perturbation data. Such updating can include creating or modifying a first analog stored in the symbolic memory network.

The disclosed embodiments include a ninth system for symbolic machine learning. The system can be a training system. As described herein, the training system can include an inference component that selects a perturbation of a symbolic memory network based at least in part on a state of a symbolic representation generator. The training system can also include a symbolic representation generator that updates the state of the symbolic memory network using input data obtained from an environment and the selected perturbation. In this manner, the inference component can guide the development of the symbolic memory network. As described and demonstrated herein, this architecture can improve upon conventional machine learning systems by reducing the memory and compute resources required for suitable performance of tasks. Furthermore, the training system can learn by observing the actions of another entity that is interacting with the environment. The input data obtained from an environment can reflect the effect of these interactions and can be used to update the state of the symbolic memory network, enabling the training system to learn even without interacting with the environment.

In particular, the ninth system can perform operations for symbolic machine learning. The system can be a training system. The training system can select, by an inference component of the training system and based on a state of a symbolic representation generator, a perturbation of a symbolic memory network from candidate perturbations. The training system can update, by the symbolic representation generator, a state of the symbolic memory network using the selected perturbation and input data obtained from an environment.

The disclosed embodiments include a tenth system for providing commands to take action in an environment using a symbolic representation generator and an inference component. As described herein, the inference component can select commands based on the symbolic memory network. The commands can be provided to the environment. The symbolic representation generator can then update the symbolic memory network using input data obtained after provision of the commands from the environment. In this manner, the updating of the symbolic memory network can be integrated into a process of self-supervised experimentation. As described and demonstrated herein, this architecture can improve upon conventional machine learning systems by reducing the memory and compute resources required for suitable performance of tasks.

In particular, the tenth system can perform operations for providing commands using a symbolic representation generator and an inference component. The system can select, by an inference component and based on a state of a symbolic representation generator, a command to take an action in an environment from candidate commands. The system can provide the command to take the action in the environment. The system can update, by the symbolic representation generator and after providing the command, the state of the symbolic representation generator using input data obtained from the environment.

The disclosed embodiments include an eleventh system for providing commands using a symbolic representation generator and an inference component. As described herein, the inference component can generate a perturbation and provide a command to the environment based on a state of the symbolic memory network, perturbation effect estimates, and command effect estimates. The symbolic representation generator can then update the symbolic memory network according to the perturbation and using input data obtained after provision of the commands from the environment. In this manner, the updating of the symbolic memory network can be integrated into a process of self-supervised experimentation. As described and demonstrated herein, this architecture can improve upon conventional machine learning systems by reducing the memory and compute resources required for suitable performance of tasks.

In particular, the eleventh system can perform operations for providing a command to the environment. The system can select, by an inference component, a treatment including a perturbation of components, operations, or parameters of a symbolic representation generator and a provision of a command to take action in an environment. The selection can be based on a state of the symbolic representation generator, an estimated effect of the perturbation, and an estimated effect of the command. The system can perturb the components, operations, or parameters of the symbolic representation generator in accordance with the selected perturbation and provide the command to the environment. The system can update, by the symbolic representation generator after the perturbation and the provision of the command, the state of the symbolic representation generator using input date obtained from the environment.

The disclosed embodiments include a twelfth system for generating relationship analogs. As described herein, the relationship analogs can represent relationships between treatments and outcomes learned by the system through experimentation. The system can generate relationship analogs by binding treatment analogs to outcome analogs using causal localist units. As described herein, this architecture for representing relationships supports identification of relationship strength, refinement of analogs over multiple experiments, cross-domain learning, and the ability to prompt the system to take actions to achieve desired outcomes, thereby improving upon conventional machine learning systems.

In particular, the twelfth system can perform operations for generating relationship analogs. The system can accumulate analogs in or from a working memory of a symbolic representation generator. The system can determine, in the accumulated analogs, an observed correlate and an observed outcome. The system can associate the observed correlate and the observed outcome with causal localist units. The system can bind the observed correlate, the observed outcome, and the causal localist units into a relationship analog. At least one of connection weights or metadata associated with the causal localist units can specify a relationship strength.

Additionally or alternatively, the twelfth system can include means for accumulating analogs in or from a working memory of a symbolic representation generator. The system can include means for determining, in the accumulated analogs, an observed correlate and an observed outcome. The system can include means for associating the observed correlate and the observed outcome with causal localist units. The system can include means for binding the observed correlate, the observed outcome, and the causal localist units into a relationship analog. At least one of connection weights or metadata associated with the causal localist units can specify a relationship strength.

The disclosed embodiments include a thirteenth system for taking action in an environment based on a relationship analog. As described herein, the relationship analogs can represent relationships between treatments and outcomes learned by the system through experimentation. Existing relationships can provide templates for taking goal directed action in the environment. The system can retrieve a suitable existing relationship can be retrieved (e.g., from a symbolic memory network) based on the contents of a working memory of a symbolic representation generator. As described herein, this architecture for representing relationships supports identification of relationship strength, refinement of analogs over multiple experiments, cross-domain learning, and the ability to prompt the system to take actions to achieve desired outcomes, thereby improving upon conventional machine learning systems.

In particular, the thirteenth system can perform operations for taking action in the environment based on relationship analogs. The system can accumulate analogs in or from a working memory of a symbolic representation generator. The system can accumulate a goal analog, the goal analog comprising a reward analog bound to a causal localist unit. The system can retrieve, based on the analogs accumulated in or from the working memory and the goal analog, a relationship analog. The system can provide instructions to take an action in an environment based on the retrieved relationship analog.

Additionally or alternatively, the thirteenth system can include means for accumulating analogs in or from a working memory of a symbolic representation generator. The system can include means for accumulating a goal analog, the goal analog comprising a reward analog bound to a causal localist unit. The system can include means for retrieving, based on the analogs accumulated in or from a working memory and the goal analog, a relationship analog. The system can include means for providing instructions to take an action in an environment based on the retrieved relationship analog.

The disclosed embodiments include a fourteenth machine learning system for combined observational and experimental learning using relationship analogs. As described herein, analogs can be generated using non-interactive learning. The system can then use these analogs to generate additional analogs through interactive experimentation. These additional analogs can extend, generalize, or refine the originally generated analogs. For example, these additional analogs can represent a process of relational learning as applied to the original analog or represent the commonalities observed in multiple experiments through a process of comparison-based refinement. This ability to combine observational and experimental learning constitutes a technical improvement over conventional machine learning systems.

In particular, the fourteenth system can perform operations for combined observational and experimental learning using causal relationship analogs. The system can generate a first relationship analog through non-interactive learning. The system can generate a second relationship analog through interactive experimentation using the first causal relationship analog. The interactive experimentation can include accumulating analogs during an experimental unit and specifying a goal. The interactive experimentation can further include retrieving the first relationship analog based on the specified goal and the accumulated analogs. The interactive experimentation can further include generating the second relationship analog based on at least one of relational learning or comparison-based refinement, the generation using the first relationship analog and the accumulated analogs.

Additionally or alternatively, the fourteenth system can include means for generating a first relationship analog through non-interactive learning and symbolic representation generator means for generating a second relationship analog through interactive experimentation using the first relationship analog. The interactive experimentation can include accumulating analogs during an experimental unit and specifying a goal. The interactive experimentation can further include retrieving the first relationship analog based on the specified goal and the accumulated analogs. The interactive experimentation can further include generating the second relationship analog based on at least one of relational learning or comparison-based refinement using the first relationship analog and the accumulated analogs.

The disclosed embodiments include a fifteenth system for taking action in an environment. The system can generate a policy that includes symbolic representation experimental conditions (SRECs). The SRECs can be generated based on analogs present in a symbolic representation. In some embodiments, the symbolic representation can be a symbolic memory network. During an experimental unit, the system can provide instructions to take an action in the environment (or perturb the symbolic representation generator) when analogs in the symbolic representation match SRECs assigned to the policy. As described herein, the generation and assignment of SRECS can link the contents of the symbolic representation to actions taken by the system (and to perturbations of the symbolic representation generator). Thus, the self-supervised experimentation architecture described herein can include the recited generation and assignment of SRECs and taking actions based on the SRECs. As described and demonstrated herein, this architecture can improve upon conventional machine learning systems by reducing the memory and compute resources required for suitable performance of tasks.

In particular, the fifteenth system can perform operations for taking actions in the environment. The system can determine SRECs based on analogs contained in a symbolic representation generated by a symbolic representation generator. The system can further assign at least some of the SRECs to a policy in accordance with an experimental design. The system can, during an experimental unit, match a first SREC assigned to the policy to analogs in the symbolic representation and provide instructions to take actions in an environment based on the matched first SREC.

The disclosed embodiments include a sixteenth system that experiments upon the operations, components, and parameters of a symbolic representation generator. The system can perform this experimentation while the symbolic representation generator computes a symbolic representation and takes actions based on the contents of the symbolic representation. In some embodiments, the symbolic representation can be a symbolic memory network. As described herein, such experimentation enables the system to guide the development of a symbolic representation that encodes causal relationships observed in the environment. As described and demonstrated herein, this architecture can improve upon conventional machine learning systems by reducing the memory and compute resources required for suitable performance of tasks.

In particular, the sixteenth system can perform operations for experimenting upon the operations, components, and parameters of a symbolic representation generator. The system can determine symbolic representation generator parameters and select and configure an experimental design. The system can assign SRECs to a policy according to the experimental design. The system can, during an experimental unit, match SRECs assigned to the policy to analogs in a symbolic representation generated by the symbolic representation generator using input obtained from an environment according to the symbolic representation generator parameters. The system can provide instructions to take actions in the environment based on a matched first SREC. The system can further provide instructions to update the symbolic representation generator parameters based on a result of the experimental unit.

The disclosed embodiments include a seventeenth system that uses a secondary memory network. The secondary memory network can be configured to store traces (or analogs) for subsequent retrieval and use in generating analogs. As described herein, a system may store a trace (or analog) when an attempt to generate an analog using the trace fails. The system may retrieve the trace (or analog) for subsequent processing suitable conditions are met. The retrieved trace (or analog) can be used to generate another analog, which can be stored in the symbolic memory network (or potentially stored in the secondary memory). This generated analog may subsequently be retrieved and prompt the system to take an action in the environment, as described herein. In some embodiments, the secondary memory can preserve inputs including potentially valuable data that might otherwise be deleted from the symbolic memory network when analog creation fails, protect the long-term network memory from un-refined analogs that may entangle multiple causal relationships, support construction of analogs in non-sequential environments, and reduce resource requirements. Accordingly, a system architecture as described herein that includes the secondary memory can constitute an improvement over conventional machine learning systems.

In particular, the seventeenth system can perform operations for taking action in the environment using a secondary memory network. The system can retrieve a trace from the secondary memory network. The system can generate an analog by reprocessing the trace using: at least one of input data obtained from an environment, and at least one analog obtained from a symbolic memory network. The system can determine that the generated analog may be stored in the symbolic memory network. The system can provide instructions to take an action in the environment based on subsequent retrieval of the generated analog from the symbolic memory network.

The disclosed embodiments include an eighteenth system that includes multiple inference engines that generate differing candidate actions. One inference engine can generate a causal analog using abduction and a candidate action corresponding to the causal analog. Another inference engine can generate a candidate action based on a causal model, as described herein. A moderator can select among the candidate actions based on information-theoretic criteria. As may be appreciated, the ability to generate multiple candidate actions, including actions based on causal analogs, constitutes an improvement over conventional machine learning systems.

In particular, the eighteenth system can perform operations for taking action in an environment. The system can generate multiple candidate actions using corresponding inference engines, the inference engines generating the multiple candidate actions using a symbolic memory network. The system can determine information metric values for respective candidate actions. The system can select one of the multiple candidate actions based on the determined information metric value. The system can provide instructions to perform the selected candidate action in an environment.

The disclosed embodiments include a nineteenth system that experimentally determines a selectivity threshold for identifying analogs as being entangled. As described herein, an entangled analog may lack selectivity for a particular association. Instead, the entangled analog may represent a mixture of different associations. As described herein, a comparison-based refinement process can be used to generate less-entangled analogs. In some embodiments, both the original entangled analog and the newly generated, less-entangled analog may be retained in the symbolic memory network. As may be appreciated, retaining multiple related copies of an analog in the symbolic memory network may increase compute and memory requirements. For example, as described herein, retrieval of analogs into working memory may involve calculating activations for analogs stored in the symbolic memory network. Calculating activations for many similar analogs may be computationally inefficient. The system can experiment upon a selectivity threshold to determine when an entangled analogs may be released from the symbolic memory network, thereby reducing compute and optionally memory requirements, while monitoring the effect on performance metrics (e.g., task performance, predictive accuracy, rewards, or the like).

In particular, the nineteenth system can perform operations for taking action in an environment. The system can identify an analog in a symbolic memory network of a symbolic representation generator as being entangled. This identification can be based upon a selectivity threshold monitored by an inference component. The inference component can monitor the selectivity threshold at least in part by experimenting on the selectivity threshold to determine a causal relationship between the selectivity threshold and at least one effect estimate. The system can identify a disentangled version of the identified entangled analog in the symbolic memory network of the symbolic representation generator using the identified entangled analog. In response to the identification of the disentangled version of the identified entangled analog, the system can release the identified entangled analog from the symbolic memory network. The system can provide instructions to take an action in an environment based on the disentangled version of the identified entangled analog.

The disclosed embodiments include a twentieth system for generating disentangled analogs using entangled analogs retrieved from a secondary memory network. As described herein, an entangled analog may lack selectivity for a particular association. Instead, the entangled analog may represent a mixture of different associations. A secondary memory can store entangled analogs. Such entangled analogs may be retrieved according to a decay probability and used to generate another analog. Should the generated analog satisfy a strength condition, the analog can be stored in the symbolic memory network. In this manner, the secondary memory network can be used to store entangled analogs, while the symbolic memory network stores more-processed analogs. As may be appreciated, this system can reduce the amount of redundant data in the symbolic memory network, and thereby potentially improve storage and computational efficiency.

In particular, the twentieth system can perform operations for taking action in an environment. The system can retrieve an entangled analog to a working memory from a secondary memory network in accordance with a retrieval probability, the retrieval probability based at least in part on decay function metadata associated with the entangled analog. The system can generate an analog in the working memory using the retrieved entangled analog and input data or an analog retrieved into the working memory from a symbolic memory network. The system can store, based on a strength of the generated analog and a strength threshold, the generated analog in the symbolic memory network. The system can provide instructions to take an action in an environment based on a subsequent retrieval of the generated analog from the symbolic memory network.

The disclosed systems can be implemented using processors and non-transitory computer-readable media containing instructions that, when executed by the processors, cause the systems to perform the disclosed operations. The disclosed embodiments also include computer implemented methods corresponding to the disclosed operations. The disclosed embodiments also include the non-transitory computer-readable media containing instructions that, when executed by the processors, cause the systems to perform the disclosed operations.

The foregoing general description and the following detailed description are exemplary and explanatory only and are not restrictive of the claims.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1A depicts an exemplary machine learning system including a symbolic representation generator and an inference component, in accordance with one or more aspects of this disclosure.

FIGS. 1B to 1D depict exemplary applications of the machine learning system of FIG. 1A, in accordance with one or more aspects of this disclosure.

FIG. 2 depicts an exemplary machine learning process, in accordance with one or more aspects of this disclosure.

FIG. 3A depicts exemplary components of a symbolic representation generator, in accordance with one or more aspects of this disclosure.

FIG. 3B depicts exemplary components of a symbolic representation generator configured to cause the machine learning system to provide output including commands, in accordance with one or more aspects of this disclosure.

FIG. 3C depicts operation of an exemplary symbolic representation generator including a memory network and a secondary memory network, in accordance with one or more aspects of this disclosure.

FIG. 3D depicts components of a secondary memory network, in accordance with one or more aspects of this disclosure.

FIG. 3E depicts exemplary components of a symbolic representation generator configured with multiple preprocessors, invariance circuits, and memory categories, in accordance with one or more aspects of this disclosure.

FIG. 3F depicts an exemplary process for controlling preprocessing of input data, in accordance with one or more aspects of this disclosure.

FIGS. 3G to 3J depict exemplary applications of the process of FIG. 3F, in accordance with one or more aspects of this disclosure.

FIG. 3K depicts an exemplary operation of linguistic and visual preprocessors, in accordance with one or more aspects of this disclosure.

FIG. 4A depicts an exemplary implementation of a memory network, in accordance with one or more aspects of this disclosure.

FIGS. 4B to 4E depict motivation for and exemplary implementations of relational metric precision, in accordance with one or more aspects of this disclosure.

FIG. 4F depicts an exemplary invariance circuit, in accordance with one or more aspects of this disclosure.

FIG. 4G depicts selection of an analog based on the environment, in accordance with one or more aspects of this disclosure.

FIG. 4H depicts selection of analogs based on the contents of the driver, in accordance with one or more aspects of this disclosure.

FIG. 4I depicts mapping between localist units in the selected analog in the driver and localist units of analogs in the recipient, in accordance with one or more aspects of this disclosure.

FIG. 4J depicts generalization using the memory network, in accordance with one or more aspects of this disclosure.

FIG. 4K depicts predicate learning using the memory network, in accordance with one or more aspects of this disclosure.

FIG. 4L depicts relational refinement using the memory network, in accordance with one or more aspects of this disclosure.

FIGS. 4M and 4N depict difference-encoding using memory network, in accordance with one or more aspects of this disclosure.

FIGS. 4O to 4Q, depict the progressive formation of disentangled analogs, in accordance with one or more aspects of this disclosure.

FIG. 5A depicts an exemplary inference component, in accordance with one or more aspects of this disclosure.

FIG. 5B depicts an exemplary inference component configured to cause the machine learning system to provide output including commands, in accordance with one or more aspects of this disclosure.

FIG. 5C depicts an exemplary machine learning system including a symbolic representation generator and an inference component, the inference component including a moderator and two inference engines, in accordance with one or more aspects of this disclosure.

FIGS. 5D and 5E depict selection between candidate actions generated by a normative and abductive model in the context of a game of Space Invaders®.

FIG. 6 depicts a causal monitoring process, in accordance with one or more aspects of this disclosure.

FIG. 7A depicts interleaving of experimental units assigned different levels of an independent variable in a sequence of five experimental units, in accordance with one or more aspects of this disclosure.

FIG. 7B depicts an exemplary dependence of the observed performance metric on experiment duration, in accordance with one or more aspects of this disclosure.

FIG. 7C depicts an exemplary interleaving of experimental units into two distinct clusters, in accordance with one or more aspects of this disclosure.

FIGS. 7D and 7E depict exemplary data windows for the first and second clusters depicted in FIG. 7C, in accordance with one or more aspects of this disclosure.

FIG. 7F depicts performance measure values for a series of experimental units, in accordance with one or more aspects of this disclosure.

FIG. 8A depicts components of an exemplary causal model, in accordance with one or more aspects of this disclosure.

FIG. 8B depicts treatment effect estimates, in accordance with one or more aspects of this disclosure.

FIGS. 9 to 10C illustrate a method of generating salience data, in accordance with one or more aspects of this disclosure.

FIGS. 11A and 11B depict treatment effect estimates, in accordance with one or more aspects of this disclosure.

FIG. 11C depicts selection frequency of the treatment levels during exploit trials, in accordance with one or more aspects of this disclosure.

FIGS. 12A and 12B depict salience data, in accordance with one or more aspects of this disclosure.

FIG. 12C depicts an exemplary mapping from dynamicity scores to activation bias, in accordance with one or more aspects of this disclosure.

FIG. 13 depicts perturbation of memory network, in accordance with one or more aspects of this disclosure.

FIG. 14A depicts an exemplary process for initializing a machine learning system, in accordance with one or more aspects of this disclosure.

FIG. 14B describes a suitable experimental design, experimentation, and analysis process for determining treatment effects, in accordance with one or more aspects of this disclosure.

FIGS. 15A to 15D depict an exemplary experimental design process, in accordance with one or more aspects of this disclosure.

FIGS. 16A to 16E depict an exemplary experimental design process, in accordance with one or more aspects of this disclosure.

FIGS. 17A to 17C depict an exemplary experimental design process, in accordance with one or more aspects of this disclosure.

FIGS. 18A and 18B depict an exemplary experimental design process, in accordance with one or more aspects of this disclosure.

FIG. 19A depicts a process for performing reward-based observational learning, in accordance with one or more aspects of this disclosure.

FIGS. 19B and 19C provide two equivalent depictions of an analog, in accordance with one or more aspects of this disclosure.

FIG. 20A depicts an exemplary implementation of causal localist units, showing an observed treatment analog and observed outcome analog, in accordance with one or more aspects of this disclosure.

FIG. 20B depicts an alternative exemplary implementation of causal localist units, showing an observed treatment analog and observed outcome analog, in accordance with one or more aspects of this disclosure.

FIG. 21 depicts matching the observed treatment and outcome with another observed treatment and output, in accordance with one or more aspects of this disclosure.

FIG. 22 depicts representational generalization using the causal analog depicted in FIG. 21, in accordance with one or more aspects of this disclosure.

FIGS. 23A and 23B depict comparison-based refinement using the causal analogs depicted in FIG. 22, in accordance with one or more aspects of this disclosure.

FIG. 24 depicts a process of reward-based interactive learning, in accordance with one or more aspects of this disclosure.

FIG. 25A depicts stored and accumulated analogs, in accordance with one or more aspects of this disclosure.

FIG. 25B depicts stored and accumulated analogs using an alternative exemplary implementation of causal localist units, in accordance with one or more aspects of this disclosure.

FIG. 26 depicts matching a retrieved analog to the accumulated analogs, in accordance with one or more aspects of this disclosure.

FIGS. 27A and 27B depict representation generation and comparison-based refinement using the causal analogs depicted in FIG. 26, in accordance with one or more aspects of this disclosure.

FIGS. 27C and 27D depict generation of causal relationship analogs, in accordance with one or more aspects of this disclosure.

FIG. 28 depicts interactions between an environment and components of a machine learning system during reward-based interactive learning, in accordance with one or more aspects of this disclosure.

FIG. 29A depicts exemplary selection of actions based on analogs using a selection function during an experimental unit, in accordance with one or more aspects of this disclosure.

FIG. 29B depicts exemplary selection of actions based on analogs using a set of action instances during an experimental unit, in accordance with one or more aspects of this disclosure.

FIGS. 30A to 30D, 31A and 31B, and 32A to 32D illustrate performance of a machine learning system in accordance with one or more aspects of this disclosure at playing Breakout®, a well-known benchmark for artificial intelligence research.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method operations disclosed in the figures can be rearranged, combined, or divided without departing from the envisioned embodiments. Similarly, additional operations may be added, or operations may be removed without departing from the envisioned embodiments. Thus, the materials, methods, and examples are illustrative only and are not intended to be necessarily limiting.

Conventional sub-symbolic machine learning architectures (e.g., large language models, deep learning neural networks, and the like) can be constrained by their architecture as purely statistical function approximation machines. These sub-symbolic architectures can be optimized to minimize error in high-dimensional parameter spaces via gradient-based methods such as backpropagation. However, such sub-symbolic architectures lack inherent mechanisms for encoding or reasoning with causal structures, instead relying on statistical correlations within their training data. This inability to infer causation from correlation arises from their design, which prioritizes predictive accuracy over principled causal inference, preventing them from distinguishing between true causal relationships and spurious statistical patterns.

Consequently, sub-symbolic architectures can fail in out-of-distribution contexts, often producing hallucinations (e.g., overconfident, semantically, or factually incorrect outputs). Furthermore, such hallucinations may be difficult to identify or mitigate, because sub-symbolic architectures may be configured to use likelihood or reward as proxy for truth value (e.g., a likely statement may not be a true statement). Moreover, sub-symbolic architectures can encode knowledge in entangled, distributed representations across weight matrices, where features and concepts are implicitly embedded through non-localized activations. This structural entanglement results in opaque models that may lack interpretable, decomposable representations, severely limiting their application in domains requiring traceable, human-readable decision processes.

Sub-symbolic architectures may also lack the ability to encode structured, symbolic representations of relational or compositional knowledge. Unlike human cognition, which systematically constructs and operates on first-order logics (e.g., reasoning about objects and their explicit relationships, such as “A is above B”) and second-order logics (e.g., reasoning about rules, such as “for all X, if X is true of Y, then Z holds”), these sub-symbolic architectures may not represent predicates, quantifiers, or variables. Their non-symbolic, task-specific representations may preclude the systematic generalization, compositionality, and abstraction necessary to reuse learned knowledge across domains, leading to brittle performance and requiring exhaustive retraining for even marginally altered tasks. And while certain hybrid neuro-symbolic architectures may represent predicates, quantifiers, and variables, these architectures may include both a sub-symbolic component and a symbolic component. The symbolic component, and not the sub-symbolic component, may be tasked with representing such predicates, quantifiers, and variables.

Additionally, the brute-force optimization techniques upon which sub-symbolic architectures rely, such as iterative backpropagation through large parameter spaces, necessitate vast computational resources and massive labeled datasets to constrain their solutions. This reliance not only scales poorly but also reflects a fundamental absence of inductive biases required for efficient learning in data-sparse environments, further compounding their inefficiency and limiting their scalability to real-world contexts where structured reasoning and sparse data availability are critical. In sum, the nature of sub-symbolic architectures as statistical function approximators can restrict the ability of such architectures to address tasks requiring causal inference, systematic generalization, and human-level relational reasoning.

Such inefficiencies, in some conventional implementations, can restrict the democratization of artificial intelligence by tethering performance to massive computational resources and labeled datasets, potentially preventing resource-constrained regions and organizations from accessing state-of-the-art capabilities. The reliance on brute-force optimization techniques can exacerbate the environmental costs of artificial intelligence development, as the computational demands for training large-scale models contribute significantly to energy consumption and carbon emissions. Moreover, the opacity of entangled representations can impede adoption in critical domains such as healthcare, autonomous systems, and legal decision-making, where the inability to produce interpretable, causally grounded outputs undermines trust and safety. Without mechanisms for relational reasoning or abstraction, sub-symbolic architectures may fail outright in high-stakes scenarios requiring adaptive, cross-domain generalization, from scientific discovery to dynamic crisis management, stalling progress in fields that demand robust, explainable intelligence. Furthermore, such limitations can prevent the effective application of deep learning across niche, data-sparse products and processes, where reliance on massive datasets and fully digitized environments renders sub-symbolic architectures infeasible.

Systems and techniques of this disclosure, in some embodiments, implement a machine learning system that combines a symbolic architecture with an inference component for autonomously discovering and optimizing causal relationships. The symbolic computational architecture of this disclosure can generate structured, symbolic relational representations from raw, unstructured inputs and use those representations for symbolic thought, problem solving, and cross-domain generalization. The inference component complements the symbolic architecture by enabling the de novo generation of structured symbolic representations while integrating causal inference.

In some embodiments, the disclosed machine learning system can improve upon the performance of conventional sub-symbolic architectures and addresses limitations of sub-symbolic architectures, including massive energy consumption, the propensity to hallucinate, fundamental limitations in interpretability, and the related risks to artificial intelligence, alignment, control, and safety.

On games that current sub-symbolic architectures can master, the architecture of this disclosure demonstrates dramatic improvements in speed, efficiency, memory or storage requirements, and processing power or compute. A machine learning system in accordance with one or more aspects of this disclosure can learn to play Breakout®, a game with a rich history as an artificial (AI)/machine learning (ML) benchmark, de novo, starting from raw pixel input and receiving only reward signals, with no hand-coded features or prior knowledge of game mechanics. A machine learning system in accordance with one or more aspects of this disclosure can master Breakout® in fewer than two games (~8 trials), compared to the many thousands of games required by advanced deep learning-based AI systems.

The machine learning system can, in some embodiments, further master extended versions of Breakout® with added complexities, such as an environment with non-stationary causal relationships, rules, or rewards; dynamic color rules requiring one or more of paddle and ball color matching; delayed rewards necessitating long-term causal reasoning; or precision targeting of color-specific bricks. In some scenarios, the performance gap between state-of-the-art deep learning system and those of the instant disclosure widens. In other scenarios (e.g., scenarios combining such complexities) state-of-the-art deep learning systems fail outright. In contrast, a machine learning system in accordance with one or more aspects of this disclosure can consistently master extended versions of Breakout® with added complexities in far fewer trials than state-of-the-art deep learning systems require for standard Breakout®.

The machine learning system of this disclosure can, in some embodiments, learn purely by observing a game being played. Starting from a blank slate, the machine learning system can passively observe environment interactions (e.g., a human playing the game) and, upon first obtaining the ability to interact with the game, can exhibit expert play in a zero-shot, or near-zero-shot, fashion. This ability, mirroring human observational learning, is entirely absent in current state-of-the-art deep learning systems, which rely heavily on trial-and-error explorations or extensive training datasets. These results suggest a fundamentally new paradigm for AI.

In some embodiments, the symbolic architecture can be an implementation based on, or a version of, the DORA (Discovery of Relations by Analogy) neurocomputational model described in Doumas, Leonidas & Hummel, John & Sandhofer, Catherine, “A Theory of the Discovery and Predication of Relational Concepts,” Psychological Review, 115, 1-43, (2008) and Doumas, L. A. A., Puebla, G., Martin, A. E., & Hummel, J. E., “A theory of relation learning and cross-domain generalization,” Psychological Review, 129(5), 999-1041 (2022), or the LISA (Learning and Inference with Schemas and Analogies) neurocomputational model described in Hummel, J. E., & Holyoak, K. J., “Distributed representations of structure: A theory of analogical access and mapping,” Psychological Review, 104, 427-466, (1997) and Hummel, J. E., & Holyoak, K. J., “A symbolic-connectionist theory of relational inference and generalization,” Psychological Review, 110, 220-264, (2003), which are incorporated herein by reference in their entireties for all purposes. Unlike sub-symbolic architectures, which are purely function approximation machines, DORA models how the human cortex builds symbolic relational representations and mediates symbolic thought, including first-order logics and second-order logics. Such “functional second-order capacity” can include the ability of the architecture to represent predicates and attributes as independent entities, separate from their instances, and to dynamically bind those predicates to arbitrary fillers. This ability can be functionally equivalent to capabilities of formally defined second-order logic (even though the architecture may not implement the full symbolic calculus of formal second-order logic as defined in mathematical logic). The architecture can achieve this functional equivalence using neural-symbolic mechanisms of role-filler binding and dynamic assignment. Additionally, DORA replicates critical features of human cognition, such as abstraction (deriving general principles from specific examples), compositionality (combining simpler elements into complex structures), and systematicity (reusing representations across contexts). The disclosed embodiments are not limited to implementations based on, or being versions of, the DORA neurocomputational model. For example, a symbolic representation generator based on concepts implemented by the DORA neurocomputation model may also be used (e.g., representing relations with units capable of binding arguments, including other relations, the arguments in turn being represented by other units, or other implementation-relevant concepts).

Conventional stand-alone implementations of DORA as an artificial intelligence system can face implementation challenges, including scalability challenges. As the number of objects and relations increases, the number of possible relational structures can grow exponentially. This combinatorial explosion can make such DORA implementations impractical for real-world problem spaces or large-scale, complex environments or problem domains. In some embodiments, as disclosed herein, an inference component can address scalability challenges by empirically determining important (or unimportant) relational structures. In some embodiments, the inference component can perform self-supervised management of the experimental parameters involved in this empirical determination.

In some embodiments, the inference component can be a version of Dynamic Causal Learning (DCL), as described in U.S. Pat. No. 12,282,303 (“Deep Causal Learning for Continuous Testing, Diagnosis, and Optimization”); U.S. Pat. No. 12,386,320 (“Controlling a Manufacturing Process Using Causal Models”); U.S. Pat. No. 11,927,926 (“Determining Causal Models for Controlling Environments”); U.S. Pat. No. 12,487,569 (“Method of Performing a Process and Optimizing Control Signals Used in the Process”); U.S. Pat. No. 11,853,018 (“Determining Causal Models for Controlling Environments”); U.S. Pat. No. 11,927,926 (“Determining Causal Models for Controlling Environments”); and U.S. Pat. No. 11,966,204 (“Determining Causal Models for Controlling Environments’) which are incorporated herein by reference in their entireties for all purposes. In addition to the above-referenced patents, DCL is further described below. DCL can be implemented as a model-free, fully autonomous causal inference framework inspired by the principles of adaptive clinical trials, designed to discover and optimize causal relationships in complex environments. By operating in a “model-free” way, DCL does not, in some embodiments, rely on predefined structural models but empirically derives causal models through recursive experimentation. In some implementations, once initialized with data streams, variable definitions, and an optimization goal, DCL can operate without user intervention or external hyperparameter tuning.

In some implementations, DCL can conduct thousands of interconnected randomized experiments, continuously refining its data-driven causal models and optimizing system performance. Parameters, such as the assignment of treatment levels to experimental units, the adjustment of temporal or spatial extents, or the balance between exploration and exploitation, can be treated as part of a dynamic, recursive process. This causal inference framework can experiment on its own operational parameters in real time, while simultaneously experimenting on the external world. Point and interval effect estimates, computed for variables and interaction, can drive decision-making, and guide the allocation of epistemic resources, enabling this causal inference framework to prioritize regions of the variable space with greater statistical power and optimization potential.

Conventional implementations of DCL can scale to systems with thousands of variables, discovering complex interactions while managing dimensionality. The components of this causal inference framework can operate as independent optimization routines, conditionally adjusting to each other in an emergent, synchronized balance. In some embodiments, this emergent, synchronized balance can ensure Pareto-optimal configurations. By unifying adaptive experimentation and causal inference, this causal inference framework can transform the rigor of clinical trials into a dynamic, real-world optimization engine that can be autonomous and can reduce or eliminate the need for predetermined hyperparameters.

Systems of this disclosure include, as a non-limiting example, a machine learning system that combines a symbolic representation generator (e.g., configured to construct and maintain a memory network, such as a symbolic connectionist neural network), such as DORA, with an inference component, such as DCL. This combination can address various limitations described above, while enabling novel emergent capabilities.

The systems of this disclosure may in some embodiments enhance the scalability and applicability of artificial intelligence systems in real-world, unstructured environments. The system architectures of this disclosure can provide scalable, automated alternatives to the use of hand-specified features, predefined data streams, or carefully framed constraints provided by human users. The system architectures of this disclosure can therefore mitigate challenges to implementation of an inference component, such as DCL, as an AI solution in real-world, unstructured environments. Additionally, the systems of this disclosure enhance the robustness and error-resilience of such an inference component, while also reducing resource footprint and easing domain expertise reliance. System architectures of this disclosure can augment an inference component, such as DCL, with the ability to autonomously construct representations and operate de novo, thereby enabling the inference component to discover and define the representations needed to tackle real-world, unstructured tasks, particularly those that have not already been digitized into certain formats.

In some embodiments, the inference component can perform multiple separate instances of causal experimentation. In accordance with some disclosed embodiments, this experimentation can be self-supervised. These instances can address different facets of learning and representation. One instance can function internally, focusing on the memory network. Through dynamic experimentation, the inference component can systematically excite or inhibit components of the memory network. In this manner, the inference component can test the causal relevance of specific components for task performance, predictive accuracy, or the like. This internal experimentation allows the machine learning system to dynamically prioritize relational representations that are predictive of outcomes while refining the broader library of representations for generalizability.

Another instance can function externally, conducting adaptive experiments in the environment. By actively manipulating the state of the environment and observing the effects of such manipulations on inputs received from the environment (e.g., reward signals, or the like), this external instance can generate confound-free, causally robust knowledge that grounds the memory network in the true dynamics of the external world.

In some embodiments, such multiple layers of internal and external experimentation can create a feedback loop, enabling the machine learning system to refine its relational knowledge while efficiently navigating the combinatorial explosion of possible relational structures. These mechanisms not only enhance the machine learning system's scalability and interpretability but can also empower it to adaptively and autonomously master complex tasks from raw inputs.

As described herein, in some embodiments, experimental results can feed back into the memory network. In some embodiments, the experimental results can refine the structured relational representations stored within the memory network, enhancing their granularity and fidelity. In some embodiments, the experimental results can dynamically prioritize task-relevant representations, enabling the machine learning system to allocate computational resources efficiently while maintaining the flexibility to adapt to new contexts. This integration of reward-driven and knowledge-driven experimentation can facilitate the machine learning system's ability to balance performance metrics based on existing knowledge representations (e.g., exploitation) and constructing new knowledge representations that can be flexibly employed for later performance improvements (e.g., exploration).

In some embodiments, the inference component can apply counterfactual reasoning to components of the memory network to evaluate their relevance to predictive accuracy. In such embodiments, the inference component can determine the components of the memory network that enable accurate predictions of future events in the environment. Notably, such counterfactual reasoning and evaluation need not involve interactions with the environment. Instead, such reasoning and evaluation can proceed observational.

For example, when two components of the memory network appear relevant to understanding an observed causal chain, the inference component can dynamically modulate the activation of these components, exciting or inhibiting each component using randomization and experimental control and evaluate the predictive performance of the machine learning model. If inhibiting a specific component does not reduce predictive accuracy, the component can be depreciated or removed from the memory network. By iteratively refining the memory network in this manner, the inference component can isolate the subset of representations required to understand the observed dynamics. This process enables the symbolic representation generator to build a robust relational model through observation that reflects underlying environmental causality, rules, or rewards. In turn, this robust relational model can provide the foundation for zero-shot mastery upon subsequent direct interaction with the environment.

In some embodiments, when the machine learning system can interact with the environment, it can continue refining its internal representations through the same self-supervised learning process. In addition, the inference component can directly experiment on the environment. This external experiment can complement the internal refinement process by generating confound-free, causally robust knowledge structures.

As described herein, in some embodiments, internal refinement and external experimentation can target complementary goals. Reward-focused external experimentation can prioritize relationships directly tied to rewards, such as testing whether paddle-ball color-matching increases the score in Breakout®. By dynamically adjusting variables and representations to maximize an objective function, external experimentation can drive short-term optimization. Conversely, knowledge-focused internal refinement can explore causal relationships independent of a reward signal, identifying latent variables and higher-order interactions that contribute to a richer causal understanding of the environment (e.g., task performance, predictive accuracy, or the like). This approach can enable the machine learning system of this disclosure to maintain a robust and generalizable knowledge base, enriching its ability to adapt to new domains or tasks.

### Machine Learning System

In accordance with some embodiments of the disclosure, a machine learning system can experimentally control at least one of actions taken in the environment or perturbations to symbolic representational operations, components, or parameters. The machine learning system can estimate the causal effects of these actions or perturbations. The machine learning system can use these estimates to govern future representational and behavioral processing. Such future representational processing may include the future performance of symbolic representational operations, components, or parameters, as described herein. Such behavioral processing may include the control of future actions to be taken in the environment.

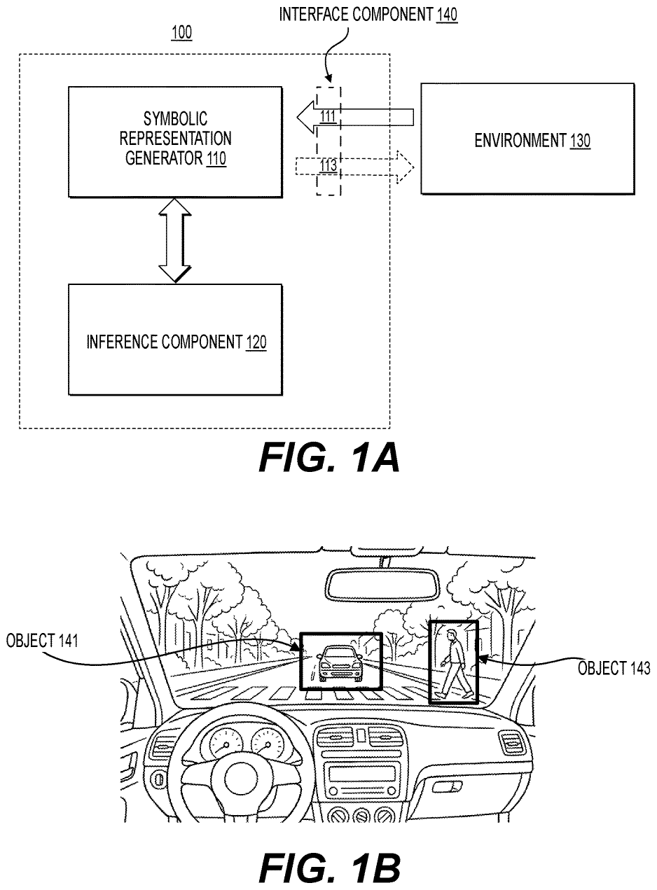

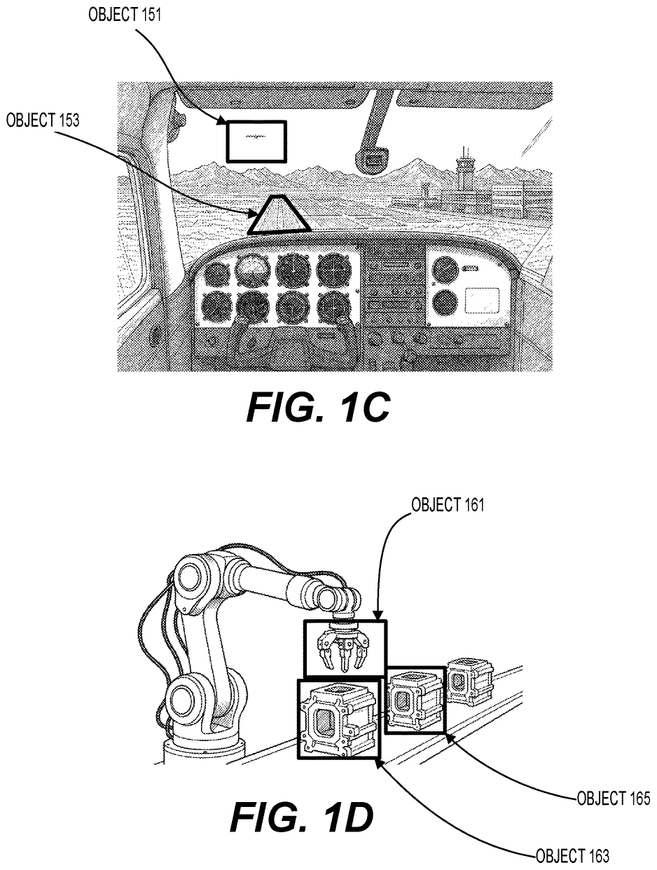

FIG. 1A depicts an exemplary machine learning system 100 including a symbolic representation generator 110 and an inference component 120 (both discussed earlier), in accordance with one or more aspects of this disclosure. Machine learning system 100 can further include an interface component 140 configured to obtain input 111 from or provide output 113 to environment 130. Environment 130 can be or include a computer application, such as a consumer entertainment or productivity application (e.g., a video game, chat program, large language model-based application, office or artistic/creative or other productivity application, or the like), production management software, robotics or autonomous operation software (e.g., autonomous driving, industrial or consumer robotics, flight, or the like), security software, simulation or design software (e.g., characterizing compound properties based on chemical formulas, circuit design, or the like), or other suitable computer application. As used herein, computer applications include both embedded and general-purpose applications. Objects can be observed in the inputs received from the environment, such as things or regions in a visual scene (e.g., a scene or frame of visual data, such as image data, acquired from the environment) or linguistic objects (e.g., words, parts of words, punctuation, or the like) in a document or the like. Furthermore, as may be appreciated, environment 130 is not limited to computer applications, and may include inputs indicative of real-world environments having physical objects observed as moving and interacting with each other (e.g., a vehicle driving or pedestrian environment, aerospace, outer space, urban, country, desert, forest, industry-specific such as manufacturing or laboratory or the like, etc.).

In some embodiments, input 111 can include information about the environment. The information about the environment can include information about objects observed in the environment. The information about the environment can include different information modalities, such as textual information (e.g., alphanumeric information, code, or the like), sensor information, data, or the like. Sensor information can include image data, video data, audio data, tactile data, chemical data, biometric data, environmental data (e.g., temperature, humidity, pressure, light, gases, or the like), spatial sensing information (e.g., radar, lidar, ultrasound, or the like), industrial or machine sensor information (e.g., speed, flow, vibration, pressure, temperature, position, or the like), or other suitable information. For example, image or video data can include pixel information (e.g., pixel values according to a color scheme such as RGB, HSL, HSV, or the like). The disclosed embodiments are not limited to input 111 including any particular content, type, or modality of such information.

In some embodiments, input 111 can be received in sets, such as frames of graphical data from a graphical user interface. In some embodiments, input 111 can be repeatedly received over time and can therefore capture changes in the environment over time (e.g., changes in the states of objects observed in the environment over time). In some embodiments, input 111 can have a spatial component. For example, machine learning system 100 can receive input 111 associated with different spatial regions. As a further example, a frame of graphical data may be segmented into chunks. These chunks may be processed sequentially, each chunk being associated with a spatial region. As may be appreciated, input 111 can include multiple input modalities. Receipt of different input modalities or input associated with different spatial regions may or may not be temporally synchronized.

In certain aspects, machine learning system 100, represents a fundamentally new class of architecture in which symbolic representations and empirical causal inference(s) are fused into a recursive, co-evolving system. In these examples, the combination of symbolic representation generator 110 and inference component 120 illustrated in FIG. 1A represents a causally grounded self-refining symbolic engine, where a causal inference module actively sculpts what the system represents, prioritizes, and reinforces.

As described herein, in some embodiments, machine learning system 100 can be implemented using one or more computing systems. For example, machine learning system 100 can be implemented using a wearable device (e.g., a smartwatch), a mobile device (e.g., a smart phone, tablet, laptop, or the like), a desktop or workstation, a computing cluster, a cloud computing platform, or any combination of the foregoing devices.

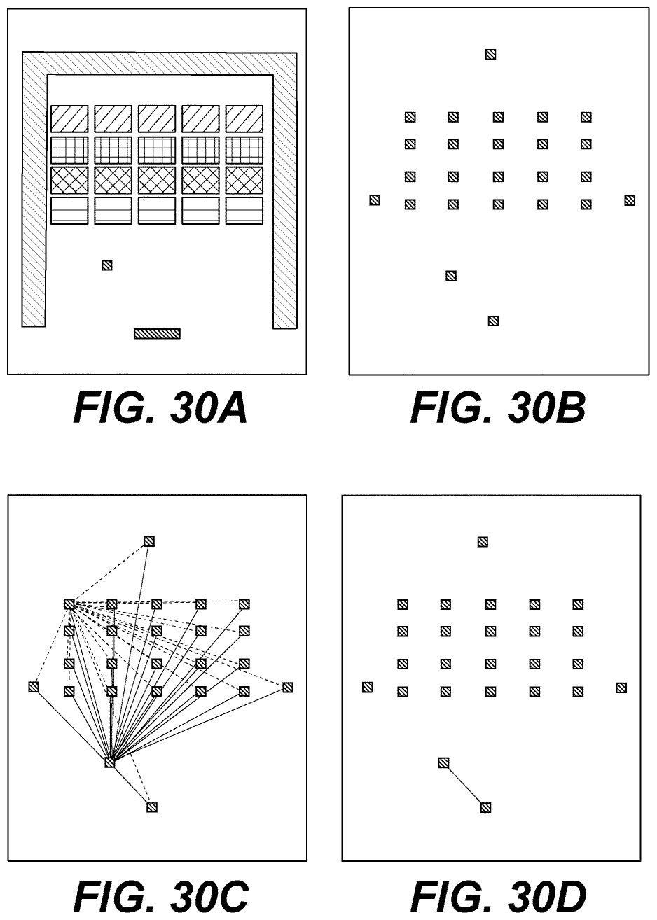

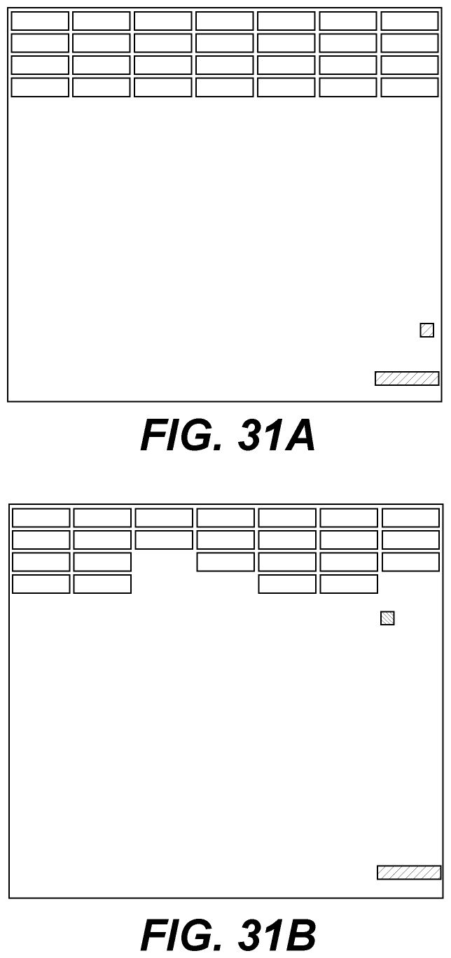

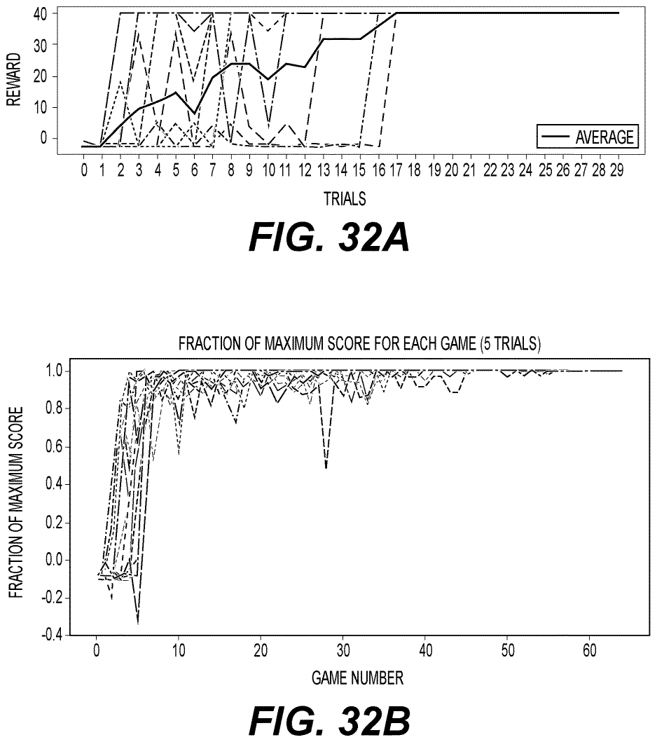

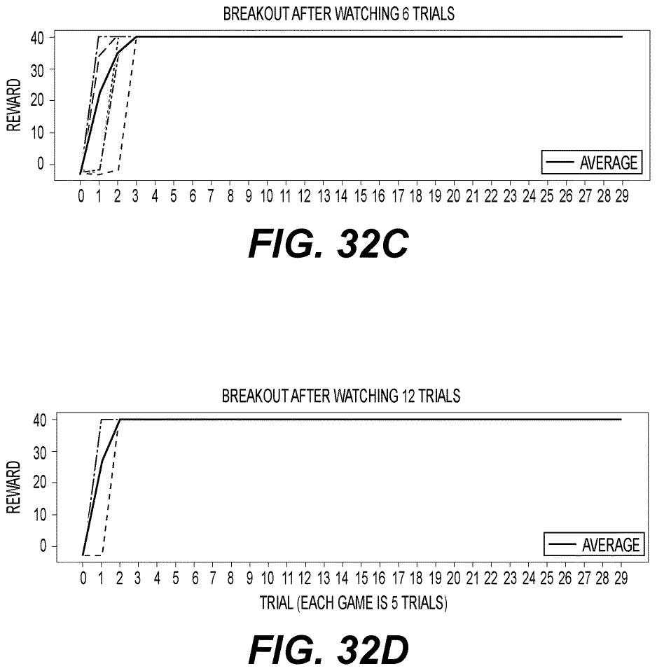

As demonstrated by the results depicted in FIGS. 30A to 30D, 31A and 31B, and 32A to 32B, machine learning systems in accordance with one or more aspects of this disclosure can be implemented using less memory or storage and less processing power or compute than traditional sub-symbolic architectures. For example, a machine learning system in accordance with one or more aspects of this disclosure can master Breakout® in fewer than two games (~8 trials), compared to the many thousands of games required by state-of-the-art advanced deep learning-based AI systems. Additionally, the memory network required to achieve this performance can be massively smaller than the million- or billion-parameter models required to implement sub-symbolic approaches. Accordingly, both the memory or storage required to implement this memory network, and the processing power required to maintain it, can be substantially less than a traditional, similarly performant sub-symbolic model.

For example, a traditional sub-symbolic model may be trained using a massive, high-performance computing cluster. The sub-symbolic model may then be deployed to another computing system that lacks the storage and compute to perform further training. In contrast, a machine learning system in accordance with one or more aspects of this disclosure can be trained and deployed (and continue training after deployment) on a computing device with comparatively limited storage, memory, and computational capacities (e.g., a smartwatch, smart phone, tablet, laptop, desktop or workstation, or the like).

As a specific example of this vast disparity in memory and compute requirements, the paper “Human-level Control Through Deep Reinforcement Learning” by V. Mnih et al. (2015) discloses a sub-symbolic architecture that apparently uses about 10 million frames (each frame using about 30 kB) to learn to play Breakout®. This system therefore requires approximately 200-300 GB of memory to store (and sufficient compute to process) the 10 million frames. In contrast, a machine learning system in accordance with one or more aspects of this disclosure can master Breakout® using about 2000 frames, a 5000 times reduction in memory (and likely a similar reduction in compute).

In some embodiments, machine learning system 100 can be configured to interact with environment 130. For example, machine learning system 100 can provide output 113 to environment 130. In some embodiments, output 113 can include commands, instructions, signals, indications, or the like (hereinafter, “commands” or “instructions” for the purpose of conciseness). Such commands can cause actions to occur in the environment or otherwise change the state of the environment (e.g., including the states of objects observed in the environment). As described herein, machine learning system 100 can be configured to provide output 113 to maximize reward signals (minimize negative reward signals) concerning the observed objects (e.g., concerning states of the observed objects or relationships among the observed objects). For example, if environment 130 represents a computer application (e.g., a game, productivity application, or any other suitable computer application), a command can be one or more of the commands supported by the computer application. In some embodiments, output 113 can include information. For example, if environment 130 represents a computer application, environment 130 can process user interactions to receive input data to machine learning system 100 (e.g., chemical formulas, queries, or the like) and output data in response (e.g., chemical characteristics, query responses, or the like).

In some embodiments, symbolic representation generator 110 can be configured to maintain a representation of the environment (e.g., a representation of objects and relationships in the environment). As compared to a sub-symbolic model, this representation can be massively smaller (e.g., 1000s of times smaller). Accordingly, this representation can require less memory or storage, and operations performed on this representation can require less compute. Symbolic representation generator 110 can maintain the representation in part by repeatedly updating the representation based on input 111 received over time by machine learning system 100. As described herein, symbolic representation generator 110 can generate the representation using input obtained from environment 130. In some embodiments, this input may be unstructured. Consistent with some disclosed embodiments, the representation can include symbolic (or localist) components that correspond to objects present in the environment, attributes of the objects, and relationships between the objects. In some embodiments, the representation can include non-symbolic (or distributed) components that indicate basic features of objects. Such non-symbolic components may indicate such basic features in a distributed manner. For example, such non-symbolic components may not support role-filler operations. Additionally, such non-symbolic components may not support cross-domain generalization. The representation can be structured, expressing relationships between objects and/or attributes as collections of components. Symbolic representation generator 110 can perform relational learning to modify the representation. As described herein, symbolic representation generator 110 can create components, connect components into analogs, and refine and generalize analogs. In some embodiments, symbolic representation generator 110 can maintain multiple representations, which may correspond to different inputs, environments, times, or objects.

An “analog” can be a collection of components in the symbolic representation. For example, an analog can include a set of multiple localist components bound together (and bound to distributed components), or multiple such sets. In some embodiments, an analog can include a collection of discrete localist components and explicit relationships among those components. In various embodiments, an analog may include, without limitation, components representing entities, objects, predicates, roles, attributes, or relations, together with explicit bindings that specify how such units participate in structured propositions, relational configurations, or causal hypotheses. An analog may further include connections to distributed components. The distributed components can include semantic features, sensory-derived attributes, or metric representations. In some embodiments, analogs may be stored, activated, retrieved, compared, refined, generalized, deferred, promoted, demoted, or eliminated by machine learning system 100. As may be appreciated, the term “analog” does not imply a certain representational formalism, naming convention, or cognitive model. Analogs in accordance with some embodiments of the disclosed can be implemented using structured symbolic representations, symbolic structures, relational propositions, knowledge structure, symbolic representations, schemas, episodes, graphs, programs, models, or other compositional representational forms. In some embodiments, analogs can exhibit explicit internal structure, explicit role-filler binding, and independent recombinability of constituent elements. In some embodiments, analogs can be individually addressable, selectively activatable or suppressible, and subject to targeted intervention. Accordingly, in some embodiments, the causal contribution of analogs to prediction, inference, or action can be empirically assessed.

In some embodiments, inference component 120 can be configured to monitor symbolic representation generator 110. In accordance with one or more aspects of this disclosure, inference component 120 can repeatedly perform self-supervised experiments to determine the causal significance of components, operations, or parameters of symbolic representation generator 110. The experiments can include providing commands to take actions in the environment or perturbing one or more components, operations, or parameters of symbolic representation generator 110. Components of symbolic representation generator 110 can include the symbolic memory network, invariance circuit(s), preprocessor(s), or the like. As may be appreciated, perturbing the components, operations, or parameters of symbolic representation generator 110 can include perturbing the components, operations, or parameters of the symbolic memory network, invariance circuit(s), preprocessor(s), or the like. For example, perturbing the components, operations, or parameters symbolic representation generator 110 can include adding, deleting, or modifying analogs in symbolic memory network; enabling, disabling, or modifying operations of the symbolic memory network (e.g., mapping, retrieval, relational learning, relational refinement, or the like), invariance circuit(s), preprocessor(s), or the like; changing thresholds or configuration parameters of the symbolic memory network, invariance circuit(s), preprocessor(s), or the like; or other modifications to symbolic representation generator 110. Additional examples of suitable perturbations are provided herein.

Such experimentation enables a reduction in representation size (and therefore memory or storage requirements, and the compute required to process the representation) as causally insignificant components in the representation can be efficiently determined through experimentation. When symbolic representation generator 110 maintains multiple representations, inference component 120 can maintain representation-specific estimates of causal significance, or estimates of causal significance based on multiple representations.

In some embodiments, inference component 120 can be configured to experiment on hyperparameters of the symbolic representation generator 110. Such hyperparameters can include preprocessor hyperparameters that govern the detection of objects and association of objects with features, and/or representation parameters including the mapping of continuous-valued dimensions to discrete distributed units (e.g., the number of such units, the boundary values between units, whether the mapping is categorical-such as step functions- or smooth-such as logistic functions, etc.).

As used herein, a perturbation can be a change to, or a deviation from, the default, normal, or current operating state or method of operation of machine learning system 100 or symbolic representation generator 110 (or component thereof, such as a memory network, preprocessor, or the like). As may be appreciated, a perturbed state or method of operation may subsequently become the default, normal, or current operating state or method of operation of machine learning system 100 or symbolic representation generator 110 (e.g., depending on the results of the experiment).

In accordance with some embodiments of the disclosure, the perturbation may occur during operation of machine learning system 100 or symbolic representation generator 110. For example, the symbolic representation generator 110 may compute the memory network based on input obtained from the environment 130 while being repeatedly perturbed. As an additional example, machine learning system 100 may continue to provide instructions to take actions in the environment 130 while being repeatedly perturbed. As may be appreciated, machine learning system 100 and the symbolic representation generator 110 may not cease operation between perturbations (or between experiments, within experiments, or the like). For example, machine learning system 100 can continue to operate during and between perturbations.

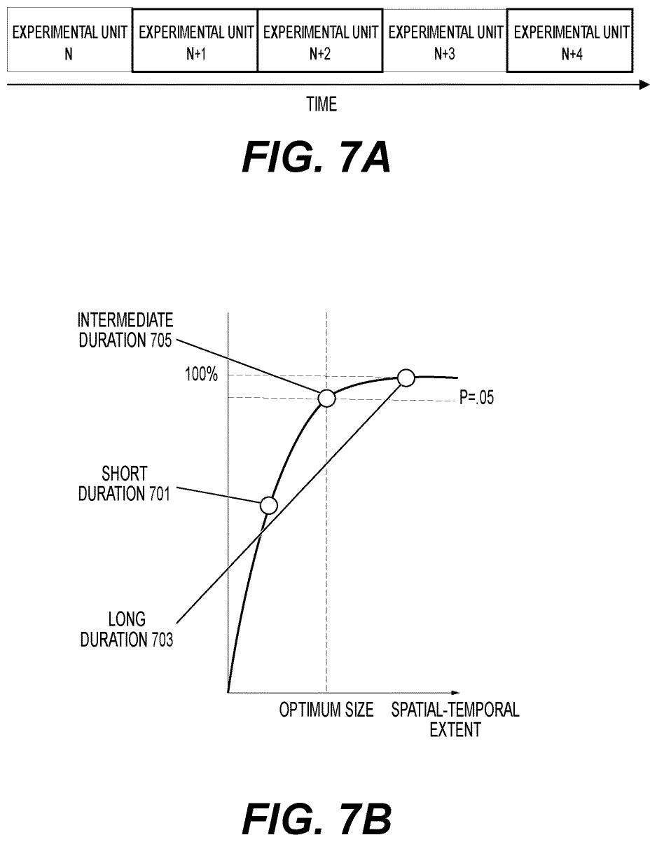

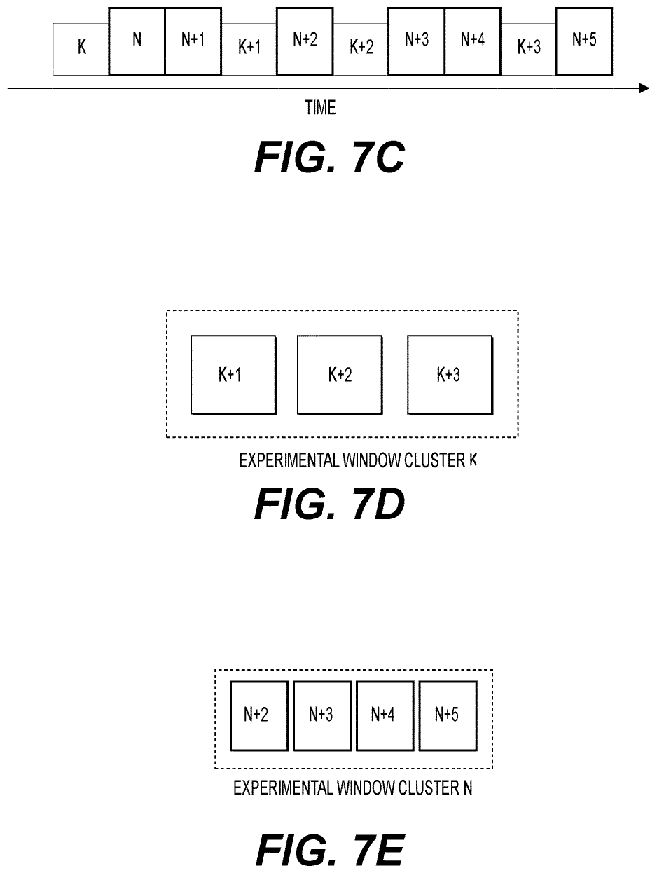

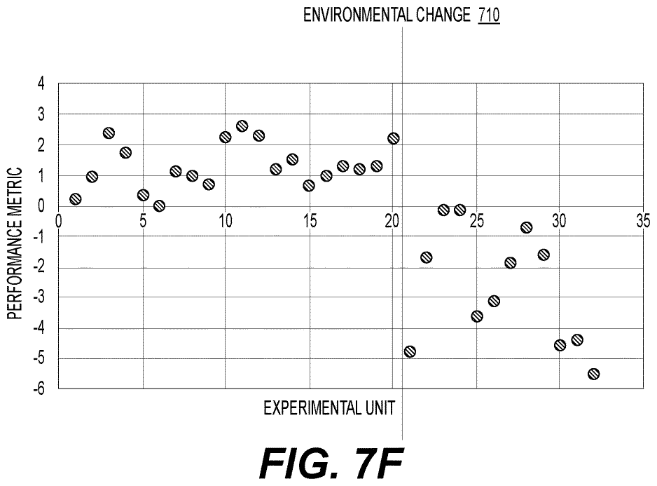

In some embodiments, a perturbation may be limited in duration. The default, normal, or prior operating state or method of operation may resume upon cessation of the perturbation (or a different perturbation may begin). In some embodiments, a perturbation may be scheduled to last the duration of an experiment and cease once the experiment is complete. The default, normal, or prior operating state or method of operation may then resume. As described herein with regards to FIGS. 7A to 7E, the operation of the machine learning system can be divided into experimental units described in terms of duration (and potentially scope). Accordingly, the perturbation may be scheduled to last the duration of such an experimental unit. The next experimental unit may then include a different perturbation.

In some embodiments, a perturbation may be limited in scope. For example, a perturbation may involve changes to a single component, operation, or parameter (or a subset of the components, operations, or parameters) of machine learning system 100 or symbolic representation generator 110 (or component thereof, such as a memory network, preprocessor, or the like). The scope of the perturbation can be selected according to an experimental design such that the effects of multiple such changes can be isolated through repeated experiments.

In some embodiments, when the perturbed component, operation, or parameter is specified by a continuous value, the perturbation may be limited in magnitude. For example, a normalized magnitude of the perturbation may be less than 1.0, less than 0.5, less than 0.2, less than 0.1, less than 0.05, less than 0.01, or less.

In some embodiments, inference component 120 can directly change components, operations, or parameters of symbolic representation generator 110. For example, inference component 120 may have access to (and be able to modify) data or instructions used to implement symbolic representation generator 110. As a further example, inference component 120 may interact with data structures used by symbolic representation generator 110 to add to, remove from, or clamp the activity of components in a representation generated by symbolic representation generator 110; enable or disable a preprocessor used by symbolic representation generator 110; overwrite the stored value of a mapping threshold used by symbolic representation generator 110; or the like. In some embodiments, inference component 120 can indirectly change components, operations, or parameters of symbolic representation generator 110. For example, inference component 120 can generate perturbation data specifying perturbations to symbolic representation generator 110. Symbolic representation generator 110 (or a system implementing symbolic representation generation 110) can obtain this perturbation data (e.g., directly or indirectly receive or retrieve the perturbation data from inference component 120, or the like). The disclosed embodiments are not limited to a particular format or implementation of such perturbation data. In some embodiments, such perturbation data can be implemented using JSON, XML, or another suitable format.

As may be appreciated, the implementation of machine learning system 100 can affect whether inference component 120 directly or indirectly perturbs symbolic representation generator 110. For example, when inference component 120 and symbolic representation generator 110 are hosted on the same computing device (or share access to common memory resources), inference component 120 may directly perturb symbolic representation generator 110. As an additional example, when inference component 120 and symbolic representation generator 110 are hosted on separate computing devices (or containers, or the like), inference component 120 may provide perturbation data instructing symbolic representation generator 110 to implement specified perturbations. Symbolic representation generator 110 may obtain this perturbation data and implement perturbations accordingly.

In some embodiments, the experiments can involve interactions with environment 130. For example, machine learning system 100 can provide output 113 to environment 130 in accordance with an experiment constructed by inference component 120. Additionally or alternatively, the experiments can be observation-only. The experiments may determine causal relationships between objects in the environment. Environment 130 may concern a computer application (e.g., the balls and paddles within the game of Breakout®), or may concern the real world (e.g., balls and bats and players within the game of baseball).

In some embodiments, experiments can involve determining the relationship between outputs 113 and inputs 111. For example, a particular output (e.g., a cursor movement command) of outputs 113 can be statistically associated with a particular input (e.g., the cursor being moved) of inputs 111. As may be appreciated, such relationships can be determined without machine learning system 100 having a-priori knowledge of the output type, or even that a component representing the output corresponds to an output capable of affecting the environment 130. In some embodiments, experiments can involve an input having a specific semantic meaning, such as reward or penalty information (e.g., a “reward”).

In some embodiments, commands can be generated by symbolic representation generator 110. For example, symbolic representation generator 110 can be configured with, or configured to generate or learn, a mapping from a state of the representation of the environment to commands. In such embodiments, based on the mapping and the state of the representation, machine learning system 100 can output a command.

In some embodiments, inference component 120 can be configured to generate commands. For example, inference component 120 can be configured to generate effect estimates involving commands. In some embodiments, inference component 120 can be configured to generate effect estimates for portions of the representation. Such a portion of the representation can map to an action. Inference component 120 can be configured to select one of the portions based on the effect estimate (and in some embodiments further based on a state of the representation). Inference component 120 can, as part of an experiment, cause machine learning system 100 to apply the mapped action during the experiment.

As may be appreciated, the implementation of interface component 140 can depend on the nature of environment 130, the types of inputs 111 obtained from environment 130, and the types of outputs 113 provided to environment 130. When inputs 111 and output 113 comprise data or signals, interface component 140 can be a software or hardware interface for the one or more computing systems that implement machine learning system 100 (e.g., a graphical user interface or display, a port or network card, or any other suitable hardware or software interface).

In some embodiments, interface component 140 can represent objects observed in the environment in a format amenable to input into the symbolic representation generator. An observation of such object(s) in the environment, including input data representing such objects can be or include a scene or frame. For example, a screen capture of a graphical user interface can be a scene or frame. As an additional example, a textual prompt can be a scene or frame. As an additional example, the input data received at a point or interval in time from a collection of sensors in an autonomous vehicle can be a scene or frame. In some embodiments, interface component 140 can include special-purpose input components, such as sensors or transducers for obtaining input 111 (e.g., video or image sensors, optical sensors such as radar or lidar sensors, audio sensors such as sonar sensors, chemical sensors, distance sensors, positional sensors, strain or force sensors, or other suitable sensors or transducers). In some embodiments, interface component 140 can include special-purpose signal conditioning components for filtering, amplifying, or digitizing obtained input 111. output signals, such as switches, multiplexors, power supplies, amplifiers, motors, actuators, or the like. The disclosed embodiments are not limited to any particular implementation of interface component 140.

FIGS. 1B to 1D depict exemplary applications of an exemplary machine learning system of FIG. 1A, in accordance with one or more aspects of this disclosure. FIG. 1B depicts application of a machine learning system in accordance with some embodiments of the disclosure to an autonomous driving or driver assistance system. Consistent with disclosure embodiments, the machine learning system can obtain input data 111 from the environment. In this example, the input data 111 can include at least one of Light Detection and Ranging (LIDAR) data, camera data, ultrasound data, GPS data, or other sensor data suitable for use in autonomous driving or driver assistance systems. Consistent with disclosed embodiments, the machine learning system can identify objects observed in the environment (e.g., object 141 and object 143) and determine relationships between these objects. In some embodiments, input data 111 can include data concerning the state of the car, such as speed data, steering direction, braking status, accelerator status, wheel traction or slippage, or the like. The machine learning system may generate a representation of the observed objects, and of the state of the car, in terms of connected sets of localist and distributed units, as described herein. Consistent with disclosed embodiments, the machine learning system can determine treatments to apply during experimental units to satisfy predetermined or learned autonomous driving or driver assistance goals. The machine learning system can provide outputs 113 that command the car to take actions (e.g., turn wheels, apply brakes, apply accelerator, etc.) that implement the determined treatments.

FIG. 1C depicts application of a machine learning system in accordance with some embodiments of the disclosure to an autonomous flight or pilot assistance system. In this example, the input data 111 can include at least one of radar data, camera data, ADS-B data, GPS data, air traffic control instructions, or other input data suitable for use in autonomous flight or pilot assistance systems. Consistent with disclosed embodiments, the machine learning system can identify objects observed in the environment (e.g., object 151, another aircraft, and object 153, a runway) and determine relationships between these objects. In some embodiments, input data 111 can include data concerning the state of the aircraft, such as airspeed data, altitude data, heading data, engine status data, fuel data, control surface status data, or the like. The machine learning system may generate a representation of the observed objects, and of the state of the aircraft, in terms of connected sets of localist and distributed units, as described herein. Consistent with disclosed embodiments, the machine learning system can determine treatments to apply during experimental units to satisfy predetermined or learned autonomous flight or pilot assistance goals. The machine learning system can provide outputs 113 that command the aircraft to take actions (e.g., increase thrust, modify control surfaces, etc.) that implement the determined treatments.

FIG. 1D depicts application of a machine learning system in accordance with some embodiments of the disclosure to a robotics task. While the depicted robot is suitable for industrial automation tasks, it may be appreciated that machine learning systems consistent with disclosed embodiments are not so limited. Such systems may also be adapted to domestic or retail robotics uses, such as robotic assistants, companions, or cleaners. In this example, the input data 111 can include at least one of camera data, robotic joint angle or tool space data (e.g., tool head location, orientation, rotation, or the like), conveyor speed, task, or other input data suitable for use in industrial automation tasks. Consistent with disclosed embodiments, the machine learning system can identify objects observed in the environment (e.g., object 161, the tool head of the robot and objects 153 and 155, machinery on a convey belt) and determine relationships between these objects (e.g., proximity, orientation, path to target, etc.). The machine learning system may generate a representation of the observed objects, and of the state of the robot, in terms of connected sets of localist and distributed units, as described herein. Consistent with disclosed embodiments, the machine learning system can determine treatments to apply during experimental units to satisfy predetermined or learned industrial automation goals. The machine learning system can provide outputs 113 that command the robot or conveyor to take actions (e.g., position robot arm, activate tool head, increase or decrease conveyor speed, etc.) that implement the determined treatments.

In accordance with some embodiments of the disclosure, machine learning system 100 can perform an empirical control process. This empirical control process can include selection of actions in the environment or perturbations to symbolic representational operations, components, or parameters; estimation of the causal effects of such actions or perturbations; and control of future actions in the environment or perturbations to symbolic representational operations, components, or parameters based on the estimated causal effects.

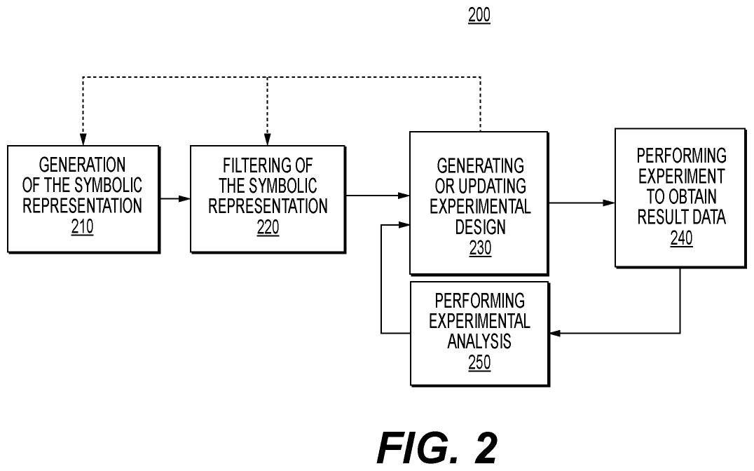

FIG. 2 depicts an exemplary machine learning process 200, in accordance with one or more embodiments of the disclosure. Process 200 can be performed by a machine learning system (e.g., machine learning system 100) that includes a symbolic representation generator (e.g., symbolic representation generator 110) and an inference component (e.g., inference component 120). In some embodiments, process 200 can include operations of generating a symbolic representation 210, filtering the symbolic representation 220 to select analogs, generating or updating an experimental design 230 using the selected analogs, performing an experiment according to the experimental design to obtain result data 240, and performing an experimental analysis based on the obtained result data (and additionally or alternatively based upon previously collected result data). The results of the experimental analysis can inform the subsequent generation or updating of the experimental design (and additionally or alternatively one or more of the subsequent generation of the symbolic representation or filtering of the analogs). In this manner, process 200 can form an experimental feedback loop, with experimental results informing the design of subsequent experiments.

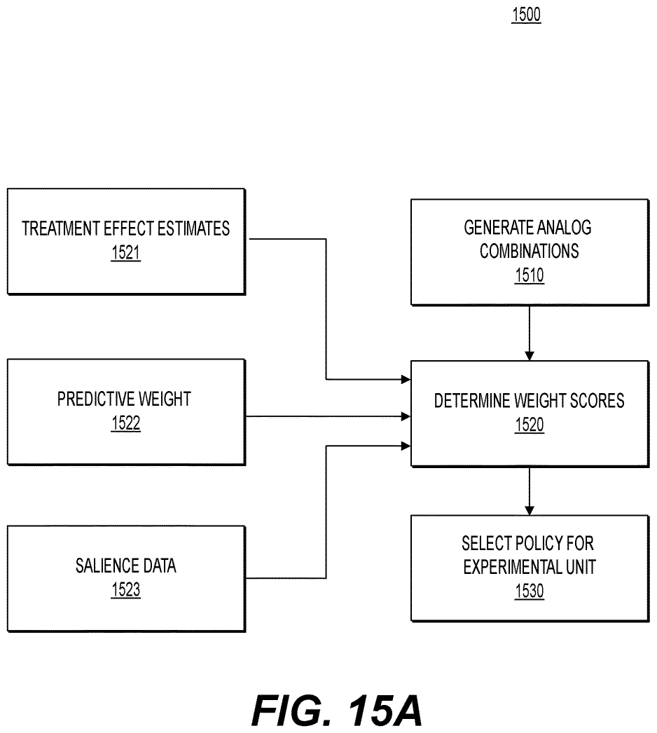

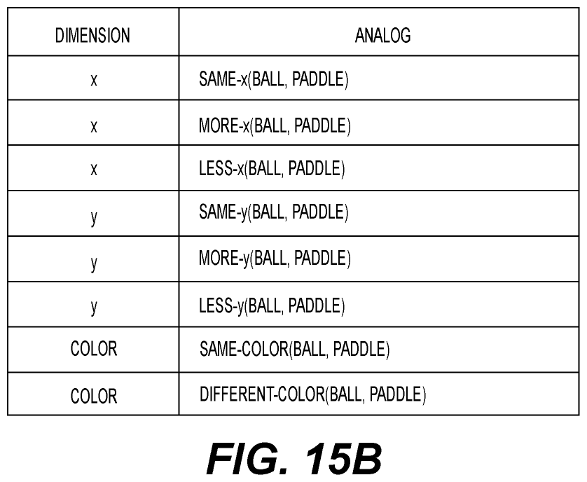

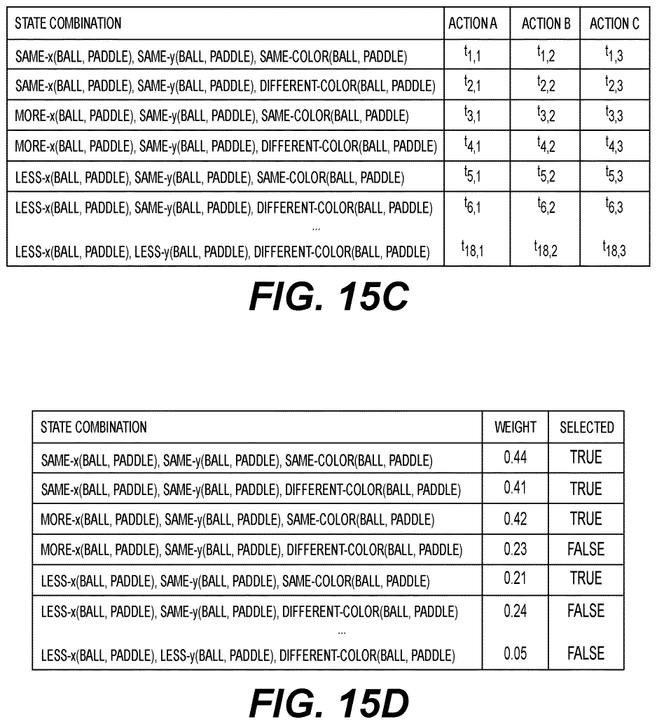

As may be appreciated, the depicted arrangement of operations in process 200 is not intended to be limiting. In some embodiments, operations such as symbolic representation generation 210 and filtering 220 (and/or filtering 220 and experimental design 230) can be combined. For example, FIG. 15A depicts a process 1500 that combines elements of filtering 220 and experimental design 230.

Process 200 can include operation 210 of generating a symbolic representation, in accordance with some embodiments of the disclosure. The symbolic representation can represent objects and relationships present in the environment. As described herein, the symbolic representation can be implemented using at least one memory network including symbolic (or localist) units and sub-symbolic (or distributed) units. The memory network can express the state of an object (e.g., an object observed in the environment) through connections between a localist unit representing the object and other localistic units or distributed units representing objects, features, or relational roles (e.g., without limitation, position, orientation, color, lighting, acceleration, velocity, movement path, size, texture, identity or exemplar or type, or the like). The memory network can express relationships between objects and/or attributes as analogs (e.g., collections of localist and distributed units). Generation of the symbolic representation can include the creation or modification of analogs stored in a memory network, the retrieval of such analogs from such a memory network, or the storage of such analogs into the memory network. In some embodiments, the symbolic representation can be implemented using multiple memory networks. The multiple memory networks can correspond to different inputs, environments, times, or objects.

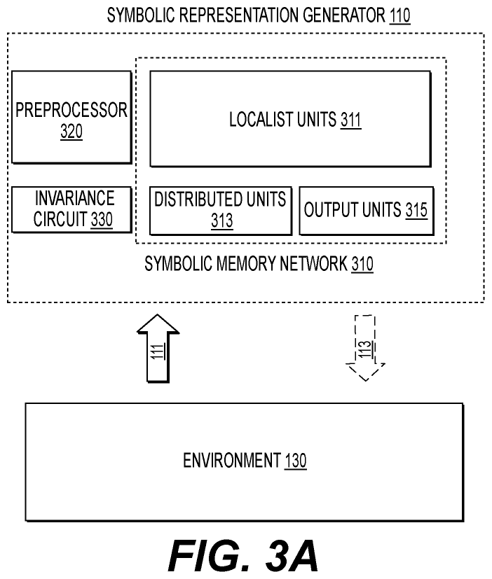

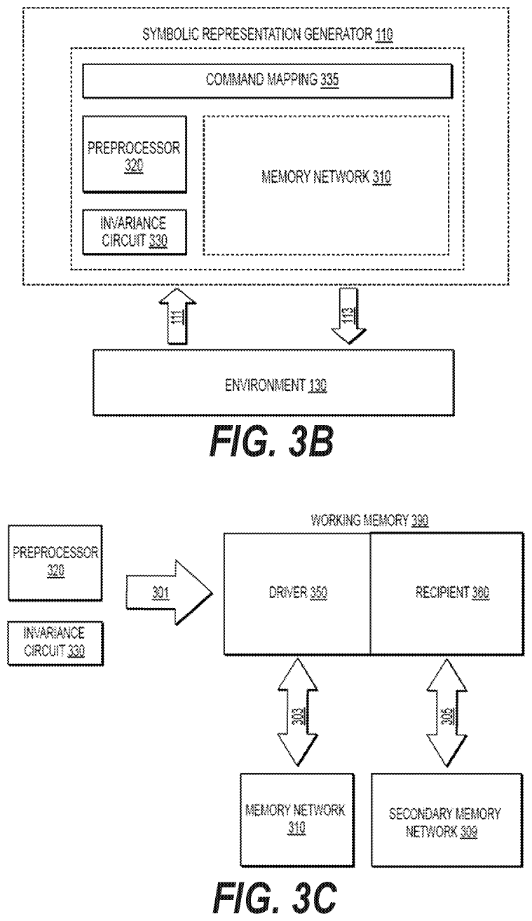

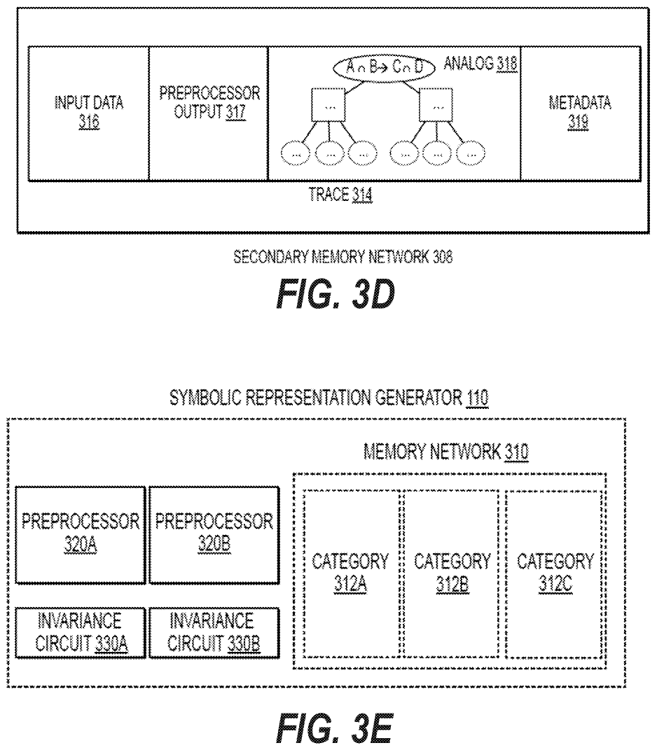

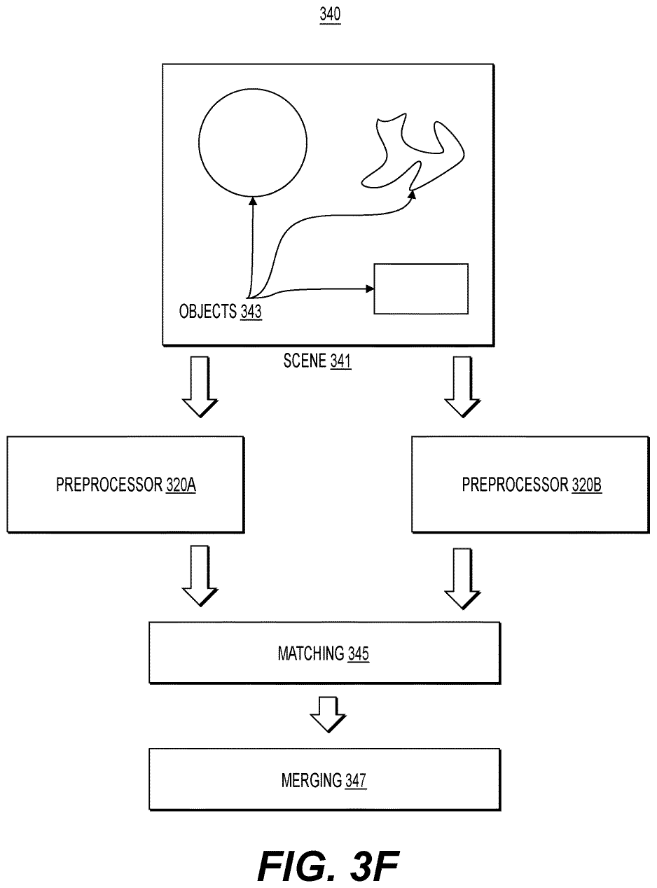

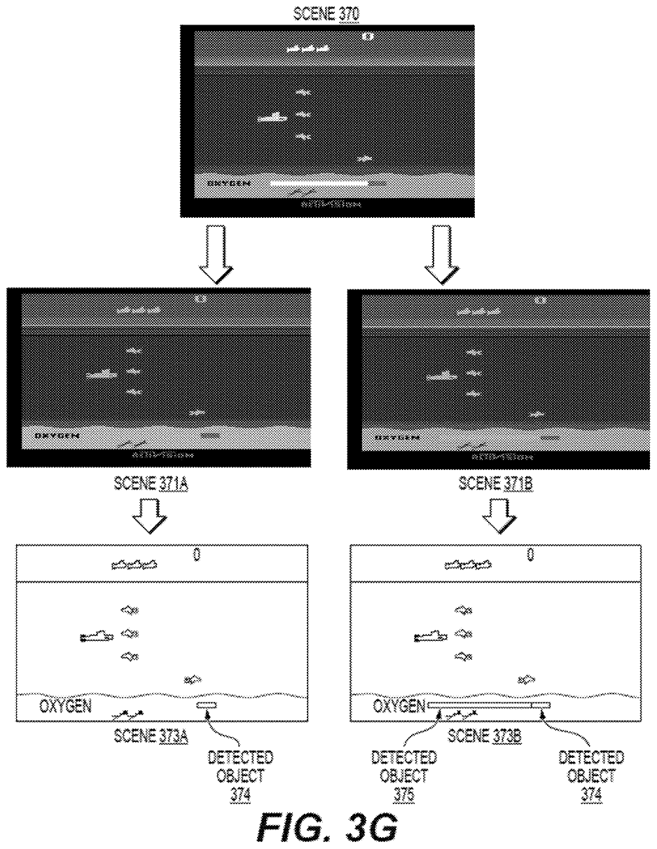

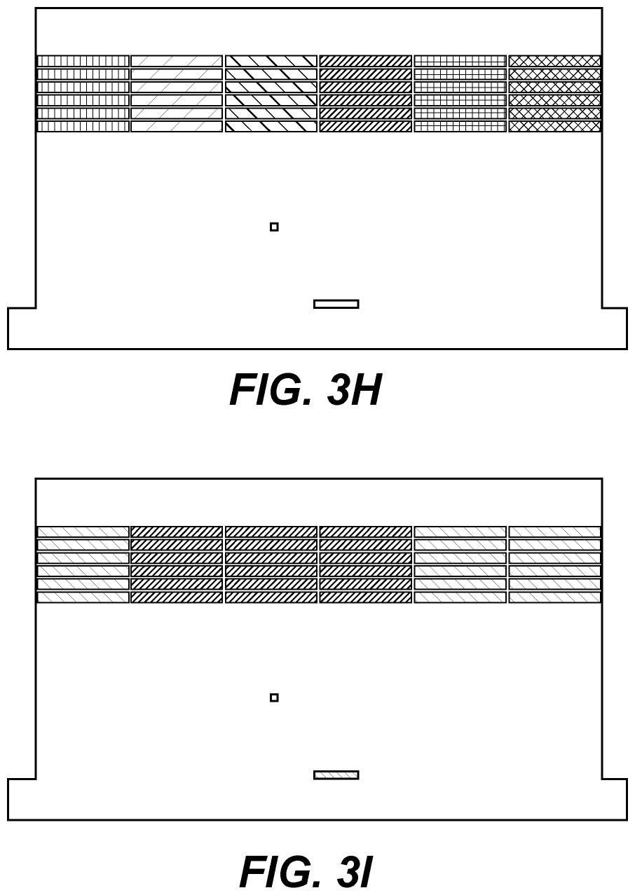

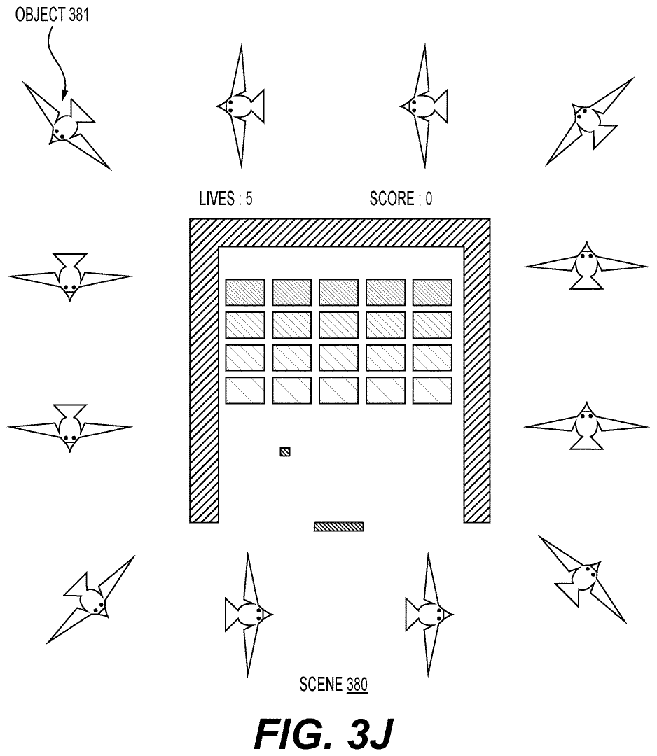

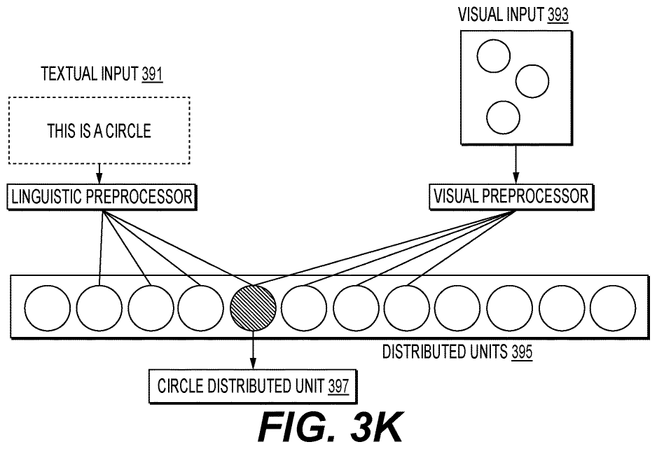

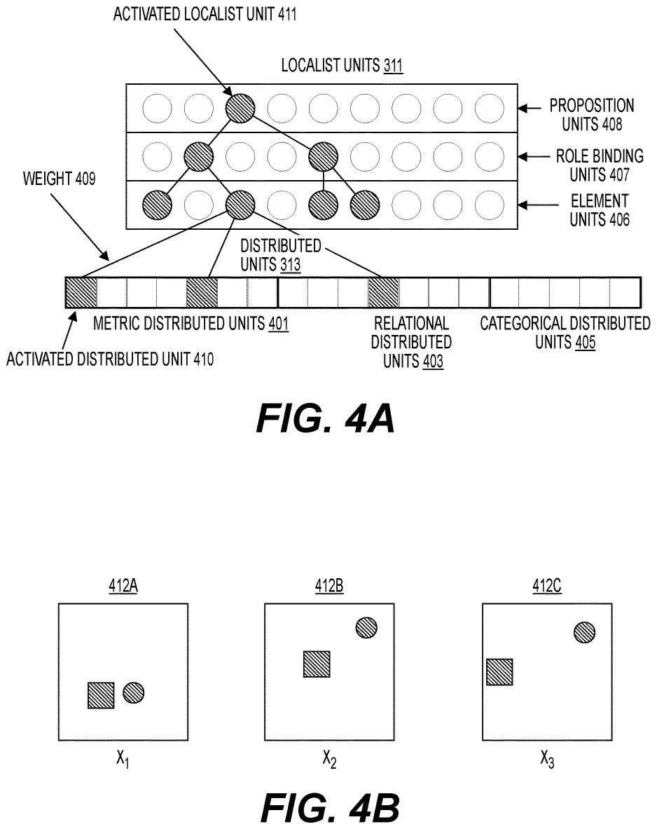

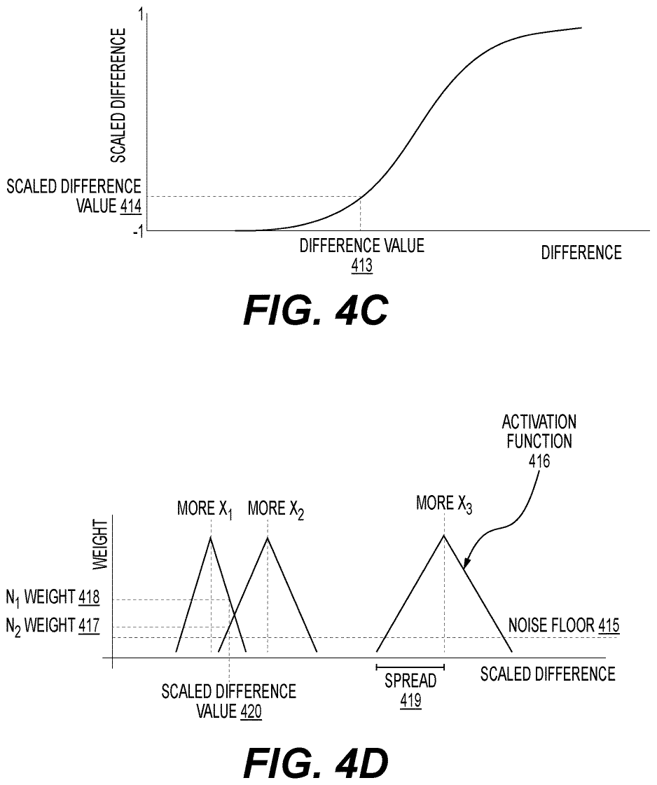

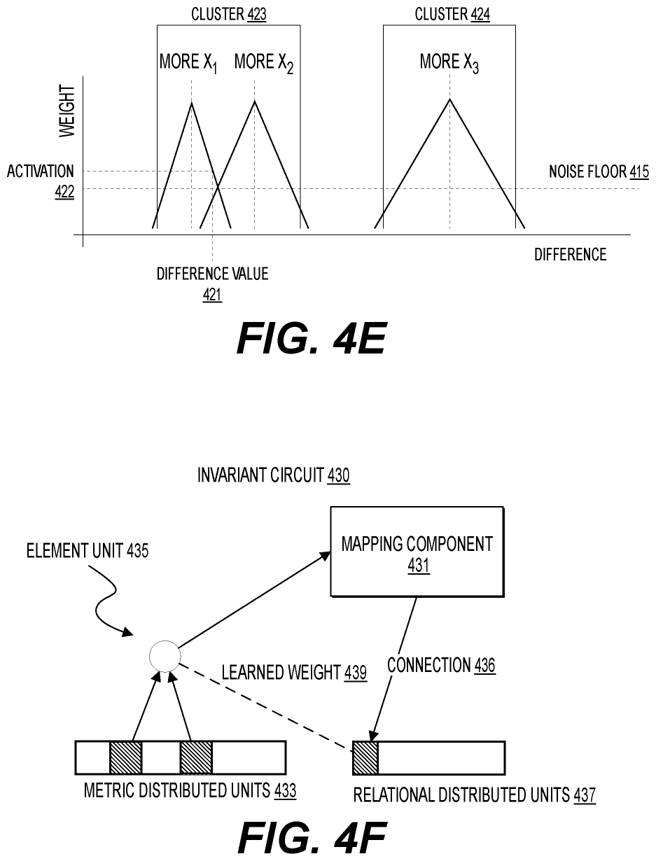

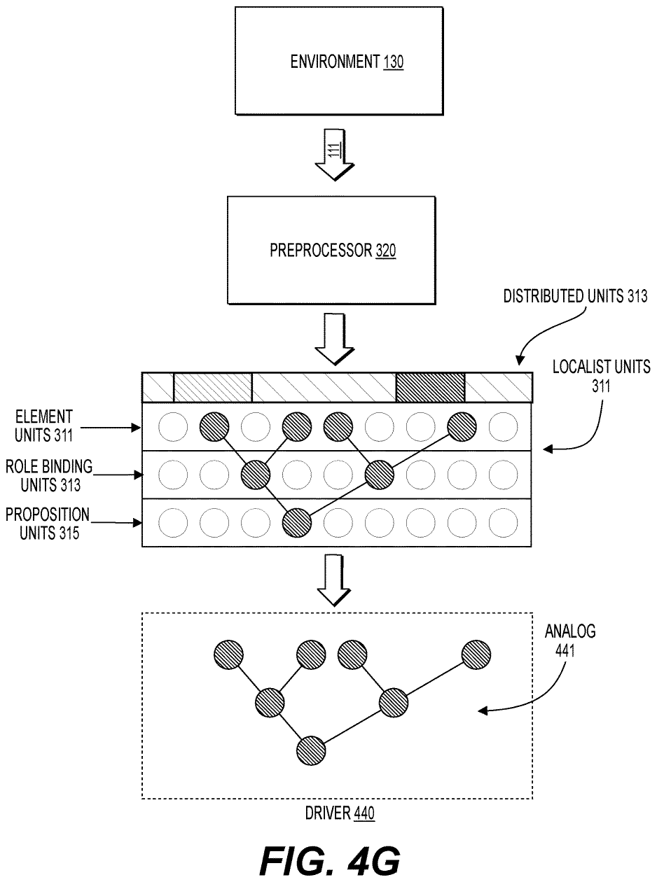

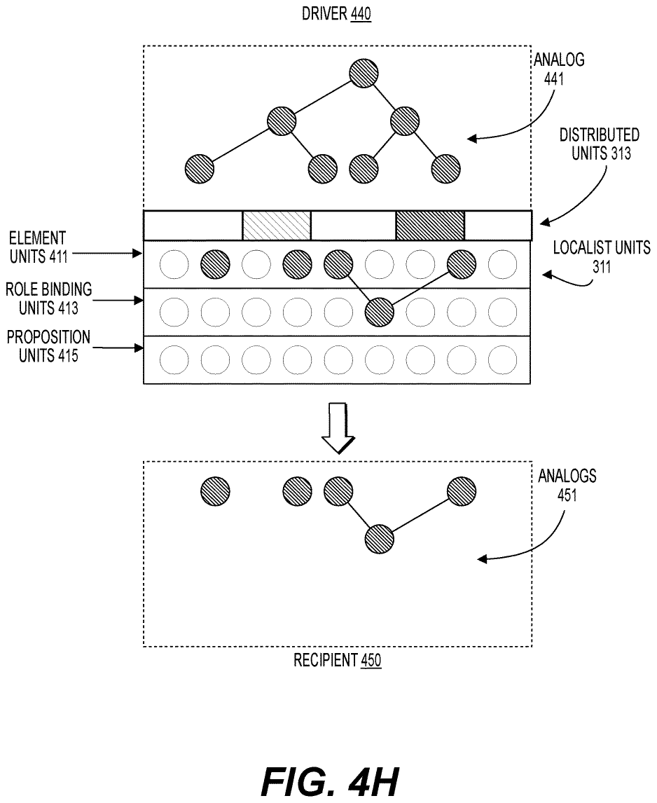

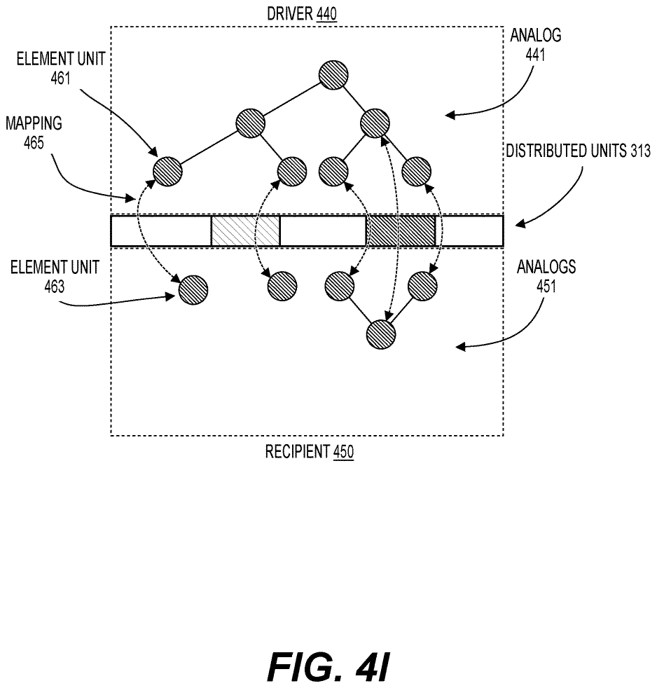

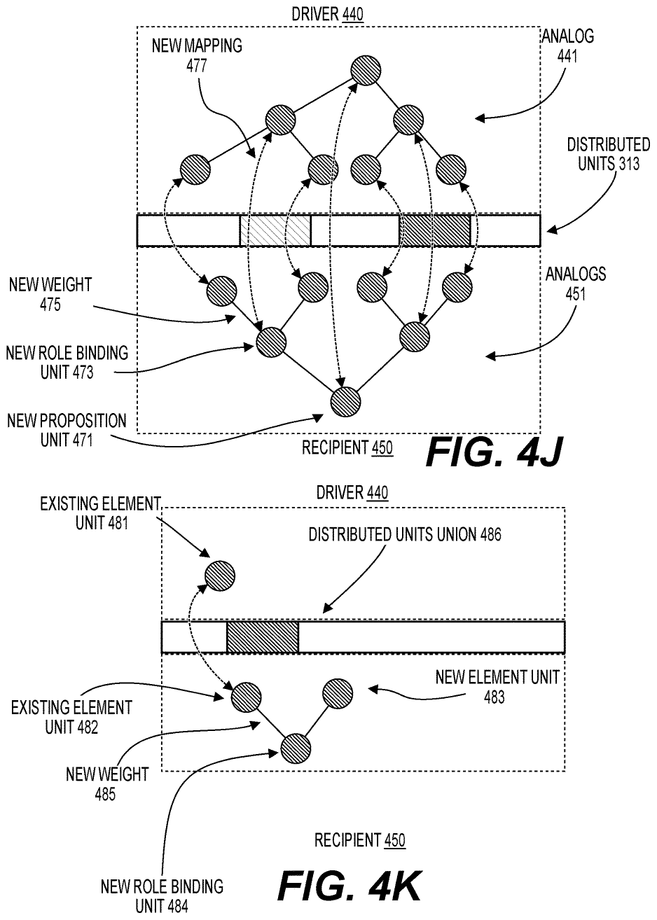

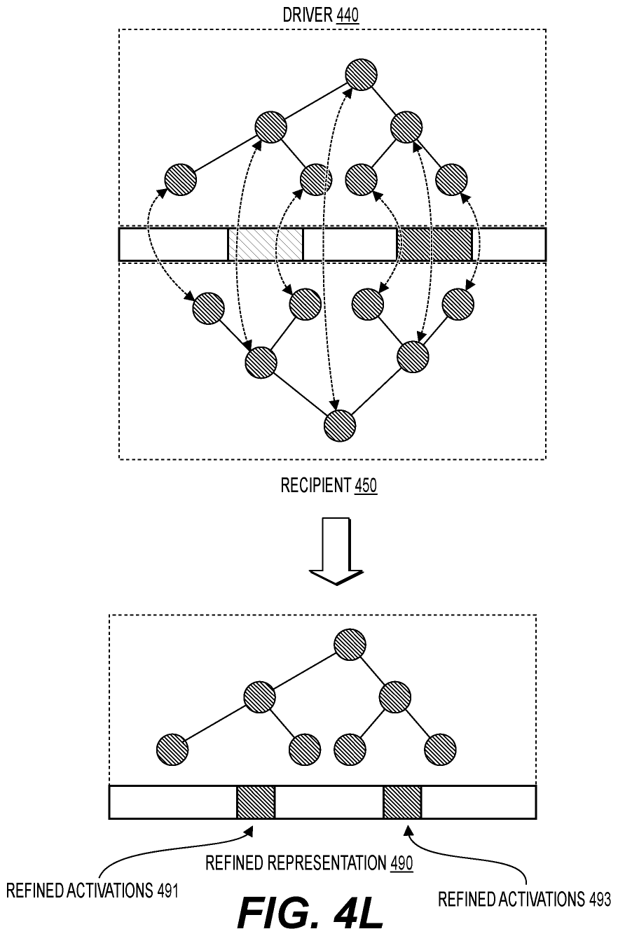

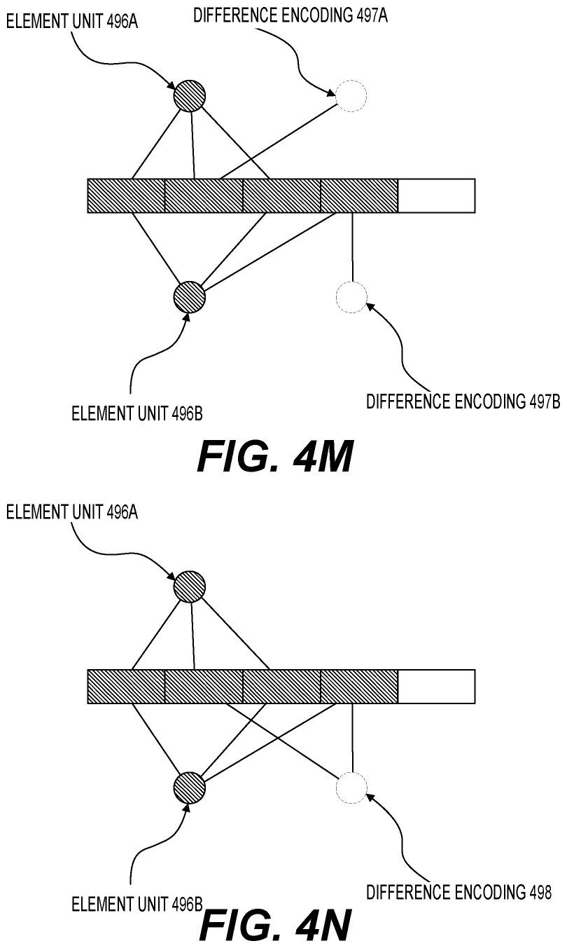

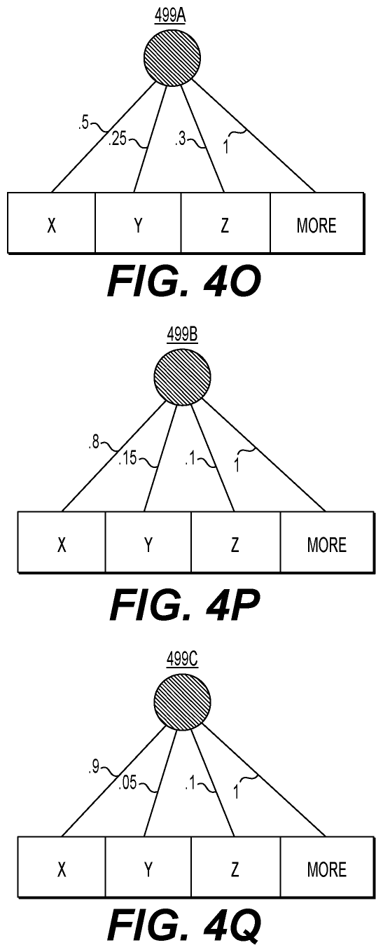

As described herein, a symbolic representation generator can be configured to maintain the at least one memory network. FIGS. 3A to 3L depict an exemplary symbolic representation generator including a memory network for implementing a representation of objects and relationships present in the environment. FIGS. 4A to 4Q describe the operations, components, and parameters of the memory network, in accordance with some embodiments. In some embodiments, when the symbolic representation is implemented using multiple memory networks, the machine learning model can be configured to maintain the multiple memory networks.

Process 200 can include an operation 220 of filtering the symbolic representation to identify a subset of the analogs contained therein, in accordance with some embodiments of the disclosure. As described herein, process 200 can include generating or updating an experimental design and performing an experiment according to that experimental design.

As described herein with regards to FIGS. 7A to 7E, the operation of machine learning system 100 can be divided into experimental units. Thus, the experiments can be performed using such experimental units. In accordance with some embodiments of the disclosure, an experimental unit can have a duration. In some embodiments, an experimental unit can have a scope. The scope of the experimental unit can be the portion of the environment considered during the experiment. For example, the experiment may concern only objects in a particular spatial region of the environment. As an additional example, the experiment may provide commands to take actions in only a portion of the environment.

As the number of analogs in symbolic representation 210 increases, the number of experimental units required to perform an experiment may become impractical. Accordingly, filtering of the symbolic representation may prevent experimentation on unpromising analogs. For example, the existence, retention, promotion, demotion, and action-authority of analogs (e.g., whether retrieval or creation of an analog causes machine learning system 100 to command an action in the environment or a perturbation of the symbolic representation generator) can be experimentally determined. In some embodiments, experimental results can determine which analogs persist, which are deferred (e.g., transferred to a secondary storage, as described herein) or removed, and which are permitted to control actions or perturbations. In this manner, filtering operation 220 can reduce the memory or storage required to create or maintain unpromising analogs and can reduce the compute required to perform experiments including such unpromising analogs.

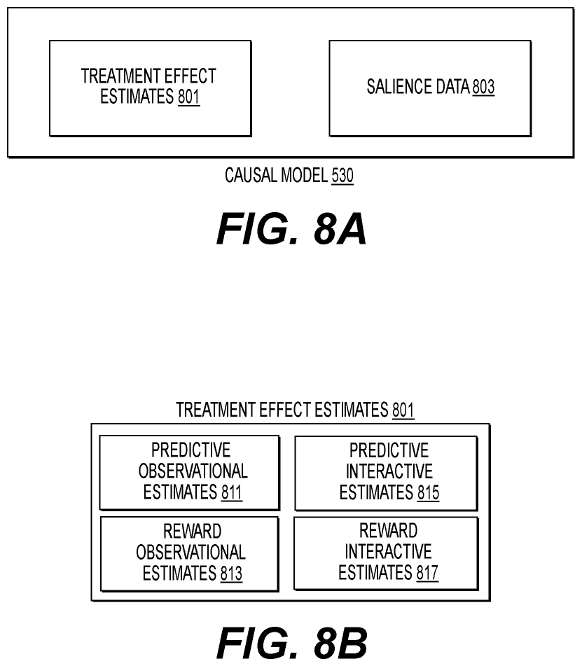

In accordance with some embodiments of the disclosure, the identified analogs can include analogs identified based on salience. As described herein with regards to FIG. 8A, machine learning system 100 can attribute salience to objects or object attributes (or to localist or distributed units representing such objects or object attributes) or relationships between objects and object attributes (or analogs representing such relationships). In some embodiments, the generation or updating of the experimental design can use analogs identified as being salience.

In accordance with some embodiments of the disclosure, the identified analogs can include analogs identified based on selectivity. As described herein with respect to FIGS. 4O to 4Q, analogs can be categorized as entangled or disentangled based on a selectivity value of the analog. In some embodiments, filter 220 can filter entangled analogs (or otherwise filter analogs based on selectivity values of the analogs). In this manner, filter 220 can limit experimentation to sufficiently selective analogs.

In accordance with some embodiments of the disclosure, the identified analogs can include analogs identified based on genericity. As described herein with respect to FIGS. 4L, element units representing objects can be categorized as generic based on connections between the element unit and distributed units, or based on the method of generation of the element unit (e.g., repeated relational refinement using a low mapping threshold, or the like). In some embodiments, filter 220 can filter generic element units (or conversely filter non-generic element units).

In accordance with some embodiments of the disclosure, process 200 can combine, at least in part, operation 210 of generating the symbolic representation and operation 220 of filtering the symbolic representation. For example, process 200 can include the perturbation of the components, operations, or parameters of the symbolic representation generator to cause generation of a pre-filtered set of analogs. As described herein with respect to FIG. 8A, the pre-filtered set of analogs can include analogs combining abstract objects and disentangled relationships. In some embodiments, such analogs can be “hypothetical” and correspond to yet-unobserved relationships. These hypothetical analogs can then be used in generation or updating of the experimental design.

As an additional example, process 200 can include the perturbation of components, operations, or parameters of the symbolic representation generator to favor the creation and refinement of salient analogs. As described herein with regards to FIGS. 3C to 3G, the symbolic representation generator can be configured with multiple (or adjustable) preprocessors and invariance circuits. As described herein, a preprocessor can observe objects in the environment and identify features of the observed objects. As described herein, an invariance circuit can identify relational invariants and associate these invariants with the observed objects. The symbolic representation generator can furthermore be configured with a memory network including portions corresponding to dimensions of object characteristics.

In accordance with some embodiments of the disclosure, process 200 can include the configuration of the symbolic representation generator to use a particular preprocessor (or particular preprocessor parameters) in generating analogs using input (e.g., input 111) received from the environment, as described herein. As an additional example, process 200 can include the configuration of the symbolic representation generator to use a particular invariance circuit (or to apply the invariance circuit across a particular dimension of object attributes), as described herein.

In accordance with some embodiments of the disclosure, process 200 can include the configuration of the symbolic representation generator and/or inference component to create or retrieve a set of analogs for a corresponding set of dimensions in the memory network. For example, process 200 can include configuring the symbolic representation generator to attribute salience to components of the memory network (e.g., to dimensions of object characteristics) by perturbing salience conditions or thresholds. As an additional example, process 200 can include configuring the symbolic representation generator to perform operations based on salience attributed to a dimension of object characteristics. For example, process 200 can include configuring the symbolic representation generator to retrieve (or favor retrieval of) analogs associated with a salient dimension of object characteristics.

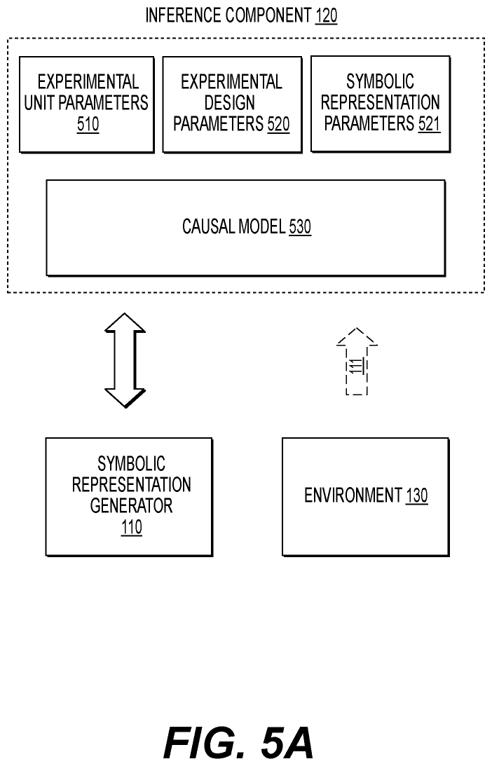

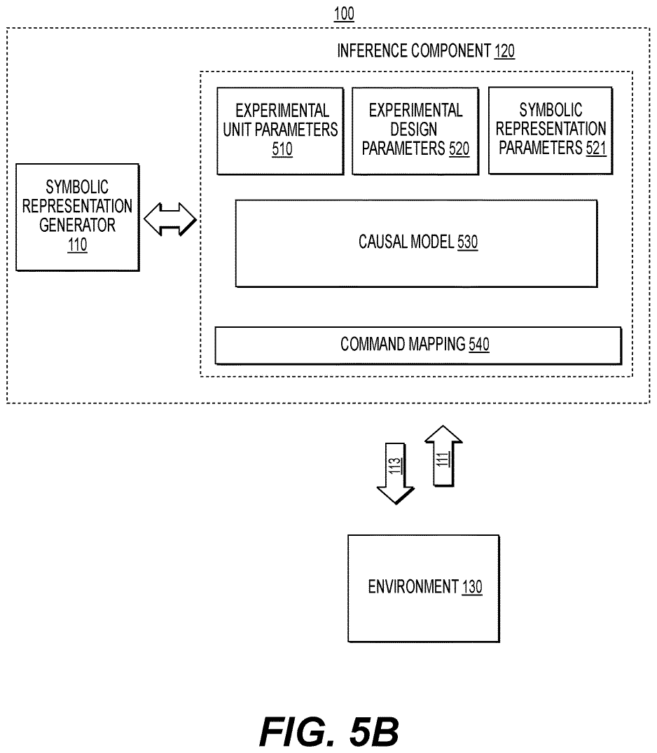

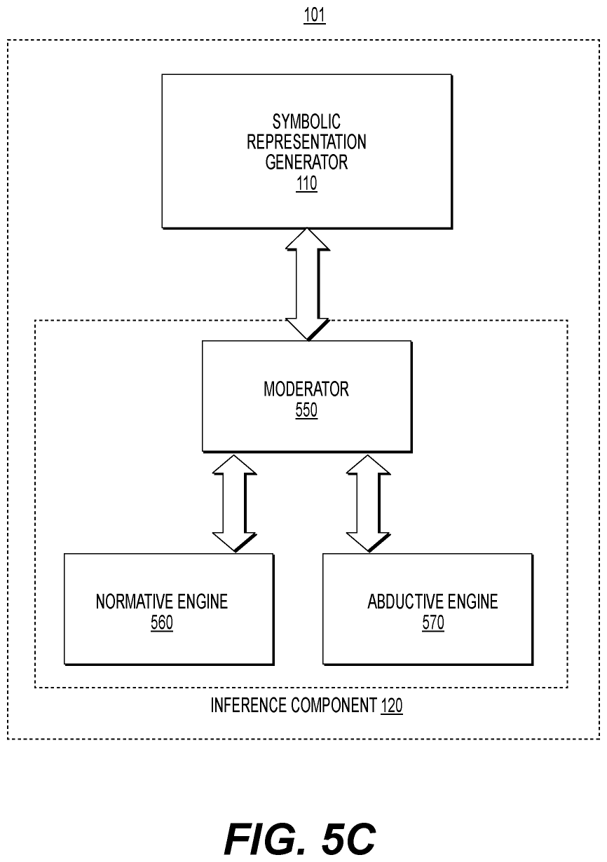

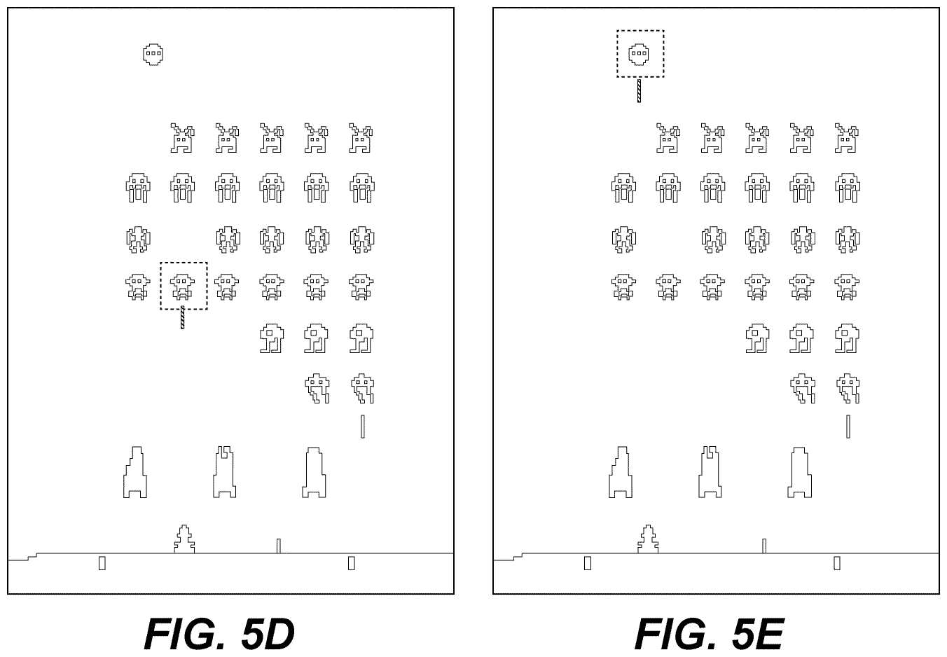

Process 200 can include an operation 230 of generating or updating an experimental design, in accordance with some embodiments of the disclosure. The generation or updating of the experimental design can depend on a causal model. As described herein with regards to FIGS. 5A to 5E, 8A and 8B, the causal model can store estimated treatment effects. These estimated treatment effects can relate potential treatments (e.g., providing instructions to take actions in the environment or perturbing the symbolic representation generator) to the state of the environment. In some embodiments, the estimated treatment effects can be estimated performance metric values (e.g., task performance, rewards, or another suitable performance metric). In some embodiments, these estimated treatment effects can be point or interval estimates. In some instances, process 200 can structure the experimental design to improve the estimation of treatment effects in the causal model (e.g., by maximizing mutual information or otherwise reducing the breadth of interval estimates). In some instances, process 200 can structure the experimental design to perform treatments resulting in designed effects (e.g., according to estimated performance metric values).

In accordance with some embodiments of the disclosure, the experimental design can implement a multi-level experiment. In some embodiments, the multi-level experiment can concern the configuration of the symbolic representation generator and/or the inference component, the type and configuration of an experimental model, and/or the assignment of polices to sets of experimental units according to the experimental model (and optionally according to the causal model). As may be appreciated, the experimental design can implement an experiment including fewer or additional levels of experimentation, or may combine levels of experimentation. For example, the experimental design may implement a single-level experiment concerning the assignment of policies to sets of experimental units according to the experimental model (and optionally according to the causal model). In some embodiments, a level of a multi-level experiment can depend upon other levels of the multi-level experiment. For example, the determination of an experimental model and/or treatments affecting the identification of analogs may affect the content and assignment of policies to experimental units.

In accordance with some embodiments of the disclosure, level(s) of the multi-level experiment can concern the configuration of the symbolic representation generator and/or the inference component. Such level(s) can concern treatments that affect the identification of analogs for experimentation, treatments involving the creation, or creation and storage, of analogs, treatments involving the modification of existing analogs, or the like (e.g., as shown in FIG. 2 through feedback from operation 230 to operations 210 and 220). Such treatments can include perturbations to the components, operations, or parameters of the symbolic representation generator and/or inference component that affect generation of analogs (e.g., in operation 210) or filtering of analogs (e.g., in operation 220). For example, such a treatment can involve changes to parameters describing graded encoding of metric properties in the symbolic representation generator, or the generation of inclusion of entangled or generic analogs in the subset of analogs used in generating the experimental design.

In accordance with some embodiments of the disclosure, level(s) of the multi-level experiment can concern the type of an experimental model (e.g., randomized controlled experiment versus state-based reinforcement learning model, full factorial design versus fractional factorial design, etc.) and/or the configuration of the experimental model. For example, a treatment level can specify that an experimental model is a fractional factorial model (e.g., experimental model type) and further specify a configuration of the fractional factorial model (e.g., number of factors, fraction index, number of runs, defining relation (or defining word), aliasing structure, or the like). As an additional example, another treatment level can specify a state-based reinforcement learning model (e.g., experimental model type) and further specify a configuration of the state-based reinforcement learning model (e.g., an architecture such as q-learning, contextual bandit, or the like; states or state-action pairs tracked; hyperparameters such as learning rate, discount factor, exploration rate; reward function, or the like). In some embodiments, multiple levels can collectively specify the type and configuration of the experimental model. For example, a first level can specify the type, and additional levels can specify different aspects of the configuration. In some embodiments, these level(s) of experimentation may depend on other level(s) of experimentation. For example, treatments that affect the identification of analogs for experimentation can affect the determination of an experimental model. In some embodiments, type and/or configuration of the experimental model may be fixed or predetermined.

In accordance with some embodiments of the disclosure, level(s) of the multi-level experiment can concern the assignment of polices to sets of experimental units according to the experimental model. In some embodiments, such policies can associate environmental states (e.g., as represented in the symbolic representation) with treatment(s). In some embodiments, such policies can associate environmental states with treatments and performance metric values for levels of the treatments. In some embodiments, such policies can specify treatment levels for environmental states. In some embodiments, as discussed with regards to FIGS. 15A to 15C, policies can be implemented using data structures referred to herein as “symbolic representation experimental conditions” or “SRECs”. In some embodiments, policies can be implemented using relationship groups.

In accordance with some embodiments of the disclosure, process 200 can implement parallel experimentation. Process 200 can allocate different experimental units to different experiments. Experimental units allocated to different experiments can be temporally interleaved (and/or interleaved in scope), such that multiple experiments are running in parallel. In some embodiments, process 200 can enable multiple compatible experiments to reuse the same experimental unit, improving the efficiency of experimentation.

In accordance with some embodiments of the disclosure, levels of experimentation can be crossed, nested, or otherwise suitably structured. For example, the experimental design may be a nested factorial design that tests, in part, a high-level perturbation to the components, operations, or parameters of the symbolic representation generator. This high-level perturbation can affect the generation and/or identification of analogs. The factorial design can include a first block of experimental units in which the high-level perturbation is “on” and a second block of experimental units in which the high-level perturbation is “off.” Within the first block of experimental units, a factorial design can test the effect of taking a first or second action based on a state of the environment (e.g., as represented by generated and identified analogs). Within the second block of experimental units, another factorial design can test the effect of taking a third or fourth action based on the state of the environment (e.g., as represented by generated and identified analogs). As an additional example, the experimental design may be a crossed factorial design in which each action is tested in each of the first and second blocks of experimental units. As would be appreciated by one of skill in the art, more complex statistical designs (e.g., including multiple level and treatment combinations, or the like) may be used.

Process 200 can include an operation 240 of performing an experiment to obtain result data, in accordance with some embodiments of the disclosure. Depending on the experimental design, the experiment can include updating the generation of the symbolic representation (e.g., in operation 210) or updating the filtering of the symbolic representation (e.g., operation 220). Updating the generation and filtering of the symbolic representation can include updating a configuration of the symbolic representation generator or the inference component. Such updates can include updates to operations, parameters, or components of the symbolic representation generator or the inference component. The experiment can further include assigning policies to experimental units according to the experimental design.

In some embodiments, the performance of the experiment can depend on an operational mode of machine learning system 100. As described herein with regard to FIG. 8B, machine learning system 100 can operate in an interactive and/or observational mode. When in interactive mode, machine learning system 100 can provide instructions to take actions in the environment. When in an observational mode, machine learning system 100 may not provide such instructions. For example, machine learning system 100 may be unable to, or configured not to, provide such instructions. However, machine learning system 100 may still observe the environment during the experimental unit, including any actions taken during the experimental unit and any rewards obtained during the experimental unit.

In accordance with some embodiments of the disclosure, process 200 can include obtaining result data concerning the performance of the experiment. As described herein, such result data can concern rewards received from the environment or predictions concerning a future state of the environment (e.g., as represented in the symbolic representation). For example, input data obtained from the environment can specify a reward value. As an additional example, a prediction can concern the presence or absence of an analog in the symbolic representation corresponding to an object observed in the environment (e.g., a brick in a game of Breakout®). In some embodiments, the result data can include at least one of rewards obtained from the environment; instructions provided to take action in the environment; actions taken in the environment; components, operations, or parameters of the symbolic representation generator (e.g., analogs selected, retrieved, created, or refined by the symbolic representation generator, as described herein); or other suitable data concerning the experiment.

In accordance with some embodiments of the disclosure, process 200 can include storing the acquired result data. For example, machine learning system 100 can be configured to store the acquired result data in any suitable datastore or database accessible to the machine learning model. The stored result data can include results obtained in one or more experimental units. For example, the stored result data can include at least results from experimental units occurring within a data window, as described herein with respect to FIGS. 7D and 7E. In some embodiments, the stored result data can include result data from experimental units occurring outside of the data window.

Process 200 can include an operation 250 of performing an experimental analysis, in accordance with some embodiments of the disclosure. As may be appreciated, the causal model can be updated based on the results of the experimental analysis. The updated causal model can then affect the generation or updating of the experimental design. For example, the causal model can associate treatments with effect estimates. Such treatment effect estimates can be or include predictive interactive estimates, reward interactive estimates, predictive observational estimates, or reward observational estimates as described herein. The experimental analysis can depend on the experimental design. As may be appreciated, depending on the experimental design, the experimental analysis can depend on results for a single experimental unit or multiple experimental units (e.g., experimental units within a data window).

In accordance with some embodiments of the disclosure, experimental analysis 250 can include evaluating the configuration of machine learning system 100 based on the causal model. In some embodiments, in addition to updating the causal model in accordance with the current experimental design, the inference component can be configured to reanalyze the stored result data according to alternative experimental designs. Such alternative experimental designs can differ from the experimental design generated or updated in operation 230 (e.g., the “current design”) across one or more levels of experimentation. For example, such alternative experimental designs can use different experimental models (e.g., different factorial designs, different statistical assumptions regarding treatment levels, different statistical analysis techniques), different configurations of a statistical model (e.g., alternative assignment of analogs into clusters, as described herein), or the like.

In accordance with some embodiments of the disclosure, experimental analysis 250 can include the comparison of current design and the alternative design(s). The alternative design(s) can be analyzed to generate alternative causal model(s). Experimental analysis 250 can include comparing the alternative causal model(s) to the existing causal model. Based on this comparison, the inference component can vary the current experimental design across one or more levels of experimentation. For example, the existing and alternative experimental designs may be factorial designs using different factors, fraction indices, defining relations, or the like. The alternative experimental design may offer a better tradeoff between complexity (e.g., number of factors) and data sparsity (e.g., number of repetitions for each combination of factors). The experimental analysis 250 can assess this tradeoff based on a comparison of the existing and alternative causal models (e.g., according to known statistical performance measures). The better performing experimental design can be selected for future use in generating or updating the experimental design.

As may be appreciated, the amount of time required to reevaluate existing results data (even over multiple combinations of alternative experimental design, experimental design configuration, and/or policy) may be less than the time required to obtain additional results data. In some embodiments, machine learning system 100 can be configured to maintain multiple potential configurations and corresponding causal models. Machine learning system 100 can be configured to use the most performant configuration(s) as starting points for generating additional alternatives, which can then be evaluated.

### Symbolic Representation Generator

FIG. 3A depicts exemplary components of symbolic representation generator 110, in accordance with one or more aspects of this disclosure. Symbolic representation generator 110 can include a memory network 310. In some embodiments, symbolic representation generator 110 can include preprocessor 320 and invariance circuit 330. Invariance circuit 330 can be configured to identify relational invariants in unstructured data input to symbolic memory network 310 (also referred to herein as “memory network 310” for concision).

Components of memory network 310 can include localist units that code for objects and attributes, or relationships. As may be appreciated, such localist units may be or represent propositions and, as such, may represent an information-theoretic minimal unit of symbolic logic. In some embodiments, memory network 310 can further include distributed units 313 and output units 315. In some embodiments, components of memory network 310 can further include connections and/or mappings between localist units 311, distributed units 313, and/or output units 315.

In accordance with some disclosed embodiments, memory network 310 can include analogs comprising collected collections of localist units. The localist units can be connected to each other and to distributed units. As described herein, symbolic representation generator 110 can be configured to create or select analogs for generalization, refinement, predicate formation, or other operations. Such analogs may be described herein as being in “working memory.” Analogs in working memory may be further described as being in the “driver” or the “recipient” or other subcategories of working memory. Analogs that are not being created or selected may be described as being in “long-term memory.”

In accordance with some disclosed embodiments, when symbolic representation generator 110 selects an analog, that analog may be deemed removed from long-term memory and placed in working memory. However, as may be appreciated, the disclosed embodiments are not limited to any particular implementation of such selection. In some embodiments, selected analogs may be moved or copied to another location in a physical memory associated with the “working memory.” In some embodiments, selected analogs may not be moved or copied to another location in a physical memory associated with the “working memory.” Instead, metadata concerning the selected analogs may be updated to reflect that these analogs have been selected.

In some embodiments, memory network 310 can be a connectionist neural network, such as a symbolic connectionist neural network. In such embodiments, concepts, objects, predicates, and roles may be represented by discrete, identifiable localist units. Semantic content may be represented in a distributed manner across populations of units. Relationships among concepts can be explicitly represented. For example, concepts can be individuated as localist units, bound into specific roles in structured propositions, and recombined compositionally into new representational structures. These role-filler bindings can be independent of the particular neural units that carry semantic content, allowing the same concept to participate in many different relational structures without loss of identity. In some embodiments, explicit role-filler bindings can be implemented dynamic binding mechanisms (e.g., temporal synchrony, or another suitable mechanism).

In some embodiments, memory network 310 can treat localist units as computational objects with explicit lifecycles. For example, localist units can be created, compared, refined, deferred, promoted, demoted, or eliminated, and may not be assumed to be epistemically valid merely by virtue of having been learned. In some embodiments, the content of symbolic representations (e.g., which analogs are instantiated) and/or the format of symbolic cognition (e.g., binding regimes, abstraction granularity, representational thresholds, and memory-governance policies) may be placed under experimental control. In some embodiments, the inference component can perform deliberate interventions on these representational choices, assign them as experimental treatments across experimental units, and update causal effect estimates based on observed outcomes.

Accordingly, in some embodiments, experimentation can govern both interaction with the external environment and the internal representational ontology of machine learning system 100. Experimental results can determine which symbolic structures persist, which are refined or deferred, and which are eliminated, and can further determine which representational structures are permitted to guide action. Such experimental governance can enable the system to distinguish between representations that are merely uncertain and representations that are epistemically invalid, and to prevent structurally defective abstractions from persisting or influencing behavior. Accordingly, machine learning system 100 can be configured to select among alternative representational contents and formats based on their empirically demonstrated causal relevance, predictive utility, and epistemic value, rather than treating the representational substrate as fixed.

In some embodiments, distributed units 313 can represent the basic features of objects and relational roles in a distributed manner. In a visual processing example, such features can include the location, size, height, width, x-position, y-position, or the like of an object observed in a visual scene, such as, without limitation, the graphical user interface or field of field of a videogame, or a single- or multi-sensor representation of the environment in an augmented reality application, virtual reality application, automated transportation application, or the like. Such features could further include the color or shape of an object. In some embodiments, such features could include relational invariants such as “bigger-than,” “smaller-than,” “same-as,” “cause-of,” “caused-by,” “higher-than,” “lower-than,” “chases,” “loves,” or the like.

As described herein, in some embodiments, output units 315 can correspond to discrete potential outputs. As described herein, machine learning system 100 can be configurable to provide output 113 to environment 130. Activation of an output unit (e.g., one of output units 315) can cause machine learning system 100 to provide a corresponding output to the environment.

As described herein, in some embodiments, preprocessor 320 can be configured to convert input 111 into features suitable for processing by memory network 310. In some embodiments, preprocessor 320 can be configured to observe objects in the environment. In some embodiments, preprocessor 320 can identify basic features of observed objects (e.g., values of distributed units 313). In some embodiments, symbolic representation generator 110 (or a component thereof) can configure localist units 311 with a localist unit corresponding to each observed object. As may be appreciated, objects can differ between different environments. In a visual processing example, an object can be depicted in image data. Preprocessor 320 can generate features such as location, size, height, width, x-position, y-position, color, shape, or the like of such an object.

In some embodiments, the preprocessor can process image data using a suitable segmentation technique. Such techniques include thresholding methods like global thresholding, adaptive thresholding, and Otsu's method; edge-based segmentation such as Canny edge detection, Sobel operator, and Prewitt operator; region-based segmentation like region growing, region splitting and merging, and the watershed algorithm; clustering-based segmentation including K-means clustering, mean shift clustering, and fuzzy C-means clustering; graph-based segmentation such as normalized cuts and minimum cut/maximum flow; model-based segmentation like active contours (snakes) and level set methods; machine learning-based segmentation using support vector machines (SVM) and random forests; deep learning-based segmentation with convolutional neural networks (CNNs), fully convolutional networks (FCNs), U-Net, Mask R-CNN, and DeepLab; superpixel-based segmentation like SLIC (Simple Linear Iterative Clustering) and SEEDS (Superpixels Extracted via Energy-Driven Sampling); instance segmentation techniques include Mask R-CNN, PANet (Path Aggregation Network), YOLACT (You Only Look At CoefficienTs), BlendMask, SOLO (Segmenting Objects by Locations), CondInst (Conditional Convolutions for Instance Segmentation), PointRend, and Meta's SAM (Segment Anything Model); and hybrid methods that combine multiple techniques. In some embodiments, the preprocessor can represent the detected objects in terms of location, size, and color. In some embodiments, the preprocessor can perform shape classification to associate shapes with detected objects.

As described herein, in some embodiments, invariance circuit 330 can be configured to identify relational invariants and associate these invariants with objects observed in the environment. Invariance circuit 330 can build such associations by causing co-activation of element and distributed units corresponding to appropriate relational invariants.

FIG. 3B depicts exemplary components of a symbolic representation generator 110 configured to cause machine learning system 100 to provide output 113 including commands (also referred to herein as instructions), in accordance with one or more aspects of this disclosure. In some embodiments, symbolic representation generator 110 can include at least some components described with regards to FIG. 3A, such as memory network 310, preprocessor 320, and invariance circuit 330. In some embodiments, memory network 310 can include at least some of the components described with respect to FIG. 3A, such as localist units 311 and distributed units 313.

In the embodiment depicted in FIG. 3B, symbolic representation generator 110 includes command mapping 335. Command mapping 335 can map from a state of machine learning system 100 to an output value. In some embodiments, the output value can be or indicate a command. Symbolic representation generator 110 can be configured to provide (or to cause machine learning system 100 to provide) the command as (or as part of) output 113.

Symbolic representation generator 110 can be configured to repeatedly generate output values using command mapping 335. In some embodiments, symbolic representation generator 110 can generate such an output value before, during, or after an operation performed on memory network 310. In some embodiments, such operations can include invariance circuit application, retrieval, mapping, and relational learning, refinement, or generalization. For example, representation generator 110 can generate an output value after a relational learning, refinement, or generalization operation. In some embodiments, symbolic representation generator 110 can generate such an output value as part of a separate operation.

In some embodiments, symbolic representation generator 110 can be configured to determine the state of machine learning system 100 based on characteristic(s) of memory network 310. Such characteristic(s) of memory network 310 can be or depend upon characteristics of localist unit(s) 311 and/or distributed unit(s) 313 included in memory network 310. Such characteristics of localist unit(s) 311 and/or distributed unit(s) 313 can include activity levels, weight information (e.g., the presence, absence, or value of weights connecting to a localist unit 311 or distributed unit 313), mapping information (e.g., the presence, absence, or value of weights connecting to a localist unit), or other relevant characteristics. For example, symbolic representation generator 110 can determine average activation levels of localist units 311 in memory network 310 during a retrieval operation. Symbolic representation generator 110 can convert these average activation levels to a vector or scalar state value.

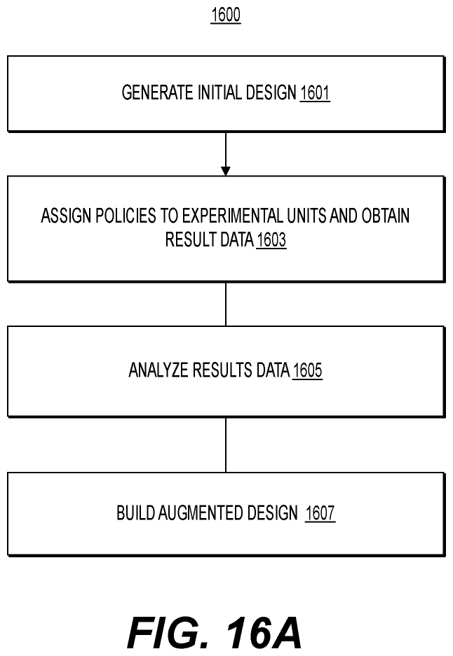

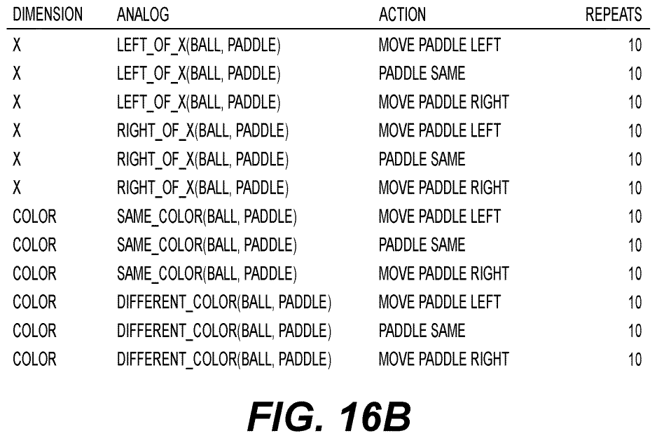

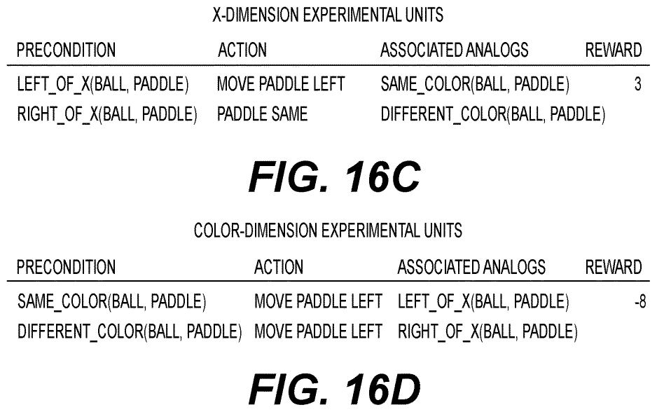

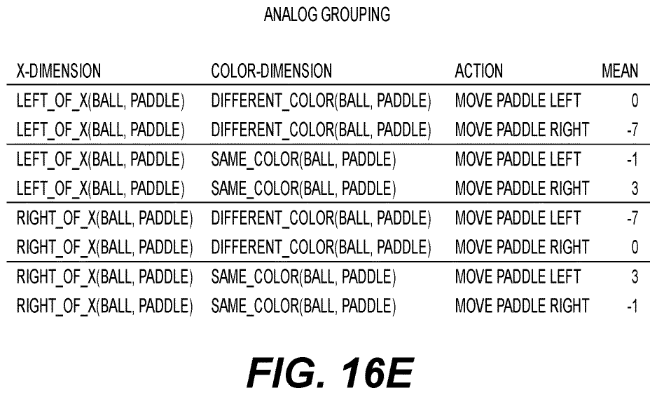

In some embodiments, symbolic representation generator 110 can be configured to determine the state of machine learning system 100 based on a portion of memory network 310 (e.g., one or more analogs). For example, the state can be or depend upon the analogs present in a working memory of memory network 310. As an additional example, the state can be or depend upon the analogs provided by the preprocessor, retrieved from long-term memory, created or refined through relational learning, or the like. In some embodiments, the state can be an SREC assigned to a policy (e.g., as depicted in FIG. 16B, or the like).

In some embodiments, symbolic representation generator 110 can determine the state based on a characteristic of a selected portion of memory network 310. For example, symbolic representation generator 110 can determine a vector or scalar state value based on an identifier associated with the portion as a whole, such as an identifier associated with a selected analog, identifiers associated with sub-portions, such as identifiers associated with localist units included in the selected analog, or the like.

In some embodiments, command mapping 335 can be configured (e.g., by a user or another system) with a predetermined set of commands. In some embodiments, command mapping 335 can be configured (e.g., by a user or another system) with predetermined mappings from at least some states to corresponding commands. In some embodiments, symbolic representation generator 110 can be configured to automatically generate mappings from at least some states to corresponding commands. For example, symbolic representation generator 110 can implement a machine-learning process (e.g., a reinforcement learning process, such as Q-learning, or another suitable process) to learn a mapping from states to predetermined commands using inputs 111 received from the environment. In some embodiments, the machine-learning process can be capable of outputting symbolic data (e.g., tabular Q-learning or the like).

Symbolic Representation Generator with Primary and Secondary Memory

FIG. 3C depicts operation of an exemplary symbolic representation generator 110 including a memory network 310 and a secondary memory network 309, in accordance with one or more aspects of this disclosure. In some embodiments, the addition of secondary memory network 309 can enable machine learning system 100 to defer epistemic tasks and reanalyzing structures within a symbolic framework at later time (e.g., when resources become free or when new input reactivates to improve understanding or outcomes). This capability may improve the ability of machine learning system 100 to handle complex decision-making or knowledge processing. In some embodiments, the secondary memory network 309 can be configured to retain traces separate from analogs (and therefore potentially without impacting the computational time for retrieving, mapping, inference, or refinement).

In some embodiments, machine learning system 100 can include a failure detector configured to monitor the symbolic construction process and trigger deferral of a trace when a deferral condition, as described herein, is satisfied. This detector may include mechanisms to monitor higher priority tasks analysis. In some embodiments, machine learning system 100 can include a deferred instance constructor, which can encapsulate failed symbolic construction attempts into traces for storage in the secondary memory network 309. In some embodiments, inference component 120 can be configured to apply new input data or analogs to stored traces in an experimental loop. In some embodiments, machine learning system 100 can include resolution and integration logic to determine whether a re-processed trace can be stored in secondary memory network 309.

The addition of secondary memory network 309 can provide multiple benefits, in accordance with some disclosed embodiments. For example, in some embodiments, the secondary memory network 309 can preserve incomplete learnings and memory consolidations. Absent secondary memory network 309, in some embodiments the symbolic representation generator may be configured to delete analogs in working memory (e.g., analogs in working memory output by preprocessor 320 or created by invariance circuit 330) when those analogs cannot be mapped to existing analogs in long-term memory. This may cause machine learning system 100 to lose potentially valuable data. A machine learning system can instead be configured to store such analogs in secondary memory network 309, preserving them for subsequent analysis.

In some embodiments, the secondary memory network 309 can protect long-term memory from entangled analogs. The symbolic representation generator may be configured to store refined analogs (e.g., generated using relational refinement as described in FIG. 4L, or the like). But such analogs may exhibit varying degrees of refinement. Some such analogs may be highly specific for a particular relationship (e.g., “disentangled,” as described herein), while others may combine multiple different characteristics and relationships (e.g., “entangled,” as described herein). Through a process for repeated retrieval, mapping, and refinement, as described herein, analogs can be compared and used to generate “more-disentangled” analogs. In some embodiments, secondary memory network 309 can store entangled analogs (which can be used to generate disentangled analogs). Furthermore, in some embodiments, secondary memory network 309 can store analogs that have not been tested or used.

In some embodiments, the secondary memory network 309 can enable machine learning system 100 to handle dynamic non-sequential environments. As may be appreciated, an environment may not provide cleanly comparable examples of relationships or objects in separate but sequential episodes. Important comparisons might be days or weeks apart. Secondary memory network 309 can store information in a “half a comparison” state and wait for a match, allowing machine learning system 100 to perform intersecting discovery across temporally separated episodes.

In some embodiments, the addition of secondary memory network 309 can reduce resource requirements. For example, machine learning system 100 may lack compute to consistently perform retrieval, mapping, and refinement as input is received from the environment. Machine learning system 100 can be configured to store traces (as described herein with respect to FIG. 3D) and process these traces as computational resources become available. This ability to defer computation can reduce the amount of computational resources required to implement machine learning system 100.

In some embodiments, the secondary memory network 309 can enable machine learning system 100 to store partially processed traces. As may be appreciated, deleting such partially processed structures could waste both compute and input data. However, storing such partially processed results in memory network 310 could negatively impact the performance of machine learning system 100. Instead, in accordance with some embodiments of the disclosure, secondary memory network 309 can be configured to store traces marked by machine learning system 100 for subsequent processing. These traces can form a latent symbolic continuation set, to be processed when the contents of memory network 310 have changed, new input data has been acquired, or computational resources have become available.

As described herein, inference component 120 can be configured to experiment upon components, operations, and parameters of the symbolic representation generator 110. In accordance with some embodiments of the disclosure, inference component 120 can treat configuration values that specify the components, operations, and parameters of the symbolic representation generator 110 as treatment variables assigned according to an experimental design across experimental units. Inference component 120 can update causal effect estimates (e.g., point or interval estimates) of these configuration values on performance metrics.

As may be appreciated, configuration values specifying the components, operations, and parameters of the symbolic representation generator 110 include configuration values specifying the components, operations, and parameters of secondary memory network 309. For example, such configuration values can specify when traces are stored in the symbolic memory network or transferred to secondary memory network 309 or deleted (e.g., one or more of criteria for determining unsuccessful analog generation, or insufficient selectivity of a generated analog, a strength condition, or the like). As an additional example, such configuration values can specify whether traces are retrieved from secondary memory network 309, deleted from memory, or marked as to be disregarded (e.g., one or more of schedule parameters for retrieval according to a schedule, event criteria for retrieval upon occurrence/non-occurrence of an event, probability values for probabilistic retrieval, decay schedule parameters affecting retrieval likelihood, or the like). As a further example, such configuration values can specify whether retrieved traces are reprocessed to generate a new trace and if so, whether the new trace is stored in the symbolic memory network, stored in secondary memory network 309, deleted from memory, or marked as to be disregarded. As a further example, whether an analog is released (as described herein) can depend upon at least one configuration value (e.g., a selectivity threshold, a number of times retrieved threshold, a strength threshold, a duration in memory threshold, or the like).

Accordingly, inference component 120 can treat such configuration values as treatment variables and updates causal effect estimates (e.g., point or interval estimates) of configuration values on performance metrics. In some embodiments, these estimates can determine whether a trace stored in secondary memory network 309 is retrieved and/or reprocessed to generate a new trace. In some embodiments, these estimates can determine whether such a new trace is stored in symbolic or secondary memory, (or marked as to be disregarded), or used to guide provision of instructions to take action in the environment.

In some embodiments, machine learning system 100 can attempt to generate analogs using data obtained from a preprocessor 320 (e.g., based on input data, such as input data 111, obtained from an environment, or the like) or generated by invariance circuit 330 (e.g., data 301). In some instances, the attempt may be unsuccessful, or the analog may satisfy criteria for storing the analog in secondary memory network 309. In some instances, the attempt to generate analogs may fail, due to incomplete performance of pre-processing, invariance circuit application, analog retrieval, mapping to retrieved analogs, generalization, predicate learning, relational refinement, abduction, or the like, as described herein. For example, comparison of element units may fail to yield an invariant, predicate refinement may halt, or a proposition may not be completed. In some embodiments, the criteria may concern the selectivity of the generated analog. In such embodiments, machine learning system 100 may be configured to store selective analogs in memory network 310; machine learning system 100 may deem the generated analog insufficiently selective. For example, as described herein, machine learning system 100 can deem the analog “entangled” and therefore suitable for storage in secondary memory network 309. In some embodiments, in response to an unsuccessful attempt at generation of an analog or to satisfaction of secondary memory network 309 storage conditions, the machine learning system 100 can store a trace in secondary memory network 309 (e.g., trace 305). As described herein, the trace may include an analog (which may be partially constructed), raw data, perceptual data, metadata, or the like.

In some embodiments, machine learning system 100 can retrieve traces from secondary memory network 309. The machine learning system 100 can retrieve such traces when computational resources become available, or when additional traces or data becomes available to support further refinement or processing of the traces. In some embodiments, once retrieval and attempted reprocessing of the trace is complete, machine learning system 100 can determine whether to return updated traces to secondary memory network 309, store analogs to memory network 310 (e.g., analogs 303), or delete the trace.

In some embodiments, machine learning system 100 can retrieve traces from secondary memory network 309 according to a schedule or in response to an event. Such an event could include an indication that compute or memory for processing the traces is available. Such an event could include a determination that new input obtained from the environment, or the contents of working memory 390, overlaps with a trace. In some embodiments, symbolic representation generator 110 can be configured to attempt retrieval of memory traces stored in secondary memory network 309, as described herein. In some embodiments, the results of such attempted retrieval can depend on an overlap between distributed units associated with the contents of working memory 390 and memory traces stored in secondary memory network 309. For example, such attempted retrieval can depend on activation flowing from the analogs in working memory 390 to corresponding analogs in secondary memory network 309.

For example, in some embodiments the symbolic representation generator may attempt to retrieve analogs from memory network 310 with one probability (e.g., a) and attempt to retrieve analogs from secondary memory network 309 with another probability (e.g., 1-a). In some embodiments, these probabilities can be hyperparameters stored and experimented upon by inference component 120. In some embodiments, if an attempt at retrieval fails for one memory, retrieval will be attempted with the other memory.

In some embodiments, the symbolic representation generator 110 can re-attempt processing of retrieved traces. Such processing can be performed using at least some of the components of the retrieved trace, such as input data from the environment, analogs, localist units, or the like. In some embodiments, such processing can include retrieving current analogs from memory network 310 (e.g., analogs 303) and performing invariance generation, mapping, inference, generalization, and/or refinement. In some embodiments, processing may resume at the operation where processing previously failed. For example, when the trace was stored because mapping (or retrieval) failed, processing may resume at mapping (or retrieval). In some embodiments, processing may return to an initial or predetermined step (e.g., application of the invariance circuit, selection of an analog for retrieval, or the like). In some embodiments, such processing can include running internal perturbations to evaluate structural sufficiency of the retrieved trace.

In some embodiments, machine learning system 100 can be configured to determine whether to store an analog generated by processing retrieved traces in memory network 310 or secondary memory network 309 (or delete the analog). In some embodiments, this determination can depend on suitable conditions (e.g., whether the analog was successfully created, whether the analog mapped to existing analogs in memory network 310, whether the analog satisfied a threshold or other condition for classifying the analog as “disentangled”, or other suitable conditions). In some embodiments, machine learning system 100 can determine whether to delete the memory trace used to generate the analog (e.g., when adding the analog to memory network 310 or secondary memory network 309) or continue to store the memory trace used to generate the analog in secondary memory network 309.

In some embodiments, the trace can be associated with a strength value. The strength value may reflect the number of times that the trace has been reprocessed (as may be appreciated, in some embodiments, each reprocessing may generate a new trace, and an updated strength value reflecting the additional reprocessing can be associated with the new trace). In some embodiments, the strength value of the trace may satisfy a transfer condition and at least some of the trace (e.g., an analog included in the trace) can be transferred to memory network 310.

As described herein, once the analog is stored in memory network 310, the analog can be used to determine whether to provide instructions to take actions in the environment. For example, the analog can be retrieved into working memory. The inference component can then, according to a policy as described herein, provide instructions to take an action in the environment. As an additional example, the analog can be, or be incorporated into, a relationship analog (e.g., a causal relationship analog). The retrieval of the relationship analog can cause the inference component to provide instructions to take an action in the environment. In some embodiments, retrieval of traces into working memory may not cause provision of instructions to take action in the environment.

In some embodiments, hyperparameters monitored by inference component 120 can govern the use of secondary memory network 309. For example, such hyperparameters can govern the storage and retrieval of memory traces from secondary memory network 309. As an additional example, such hyperparameters can govern the decision whether to store the results of re-processing a memory trace in memory network 310 or secondary memory network 309 (or delete the results of re-processing the memory trace). In some embodiments, inference component 120 can experiment on memory traces when new memory traces become available (or when new memory traces map to existing memory traces). In some embodiments, such experimentation can be part of the selection and configuration of an experimental model (e.g., the inner levels of experimentation described herein with regards to FIG. 2) Accordingly, machine learning system 100 can be configured to identify unprocessed analogs and defer processing of such analogs.

For example, inference component 120 can set conditions for inclusion or exclusion of traces from secondary memory network 309. For example, when an analog is incomplete (e.g., the analog lacks a mapped localist unit) or entangled, machine learning system 100 can determine whether to store a corresponding trace in secondary memory network 309 or delete the analog. The inference component 120 can continuously tune a condition for this decision by measuring deltas in performance based on the condition. If entangled analogs are presently demonstrating epistemic leverage, then inference component 120 can ease the condition (e.g., make storage more likely). If entangled analogs rarely mature into disentangled analogs, then inference component 120 can strengthen the condition (e.g., make storage less likely). As an additional example, machine learning system 100 can consider how many failed reactivations occur, how small the expected value of information (VOI) is, and how long it has been since the last useful overlap in determining whether to delete a trace stored in secondary memory network 309. The inference component 120 can adaptively adjust the conditions for deleting traces depending on the rate of incoming new structures, resource constraints, and observed payoff.

In some embodiments, at least some traces stored in secondary memory network 309 can be associated with decay information. When the decay information associated with a trace satisfies a deletion condition, machine learning system 100 can remove the trace from (or overwrite the trace in) secondary memory network 309. In this manner, suitably decayed traces can be deleted or overwritten, freeing memory for storage of new traces. In some embodiments, the decay information can implement a time-based deletion strategy. For example, the decay information can be a storage date/time or most recent retrieval date/time. Machine learning system 100 can be configured to permit overwriting of traces stored or most recently retrieval more than some time interval prior (e.g., new trace overwrites older time-stamped trace). In some embodiments, in such a system, machine learning system 100 can be configured to adjust the decay information when conditions are satisfied (e.g., the trace being retrieved into working memory, being reactivated by some reset mechanism, or the like). Such adjustments can include resetting the decay information to reflect the time the conditions are satisfied.

FIG. 3D depicts components of secondary memory network 309, in accordance with one or more aspects of this disclosure. In particular, secondary memory network 309 includes trace 314. Machine learning system 100 can be configured to store trace 314 in secondary memory network 309, as described with regards to FIG. 3C. In some embodiments, trace 314 can include at least one of input data 316, preprocessor output 317, analog 318, or metadata 319. Input data 316 can include raw data obtained from the environment (e.g., items of input data 111 as described herein). Preprocessor output 317 can include data that has been at least partially processed by preprocessor 320 (e.g., element units, distributed unit activations, or the like). Analogs 318 can include localist units bound to distributed units (e.g., metric, categorical, relational units, or the like). In some embodiments, analog 318 can include both multiple analogs from working memory (e.g., analog(s) stored from the driver and analog(s) retrieved from the memory network 310). In some embodiments, metadata 319 can include decay information or strength information, as described herein. In some embodiments, machine learning system 100 can be configured to use metadata 319 in determining whether to transfer the retrieve trace 314, transfer trace 314 to memory network 310, or delete trace 314. In some embodiments, the metadata can include a procedural context describing the cause of storage of trace 314 (e.g., the comparison results or invariants that triggered generation of trace 314, whether trace 314 was too entangled for storage in memory network 310, failure of a particular step of retrieval, mapping, generation, or refinement, or the like).

FIG. 3E depicts exemplary components of a symbolic representation generator 110 configured with multiple preprocessors, invariance circuits, and memory categories, in accordance with one or more aspects of this disclosure. In some embodiments, symbolic representation generator 110 can include at least some components described with regards to FIGS. 3A to 3C, such as memory network 310, command mapping 335, and secondary memory network 309.

In accordance with some embodiments of the disclosure, preprocessor 320A and preprocessor 320B can be configured to convert input 111 into features suitable for processing by memory network 310. In some embodiments, preprocessor 320A and preprocessor 320B can be configured to handle different modalities. For example, preprocessor 320A can be configured to accept textual input, while preprocessor 320B can be configured to accept graphical input. In some embodiments, given semantically similar inputs (e.g., the text “circle” and a graphical image of a circle), the two preprocessors can be configured to create element units and bind the element units to similar distributed units. In some instances, the sets of bound distributed units may overlap, as each of the inputs may be semantically “entangled” (e.g., an element unit generated from graphical input may be additionally bound to metric or categorical distributed units representing the position, size, color, or the like; while an element unit generated from textual input may be additionally bound to metric or categorical distributed units representing part of speech or relationships to other words extracted from the text).

In some embodiments, as depicted in FIG. 3E, symbolic representation generator 110 can include multiple depicted invariance circuits (e.g., invariance circuit 330A and invariance circuit 330B) and/or memory network categories (e.g., memory network categories 312A, 312B, and 312C). In some embodiments, the memory network categories can correspond to dimensions (e.g., x dimension, y dimension, size, color, or other such dimensions). In some embodiments, the memory network categories can correspond to combinations of dimension and salience. In some embodiments, symbolic representation generator 110 can be configured to form categorically specific streams using the invariance circuits and memory network categories. The categorically specific streams can operate in parallel, reducing the time required to generate categorically specific analogs.

In some embodiments, the symbolic representation generator 110 can be configured to perform analog creation as described herein with regards to FIG. 4G, then perform categorically specific invariance circuit application in parallel. For example, symbolic representation generator 110 can be configured to generate two element units in memory network 310 bound to corresponding sets of distributed units, and based on two objects in the environment. As described with regards to FIG. 4F, symbolic representation generator 110 can generate an x-dimension specific version of the two elements bound to relational distributed units (which may be x-dimension specific) using an invariance circuit configured or parameterized to identify relations in the x-dimension. Symbolic representation generator 110 can also generate a y-dimension specific version of the two elements bound to relational distributed units (which may be y-dimension specific) using the invariance circuit configured or parameterized to identify relations in the y-dimension. Additionally or alternatively, symbolic representation generator 110 can use separate invariance circuits for different dimensions.

In some embodiments, the symbolic representation generator 110 can be configured to perform retrieval using the output of the categorically specific invariance circuits. Such retrieval may be expressly or implicitly limited to categorically corresponding analogs in memory network 310. For example, the symbolic representation generator 110 can expressly limit retrieval to analogs associated through storage location or metadata with a particular category. As an additional example, the presence of x-dimension relational distributed units can implicitly limit retrieval to analogs also including such x-dimension relational distributed units. As described herein, retrieval can be followed by operations of mapping, generalization, relational learning, and relational refinement. These operations can be performed using the retrieved, dimensionally specific analogs. In this manner, the configuration of symbolic representation generator 110 can drive dimensionally specific relational learning.

As described herein, in some embodiments inference component 120 can perform experimentation on the configuration of the symbolic representation generator. In some embodiments, such experimentation can include specifying the memory network categories or specifying memory network categories from which analogs can be retrieved (e.g., based on salience).

As described herein, in some embodiments inference component 120 can perform filtering on analogs in memory network 310. Such filtering can compress the representation of the environment, enabling the inference component to use more efficient experimental designs. In some embodiments, such experimentation can include limiting experimental design (or policy generation) to analogs belonging to particular categories (e.g., x-dimension, combination of y-dimension and salience, or the like).

FIG. 3F depicts an exemplary process 340 for controlling preprocessing of input data, in accordance with one or more aspects of this disclosure. For convenience of description, process 340 is described herein as being performed by machine learning system 100. However, this description is not intended to be limiting. Process 340 can be performed by one or more components of machine learning system 100 (e.g., symbolic representation generator 110, inference component 120, or the like), or another system.

In some embodiments, inference component 120 can design and perform causal experiments upon one or more operations of process 340. Such causal experiments can enable inference component 120 to evaluate counterfactual scenarios, testing which aspects of the input data are causally linked to performance metrics (e.g., task performance, predictive accuracy, rewards, or the like). As described herein, inference component 120 can select perturbations to discriminate between preprocessing approaches and monitor the results of such perturbations. In this manner, the inference component can search the space of preprocessors and preprocessor configurations to identify suitable machine learning system configurations. As described herein, the inference component 120 can build a causal model of the relationship between such machine learning system configurations and performance metrics (e.g., task performance, predictive accuracy, rewards, or the like). In some embodiments, the causal model can include point and interval estimates of such relationships.

In accordance with some embodiments of the disclosure, this causal experimentation can concern the data to process, the processed objects and features to retain, the preprocessors to use, the configuration parameters for these preprocessors, or the like. Based on the results of such causal experimentation, machine learning system 100 can be configured to exclude objects or features apparently unrelated to performance metrics (e.g., task performance, predictive accuracy, rewards, or the like). As may be appreciated, limiting the objects and features extracted during preprocessing can dramatically reduce the number of relationships handled by machine learning system 100. In this manner, process 340 can improve the performance of machine learning system 100 by reducing memory and compute requirements.

Additionally, process 340 may enable identification of incorrect or uncertain labels in training data (e.g., “label noise”). Process 340 may also enable generation of confidence scores for different extracted features of the input data. Process 340 may also enable the use of more “noisy” input data, such as data obtained through other image analysis techniques (e.g., noise reduction; contrast enhancement; edge detection; segmentation; feature extraction such as texture, shape, color, size, position, or the like; object detection and recognition such as template matching, machine learning, deep learning or the like; image classification such as Bag of Visual Words, Scale-Invariant Feature Transform, convolutional neural networks or the like; image reconstruction such as tomographic reconstruction or super-resolution; 3D image analysis, such as stereo vision or 3D reconstruction; or the like.

In an initial step, machine learning system 100 can obtain image input data including visual scene 341, in accordance with some embodiments of the disclosure. As described herein, machine learning system 100 can obtain this input data from an environment. This visual scene can include objects 343 (e.g., a circle, a rectangle, and an irregularly shaped object).

In a subsequent step, machine learning system 100 can apply the input data to at least one preprocessor to observe objects in the environment and identify features of the observed objects, in accordance with some embodiments of the disclosure. As depicted in FIG. 3E, multiple different preprocessors can be used (e.g., preprocessor 320A and 320B). Additionally or alternatively, a preprocessor can be used with multiple different processing parameters. As described herein, the preprocessor may use a thresholding segmentation method, edge-based segmentation method, region splitting and merging segmentation method, clustering-based segmentation method, graph-based segmentation method, model-based segmentation method, machine learning-based segmentation method, instance segmentation technique, another suitable method, or a combination of any of the foregoing to identify objects and extract object features. These methods may have configuration parameters including, for example, colorspace(s) for thresholding, number of clusters (k) for clustering methods, initialization methods, number of iterations for iterative methods, sensitivity thresholds, gaussian kernel sizes, gradient calculation methods, anchor scales and ratios, learning rates, batch sizes, prompting strategies, model variants, input image resolution or colorspace, post-processing techniques such as morphological operations to refine results, confidence thresholds, or the like. In accordance with some disclosed embodiments, through repeated experimentation, inference component 120 can determine point and interval estimates for such techniques, or for the configuration parameters of such techniques.

In a matching step 345, machine learning system 100 can match objects detected by different preprocessors (or preprocessing configurations), in accordance with some embodiments of the disclosure. Additionally, in some embodiments, machine learning system 100 may match objects observed in different scenes (e.g., different frames of video data). As described herein, each preprocessor can output information specifying objects and features of these objects. For example, depicted preprocessor 320A and preprocessor 320B can each output information specifying an element unit corresponding to one of objects 343 (e.g., the circle) and distributed units corresponding to features of that object (e.g., distributed units corresponding to the x and y positions of the circle, the size of the circle, a color of the circle, or the like). As may be appreciated, object matching can enable machine learning system 100 to delete from the symbolic memory network duplicate objects and create merged objects. In this manner, process 340 can reduce the number of objects and relationships processed by machine learning system 100, thereby reducing system compute and memory requirements, reducing experimentation space, and speeding learning.

In accordance with some embodiments of the disclosure, machine learning system 100 can be configured to use object features to match objects. The disclosed embodiments are not limited to any particular matching approach. Suitable matching techniques can include those based on shape descriptors matching and computer vision tracking (e.g., Scale-Invariant Feature Transform, Speeded-Up Robust Tracking, Oriented FAST and Rotated BRIEF, and the like), contour based tracking techniques, template Matching techniques, deep-learning-based tracking, shape-based tracking methods (e.g., Moment-based methods, such as Hu Moments and/or Zernike Moments that use statistical moments to describe shape; geometric hashing methods that recognize shapes by creating a hashing table; Hough transform methods; or the like). In some embodiments, machine learning system 100 can use a shape-based method that captures and encodes different aspects of an object known to be relevant to human visual perception (and therefore interpretable and meaningful to users), such as: symmetry of shape (e.g., using Hu or Zernike moments), number of sides or vertices (e.g., using polygonal approximation), curvature (e.g., using curvature scale space, Fourier descriptors, or the like), types of vertices, parallelism of opposite sides (e.g., using Hough transform, line segment detection, or the like), solid vs hollow, or the like. As may be appreciated, the choice of matching technique can depend on the choice of processing technique.

In a merging step 347, machine learning system 100 can merge features of matched objects. For example, different preprocessors may have returned different sizes for an object. Machine learning system 100 can be configured to select one of these sizes for the object, determine a new size based on the multiple different sizes (e.g., an average or weighted average, or the like), or the like. In some embodiments, different types of features may be merged in different ways. For example, machine learning system 100 can average metric feature values and select among categorical feature values.

As described herein, the inference component 120 can be configured to experiment upon the feature merging. In some embodiments, the inference component 120 can include certain features but not others in the merged object (e.g., as a result of experimentation). In some embodiments, the inference component 120 can exclude certain objects from the preprocessor output (e.g., as a result of experimentation). As may be appreciated, the result of these experiments can inform estimates of the effect of such perturbations on performance metrics (e.g., task performance, predictive accuracy, rewards, or the like).

As may be appreciated, process 340 is not limited to image input data. Additionally or alternatively, process 340 can be performed on data obtained using techniques such as morphological analysis (e.g., tokenization, stemming, lemmatization), syntactic analysis (e.g., part-of-speech tagging, parsing), semantic analysis (e.g., named entity recognition, word sense disambiguation, semantic role labeling), pragmatic analysis (e.g., coreference resolution, discourse analysis), sentiment analysis (e.g., polarity detection, emotion detection), topic modeling (e.g., latent Dirichlet allocation, non-negative matrix factorization), text classification (e.g., supervised or unsupervised learning), machine translations (e.g., rule-based translations, statistical machine translation, neural machine translation), information retrieval (e.g., keyword search, semantic search), text summarization (e.g., extractive summarization, abstractive summarization), or the like.

FIGS. 3G to 3J depict exemplary applications of the process of FIG. 3F, in accordance with one or more aspects of this disclosure. FIG. 3G depicts two instances of a preprocessor detecting objects in the same scene 370. In both instances, the preprocessor quantizes the intensities in the original scene 370. Such quantization can include clustering the color values (or intensities in a grayscale image, as in FIG. 3G) for the pixels into a predetermined number of clusters (e.g., using k-means clustering or another suitable method), selecting a representative color value (or intensity) for each cluster, and replacing the color values for the pixels with the corresponding representative color values (or intensity values). For example, when 8-bit intensity values between 30 and 130 fall into a single cluster, and the representative value for that cluster is selected to be 80, then the color values for all pixels having color values between 30 and 130 can be replaced with the value 80.

FIG. 3G depicts the resulting intensity quantizations using 7 clusters (scene 371A) and using 8 clusters (scene 371B). The greater number of clusters used to generate scene 371B enables better fidelity to the original scene 370. For example, when using 7 clusters, the bar that depicts remaining oxygen is in the same quantization cluster as the seafloor. Accordingly, scene 371A depicts the bar and the seafloor with the same intensity. In contrast, when using 8 clusters, the bar that depicts remaining oxygen is in a different quantization cluster than the seafloor. Accordingly, scene 371B depicts the bar and the seafloor with different intensities.

Following color quantization, the preprocessor can perform image segmentation to detect objects. As may be appreciated, image segmentation can depend on the results of color quantization, which may in turn depend on a variety of factors, including the predetermined number of clusters for clustering. For example, the preprocessor can perform the same image segmentation process on scene 371A and scene 371B to generate differing scenes 373A and 373B.

As depicted in FIG. 3G, the preprocessor may segment out the expended portion of the oxygen bar in both scenes (e.g., detected object 374). However, the preprocessor may not segment out the bar that depicts remaining oxygen in scene 371A, as scene 371A depicts that bar and the seafloor with the same intensity. In contrast, the preprocessor may segment out the bar that depicts remaining oxygen in scene 371B, as scene 371B depicts that bar and the seafloor with the differing intensities. Accordingly, when the preprocessor is configured to use 7 clusters, machine learning system 100 may lack information about the bar that depicts remaining oxygen.

In accordance with some embodiments of the disclosure, inference component 120 can be configured to experiment upon preprocessor configuration parameters, such as the number of clusters used in quantization. In this example, detected object 374 was segmented (and thus identifiable as an object in scene 370) when quantization was performed with 8 clusters, but not when quantization was performed with 7 clusters. Should detected object 374 be relevant to performance metrics, inference component 120 may learn a negative effect estimate for setting the number of quantization clusters to 4.

FIGS. 3H and 3I depict an example of the potential consequences of a preprocessor quantizing the color values for pixels into too-few clusters. FIG. 3H depicts a game of Breakout® in which the color of the ball, brick, and paddle affect the scoring. For example, in such a game, points might be deducted from the score when the ball contacts the paddle or a brick, and the ball is a different color from the paddle or brick. In this example, each column of bricks has a different color, the paddle has a color, and the color of the ball may repeatedly change. FIG. 3I depicts the output of a preprocessor configured to quantize the input data (e.g., the game screen depicted in FIG. 3H) into only two quantization clusters. In this example, three of the columns of brick, the ball, and the paddle have all been clustered into the same color. As a result, machine learning system 100 may be unable to determine whether the ball and a brick or the paddle actually have the same color, negatively affecting the ability of machine learning system 100 to play the game. As in the example of FIG. 3G, inference component 120 may learn a negative effect estimate for setting the number of quantization clusters to 2.

FIG. 3J depicts a scene 380 including extraneous objects (e.g., birds) and relevant objects (e.g., walls, bricks, ball, paddle, score, and lives). The movement of the extraneous objects has no effect on gameplay. Given a preprocessor (or preprocessor configuration) that identifies the extraneous objects and another preprocessor (or preprocessor configuration) that does not identify the extraneous objects, the inference component 120 can perform experiments comparing the performance metrics (e.g., task performance, predictive accuracy, rewards, or the like) of these two preprocessors (or preprocessor configurations).

In accordance with some disclosed embodiments, when using the preprocessor that identifies the extraneous objects (e.g., extraneous object 381, and the like), machine learning system 100 may attempt to determine causal relationships between them (and between them and the relevant objects). These extraneous objects can therefore act as “noise” and retard identification of underlying causal relationships (e.g., ball hitting paddle increases score). For example, if the paddle approached a bird in several experimental units, and points were scored in these experimental units, the inference component 120 could erroneously estimate that getting the paddle close to the bird or chasing it can cause a reward. As may be appreciated, the accumulation of data through randomized trials would eventually correct this estimate. But when using a preprocessor (and/or preprocessor configuration setting) that does not identify the extraneous objects, the noise would not be encountered at all, so inference component 120 would more rapidly learn that points are caused by hitting the ball with the paddle. The experimentation on the preprocessor may therefore favor selection of preprocessors or preprocessor configuration settings that omit the extraneous objects from the preprocessor output.

FIG. 3K depicts an exemplary operation of linguistic and visual preprocessors, in accordance with one or more aspects of this disclosure. In some embodiments, machine learning system 100 can be configured to process language and determine a representation of linguistic information within the existing symbolic framework. This entails defining mappings from natural language to symbols and aligning language representations with visual ones. For example, a linguistic preprocessor may extract lexical features (e.g., identifying words and their parts of speech, such as noun, verb, adjective, etc., and morphological information, such as tense, number, etc.); syntactic features (e.g., analyzing the grammatical structure of sentences, such as parsing to identify subjects, objects, predicates, and phrases); semantic features (e.g., understanding the meanings of words and phrases, including word sense disambiguation and semantic roles); pragmatic features (considering the context in which language is used, such as speaker intent, tone, and implied meanings); relational features (e.g., identifying relationships between entities mentioned in the text, such as “is a part of,” “causes,” or “is similar to”); and the like. The extraction of such features may allow machine learning system 100 to form representations of linguistic information and learn relations between concepts in a manner analogous to how it processes visual information.

In accordance with some embodiments of the disclosure, a textual input (e.g., textual input 391) can be applied to a linguistic preprocessor, which may extract features using one or more of tokenization, part-of-speech tagging, named entity recognition, lemmatization, dependency parsing, measures of semantic similarity, coreference resolution, word sense disambiguation (WSD), sentiment analysis, discourse analysis, data augmentation (e.g., synonym replacement, back-translation, random deletion/insertion, contextual paraphrase, or the like), visualization (e.g., sentence dependency tree, sentiment per sentence, named entity recognition timeline), graph processing, or the like. The extracted features can include objects (represented by element units) and object characteristics (represented by distributed unit activations). In some embodiments, the linguistic preprocessor and the visual preprocessor can be configured to map equivalent detected objects to the same distributed units. For example, as shown in FIG. 3K, the textual input 391 and visual input 393 can be mapped to overlapping ones of distributed units 395, which can in turn be mapped to circle distributed unit 397.

### Memory Network Configuration

FIG. 4A depicts an exemplary implementation of memory network 310, in accordance with one or more aspects of this disclosure. This exemplary implementation can include one or more distributed units (corresponding to one or more of distributed units 313). Consistent with some disclosed embodiments, the distributed units 313 can include metric distributed units 401, categorical distributed units 405, relational distributed units 403, and the like.

Consistent with some disclosed embodiments, metric distributed units 401 can include features that support relational operations (e.g., greater-than, less-than, equal-to, etc.). Such features can be continuously valued and may be associated with a dimension or attribute. As a visual processing example, the x-coordinate (or the size, height, lighting, chromaticity, luminance, hue, saturation, RGB values, CMYK values, orientation, curvature, symmetry, skewness, aspect ratio, roundness, parallelism, compactness, elongation, acceleration, velocity, or movement path. or the like) for the detected objects in an environment can form a dimension of distributed units. Consistent with some disclosed embodiments, categorical distributed units 405 can include categorical features such as shape, type, color, status, numeric ranges (e.g., “0-3”, “3-6”, etc.), or the like. Consistent with some disclosed embodiments, relational distributed units 403 can encode relational operations on metric distributed units 401. In some embodiments, relational distributed units 403 can be dimensionally independent. For example, while the distributed units 313 may include metric distributed units 401 corresponding to x-position and to y-position, relational distributed units 403 may include greater-than and less-than. Additionally or alternatively, relational distributed units 403 may include dimensionally specific relational distributed units 403, such as x-greater-than, y-greater-than, etc.

As described herein, in some embodiments, localist units 311 can be arranged hierarchically, with higher-level localist units binding lower-level localist units. In some embodiments, localist units can include element units 406, role-binding units 407, and proposition units 408. An element unit can correspond to a single-argument relational predicate (e.g., a relational role) or an argument to such a predicate. For example, an element unit may represent a noun, verb, proposition, punctuation, or other linguistic object when machine learning system 100 is configured to interact with a consumer productivity application. An element unit may represent a chemical bond, compound, or moiety thereof when machine learning system 100 is configured to interact with simulation or design software for characterizing properties of one or more compounds based on chemical formulas. An element unit may represent an object detected in the environment, or an attribute of such an object when machine learning system 100 is configured to interact with autonomous operation software or consumer entertainment software. As may be appreciated, an analog including an element unit and any distributed units connected to that element unit can represent the state of an object detected in the environment. Accordingly, metric distributed units, categorical distributed units, and relational distributed units can in part define the state of the object. In some embodiments, such an analog can represent the state of the object at a particular time (e.g., the acquisition time of a particular scene or frame used to generate the analog). Thus, the state of an object observed in the scene or frame can be or include an element unit and scene attributes (e.g., the distributed units connected to the element unit).

In accordance with some disclosed embodiments, respective role-binding unit 407 can bind a single-argument relational predicate and a particular argument into a role-filler pair. For example, in a visual processing environment, an argument can be an object b, and a single-argument relational predicate can be “greater-x(⋅).” A respective role-binding unit 407 can then represent the composition of object b and predicate “greater-x(⋅)” into the role-filler pair “greater-x(b)”.

In accordance with some disclosed embodiments, proposition can bind multiple role-binding units 407 into a single relationship. To continue the prior example, when a respective role-binding unit 407 “less-x(p)” represents the composition of object p and predicate “less-x(⋅)”, a proposition can bind “greater-x(b)” and “less-x(p)” into the relationship, “right_of(b,p)”.

In accordance with some disclosed embodiments, bindings between localist units 311 (and between localist units 311 and distributed units 313) can be represented by co-activation. Each of localist units 311 (and each of distributed units 313) can have an activation level. The activation level of a localist unit 311 at step n can depend on an input to the localist unit 311 (or distributed unit 313). The activation level of a localist unit 311 at step n can further depend on a prior activity level of the localist unit 311 (e.g., a step n−1). Localist units 311 can competitively inhibit other localist units 311 of the same type (e.g., elements, role-binding units, proposition). In some embodiments, a degree of such competitive inhibition can depend on weights between localist units of the same type. Furthermore, localist units 311 can be self-inhibitory. Accordingly, while FIG. 4A depicts multiple active role-binding units and elements (e.g., activated localist unit 411 and activated distributed unit 410), such role-binding units and elements would not necessarily be active at the same time. Instead, localist units (and distributed units) can become active in complex temporal patterns indicating relationships between such localist units (and distributed units). As may be appreciated, there need not be any fixed relationship between step and time. For example, a computing device implementing machine learning system 100 need not maintain any fixed time interval between steps.

As described herein, in some embodiments, a localist unit or distributed unit may be connected to one or more other localist units. Additionally or alternatively, the localist unit may be connected to one or more distributed units. These connections (depicted in FIG. 4A as dark lines) between localist units, or between localist units and distributed units can be associated with numeric-valued weights (e.g., weight 409). The input to a localist unit or distributed unit can depend in part on the connections to that localist unit or distributed unit and the weights associated with those connections. In some embodiments, the weights between localist units can be uniform, while the weights between localist units and distributed units can vary (e.g., based on the determined strength of the association between the localist and distributed units). In some embodiments, weights between localist units can vary. Connections between localist units and distributed units are shown only where particularly relevant, for clarity. The strength of the connection between the localist and distributed units is depicted by the shading of the distributed unit, with a stronger connection indicated by darker shading.

### Invariance Operations

FIG. 4B depicts an exemplary invariance circuit 430, in accordance with one or more aspects of this disclosure. In some embodiments, machine learning system 100 can be configured to execute invariance circuit 430 to associate relational distributed units derived from metric distributed unit differences (e.g., “greater-than”, “less than”, “equal”, or other suitable relations) with elements. In this manner, memory network 310 can develop a richer representation of the elements, which in turn can support improved representational learning. Although only element unit 435 is depicted in FIG. 4B, invariance circuit 430 can be configured to operate on pairs of such element units. The element units in such pairs can exhibit complex patterns of activation that interact with mapping component 431 to bind distributed units representing relational invariants to each element unit.

As described herein, in some embodiments, symbolic representation generator 110 can activate one or more of metric distributed units 433. In this example, two metric distributed units are connected to element unit 435. The activations of these two distributed units contribute to the input of element unit 435 (in accordance with the weights associated with these connections). Accordingly, over multiple steps, element unit 435 can become active. The activation of element unit 435 can in turn contribute to mapping component 431.

As described herein, in some embodiments, mapping component 431 can be connected to one or more of relational distributed units 437. For clarity, mapping component 431 is depicted as being connected to one of relational distributed units 437 by connection 436. As may be appreciated, mapping component 431 is not so limited. Instead, mapping component 431 may be connected to multiple relational distributed units 437 (e.g., one or more for each element connected to mapping component 431). In some embodiments, symbolic representation generator 110 can be configured to select connection 436 each time invariance circuit 430 is executed. As described herein, in some embodiments, connection 436 can be selected randomly or based on the existing weights or mappings in memory network 310.

Mapping component 431 can map inputs received from elements (e.g., element unit 435) to outputs provided to ones of relational distributed units 437. The mapping can be “spatially” complex, in that inputs from different element units can be weighted differently. Additionally or alternatively, the mapping can be “temporally” complex. For example, as described herein, symbolic representation generator 110 can be configured to sequentially calculate activations and other values of memory network 310. The weight of a mapping from mapping component 431 to one of relational distributed units 437 can depend on the “step” in this sequence. For example, the mapping to some connections may more-heavily weight inputs received at earlier steps in the sequence, while mapping to other connections may more heavily weight inputs received at later steps in the sequence. Activation levels of element units connected to mapping component 431 can oscillate. The oscillating activation levels of elements units, in combination with the spatial and temporal complexity of the mapping implemented by mapping component 431, can cause the relational distributed units connected to mapping component 431 to represent relational invariants, such as “greater-than,” “less-than” or the like. Symbolic representation generator 110 can then bind co-activated elements and relational distributed units using learned weights (e.g., learned weight 439).

In some embodiments, the magnitudes of the learned weights can depend, at least in part, on the activation levels of the co-activated elements and relational distributed units. In some embodiments, the magnitudes of the learned weights can be set to predetermined values (e.g., 1, or another suitable value). In some embodiments, multiple relational distributed units can be bound to co-activated elements with weight(s) valued according to disclosed implementations of relational metric precision.

### Relational Metric Precision

In some embodiments, machine learning system 100 can be configured to use relational metric precision to enable preservation of metric properties without sacrificing relational compositionality or symbolic generalization. In this manner, machine learning system 100 can support both purely categorical representations (e.g., Object A is “above” Object B) and continuous, metric-sensitive representation (e.g., Object A is “3.5 units above” Object B).

As described herein, in some embodiments, memory network 310 can be configured to support encoding distributed units (e.g., metric distributed units, relational distributed units, and the like) using overlapping Gaussian receptive fields (and scaled difference in some embodiments). In this manner, memory network 310 can be configured to enable graded encoding of metric properties. Instead of discrete relational predicates (e.g., Left-Of(A, B)=True), each relation can be represented continuously across a range of relations.

As described herein, in some embodiments, each relational predicate can operate in either categorical or metric mode, determined by inference component-driven precision control. In some embodiments, the same localist units or distributed units can dynamically switch between discrete and continuous representations.

In this manner, machine learning system 100 can preserve structured relational reasoning while enabling fine-grained metric encoding; prevent unnecessary computational or memory overhead by applying metric precision selectively; reduce the need for hardcoded heuristics; and bridge the gap between symbolic architectures and continuous function approximation, allowing generalization across both discrete and continuous domains.

For convenience of description, the implementation of relational metric precision is described with regards to symbolic representation generator 110. However, the implementation of relational metric precision can additionally or alternatively involve other components of machine learning system 100.

FIGS. 4B to 4E depict motivation for and exemplary implementations of relational metric precision, in accordance with one or more aspects of this disclosure. In some embodiments, such relational metric precision can enable symbolic representation generator 110 to support relational degrees or modifiers. For example, such relational metric precision can enable symbolic representation generator 110 to distinguish between propositions like “John loves Mary” from propositions like “John loves Mary very much.” In some embodiments, symbolic representation generator 110 can disentangle such propositions, as described herein, and combine them across dimensions to obtain dimension-agnostic relational metric precision propositions such as “very” and “very very”. As may be appreciated, such capabilities can support hypothesizing novel situations (e.g., “imagining”) and reduce the data required to learn different degrees of metric precision by pooling information across dimensions.

As depicted in FIG. 4B, input data (e.g., images) can depict relationships that can be encoded into an analog. For example, symbolic representation generator 110 can be configured to generate an analog representing the relationship right-of(circle, square) using image 412A based on the knowledge of the dimension x as a primitive and the encoding of the concept of a “more than” as a relational distributed unit. However, absent a mechanism for relational metric precision, symbolic representation generator 110 might similarly generate the analog right-of(circle, square) using image 412B and 412C, even though the relationship between the square and the circle is clearly different in these images.

As depicted in FIG. 4C, symbolic representation generator 110 can be configured to generate scaled difference values (e.g., scaled difference value 414) for pairs of element units, in accordance with some embodiments of the disclosure. A described herein, a preprocessor can represent objects detected in the environment in terms of metric dimension values (e.g., size, x, y, or z location, or the like). Symbolic representation generator 110 can generate difference values (e.g., difference value 413) using metric dimension values obtained from a preprocessor.

In accordance with some disclosed embodiments, symbolic representation generator 110 can apply a function to the difference values to generate scaled difference values. In some embodiments, the function can be a logistic function that maps the domain (−∞, ∞) (or another suitable domain, for example dependent on the range of the input data) to the range (−1, 1) (or another suitable range, such as zero to one, or the like). The logistic function can be continuously valued, enabling smooth transitions between categories and preserving metric variation within relational encodings. The logistic function can be parameterized by a scaling factor κ, which can determine the granularity of metric encoding:

$$R ( A , B ) = 2 * {( 1 + {e}^{- κ P ( A , B )} )}^{- 1} - 1$$

P(A, B) represents a function of the difference value for the dimension (e.g., height difference, distance, angle) between the detected objects A and B. In some implementations, P(A, B) may equal −P(B, A). In some embodiments, a “dead-zone” can implement a measure of equivalence:

$$P ( A , B ) = \{ \begin{matrix}0 , \vert A - B \vert < b \\ A - B - b , A - B \geq b \\ A - B + b , A - B \leq - b\end{matrix}$$

Values within the dead zone can be treated as equivalent, while values outside the dead zone can be scaled to avoid discontinuities at the boundaries of the dead zone. As may be appreciated, other suitable dead zone implementations may be used.

Scaling factor κ dynamically modulates the steepness of the function, enabling the system to flexibly encode categorical vs metric distinctions. For example, when κ>>1, even slight non-zero difference values yield scaled difference values of approximately negative one or one. Alternatively, when κ<<1, slight non-zero difference values yield slight changes in scaled difference values.

As depicted in FIG. 4D, symbolic representation generator 110 can be configured to use scaled difference values to determine weights connecting element units to relational metric units, in accordance with some embodiments of the disclosure. A relational metric dimension (e.g., greater than x) can be implemented using N distributed units. Each of these N distributed units can be associated with an activation function (e.g., activation function 416). Each activation function ƒᵢ( ) can map from scaled difference values x to weights wᵢ for a corresponding distributed unit i. In some embodiments, a noise floor 415 can determine a minimum activation level: activations less than this level can be set to zero. Activation functions can be parameterized by type (e.g., Gaussian, triangular, or the like), spreads (e.g., spread 419) of such activation function types (e.g., a standard deviation σᵢ of a Gaussian filter), central points μᵢ of the activation function (e.g., a mean of a Gaussian filter) and other suitable parameters. For example, given Gaussian filter activation functions parameterized by means and standard deviations:

$${w}_{i} = {f}_{i} ( x \vert {μ}_{i} , {σ}_{i} ) , i from 1 to N$$

In accordance with some embodiments of the disclosure, the centers of the various activation functions (e.g., μᵢ) can be located at appropriate locations along the scaled difference axis. For some modalities, when using Gaussian activation functions, a just-noticeable-differences criterion can specify that standard deviation σᵢ should be as follows:

$${σ}_{i} = k log ( {μ}_{i} ) + m$$

This is a logarithmic function that obeys Weber's law for different modalities like light and sound, subject to an affine transformation.

In some embodiments, the activations functions can be symmetrically disposed around zero. For example, one activation function centered at μ=0 can correspond to a relational distributed unit representing the concept of “equivalent.” A sequence of activation functions for positive values of μᵢ can be given according to the just-noticeable-differences criterion above. These activations functions can correspond to relational distributed units representing gradations of “more than.” Another sequence of activation functions for negative values of μᵢ can be given, similarly spaced to corresponding activation functions for positive values of μᵢ. These activations functions can correspond to relational distributed units representing gradations of “less than.”

As may be appreciated, the parameters determining the mapping from difference values to distributed unit weights (e.g., activation function type, spread, central points, number of relational distributed units, dead zone b, scaling factor κ, scaling function type, noise floor value, or the like) can be empirically determined, as described herein. For example, such parameters can be treatments in multi-level experimentation. As an example, machine learning system 100 can learn to increase the size of the dead zone when tasks merely require two objects be “close enough.” As a further example, machine learning system 100 can control the value of κ to move between categorical representations (e.g., in which only the extreme distributed units are activated) and metrically precise representations (e.g., in which distributed units close to zero are also activated).

As depicted in FIG. 4E, symbolic representation generator 110 can be configured to use difference values to determine which relational distributed units are activated, in accordance with some embodiments of the disclosure. In this implementation, the symbolic representation generator 110 can bind an object associated with a difference value (e.g., object A associated with the difference value P(A,B) or corresponding object B associated with the difference value P(B,A)) to the relational distributed units most activated by that difference value. As in FIG. 4D, a metric dimension (e.g., x distance) can be implemented using N units, each associated with an activation function having a spread and central point.

As may be appreciated, the activation functions may overlap. At the point of overlap, the contribution to activation of two adjacent activation functions may be equivalent. The activation value at which this overlap occurs may depend on the separation between the means of the two activation functions. In some embodiments, this point of overlap can define a “noise floor” (e.g., noise floor 415). Alternatively, in some embodiments the noise floor can be selected such that this point of overlap is above the noise floor. As described herein, the noise floor can be experimentally controlled and adjustable. The centers of the various activation functions (e.g., μᵢ) can be located at appropriate locations along the x-axis (the difference-value axis), such that the points of overlap for consecutive units occur above the level of the noise floor. As depicted in FIG. 4E, only relational distributed units activated above the level of the noise floor (e.g., activation 422 of unit N₁) would be bound to the detected object. As in FIG. 4D, for some modalities, a just-noticeable-differences criterion can specify the standard deviation σᵢ given the centers of the activation functions. As described herein, symbolic representation generator 110 can be configured to generate analogs encoding invariants such as “right-of” from observations of various objects to the side of various other ones.

According to the implementation depicted in FIG. 4E, symbolic representation generator 110 can be configured to generate analogs that activate the above Gaussians with some activations above the noise floor and create a moreⱼ+x predicate (assuming x is the dimension being compared for simplicity and without loss of generality). When another similar right-of combination is observed, it would create a moreₖ+x predicate. As described herein, one such analog can be used to retrieve another from memory network 310. These two analogs can be mapped. If these two analogs correspond to objects that are similarly close, then the value of their mapping may exceed a mapping strength threshold for refinement, as described herein. The symbolic representation generator can then create a new analog by refining these two mapped analogs, as described herein. Should the mapping strength threshold be lower (e.g., 0.1, 0.2, or the like), then multiple such analogs may be refined into analogs connected to distributed units corresponding to a set of Gaussian filters (e.g., Cluster 423). Such analogs may be akin to categorical relations. For greater x-distance values, or should the mapping strength threshold be higher (e.g., 0.8, 0.9, or the like), then only analogs connected to the same Gaussian filters may map to each other, resulting in relational metric precision corresponding to N (e.g., {just-right-of, right-of, . . . very-very right-of} with a total set size of N). In the example depicted in FIG. 4E, the highest μᵢ x-distance Gaussian filter may form its own cluster (e.g., cluster 424).

In some embodiments, consistent with the motivation and implementations depicted in FIGS. 4B to 4E, retrieval and mapping may be performed across dimensions. Such cross-dimensional comparisons may enable machine learning system 100 to generate a “moreⱼ” predicate from pooling observations with an eⱼ degree of metric precision on any dimension. For example, the invariant “very” exists in both the observations of “very right of” and “very above.” In some embodiments, implementing such cross-dimensional comparisons can reduce data requirements and abstract over dimension-relevant information, enabling machine learning system 100 to “imagine” with metric precision across novel situations using analogical generalization in accordance with some embodiments of the disclosure. For example, machine learning system 100 can imagine, using analogical generalization as described herein, “very wide” from examples depicting “very right-of” and “very above.”

### Memory Network Operations

FIG. 4F depicts an exemplary invariance circuit 430, in accordance with one or more aspects of this disclosure. In some embodiments, machine learning system 100 can be configured to execute invariance circuit 430 to associate relational distributed units derived from metric distributed unit differences (e.g., “greater-than,” “less than,” “equal,” or other suitable relations) with elements. In this manner, memory network 310 can develop a richer representation of the elements, which in turn can support improved representational learning. Although only element unit 435 is depicted in FIG. 4F, invariance circuit 430 can be configured to operate on pairs of such element units. The element units in such pairs can exhibit complex patterns of activation that interact with mapping component 431 to bind distributed units representing relational invariants to each element unit.

As described herein, in some embodiments, symbolic representation generator 110 can activate one or more of metric distributed units 433. In this example, two metric distributed units are connected to element unit 435. The activations of these two distributed units contribute to the input of element unit 435 (in accordance with the weights associated with these connections). Accordingly, over multiple steps, element unit 435 can become active. The activation of element unit 435 can in turn contribute to mapping component 431.

As described herein, in some embodiments, mapping component 431 can be connected to one or more of relational distributed units 437. For clarity, mapping component 431 is depicted as being connected to one of relational distributed units 437 by connection 436. As may be appreciated, mapping component 431 is not so limited. Instead, mapping component 431 may be connected to multiple relational distributed units 437 (e.g., one or more for each element connected to mapping component 431). In some embodiments, symbolic representation generator 110 can be configured to select connection 436 each time invariance circuit 430 is executed. As described herein, in some embodiments, connection 436 can be selected randomly or based on the existing weights or mappings in memory network 310.

Mapping component 431 can map inputs received from elements (e.g., element unit 435) to outputs provided to ones of relational distributed units 437. The mapping can be “spatially” complex, in that inputs from different element units can be weighted differently. Additionally or alternatively, the mapping can be “temporally” complex. For example, as described herein, symbolic representation generator 110 can be configured to sequentially calculate activations and other values of memory network 310. The weight of a mapping from mapping component 431 to one of relational distributed units 437 can depend on the “step” in this sequence. For example, the mapping to some connections may more heavily weight inputs received at earlier steps in the sequence, while mapping to other connections may more heavily weight inputs received at later steps in the sequence. Activation levels of element units connected to mapping component 431 can oscillate. The oscillating activation levels of elements units, in combination with the spatial and temporal complexity of the mapping implemented by mapping component 431, can cause the relational distributed units connected to mapping component 431 to represent relational invariants, such as “greater-than,” “less-than,” or the like. Symbolic representation generator 110 can then bind co-activated elements and relational distributed units using weights (e.g., learned weight 439). The magnitudes of the learned weights can depend, at least in part, on the activation levels of the co-activated elements and relational distributed units.

FIG. 4G depicts selection of an analog based on the environment, in accordance with one or more aspects of this disclosure. In some embodiments, symbolic representation generator 110 can select one or more analogs as a focus for modifying memory network 310. The selected analog can be described as being “in the driver,” a part of the “working memory.”

In an initial step of selecting the analog, machine learning system 100 can receive input 111 from the environment. Preprocessor 320 can convert the input into activations for distributed units 313 (e.g., depicted in FIG. 4G as varying crosshatching, with darker crosshatching indicating greater activation).

As described herein, in some embodiments, activation can flow from distributed units 313 to localist units 311. In some embodiments, input to element units 411 can depend in part on the activation of connected distributed units 313 and the weights associated with those connections (not shown in FIG. 4G). Element units can also competitively inhibit other element units. In some embodiments, input to role-binding units 413 can depend in part on the activation of connected element units 411 and the weights associated with those connections. Role binding units can also competitively inhibit other role binding units. In some embodiments, input to proposition units 408 can depend in part on the activation of connected role-binding units 413 and the weights associated with those connections. Proposition units can also competitively inhibit other proposition units.

As a result of the activation flowing from distributed units 313 to localist units 311, and due to localist unit competitive and self-inhibition, collections of localist units can activate in complex spatial and temporal patterns. For clarity, the localist units in analog 441 are all shown as active. However, not all of these localist units would be simultaneously active.

Symbolic representation generator 110 can calculate activations for localist units 311 until a termination condition is satisfied. The termination condition can depend on the number of steps calculated, the state of localist units 311, or another suitable termination condition. Symbolic representation generator 110 can determine activation values associated with localist units. An activation value for a localist unit can depend on the activation of the localist unit over the calculated sequence of steps (e.g., a maximum value, a sum, or other function of the activation values over the sequence of steps). In some embodiments, the activation value can be converted to a selection probability (e.g., using the Luce choice axiom or the like). In some embodiments, symbolic representation generator 110 can identify analogs and determine a selection probability for the entire analog based on the selection probabilit(ies) of the highest-order localist unit(s) in the analog. For example, the selection probability of analog 441 can be determined based on the selection probability of the proposition unit in analog 441.

As described herein, in some embodiments, one or more analogs can be selected based on the selection probabilities for the analogs. For example, as depicted in FIG. 4G, analog 441 has been selected into driver 440 (e.g., a portion of the working memory of memory network 310).

FIG. 4H depicts selection of analogs based on the contents of driver 440, in accordance with one or more aspects of this disclosure. In some embodiments, symbolic representation generator 110 can select one or more analogs as a target when modifying memory network 310. The selected analogs can be described as being “in the recipient,” a part of the “working memory.”

In an initial step, when there are multiple analogs in driver 440, symbolic representation generator 110 can select one of the analogs. The selection can be random, based on input 111 received from environment 130, or in another suitable manner. Symbolic representation generator 110 can select one or more of the highest-order localist units in the selected analog. For example, when the highest-order localist unit in the analog is a proposition unit, the proposition unit can be selected. When the highest-order localist unit in the analog is a role-binding unit, the role-binding unit can be selected. In the example depicted in FIG. 4H, the highest-order localist unit is a preposition unit in analog 441.

As described herein, in some embodiments, symbolic representation generator 110 can activate the selected localist unit. The disclosed embodiments are not limited to a particular method of activating the localist unit. In some embodiments, symbolic representation generator 110 can activate the localist unit by setting an input to the localist unit to a predetermined value and iteratively calculating the activations (and weights, mappings, etc.) in memory network 310.

As described herein, in some embodiments, activation can flow from the selected localist unit to connected lower order localist units in the analog. The input to these lower order localist units can depend, in part, on the activation of the selected localist unit and the weights associated with these connections.

As described herein, in some embodiments, activation can flow from the element units in the analog to connected ones of distributed units 313. The input to the connected ones of distributed units 313 can depend at least in part on the activation of element units in the analog and weights associated with those connections (not shown in FIG. 4G). In some embodiments, the input to these localist units can further depend on mapping connections between the localist units in the driver and other localist units of the same type (e.g., elements in the driver can map to other elements in localist units 311 that not in the driver, role-binding units in the driver can map to other role-binding units in localist units 311 that are not in the driver, etc.). The generation of mappings and updating of mappings is depicted in FIG. 4I.

As described herein, in some embodiments, activation can flow from the connected ones of distributed units 313 to ones of localist units 311 (apart from the analogs in driver 440). Similar to the process depicted in FIG. 4G, collections of localist units 311 can activate in complex spatial and/or temporal patterns. For clarity, localist units in analog 441 and analogs 451 are all shown as active. However, these localist units would not necessarily all simultaneously be active (due to competitive and self-inhibition among the activated localist units).

Symbolic representation generator 110 can calculate activations for localist units 311 until a termination condition is satisfied. The termination condition can depend on the number of steps calculated, the state of localist units 311, or another suitable termination condition. Symbolic representation generator 110 can determine activation values associated with localist units. An activation value for a localist unit can depend on the activation of the localist unit over the calculated sequence of steps (e.g., a maximum value, a sum, or other function of the activation values over the sequence of steps). In some embodiments, the activation value can be converted to a selection probability (e.g., using the Luce choice axiom or the like). In some embodiments, symbolic representation generator 110 can identify analogs and determine a selection probability for the entire analog based on the selection probabilit (ies) of the highest-order localist unit(s) in the analog. For example, the selection probability of each of analogs 451 can be determined based on the selection probability of the highest-order localist unit in each connected one of analogs 451.

As described herein, in some embodiments, one or more analogs can be selected based on the selection probabilities for the analogs. For example, as depicted in FIG. 4H, analogs 451 have been selected into the recipient 450 (e.g., a portion of the working memory of the memory network 310).

FIG. 4I depicts mapping between localist units in the selected analog in the driver 440 and localist units of analogs in the recipient 450, in accordance with one or more aspects of this disclosure. Symbolic representation generator 110 can be configured to map units in the driver 440 (e.g., a unit A) to units in the recipient 450 (e.g., unit B) to the extent that each unit in the driver 440 corresponds to the mapped unit in the recipient and not to other units in the recipient 450 (e.g., unit A corresponds to unit B and not to other units C in the recipient). The mapping process can include generation of mapping hypothesis that are then used to create or update mapping connections.

Similar to the process of FIG. 4G, symbolic representation generator 110 can activate the previously selected localist unit by setting an input to the localist unit to a predetermined value and iteratively calculating the activations (and weights, mappings, etc.) in memory network 310.

As described herein, in some embodiments, activation can flow from the selected localist unit through the lower order localist units in analog 441, through the connected ones of distributed units 313, and into the analogs 451 in the recipient. This flow can depend on the weights associated with the connections between localist units, and between localist units and distributed units.

In some embodiments, localist units can be connected to other localist units of the same type by mapping connections (depicted in FIG. 4I as light grey double-headed arrows). For example, element 461 in driver 440 can be connected to element 463 in the recipient by mapping 465. In some embodiments, the input to a localist unit in the recipient can additionally depend on mappings to that localist unit. For example, a localist unit in driver 440 can excite any localist units in the recipient of the same type to which they map and inhibit all localist units in the recipient of the same type to which they do not map.

As described herein, in some embodiments, symbolic representation generator 110 can determine mapping hypotheses in addition to determining activations, while iteratively updating memory network 310. In each iteration, symbolic representation generator 110 can make incremental adjustments to mapping hypotheses for pairs of localist units. Each pair can include a localist unit in the driver (e.g., element 461) and a localist unit in the recipient (e.g., element 463). The incremental adjustment can depend on the activation values of these localist units.

Symbolic representation generator 110 can calculate mapping hypotheses for localist units 311 until a termination condition is satisfied. Symbolic representation generator 110 can then overwrite existing mapping connections or write new mapping connections for pairs of localist units based on the mapping hypotheses for these pairs of localist units. For example, the mapping hypothesis can be divisively normalized, thereby restricting the mapping hypotheses to a numerical range (e.g., the interval [0,1]) and forcing the mapping hypothesis for each pair of localist units to compete with all other mapping hypothesis involving each localist unit in the pair of localist units. The divisively normalized mapping hypotheses can then be used to create (or update the numerical values of) mapping connections. In some embodiments, the numerical values of the mapping connections can be in a range (e.g., the interval [0, 1.1]). As may be appreciated, localist units of the same type that exhibit similar temporal coactivation (and dissimilar temporal coactivation with other localist units of the same type) may have greater mapping connection numerical values.

FIG. 4J depicts generalization using memory network 310, in accordance with one or more aspects of this disclosure. Similar to the process of FIG. 4G, symbolic representation generator 110 can activate the previously selected localist unit by setting an input to the localist unit to a predetermined value and iteratively calculating the activations (and weights, mappings, etc.) in memory network 310. When a localist unit in driver 440 does not map to a localist unit in recipient 450, symbolic representation generator 110 can create new localist units (e.g., new proposition 471, new role binding unit 473) in recipient 450 and map the unmapped localist units in driver 440 to these new localist units (e.g., new mapping 477). These new localist units can be clamped active, and symbolic representation generator 110 can learn connections and weights (e.g., new weight 475) between these new localist units and existing localist units in the recipient 450.

Similar to the process depicted in FIG. 4J, symbolic representation generator 110 can generate new a localist unit in localist units 311 when a localist unit in the driver does not map to any localist unit in localist units 311 (not just any localist unit in recipient 450). The localist unit can be of the same type as the unmapped localist unit in the driver. Symbolic representation generator 110 can create a mapping between the localist unit in the driver and the new localist unit.

FIG. 4K depicts relational learning (also referred to as “predicate learning”) using memory network 310, in accordance with one or more aspects of this disclosure. Similar to the process described with respect to FIG. 4G, symbolic representation generator 110 can activate existing element 481 in driver 440 by setting an input to existing element 481 to a predetermined value and iteratively calculating the activations (and weights, mappings, etc.) in memory network 310. Existing element 481 can be mapped to existing element 482 in recipient 450. However, existing element 481 and existing element 482 may not be connected to a common role-binding unit.

As described herein, in some embodiments, symbolic representation generator 110 can create a new element 483 and a new role binding unit 484 in recipient 450. These new localist units can be clamped active, and symbolic representation generator 110 can learn connections and weights (e.g., new weight 485) between these new localist units and existing localist units in the recipient 450. Furthermore, new element 483 can learn connections to the distributed units in the intersection of the distributed units connected to existing element 481 and the distributed units connected to existing element 482 (e.g., distributed units union 486). In this manner, memory network 310 can explicit representation of the featural overlap of existing element 481 and existing element 482 (e.g., new role binding unit 484) that can be bound to an argument (e.g., new element 483).

FIG. 4L depicts relational refinement (or comparison-based refinement) using memory network 310, in accordance with one or more aspects of this disclosure. Symbolic representation generator 110 can create a new element unit for each mapped pair of element units the driver 440 and the recipient 450. Suitable proposition units, role-binding unit, and the like can then be created mapping to the element units and to each other through the process of relational learning as depicted in FIG. 4K. Due to the activation timing of the localist units, symbolic representation generator 110 can connect each new proposition unit to the appropriate new role-binding units, and the new role binding units to the appropriate new element units. The element units can learn connections to the distributed units 313 in accordance with the activation of those units. Accordingly, distributed units connected to mapped pairs of element units will form stronger connections to the corresponding new element units than distributed units connected to only one of a mapped pair of element units.

In this manner, a new refined analog 490 is generated from the two original analogs. This new refined analog 490 includes a refined collection of distributed units 313 that reflects the intersection of distributed unit activations of the two original analogs (e.g., refined activations 491 and 493). The refined collection of distributed unit activations may better represent properties shared by the two original analogs.

In some embodiments, symbolic representation generator 110 can create the new element unit when the mapping connection between the mapped pairs of element units in the driver 440 and the recipient 450 satisfies a mapping condition. The mapping condition may be satisfied when a numerical value of the mapping connection exceeds a numerical threshold. As may be appreciated, element units bound to more “similar” sets of distributed units (e.g., in terms of degree of overlap, contributions to activation, or another suitable measure) may exhibit greater mapping connection numerical values.

As may be appreciated, the higher the threshold, the greater the degree of similarity required to create the refined analog, and the greater the intersection of distributed units bound to the new element units. The larger number of distributed units bound to the new element units can cause the refined analogs to represent specific elements (e.g., particular objects in the environment, attributes specific to such particular objects, or the like). Conversely, the lower the threshold, the lesser the degree of similarity required to create the refined analog and the smaller the intersection of distributed units bound to the new element units. As may be appreciated, dissimilar distributed unit activations can be averaged away, while common distributed unit activations can be preserved. Thus, the smaller number of distributed units bound to the new element units can cause the refined analogs to represent generic elements (e.g., a class of objects in the environment, generic attributes of objects in that class of object, or the like).

As described herein, element units can represent objects in the environment. In accordance with some embodiments of this disclosure, symbolic representation generator 110 can be configured to label such element units as generic. In some embodiments, symbolic representation generator 110 can label such element units as being based on the connections between the element unit and distributed units. For example, when all connections between the element unit and the distributed unit exceed genericity threshold value, then the element unit can be labeled generic. Additionally or alternatively, the symbolic representation generator 110 can be configured to track the generation method of the element unit. For example, an element unit generated using a low mapping threshold (or multiple refinements using a low mapping threshold) may be labeled generic.

As may be appreciated, the generation of generic elements can reduce the memory or storage requirements of the memory network. The generic elements can serve in place of more specific (but potentially unnecessary) analogs representing static objects or relationships between static objects. The more specific analogs can then be deleted from the symbolic memory network, effectively compressing the memory network. As may be appreciated, the reduction in memory or storage requirements can also support a reduction in the compute required to implement machine learning system 100.

In some embodiments, as described herein, the symbolic representation generator 110 can be configured to use the mapping condition to compress the representation of environment 130 maintained by memory network 310. In some embodiments, memory network 310 can include multiple categories of analogs (e.g., categories based on salience data, such as dynamic, static, or the like), and the mapping condition threshold value may differ between these categories of analogs. In some embodiments, inference component 120 can be configured to control the mapping condition threshold value (or values for multiple categories of analogs). For example, inference component 120 can be configured to maintain a set of symbolic representation parameters including such threshold value(s). Inference component 120 can be configured to perturb the threshold value(s) as part of the experimental process described herein.

FIG. 4M depicts difference-encoding using memory network 310, in accordance with one or more aspects of this disclosure. In accordance with some embodiments of the disclosure, symbolic representation generator 110 can be configured to use difference-encoding to develop causal or counterfactual analogs. In some embodiments, difference-encoding can be performed as an adjunct to relational refinement as described in FIG. 4L. For example, in addition to determining a refined analog 490, symbolic representation generator 110 can determine difference encoding 497A and 497B. In some embodiments, difference-encoding can be performed as a stand-alone operation by symbolic representation generator 110.

In accordance with some embodiments of the disclosure, element unit 496A and element unit 496B can be in the working memory of memory network 310. These element units can represent objects in the environment. In some embodiments, element unit 496A can be selected (e.g., as described with respect to FIG. 4G) and element unit 496B can be subsequently retrieved (e.g., as described with respect to FIG. 4H). In some embodiments, element unit 496A can be mapped to element unit 496B (e.g., as described with respect to FIG. 4I). The mapping can satisfy a mapping condition. In some embodiments, as described herein with respect to FIG. 4L, the mapping condition can depend on a category of at least one of element unit 496A or element unit 496B.

In some embodiments, symbolic representation generator 110 can create element units representing the difference in distributed unit activation between element unit 496A and element unit 496B. In some embodiments, symbolic representation generator 110 can create an element unit representing distributed units specific to (or more-strongly bound to) element unit 496A (e.g., difference encoding 497A) and an element unit representing distributed units specific to (or more-strongly bound to) element unit 496B (e.g., difference encoding 497B). The disclosed embodiments are not limited to any particular formula for determining the weights of the connections binding such element units to corresponding distributed units. In some embodiments, a connection weight between a distributed unit and a difference encoding (e.g., difference encoding 497A or 497B) can depend on (e.g., be the difference between) the connection weights between the distributed unit and respective ones of element units 496A and 496B.

FIG. 4N depicts another difference-encoding implementation using memory network 310, in accordance with one or more aspects of this disclosure. In this implementation, an element unit (e.g., difference encoding 498) encodes the differences in distributed unit activations between element unit 496A and element unit 496B. As described with regards to FIG. 4M, the disclosed embodiments are not limited to any particular formula for determining the weights of the connections binding this element unit to the corresponding distributed units. In some embodiments, a connection weight between a distributed unit and difference encoding 498 can depend on (e.g., be, or depend upon, the difference between) the connection weights between the distributed unit and respective ones of element units 496A and 496B.

In some embodiments, the difference-encoding implementation depicted in FIG. 4N can be used to encode estimated effects. For example, a first analog may be a causal analog corresponding to the effect of applying a treatment during an experimental unit. A second analog may be a causal analog corresponding to the effect of not applying the treatment (or applying a different treatment) during an experimental unit. A difference-encoding for these two analogs can represent a difference in effect between applying and not applying the treatment. Multiple repeats of this difference encoding may be generated as multiple pairs of analogs including the treatment and not including the treatment are obtained. These repeats can undergo relational refinement. This relational refined analog can represent a mean of differences between replicates of applying and not applying the treatment. Additionally or alternatively, multiple causal analogs including the treatment can be refined to generate a refined analog representing the mean treatment effect and multiple causal analogs not including the treatment can be refined to generate a refined analog representing the mean no-treatment effect. A difference encoding between the mean treatment effect analog and the mean no-treatment effect can represent a difference in means between applying and not applying the treatment.

As may be appreciated, the difference encodings depicted in FIGS. 4M and 4N can be localist units representing the difference between two objects in the environment. The difference encodings can be bound with other element units or causal units as described herein.

FIGS. 4O to 4Q, depict the progressive formation of disentangled analogs, in accordance with one or more aspects of this disclosure. In some embodiments, machine learning system 100 can be configured to perform memory compression using such analogs. As described herein, symbolic representation generator 110 can be configured to perform operations including retrieval, mapping, generalization, and refinement. During these processes, an analog from memory network 310 can be stored in a working memory. The analog can be retrieved in a retrieval phase that may involve activation of all semantic features associated with the driver within memory network 310 (e.g., to identify the analog for retrieval). As the number of analogs stored in memory network 310 increases, this retrieval process requires more resources (e.g., more time or compute). As may be appreciated, the result of retrieval, mapping, generalization, and refinement may be another analog, which may be similar to the retrieved analog. As may be appreciated, the retrieved analog may be redundant in view of the newly generated analog. Accumulating redundant analogs in memory network 310 can contribute to the increasing resources required to perform retrieval.

FIG. 4O depicts a hypothetical element unit 499A for a newly created analog. As may be appreciated, such an analog may include localist units (e.g., element units) connected to numerous distributed units. These distributed units may concern particular characteristics of the objects and relationships observed in the input data used to create the analog. Additionally, such an element unit may also include a relational distributed unit generated by an invariant circuit (e.g., “more” in this example). When constructed using an invariant circuit as described herein, in some embodiments, the weight connecting the element unit to the relational distributed unit may be a predetermined value, which may be a maximum value (e.g., 1). In some instances, the weights connecting the element unit to non-relational distributed unit may be less than this predetermined value. For example, normalized to the predetermined value, the weights connecting the element unit to non-relational distributed unit may be less than 0.5, 0.25, 0.1, 0.05, or less. Furthermore, the differences between these weights, normalized to the full range of potential weights, may be less than 0.25, 0.1, 0.05, 0.025, or less.

FIG. 4P depicts a hypothetical element unit 499B for an analog created using hypothetical element unit 499A through the refinement process described herein. As described herein with regards to FIG. 4L, this refinement process can generate a new analog from two existing analogs. The element unit(s) of the new analog will connect more strongly to distributed units connected to both existing analogs, and less strongly to distributed units connected to only one of the existing analogs. Thus, connections reflecting shared characteristics or relationships will be strengthened, while connections reflecting potentially spurious characteristics that differ between the existing analogs will be weakened.

In this example, the hypothetical element unit mapped to another hypothetical element unit representing the relationship “more” in the X dimension (along with other characteristics). Thus, the connection to the relational distributed unit remains unchanged (or strengthened in some implementations). The connection to the x distributed unit is also strengthened, while the connection to the other distributed units diminishes.

In some embodiments, machine learning system 100 can be configured to deem analogs entangled or disentangled based on connections between distributed units and one or more element units. For example, machine learning system 100 can generate a selectivity metric that depends on such connections. For example, the selectivity metric for an element unit (e.g., an element unit representing a single-argument relational predicate, or the like) can depend on the connection weights between the element unit and two or more distributed units. For example, the selectivity can depend on an average of the two highest weights among connections between that element unit and the distributed units (e.g., 1 and 0.8 for hypothetical element unit 499B). In some embodiments, the selectivity can depend on an average of the two highest weights in specific distributed unit categories (e.g., the highest weight among the relational distributed units and the highest weights among the metric distributed units).

In some embodiments, the selectivity metric can further depend on the weights of the remaining connections. For example, the selectivity metric can be a ratio or difference between the average of the two highest weight connections and the average of the remaining connections. In some embodiments, machine learning system 100 can deem an analog disentangled when the selectivity metric for the element exceeds a selectivity threshold (which can be a stored hyperparameter monitored by the inference component 120 as described herein). In the example depicted in FIG. 4P, the analog may be deemed disentangled because the difference between the average of the two highest weight connections and the average of the remaining connections exceeds 0.7. As may be appreciated, other thresholds and other functions for determining the selectivity metric can be used without limitation.

As may be appreciated, disentangled units can continue to be refined. FIG. 4Q depicts a hypothetical element unit 499C for an analog created using hypothetical element unit 499B through the refinement process described herein. As shown in FIG. 4Q, the value of the connection to the x distributed unit has increased through additional refinement, while the values of the connections to the remaining metric units have decreased. Accordingly, a selectivity value for hypothetical element unit 499C may be greater than a selectivity value for hypothetical element unit 499B.

In some embodiments, machine learning system 100 can be configured to compress memory network 310 by identifying entangled analogs stored in memory network 310. The machine learning model can then use the symbolic representation generator 110 to retrieve analogs mapping to each identified entangled analog. These retrieved analogs may be disentangled versions of the identified analog. In some embodiments, the machine learning model may retain only the most disentangled version of the identified analog, releasing more-entangled versions of the identified analog. In some embodiments, releasing the more-entangled version of the identified analogs can include transferring these more-entangled versions to a secondary memory (e.g., adding them to the secondary memory and removing them from the memory network, or the like). As may be appreciated, the more-entangled analogs may still encode useful representations of causal relationships in the environment. Preserving these more-entangled analogs in the secondary memory may enable them to be later retrieved and refined (e.g., based on increased availability of memory or compute in the system, the receipt of additional input of the environment, or the like). In some embodiments, releasing the more-entangled versions of the identified analogs can include marking the more-entangled versions as being released. Marking the analogs as being released may cause the symbolic representation generator 110 to disregard these marked analogs when performing operations of retrieval, mapping, and learning as described herein. In this manner, marking the more-entangled versions of the identified analogs can reduce the effective number of analogs processed by the symbolic representation generator 110, thereby reducing the computational requirements of the system while preserving the analogs in the memory network. In some embodiments, releasing the more-entangled versions of the identified analogs can include deleting these analogs from the memory network.

In some embodiments, additional refinement can be performed to generate a single, disentangled version using the identified analog and the retrieved analogs. For example, each of the retrieved analogs can be used to generate a new, refined analog using the process of relational refinement described herein. In some embodiments, once the identified analog or the retrieved analogs have been used to generate a new, refined analog, they can be released, as described herein. Reducing the number of stored analogs in this manner can significantly reduce resource requirements (e.g., processing time, compute, memory, or the like).

In various embodiments, such identification and deletion (or combining) can be performed once or repeatedly. For example, such identification and deletion (or combining) can be performed according to a schedule, or in response to an event or determination (e.g., a determination that the memory network included at least a threshold number of analogs or consumed at least a threshold amount of memory).

In some embodiments, analogs can be tagged with metadata. Machine learning system 100 can be configured to use this metadata to implement temporal decay of entangled analogs. In such embodiments, entangled analogs may be eventually deleted from the memory of machine learning system 100. In some embodiments, machine learning system 100 can be configured to store entangled analogs as traces in a secondary memory (e.g., secondary memory network 309, or the like). As described herein, these traces can include metadata (e.g., metadata 319, or the like). Machine learning system 100 can be configured to use the metadata to implement a decay function, wherein the probability of the analog being retrieved into working memory decreases as the time since the entangled analog was stored or last retrieved, number of input data sets received (e.g., frames, or the like) since the entangled analog was stored or last retrieved, number of retrieval operations performed (e.g., from memory network 310 or secondary memory network 309) since the entangled analog was stored or last retrieved, or another suitable measure, increases. In some embodiments, analogs associated with different input modalities may have different rates of decrease. In some embodiments, the rate(s) of decrease can be hyperparameter(s) monitored by the inference component 120. In some embodiments, when an analog is retrieved into working memory, a strength value of the analog (or of an analog generated using the retrieved analog) can increase (as described herein). When the analog (or the generated analog) satisfies a transfer condition, machine learning system 100 can move the analog from secondary memory network 309 to memory network 310 (or store the generated analog in memory network 310). In some embodiments, the transfer condition can be implemented using the strength value and a strength threshold (e.g., a hyperparameter monitored by inference component 120). The transfer condition can be satisfied when the strength value exceeds the strength threshold. As may be appreciated, this process can reduce the amount of redundant data in long-term memory, and thereby potentially improve the storage and computational efficiency of machine learning system 100.

### Inference Component

FIG. 5A depicts an exemplary inference component 120, in accordance with one or more aspects of this disclosure. In accordance with some embodiments of the disclosure, inference component 120 can perform experiments and construct inferences based on experimental results. As may be appreciated, other components of machine learning system 100 may also implement inferential reasoning. For example, symbolic representation generator 110 can implement inferential reasoning through operations performed on the symbolic representation, such as those described herein with regards to FIGS. 4H to 4Q.

In accordance with some embodiments of the disclosure, inference component 120 can be configured to store experimental unit parameters 510, experimental design parameters 520, symbolic representation parameters 521, and causal model 530. As described herein, inference component 120 can be configured to interact with symbolic representation generator 110. For example, inference component 120 can be configured to monitor the causal significance of localist units, distributed units, weights, mappings, activations, or the like in memory network 310. In some embodiments, inference component 120 can be configured to obtain feedback signals from environment 130 (e.g., reward signals, or the like). As described herein, environment 130 can also provide input to symbolic representation generator 110. In some embodiments, inference component 120 can be configured to interact with environment 130. For example, inference component 120 can be configured to provide commands to environment 130.

As described herein, in some embodiments, inference component 120 can be configured to determine the input scope and duration of experiments. As described herein, in some embodiments such parameters may be treatment specific. For example, a particular treatment may affect the performance of machine learning system 100 over a long period of time, or a wide range of inputs obtained from environment 130 (e.g., where the environment includes a spatial extent, a particular treatment may affect the performance of machine learning system 100 over the entire spatial extent of environment 130, or only a portion of the spatial extent of environment 130). The input scope and duration associated with such a treatment may be greater than the input scope and duration associated with a treatment that affects the performance of machine learning system 100 over a short period of time, or a limited range of inputs. As described herein, in some embodiments, experimental unit parameters 510 can store the determined parameters specifying input scope and duration.

As described herein, in some embodiments inference component 120 can be configured to analyze experiments. In some embodiments, the analysis of experiments can involve separately considering clusters of experiments that are empirically determined to be causally similar. For example, such experiments may involve similar external factors (e.g., unknown, or uncontrolled influences on environment 130), or differing regions of a feature space subject to differing causal relationships (apparently differing causal relationships, as inference component 120 may approximate some unknown, complicated causal relationship with multiple, locally appropriate causal approximations). In some embodiments, inference component 120 can determine an experimental design and then analyze the results of the experiment in accordance with that experimental design.

In some embodiments, the analysis of experiments can involve limiting the analyzed experiments to a subset of all experiments conducted. This subset can be time-based or number-of-experimental-unit based. For example, causal relationships can change over time. Treatment effects can be diminished or confounded when the set of analyzed experiments spans an interval over which the underlying relationships substantively changed. Accordingly, in some embodiments, inference component 120 can specify a retrospective data window. Experiments conducted within that window can be included in an analysis of treatment effects, while experiments outside that treatment window can be omitted from the analysis.

In accordance with some embodiments of the disclosure, inference component 120 can monitor hyperparameters of machine learning system 100. Inference component 120 can be configured to experiment upon the values of these hyperparameters (e.g., as part of the multi-level experimentation described herein). In some embodiments, the hyperparameters can be stored in, or can be accessible to, machine learning system 100.

For example, in some embodiments, experimental design parameters 520 can store hyperparameters of machine learning system 100 that are controlled by inference component 120 and pertain to inference component 120. Such hyperparameters include the choice of experimental model, the configuration of the experimental model (e.g., analogs excluded from consideration in determining policies; analogs specifying experimental clusters; statistical model parameters such as number of factors, fraction index, number of runs, defining relation (or defining word), aliasing structure, or the like; reinforcement learning model parameters such as states (or state-action pairs) modeled, learning rate, discount factor, exploration rate, reward function, or the like), the configuration of the inference component (e.g., the split between explore and exploit units, the length of the data window, and the like), and the like.

As an additional example, in some embodiments, symbolic representation parameters 521 can store hyperparameters of machine learning system 100 that are controlled by inference component 120 and pertain to symbolic representation generator 110. Such hyperparameters can govern the choice or configuration of the preprocessor, the choice of dimension(s) for the invariance circuit, the operations of the symbolic representation generator and the like. For example, such hyperparameters can include metric specificity parameters for metric feature units, preprocessor hyperparameters that govern the detection of objects and association of objects with features, and the like. As an additional example, such hyperparameters can include parameters controlling symbolic representation generator operations such as analog selection, analog retrieval, analog mapping, relational refinement, relational learning, difference-encoding, predicate generalization, or the like.

As described herein, in some embodiments, inference component 120 can include a causal model 530. In some embodiments, causal model 530 can be configured to maintain treatment effect estimates of the effect on performance metrics (e.g., task performance, prediction accuracy, reward scores, or the like) (e.g., a response value) of outputting a command to take an action in the environment (e.g., taking an action) or perturbing a component, parameter, or operation of symbolic representation generator 110 (e.g., perturbing the symbolic representation generator). These treatment effect estimates can include point and interval estimates (e.g., d-scores, confidence intervals, or the like).

In some embodiments, as described herein, an action can be taken in the environment when machine learning system 100 outputs a command. This action can then cause provision of a reward or affect symbolic representation generator 110. In some embodiments, perturbing the symbolic representation generator can include perturbing a characteristic of at least one of the distributed units, localist units, weights, or mappings included in memory network 310. For example, activation of a distributed unit or localist unit can be perturbed. As an additional example, the strength of a weight or mapping can be perturbed. As a further example, parameters (e.g., thresholds or the like) used in the performance of the operations of FIGS. 4A to 4Q can be perturbed. As a further example, a memory category (the salience of a memory category) can be specified, or a preprocessor specified or configured. Such perturbations may both improve the short-term performance of machine learning system 100 and cause symbolic representation generator 110 to develop an improved representation (e.g., stored in memory network 310) that better captures the causal relationships affecting environment 130.

In some embodiments, causal model 530 can maintain treatment effect estimates of the effect on response values of taking an action. For example, causal model 530 can include, for each paddle control command available in a game of Breakout©, an estimate of the effect of providing the paddle control command to the environment on a reward signal obtained from the environment.

In some embodiments, causal model 530 can maintain treatment effect estimates of the effect on components, parameters, or operations of symbolic representation generator 110 of taking an action. For example, causal model 530 can include, for each paddle control command available in a game of Breakout©, an estimate of the effect of providing the paddle control command to the environment on components, parameters, or operations of symbolic representation generator 110 (e.g., on the activations, retrieval, or other characteristics of localist units, such as proposition units).

In some embodiments, causal model 530 can maintain treatment effect estimates of the effect on response values of perturbing the symbolic representation generator. For example, causal model 530 can maintain treatment effect estimate(s) for perturbing the activation(s) of proposition unit(s) on a reward signal obtained from the environment.

In some embodiments, causal model 530 can maintain treatment effect estimates of the effect on components, parameters, or operations of symbolic representation generator 110 of perturbing the symbolic representation generator. For example, causal model 530 can include estimates of the effect of perturbing activations of proposition units on the activation, retrieval, or other characteristics of localist units, such as proposition units, in memory network 310.

In some embodiments, causal model 530 can maintain treatment effect estimates specific to a configuration of memory network 310. In some embodiments, the configuration can be defined by the presence of a specified set of analogs in the working memory of memory network 310. For example, causal model 530 can maintain an estimated effect on a response value of taking an action or perturbing the symbolic representation generator when the contents of the working memory of the memory network 310 matches a specified set of analogs. As described herein, machine learning system 100 can associate sets of analogs with actions using SRECs.

In some embodiments, causal model 530 can maintain salience information concerning components, parameters, or operations of symbolic representation generator 110. Such salience information can include scores (e.g., dynamicity scores, or the like), categories (e.g., salient versus non-salient, or the like), or parameters (e.g., salience-dependent mapping condition values, or the like)

In some embodiments, inference component 120 can be configured to take actions or perturb the symbolic representation generator based on treatment effect estimates and salience information. For example, inference component 120 can assign SRECs to policies or perturb the operation of symbolic representation generator 110 based on treatment effect estimates and salience information.

FIG. 5B depicts an exemplary inference component 120 configured to cause machine learning system 100 to provide output 113 including commands, in accordance with one or more aspects of this disclosure. Similar to exemplary inference component 120 depicted in FIG. 5A, the exemplary inference component 120 depicted in FIG. 5B can be configured to store experimental unit parameters 510, experimental design parameters 520, symbolic representation parameters 521, and causal model 530. Inference component 120 can be similarly configured to interact with symbolic representation generator 110 and obtain feedback signals from environment 130 (e.g., reward signals, or the like). As described herein, environment 130 can also provide input to symbolic representation generator 110.

In the embodiments depicted in FIG. 5B, inference component 120 can be configured to provide commands to the environment according to command mapping 540. Inference component 120 can be configured to determine a treatment based on causal model 530 (and additionally in some embodiments on memory network 310). Command mapping 540 can map from the treatment to an output value. In some embodiments, the output value can be or indicate a command. Inference component 120 can be configured to provide (or to cause machine learning system 100 to provide) the command as (or as part of) output 113.

Inference component 120 can be configured to repeatedly generate output values using command mapping 540. In some embodiments, inference component 120 can generate such an output value for at least some experimental units constructed by inference component 120. During the experimental unit, inference component 120 can provide the command.

In some embodiments, causal model 530 can be configured to generate estimated effects on performance metrics for providing a command as an output. In such embodiments, in selecting a treatment based on selecting such estimated effects, inference component 120 can select the command. Accordingly, causal model 530 can effectively include command mapping 540.

In some embodiments, causal model 530 can be configured to generate estimated treatment effects on performance metrics for portions of memory network 310. Such portions can include analogs that bind localist units associated with actions into relationships with other localist units. In such embodiments, in selecting a treatment based on selecting such estimated effects, inference component 120 can effectively select a portion of memory network 310. In such embodiments, command mapping 540 can associate the selected portion of memory network 310 with the provision of at least one command. For example, inference component 120 can generate a state based on the selected portion of memory network 310, similar to the description herein with regards to command mapping 335. In some embodiments, inference component 120 can generate the state based on identifiers associated with the selected portion or localist unit(s) or distributed unit(s) included in the selected portion. Command mapping 540 can associate the state with the provision of at least one command. Inference component 120 can then provide the associated at least one command.

In some embodiments, command mapping 540 can be configured (e.g., by a user or another system) with a predetermined set of commands. In some embodiments, command mapping 540 can be configured (e.g., by a user or another system) with predetermined mappings from at least some states to corresponding commands. In some embodiments, inference component 120 can be configured to automatically generate mappings from at least some states to corresponding commands. For example, inference component 120 can implement a machine-learning process (e.g., a reinforcement learning process, such as Q-learning or tabular Q-learning, or another suitable process) to learn a mapping from states to predetermined commands using inputs 111 received from the environment.

In some embodiments, inference component 120 can update (or provide instructions to update, or otherwise cause to be updated) analogs in memory network 310 based on the generate estimated effects. In this manner, inference component 120 can generate an experiment unit based on the current state of memory network 310, and the results of the experimental unit can update (and/or create new) causal models in a recursive process.

While FIGS. 5A and 5B depict an inference component 120 including a single instance of experimental unit parameters 510, experimental design parameters 520, and causal model 530, the disclosed embodiments are not so limited. In some embodiments, inference component 120 can be configured to perform multiple independent causal experimentation processes.

In such embodiments, the inference component 120 may separately monitor different types of inputs. For example, inference component 120 can consider the state of the environment as the input (e.g., as processed by preprocessor 320). For example, the location, size, color, or other distributed unit values provided by preprocessor 320 can be taken as inputs. Inference component 120 can then determine causal relationships using associations between actions taken by machine learning system 100 and the state of environment 130. Additionally or alternatively, inference component 120 can consider a reward signal provided by environment 130 as the input. As a video game example, game score or end of game scenarios can provide such a reward signal. Inference component 120 can then determine causal relationships (e.g., between actions taken by machine learning system 100, observed state changes, etc. and the reward signal). In some non-limiting examples consistent with aspects of this disclosure, inference component 120 may store the learned causal knowledge (e.g., one or more causal relationships) to a location accessible to symbolic representation generator 110 (whether the storage mechanism is integrated into symbolic representation generator 110, or otherwise communicatively coupled to symbolic representation generator 110).

In such embodiments, the inference component 120 may independently consider different types of treatments. In some instances, a treatment can include perturbation of one or more components of memory network 310. As described herein, the perturbation can be a change to, or a deviation from, the default, normal, or current operating state of the one or more components of memory network 310. The perturbation may be limited in one or more of duration, scope, or magnitude. In some embodiments, the perturbation may be temporary, with the one or more components of memory network 310 returning to a previous or unperturbed state upon cessation of the treatment. For example, when a treatment is performed for a single experimental unit or consecutive set of experimental units, and the treatment includes a perturbation of a component of memory network 310, then the normal or current operating state of the component can be changed during the experimental unit or consecutive set of experimental units. The normal or current operating state of the component may revert upon cessation of the experimental unit or consecutive set of experimental units. In some embodiments, such perturbations can be targeted to specific components of memory network 310; directly affect the targeted, specific components in specific ways; or have a clearly delineated duration(s). For example, inference component 120 can perturb a localist unit in an experimental unit by adding an excitatory value to the input of the localist unit. The excitatory value can be added to the input in the experimental unit during specific operations of symbolic representation generator 110 (e.g., during selection of an analog for the driver, retrieval of analog(s) into the recipient, mapping, or relational learning) or over specific time intervals. In some embodiments, a magnitude of such a perturbation may be small, as compared to a magnitude associated with the perturbed component. To continue the prior example, a magnitude of the excitatory value, normalized by a magnitude of other inputs of the localist unit, may be less than 1.0, less than 0.5, less than 0.2, less than 0.1, less than 0.05, less than 0.01, or less. In some embodiments, inference component 120 can perturb a component of memory network 310 by creating the component, activating the component, or inhibiting the component.

Additionally or alternatively, inference component 120 can cause machine learning system 100 to take actions in environment 130. In some instances, inference component 120 can be configured to include commands among candidate treatments. Accordingly, inference component 120 can determine that a command should be selected from a set of candidate commands and provided to environment 130 as part of an experiment. As may be appreciated, provision of the command may cause an action to be taken in environment 130, which can then in turn affect the state of symbolic representation generator 110, or cause environment 130 to return a reward value.

As may be appreciated, inference component 120 can separately monitor different combinations of such inputs and treatments. Furthermore, inference component 120 can independently consider different rewards, different subsets of the components of memory network 310, different inputs from the environment, actions taken in the environment, or any combination of the foregoing.

In some embodiments, each separately monitored combination of measured inputs and treatments can be associated with separately maintained experimental unit parameters, experimental design parameters, and causal model. In some embodiments, one or more of these components can be shared across different combinations of inputs and treatments. For example, inference component 120 can maintain experimental unit parameters or experimental design parameters in common across multiple combinations of measured inputs and treatments.

In some embodiments, inference component 120 can be configured to empirically determine values for hyperparameters of the symbolic representation generator 110, in accordance with some embodiments of the disclosure. Inference component 120 can be configured to empirically determine such parameters in addition to maintaining a causal model, as described herein. Such hyperparameters can include metric specificity parameters for metric feature units, preprocessor hyperparameters that govern the detection of objects and association of objects with features, and the like. As may be appreciated, inference component 120 can be configured to monitor and update such hyperparameters based on performance metrics (e.g., task performance, rewards, or another suitable performance metric).

In some embodiments, inference component 120 can support empirical determination of scaling factor κ for determining the granularity of metric encoding. Such determinations can be on a per-relationship basis. In some embodiments, inference component 120 can dynamically determine and adjust the level of metric encoding (e.g., the value of scaling factor κ) based on task demands. In such embodiments, inference component 120 can conduct self-supervised causal experiments to determine whether metric specificity improves a performance metric (e.g., task performance, predictive accuracy, rewards, or the like). Based on the results of the experiments, inference component 120 can adjust scaling factor κ to modulate the degree of metric precision used in encoding a particular relationship.

In some embodiments, inference component 120 can alter, according to an experimental design, the level of metric encoding by experimentally modifying scaling factor κ and the receptive field spread of individual distributed units. Thus, inference component 120 can determine, through causal experimentation, whether higher metric precision improves performance. If an experiment reveals that fine-grained metric encoding provides no performance benefit, inference component 120 can shift the particular relationship back to categorical abstraction. Conversely, if metric encoding improves performance in a specific context, inference component 120 can determine a suitable level of metric precision for that particular relationship.

In some embodiments, inference component 120 can alter, according to an experimental design, parameters used by the preprocessor to govern the detection in input data obtained from the environment of objects, and in the association of features with such objects. Such preprocessor parameters can include image filtering or preprocessing parameters (e.g., scale filtering or encoding parameters, or the like) or parameters used by a particular object recognition method (e.g., set of basic geometric units for a recognition-by-components method, number of octaves or number scale levels for a scale invariant keypoint method, filtering parameters, detection thresholds, or the like).

### Exemplary Moderator and Multiple Inference Engines

FIG. 5C depicts an exemplary machine learning system 101 including a symbolic representation generator 110 and an inference component 120. The inference component 120 can interact with a symbolic representation generator 110, as described herein. The inference component 120 can include a moderator 550 and two inference engines, in accordance with one or more aspects of this disclosure.

As depicted in FIG. 5C, the inference engines can include a normative engine 560 and an abductive engine 570. The normative engine and the abductive engine can embody different inferential stances toward the current modeling of causal relationships in the environment by the causal model and memory network. These two engines can both provide epistemic and/or instrumental value and can be configured to run in parallel. For example, both can access the state of the symbolic representation generator. Both can generate recommendations regarding actions to be taken in the environment. However, because normative engine 560 and an abductive engine 570 select actions differently, these engines can make different recommendations.

In some embodiments, normative engine 560 can embody an assumption that that the causal relationships in the environment are appropriately modeled by the causal model and memory network. In some embodiments, normative engine 560 can be configured to refine a predefined knowledge base. It may operate within the current representational framework (e.g., estimating effects for known SRECs, or the like) and may be dependent on historical data and have difficulty generalizing to new situations.

In some embodiments, abductive engine 570 can embody an assumption that the causal relationships in the environment could be modeled differently by the causal model and memory network. In some embodiments, abductive engine 570 can be configured to generate new causal analogs (e.g., using relational generalization or inference). These new causal analogs may expand representational breadth, explain anomalies, or address the shortcomings of existing causal analogs stored in the memory network. For example, as described herein, an explanation can include at least one cause bound to at least one effect. The effect can be a specified outcome (e.g., in terms of performance metrics). The explanation can be generated using abduction. Abduction can include the selection of at least one candidate cause for a given specified outcome. The at least one candidate cause can be selected from a set of potential causes. The at least one candidate cause can include multiple candidate causes. In some instances, these multiple causes can form at least one causal chain linked to the specified outcome.

In some embodiments, normative engine 560 may be configured or adapted to maximize the expected value of knowledge refinement. In some embodiments, abductive engine 570 may be configured or adapted to maximize the expected value of new information gain. Moderator 550 can be configured to select which action to take between the actions suggested by abductive engine 570 and normative engine 560 based on the expected value of taking these actions. The actions taken can then be used to update the memory network, as described herein.

In some embodiments, normative engine 560 can generate effect estimates, which abductive engine 570 can rely upon in spotting anomalies. In some embodiments, in response to detection of an anomaly, abductive engine 570 can generate a candidate causal analog. For example, a causal model included in normative engine 560 may maintain a confidence interval of a reward for performing an action. Should inference component 120 determine that the reward resulting from performing the action falls outside the confidence interval, inference component 120 may trigger abductive engine 570 to generate a causal analog (e.g., based on the current state of the symbolic representation generator, or the like).

In some embodiments, inference component 120 can monitor the result of selecting a relationship analog (which may be a causal relationship analog, or an analog representing an association or correlation). Should the selection of the relationship analog (and the resulting action) have a desired result, inference component 120 can add the relationship analog to the memory network, thereby fueling new rounds of normative refinement by normative engine 560. In this manner, inference component 120 can use abductive engine 570 and normative engine 560 to perform a feedback process (e.g., triggering causal analog generation, testing the causal analog, adopting or deleting the causal analog from the symbolic memory network, perform relational refinement of the causal analog).

In some embodiments, moderator 550 can determine whether to provide instructions to perform an action as specified by normative engine 560 or abductive engine 570. For example, the moderator may select the action specified by abductive engine 570 (e.g., according to a causal analog generated by abductive engine 570). In some embodiments, the moderator can determine whether selecting actions according to the relationship analog satisfies a condition. For example, the moderator can perform a trial to determine the effect of the specified action (and accordingly the explanatory power of the relationship analog). Based on the results of the trial, the moderator can determine that the relationship analog satisfies an explanatory power condition. The moderator can then add the relationship analog to a memory network of symbolic representation generator 110. As may be appreciated, normative engine 560 may then begin using the relationship analog in determining actions.

In some embodiments, moderator 550 can use a value of information metric in determining whether to instruct actions as specified by normative engine 560 or abductive engine 570. The value of information metric can depend on an amount of information about the world obtained by performing an action (and in some embodiments on the estimated effect, such as a reward or reduction of uncertainty in an estimate, of performing the action). Accordingly, moderator 550 can be configured to balance expected utility gain against increase in explanatory power. In some embodiments, this balance could depend upon one or more hyperparameters stored by inference component 120 (e.g., one of experimental design parameters 520, or the like). In such embodiments, inference component 120 can be configured to perform experiments on the value of these hyperparameters, similar to the experiments performed by inference component 120 on other such hyperparameters, as described herein.

In some embodiments, moderator 550 can be configured to determine information metric values for candidate actions proposed by the normative engine 560 or abductive engine 570. In some embodiments, such candidate actions can be assessed along two dimensions. A first dimension can be prediction utility. Such prediction utility can measure how much the action improves immediate goal achievement (e.g., saving a patient, keeping a robot upright, hitting a performance metric), adjusted for risk. In some embodiments, prediction utility can be measured in terms of expected utility (e.g., the expected utility of decisions made using the model's predictions according to a utility function that quantifies the benefit of correct predictions and the cost of incorrect ones) or decision impact (e.g., assess how the model's predictions influence decision-making processes or outcomes in practical scenarios, such as improved scores in a game). A second dimension can be explanatory power. Such explanatory power can measure how much the action improves knowledge. In some embodiments, the explanatory power can have two further dimensions, depth and breadth. Depth can be shrinking confidence intervals on known effects (refining the current ontology), while breadth can be validating new mechanisms (expanding the ontology). In some embodiments, explanatory power can be evaluated in terms of accuracy (e.g., precision, recall, F1-score, and overall accuracy), log-likelihood (e.g., evaluate the likelihood of the observed data under each model with higher log-likelihood indicates better explanatory power), AIC/BIC (e.g., use Akaike Information Criterion (AIC) or Bayesian Information Criterion (BIC) to compare models, penalizing complexity), or another suitable metric.

In some embodiments, moderator 550 can be configured to determine information metric values for candidate actions according to the following formula. As may be appreciated, this formula is exemplary and not intended to be limiting. Additional or alternative implementations of an information metric value can be used.

$$VoI ( r ) = E [ GoalGrain ( r ) ] - Risk ( r ) + {w}_{d} Δ Depth ( r ) + {w}_{b} Δ Breadth ( r ) - OppCost ( r )$$

Where “r” indicates either the normative engine 560 or abductive engine 570. Accordingly, this performance metric expressly includes an estimated effect (E[GoalGain(r)]) of selecting an action according to the particular engine. As may be appreciated, such an estimated effect can be maintained by a causal model included in the engine. In some embodiments, the depth (ΔDepth(r)) and breadth (ΔBreadth(r)) terms correspond to explanatory information-value components. The weights (e.g., w_{d} and w_{b}) can be hyperparameters stored and experimented upon by inference component 120. Suitable risk and opportunity cost metrics can be selected to support safe operation and account for foregone opportunities to perform other actions.

In some embodiments, moderator 550 can select the action of the normative engine 560 or abductive engine 570 based on the information metric value for each engine. In some embodiments, the selection can be deterministic. For example, moderator 550 can select the engine with the greater information metric value. In some embodiments, the selection can be probabilistic. For example, moderator 550 can determine selection probabilities for the engines based on the information metric value for the engines. In some embodiments, moderator 550 can determine selection probabilities according to a sigmoidal function (e.g., a logistic function). As may be appreciated, this formula is exemplary and not intended to be limiting. Additional or alternative implementations of a selection function can be used:

$${α}_{t} = σ ( κ [ {VoI}_{abd} - {VoI}_{norm} ] ) , where σ ( x ) = \frac{1}{1 + {e}^{- x}}$$

Here, αₜ is the weight given to the abductive engine at time t, and 1−αₜ is the weight given to the normative engine. As shown, αₜ can depend on a difference Vol_{abd}−Volₙₒᵣₘ scaled by a proportionality constant κ. In some embodiments, κ may be a hyperparameter monitored by inference component 120. Because this allocation rule is Vol-adjusted, it ensures that both immediate utility and long-term information value are factored into every decision. The sigmoid mapping keeps allocations smooth and bounded, while constraints guarantee safety, exploration budgets, and live baselines.

In some embodiments, moderator 550 can be configured to impose conditions on selecting between engines. These conditions can include safety gates (e.g., no unsafe exploration, early stopping for harm/futility), budget ceilings (e.g., maximum exploration fraction, minimum baseline/control), identifiability guarantees (e.g., live baselines are never removed).

In some embodiments, normative engine 560 can be configured to monitor the causal significance of components in the representation of the environment. Normative engine 560 can be configured to experiment on hyperparameters of the symbolic representation generator 110, as described herein. Normative engine 560 can determine experimental units, monitor baselines, assign treatments to experimental units, determine data inclusion window length(s), and/or perform clustering. In some embodiments, normative engine 560 can include a causal model. The causal model can maintain treatment effect estimates of the effect on performance metrics (e.g., task performance, prediction accuracy, reward scores, or the like) of outputting instructions to take an action in the environment (e.g., taking an action) or perturbing a component, parameter, or operation of symbolic representation generator 110 (e.g., perturbing the symbolic representation generator). These treatment effect estimates can include point and interval estimates (e.g., d-scores, confidence intervals, or the like).

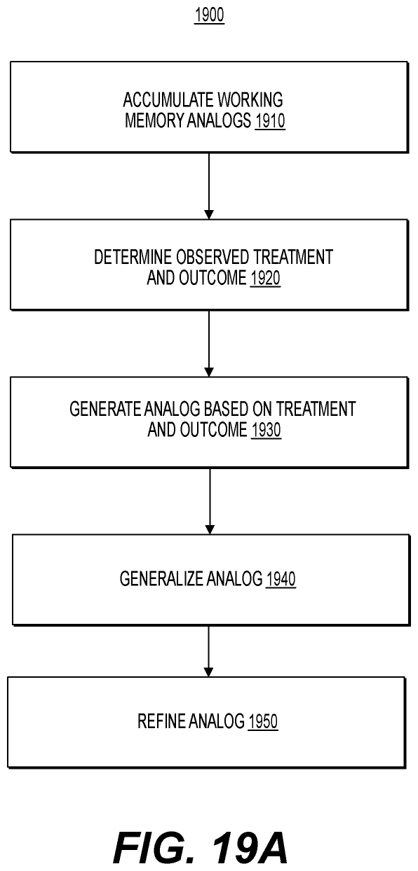

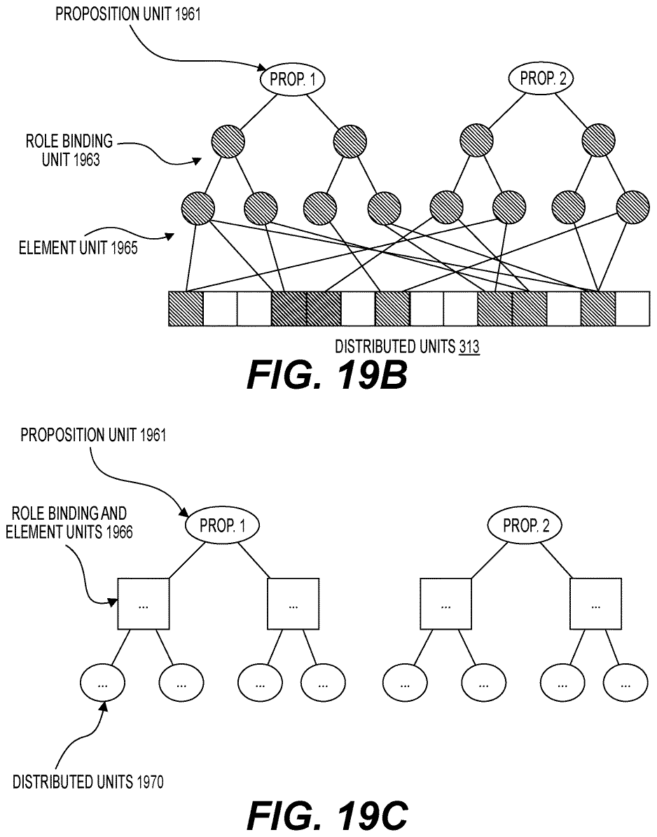

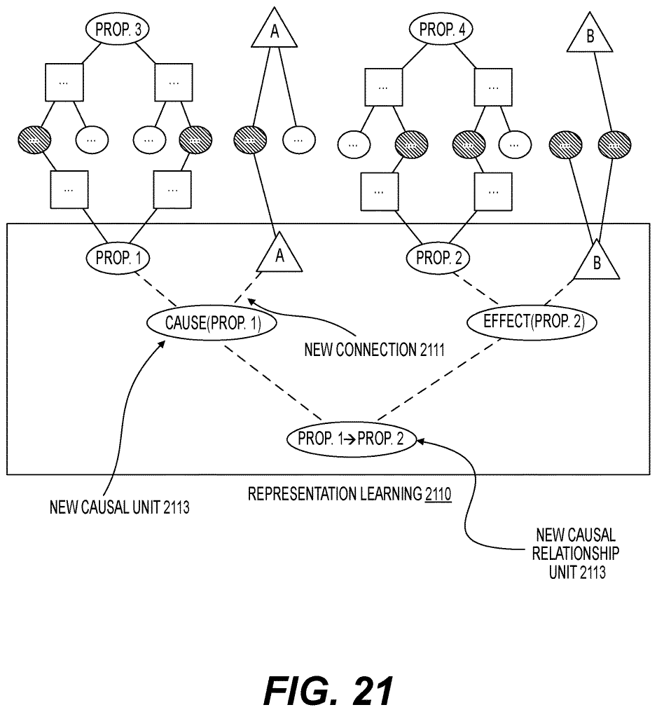

In some embodiments, abductive engine 570 can be configured to generate causal hypothesis using abduction. In some embodiments, the causal hypothesis can be implemented using causal relationship analogs (e.g., as described with regards to FIGS. 19A to 27D). In some embodiments, the causal relationship analogs can be generated using abduction (e.g., through a process of retrieval, mapping, and inference, as described with regards to FIGS. 21, 22, 23A and 23B, and 27A to 27D). In some embodiments, abductive engine 570 can be configured to perform exploratory data analysis to uncover causal relationships or patterns, perform cross-domain learning to identify new analogies that might fit new data, or perform active learning and experimentation to identify areas of highest uncertainty.

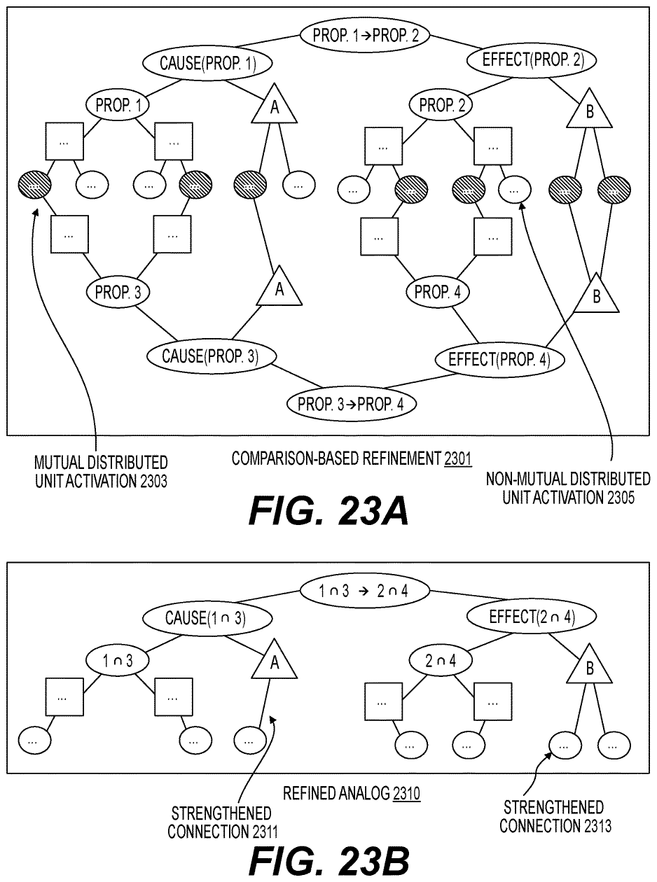

As described with regards to FIGS. 19A to 27D, the result of abduction can include new causal relationship analogs (e.g., representing newly inferred causal mechanisms). In some embodiments, these causal relationship analogs can incorporate or be stored with evidentiary metadata (e.g., as described with regards to FIGS. 23A and 23B). In some embodiments, such evidentiary metadata can include supplementary information that supports validity and reliability of inferred causal mechanisms (e.g., source data, experimental results, or the like). Such abduction may support zero-shot generalization into previously uncovered domains (e.g., learning to play Pong® through learning to play Breakout®, or the like).

In some embodiments, machine learning system 101 can trialize causal hypotheses generated by abductive engine 570 as short, baseline-anchored micro-experiments with early stopping and allocation caps. Such stopping caps may include setting a stopping threshold based on a measure of world knowledge compared to prior best explanatory models.

FIGS. 5D and 5E depict hypothetical selection of candidate actions generated by a normative and abductive engine in the context of a game of Space Invaders®. In this hypothetical example, as machine system in accordance with some embodiments of the disclosure learns to play the game, a normative engine might predict that targeting one of aliens, as shown in FIG. 5D, is the best course of action because previous experimentation has shown that destroying aliens increases score and therefore demonstrates positive utility. The normative engine may therefore evaluate which alien to target first. An information metric value for targeting an alien may be influenced more by expected utility than effect on explanatory power. An abductive engine might generate a causal analog for testing what would happen if the UFO were targeted, as shown in FIG. 5E. That information is missing from the previously learned knowledge of machine learning system 100 and thus the information metric values corresponding to the explanatory power to get that information will be much higher. The moderator would take both cases into consideration and evaluate the information metric values of the various actions factoring in both explanatory’ power and utility. Based on these information metric values, the moderator would select an action to take (and evaluate the action if the action is recommended by the abductive engine).

### Monitoring Process

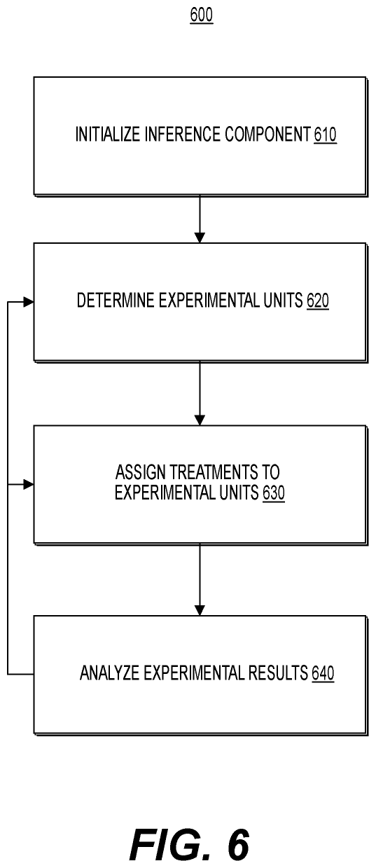

FIG. 6 depicts a monitoring process 600, in accordance with one or more aspects of this disclosure. In some embodiments, process 600 can be performed by a machine learning system 100 (e.g., by inference component 120 and/or symbolic representation generator 110). Process 600 can include initialization of machine learning system 100, the creation of experimental units, the assignment of treatments to experimental units, and the analysis of experimental results. The analysis of experimental results can in term inform the creation of experimental units and the assignment of treatments to experimental units. Process 600 can therefore form an ongoing cycle of experimentation, enabling inference component 120 to monitor the causal effect on inputs received from the environment of instructions to take action in the environment or perturbations of the symbolic representation generator 110.

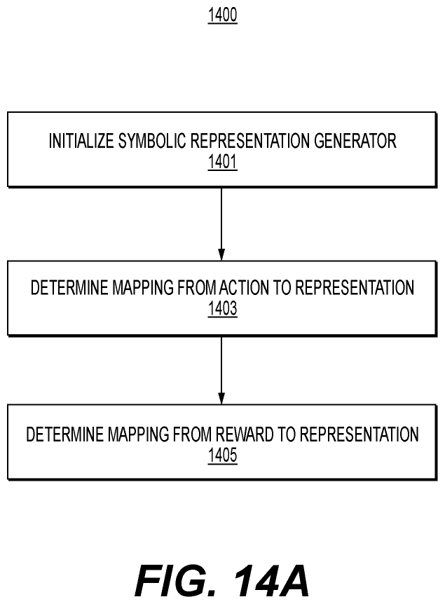

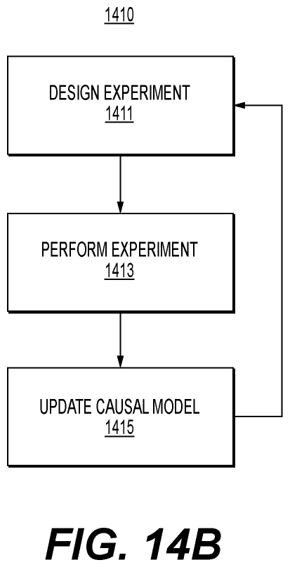

In operation 610 of process 600, machine learning system 100 can be initialized, in accordance with one or more aspects of this disclosure. In accordance with one or more aspects of this disclosure, initialization of machine learning system 100 can include the initialization of inference component 120 and/or symbolic representation generator 110. An exemplary process 1400 for initializing symbolic representation generator 110 is described with regards to FIG. 14A. This process can include provisioning a memory network of symbolic representation generator 110 with suitable analogs and determining mappings from analogs in the memory network to rewards or actions in the environment. In some embodiments, the initialization of inference component 120 can include obtaining at least one of performance metrics, treatment space, constraints, normative operational data, or experimental input scope and duration estimates.

As described herein, in some embodiments, performance metrics can include the inputs that process 600 is monitoring (e.g., task performance, predictive accuracy, rewards, or another suitable performance metric). Treatment space can include the types of treatments that inference component 120 can provide (e.g., perturbing components, or specific types of components, of memory network 310, causing machine learning system 100 to take actions in the environment, or the like). Constraints can include rules limiting potential treatments, deterministic models that define the boundaries of the search space of all permissible combinatorics of treatments (e.g., including spatial-temporal ordering of treatments), or the like. Such constraints can be user-specified and can be intended to contain implementation risks and opportunity costs. In some embodiments, constraints can be updated during implementation. For example, during implementation a constraint may be empirically demonstrated to impair performance (e.g., if the currently optimal system state appears near the boundaries of the search space defined the constraints). In highly risk-averse situations, the treatment search space can be purposely limited to the uncertainty window that already surrounds treatment decisions. Normative operational data can include probabilistic data concerning the prior state of the symbolic representation or interactions with the environment. For example, such data can be obtained by observing the operation of the system (or a similar system) for a duration prior to the beginning of process 600. In such embodiments, treatments can be initially assigned based on this probabilistic data. As causal estimates improve, the assignment of treatments can gradually deviate due to experimentation/optimization to take advantage of sampling strategies that improve utility. Experimental input scope and duration estimates can include initial estimates of the minimum and maximum extent to which the causal effects from the variation in actions/decisions spread and decay throughout the system. These estimates can be used for defining the initial search space and generating orthogonal experimental units.

In operation 620 of process 600, inference component 120 can define experimental units, in accordance with one or more aspects of this disclosure. As described herein, an experimental unit can have a duration (e.g., a number of events, samples, observations, or the like; an amount of time; or the like). In some embodiments, an experimental unit can have a scope. As may be appreciated, the longer the experimental unit duration, the more slowly inference component 120 determines causal relationships or reacts to changes in the environment. Furthermore, the longer the experimental duration, the more time for treatment affects to manifest or be observed. Conversely, the shorter the experimental duration, the greater the risk of contamination of the current experiment with carryover effects from prior experiments. As described herein, in some embodiments, inference component 120 can be configured to balance such considerations in determining experimental duration.

In some embodiments, inference component 120 can be configured to repeatedly select durations and compare the results of multiple treatment experimental units and control experimental units of the selected duration. FIG. 7A depicts interleaving of experimental units assigned different levels of an independent variable (symbolized by light and heavy boxes) in a sequence of five experimental units, in accordance with one or more aspects of this disclosure.

In some embodiments, inference component 120 can be configured to determine a performance metric (“D-score”) based on the observed difference in a response between experimental units having different levels of an independent variable. In some embodiments, the D-score can be the difference between the estimated response value for one level of an independent variable and the estimated response values for the remaining levels of the independent variable (e.g., an average of such estimate response values). The estimated response values can be averages, or another suitable statistic.

FIG. 7B depicts an exemplary dependence of the observed performance metric on experiment duration, in accordance with one or more aspects of this disclosure. In this example, the observed performance metric value is normalized to an asymptotic value. As may be appreciated, carryover effects may reduce the observed performance metric when the experimental duration is too short (short duration 701). As experimental duration increases, the observed performance metric can increase. However, as experimental duration continues to increase, carryover effects can decrease, and the observed performance metric can tend towards an asymptotic value (long duration 703). Inference component 120 can be configured to determine the longest duration that is significantly different from the asymptotic value (intermediate duration 705). In some embodiments, inference component 120 can select this duration as the experimental duration (e.g., for all experiments, experiments involving this treatment, or experiments involving this treatment level).

In some embodiments, when performing experiments, inference component 120 can be configured to implement a washout period. In some embodiments, the washout period can precede application of the treatment and monitoring of the response. In some embodiments, the washout period can follow application of the treatment and monitoring of the response. The washout period can be scaled to the experiment duration, such that increasing the experiment duration increases the washout period.

In some embodiments, inference component 120 can be configured to interleave experiments with buffers. In such embodiments, inference component 120 can be configured to separately determine experiment duration and buffer duration.

In operation 630, inference component 120 can assign treatments to experimental units, in accordance with one or more aspects of this disclosure. Inference component 120 can be configured to assign treatments to experimental units using suitable experimental design strategies (e.g., randomizing without replacement, counterbalancing and the like). In some embodiments, inference component 120 can be configured to perform different types of experiments, including baseline experiments and explore/exploit experiments. Inference component 120 can be configured to allocate experimental units to experiments. As may be appreciated, experimental units allocated to different experiments may be interleaved. As described herein, the type of experiment associated with an experimental unit can affect how treatments are assigned to the experimental unit.

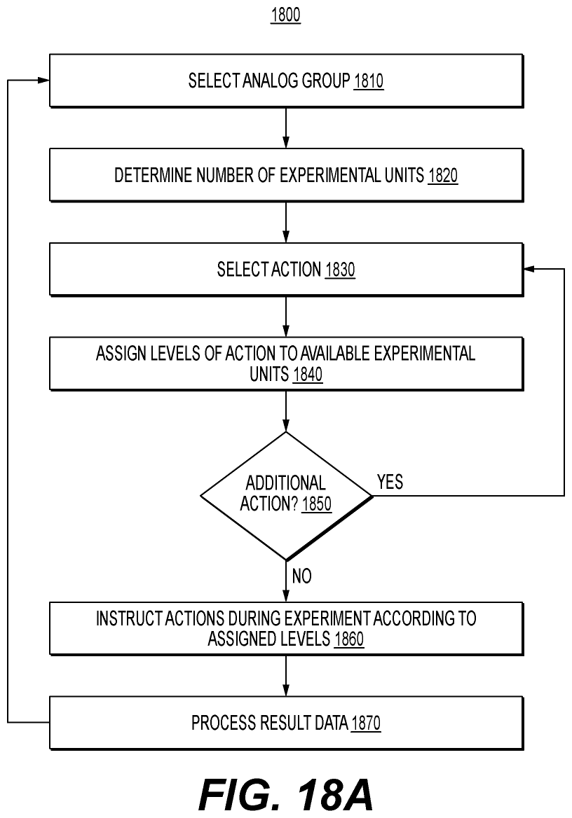

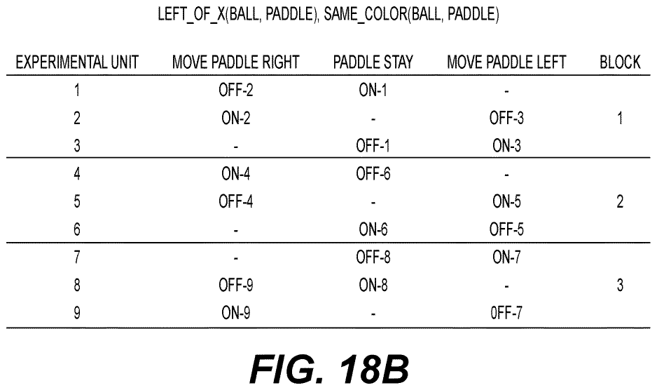

In accordance with one or more aspects of this disclosure, inference component 120 can perform baseline experiments to identify potential relationships between environmental states and treatments. Baseline experiments may reflect existing knowledge of the environment (or lack thereof). For example, inference component 120 may assign treatments in baseline experiments consistent with normative operational data obtained in operation 610. In some embodiments, inference component 120 can be configured to select treatments in baseline experiments according to some predetermined frequency distribution. For example, inference component 120 can be configured to assign treatments to environmental states with equal probability. An example of a suitable experimental design approach for baseline experiments is disclosed with regards to FIGS. 16A to 16D and 18A and 18B.

In accordance with one or more aspects of this disclosure, inference component 120 can be configured to perform baseline experiments during initialization of machine learning system 100. For example, inference component 120 can perform baseline experiments until a condition is satisfied. The condition can be performance of a number of baseline experiments, completion of a number of experimental units associated with baseline experiments, a prediction metric for one or more treatments, or another suitable condition. Once the condition is satisfied, inference component 120 can be configured to begin performing explore/exploit experiments. As may be appreciated, in some embodiments inference component 120 may continue performing baseline experiments (though with fewer experimental units allocated to these baseline experiments). The continued performance of baseline experiments may enable inference component 120 to assess the effectiveness of treatments applied in the explore/exploit experiments. Furthermore, the baseline experiments can also enable inference component 120 to explore the entire treatment space defined by the constraints obtained in operation 610.

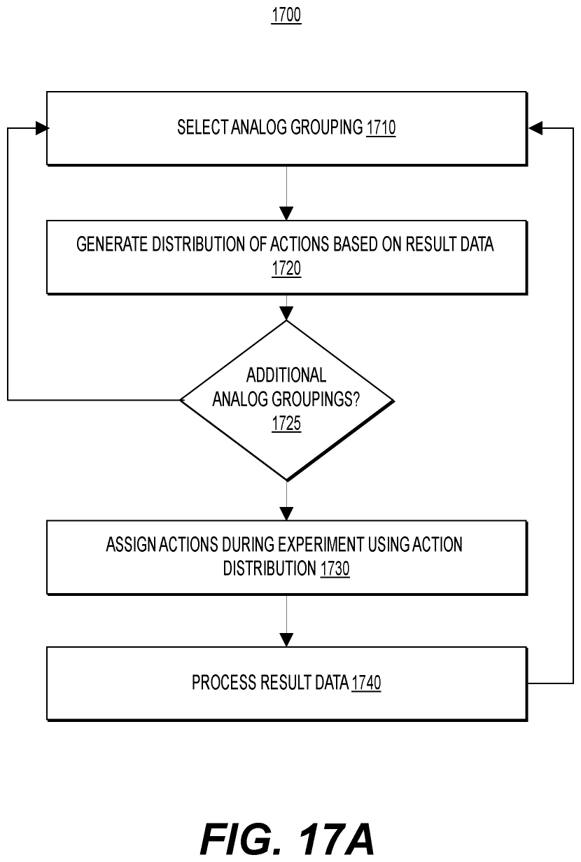

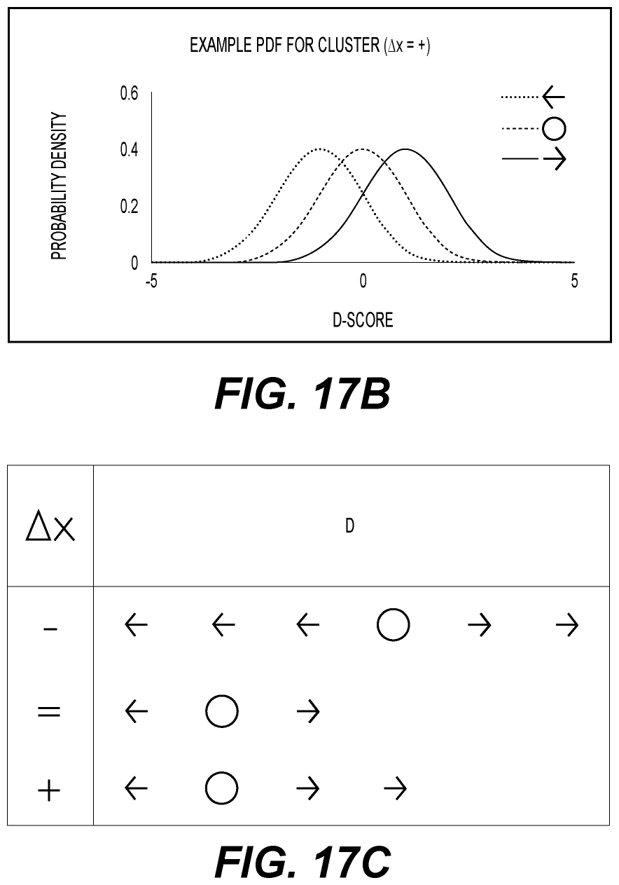

In accordance with one or more aspects of this disclosure, inference component 120 can perform explore/exploit experiments to balance improving the current treatment effect estimates (e.g., exploring) against using the current treatment estimates to obtain improved results (e.g., exploiting). In some embodiments, inference component 120 can be configured to use probability matching, Thompson sampling, upper confidence bounds-based techniques, softmax, or another suitable technique in selecting treatments, as described herein. Examples of suitable experimental design approaches for explore/exploit experiments are described with regards to FIGS. 15A to 15D and 17A to 17C.

In some embodiments, inference component 120 can be configured to vary an explore/exploit ratio allocating experimental units to exploration or exploitation. Inference component 120 can be configured to experimentally monitor this explore/exploit ratio, adjusting it as needed to maximize utility (including minimizing regret). When the cost (including opportunity cost) for executing treatments is non-uniform across treatment levels, inference component 120 can compute Bonferroni-corrected CIs and require more evidence of benefit to exploit more expensive treatments. In some embodiments, inference component 120 can assign treatments to experimental units such that a relative frequency of treatment assignment matches the relative frequency specified by an. Inference component 120 can be configured to compute D-scores, as described herein, and confidence intervals (CIs) around them can be computed for treatment levels. In some embodiments, such CIs can be suitably adjusted to correct for multiple comparisons (e.g., inference component 120 can compute Bonferroni-corrected CIs, Tukey-corrected CIs, Scheffe-corrected CIs, or CIs adjusted in another suitable manner). In computing D-scores and CIs, inference component 120 can include experimental units falling with an experimental window, as described herein.

In some embodiments, inference component 120 can monitor, using statistical power analysis, the allocation of experimental units to different types of experiments (e.g., an allocation of experimental units between baseline experiments and explore/exploit experiments). For example, inference component 120 may allocate experimental units over a period of time between baseline and explore/exploit experiments. The inference component 120 may determine the allocation such that the number of baseline or explore/exploit experimental units satisfies a statistical power condition. For example, the allocation can be selected, based on the current treatment effect estimates, to provide sufficient statistical power to detect a difference in a performance metric between experimental units in the baseline experiment and experimental units in the explore/exploit experiment. Inference component 120 can use the monitored performance metric difference to estimate the utility of internal parameters of process 600 (e.g., clustering, data inclusion window, explore/exploit ratio), allowing such parameters to be objectively tuned. Should machine learning system 100 detect a change in the environment that affects the validity of learned causal relationships, machine learning system 100 may increase the number of experimental units allocated to baseline experiments.

In some embodiments, inference component 120 can perform additional experiment types, such as pure explore experiments or pure exploit experiments. In pure explore experiments, the inference component may select treatments having the estimated most-preferred or highest-reward treatments. In pure exploit experiments, the inference component may select treatments randomly. As may be appreciated, this disclosure is not limited to baseline, explore/exploit hybrid, pure explore, and pure exploit experiments. Other suitable experiments can also be performed.

In operation 640, inference component 120 can analyze experimental results, in accordance with one or more aspects of this disclosure. In some embodiments, analysis of experimental results can include determination of sets of environmental variables (e.g., uncontrolled or unobserved environmental state) that affect relationships between actions or perturbations and experimental results. For example, in a game of Breakout®, the position of the ball relative to the paddle (or the color of the ball) may be an environmental variable. Whether the action “move paddle left” yields a favorable reward can depend on the value of this environmental variable. FIG. 7C depicts an exemplary interleaving of experimental units into two distinct clusters based on environmental variables present in those experimental units, in accordance with one or more aspects of this disclosure. The first cluster includes four experimental units, while the second cluster includes six experimental units.

As described herein, in some embodiments, inference component 120 can generate treatments corresponding to collections of environmental variables that demonstrate interactions with actions or perturbations. For example, inference component 120 can cluster experimental units into clusters with maximum within-cluster similarity of actions or perturbation effect on a performance metric and maximum between-cluster difference. In some embodiments, inference component 120 can determine the number of clusters using two related mechanisms: first, factorial ANOVA can be used to find the factors that explain the largest amount of variance between clusters and stepwise statistical power analysis can be used to select a number of factors that results in clusters with sufficient statistical power to find exploitable effects; second, clustering decisions can be placed under experimental control by continuously testing them and using baseline monitoring to objectively explore and exploit their impact on utility. An exemplary approach to forming such clusters is included in the experimental design described with regards to FIGS. 16A to 16E.

In some embodiments, inference component 120 can be configured to limit experimental result analyses to experimental units within a data inclusion window. Inference component 120 can be configured to manage this data inclusion window. In some embodiments, data inclusion window management can include determination of data inclusion window length (e.g., for a single cluster, for each cluster, or across all clusters). In some embodiments, inference component 120 can be configured to determine a data management window using factorial ANOVA to prevent over-fitting of the data and ensure that the process is responsive to dynamic changes in the underlying system. FIGS. 7D and 7E depict exemplary data windows for the first and second clusters depicted in FIG. 7C, in accordance with one or more aspects of this disclosure. As may be appreciated, in some embodiments of the disclosure, only experimental units falling within the data window may be analyzed in determining causal treatment effects.

As may be appreciated, the behavior of inference component 120 can vary during the performance of process 600. In some embodiments, inference component 120 can step through phases as it accumulates empirical data about the environment. In an initiation phase, inference component 120 can determine suitable experimental unit durations. Treatments can be assigned according to distributions specified by or in the normative operational data. Inference component 120 can determine causal effects CIs based on the results obtained from the assigned treatments. The data inclusion window can include all experimental units in a single cluster. All experiments can be baseline experiments.

In an explore/exploit and data inclusion window optimization phase, inference component 120 can begin monitoring the data inclusion window and managing the explore/exploit ratio. In some embodiments, a proportion of the experimental unit can be assigned to baseline experiments and the remainder can be allocated to explore/exploit experiments. The explore/exploit experiments can initially assign treatment levels based on CIs using one or more of probability matching, Thompson sampling, upper confidence bounds-based techniques, softmax, or another suitable technique. The difference in performance between explore/exploit experimental units and baseline experimental units can be used to determine data inclusion window levels (as short windows enable tracking of changing causal relationships in the environment, while longer windows enable greater precision in estimating causal treatment effects). Over time, the ratio of baseline to explore/exploit experimental units can decrease to a sample size sufficient to monitor the difference in performance between baseline and explore/exploit experimental units with suitable statistical power.

In a clustering phase, inference component 120 can begin determining clusters and cluster window lengths for the experimental units. Provided the data inclusion window continues to grow for each cluster (e.g., the treatment effect on the utility function is not dynamically changing), clusters can be repeatedly split into more granular sub-clusters. Inference component 120 can monitor the fitness of clustering decisions by altering clustering decisions to find those that result in an overall increase in the delta between baseline and explore/exploit, as in the data inclusion window optimization process. Furthermore, the explore/exploit ratio can be varied within and across clusters to monitor the explore/exploit ratio. In some embodiments, inference component 120 can create one cluster defined as pure explore and two additional clusters defined by a single treatment level. Factorial ANOVA can be used to identify the factors that have the strongest interaction with the treatment effect on D-score. Stepwise statistical power analysis can then be used to find the factor that explains the largest amount of variance between clusters while still resulting in clusters that have narrow enough causal effect confidence intervals to have exploitable effects.

In accordance with some disclosed embodiments, inference component 120 can be configured to monitor performance measures to identify environmental changes. FIG. 7F depicts performance measure values for a series of experimental units, in accordance with one or more aspects of this disclosure. This example concerns a game of Breakout©. In this example, machine learning system 100 developed a causal model adapted to an original Breakout© ruleset. Environment change 710 was the addition to the game of a rule that hitting the ball with the paddle when the ball and paddle are different colors causes a penalty. Prior to environmental change 710, the average performance metric value for an experimental unit was positive, reflecting the training of machine learning system 100. Following environment change 710, the average performance metric value for an experimental unit was negative, reflecting that the existing training is no longer appropriate.

Inference component 120 can be configured to detect the existence of environmental change 710 based on the change in performance metric values for experimental units. The disclosed embodiments can use any suitable method of changepoint detection. For example, online methods or methods using batches of values can be used. Suitable methods of changepoint detection can include supervised methods (e.g., machine learning methods, or the like) or unsupervised methods (e.g., likelihood ratio methods, subspace models, probabilistic methods, or the like). Suitable methods can involve repeatedly determining descriptive statistics for sliding windows of data and identifying statistically significant differences between such windows.

In response to detection of a change, inference component 120 can be configured to change the allocation of experimental units between baseline experiments and explore/exploit trials. For example, inference component 120 can begin one or more baseline experiments to explore the changed relationship between environmental state, treatments, and rewards. As an additional example, inference component 120 can continue performing explore/exploit experiments but may allocate an increased proportion of experimental units to baseline experiments.

FIG. 8A depicts components of an exemplary causal model 530, in accordance with one or more aspects of this disclosure. In some embodiments, causal model 530 can include treatment effects 801 and salience data 803. As described herein, monitoring treatment effects and salience can enable the inference component to identify predictive analogs, and suitable actions for a given state of the memory network. These capabilities enable the disclosed machine learning system to achieve performance superior to traditional sub-symbolic architectures, while using a much smaller memory network that requires less memory or storage to implement and less compute or processing power to maintain.

In some embodiments, treatment effects 801 can include point and interval estimates. In some embodiments, treatment effects 801 can be maintained at the SREC level. For example, treatment effects 801 can include treatment effects estimates for SRECs suitable for assignment to a policy (e.g., SRECs based on analogs identified by filter 220). Such treatment effects estimates can include a D-score estimate for each action that may be taken upon matching an SREC. Additionally or alternatively, treatment effects 801 can be maintained at a policy level. For example, treatment effects 801 can include a treatment effect estimate for a policy defined by a particular assignment of SRECs. Additionally or alternatively, treatment effects 801 can be maintained for combinations of policies and actions for matched SRECs. For example, a treatment effect estimate can be associated with a particular combination of 1) a policy defined by a particular assignment of SRECs, and 2) the particular actions taken when the assigned SRECs are matched. As appreciated by the inventors, associating a treatment effect estimate with a policy (or a particular combination of policy and actions) can simplify the determination of the treatment effect estimate. However, the number of policies (or combinations of policy and actions) can be far greater than the number of individual SRECs.

In some embodiments, treatment effects 801 can include point and interval estimates (e.g., D-score estimates or the like) for perturbations of components, parameters, or operations of symbolic representation generator 110. The point estimates and confidence intervals can correspond to differing perturbations of such components, parameters, or operations. For example, when the component is a proposition unit in localist units 311, a first treatment level can correspond to an excitatory input to the proposition unit when selecting analogs for the driver (e.g., as depicted in FIG. 4G), a second treatment level can correspond to no excitatory input (e.g., a control level) and a third treatment level can correspond to an inhibitory input to the proposition unit when selecting analogs for the driver.

In some embodiments, salience data 803 can include data or instructions attributing salience to objects or object attributes (or to localist or distributed units representing such objects or object attributes) or relationships between objects and object attributes (or analogs representing such relationships). In some embodiments, inference component 120 can use salience data 803 to increase the likelihood that experiments are allocated to the investigation of salience to objects, object attributes, or relationships between objects and object attributes.

In some embodiments, inference component 120 can attribute salience based on object attributes such as contrast, color, brightness, texture, motion, orientation, or other suitable object attributes. As an additional example, salience can be attributed to certain dimensions of object attribute (e.g., x position, y position, or the like), but not to other dimensions of object attributes (e.g., color, width, size, or the like).

In some embodiments, inference component 120 can attribute salience based on changes in detected objects, object attributes, or object relationships (e.g., detect object, object attribute, or object relationship dynamicity). For example, machine learning system 100 can be configured to attribute salience to dynamic objects, object attributes, or object relationships.

In some embodiments, salience data 803 can include dynamicity data. In some embodiments, dynamicity data can include at least one of raw perceptual change or relational dynamicity. Raw perceptual change can include measurements of changes in distributed unit values (e.g., the outputs of preprocessor 320). Such measurements can include fluctuations in pixel intensities, object motion, or transformations in the sensory input space. Inference component 120 can use raw perceptual change to capture the immediate, low-level changes in the environment, and enable inference component 120 to dynamically bias experiments towards localist units (e.g., element units, or the like) exhibit higher variability in distributed unit bindings. Relational dynamicity can include single unit activations (e.g., how often a localist unit, such as a proposition unit, or analog is in the driver, the recipient, or otherwise activated) and/or transitions (e.g., how often one localist unit, such as a proposition unit, or analog follows another in the driver or the recipient; or how often a localist unit is active after another localist unit). Inference component 120 can use relational dynamicity to bias experimentation towards dynamically evolving relationships. In some embodiments, inference component 120 can exclude analogs including only static objects from policy selection.

In some embodiments, machine learning system 100 can be configured to monitor dynamicity on a per-dimension basis, or evaluate a number of dimensions of change (e.g., maybe not all types of change are weighted equally or decay at the same rate, or maybe an object that is changing both position and size is weighted higher in terms of attention than on object that is changing on only one of those dimensions). In some embodiments, dynamicity-based attention might be contrast-based. For example, when 90% of the objects in a scene are moving, then attention might preferentially go to the 10% that are static. In a different example, when all of the objects are dynamic but 90% are moving to the left and 10% are moving to the right, then attention might preferentially go to the objects moving to the right.

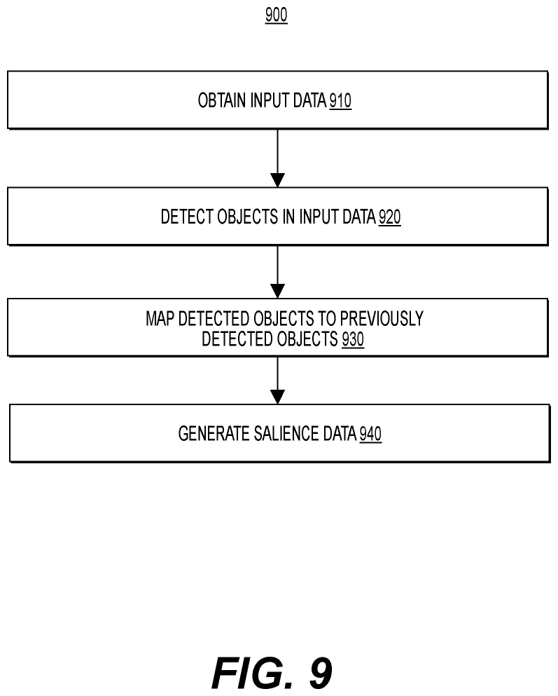

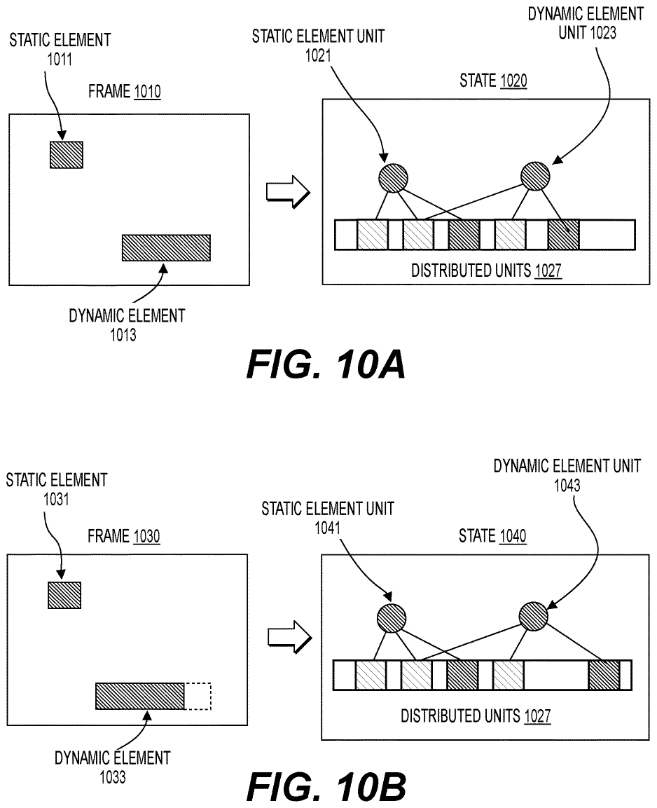

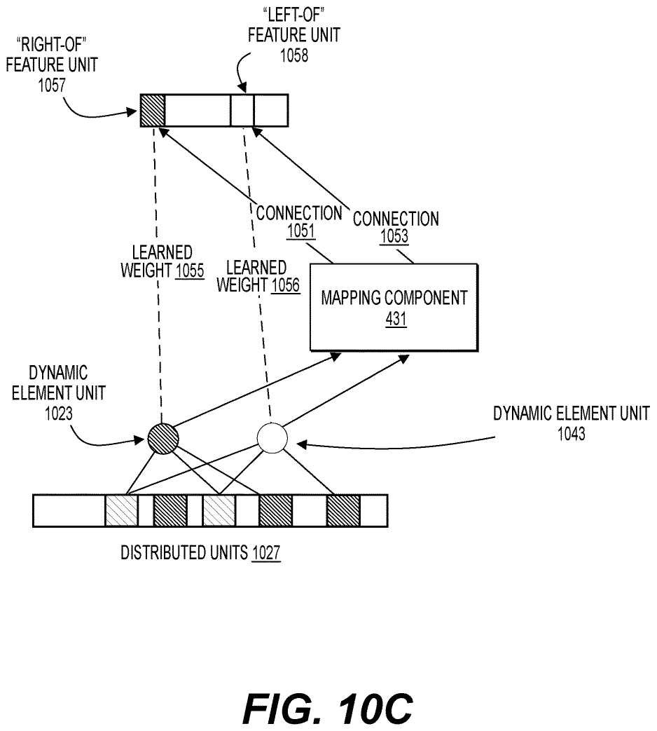

FIGS. 9 to 10C, discussed further herein, depict an exemplary method 900 for determining dynamicity of objects detected in the environment, in accordance with some disclosed embodiments.

In some embodiments, inference component 120 can be configured to attribute salience to more-predictive components of memory network 310, more-frequently selected or retrieved components, components included in SRECs more-frequently matched during experiments, or the like. In such embodiments, inference component 120 can use salience data 803 to probabilistically bias activation strength in element units, role-binding units, and/or proposition units, increasing the likelihood that frequently active localist units receive higher activation for biased relational discovery while reducing the probability of developing relations for static, redundant localist units. In some embodiments, frequently active localist units can be perturbed to experience greater competition in lateral inhibition, increasing the probability that informative relationships receive prioritization in the continual development of learned representations. As may be appreciated, such perturbations do not eliminate infrequently active localist units. Instead, such perturbations can reduce the likelihood that such localist units consume excessive computational resources, allowing for some degree of exploration while prioritizing the promising localist units. These static relational localist units can be stochastically placed in a lower hierarchy for experimentation.

In some embodiments, inference component 120 can be configured to assess the effect of perturbing components of memory network 310 on rewards received from the environment. In such embodiments, inference component 120 can use salience data 803 to bias perturbations towards localist units likely to be causally significant. Frequently active relational localist units can have an increased probability of being selected for experimentation, ensuring that interventions focus on areas with the highest likelihood of causal discovery.

In some embodiments, salience can be characterized as bottom-up salience or top-down salience. Bottom-up salience can depend on features of the input, such as changes to one or more preprocessor output dimensions (e.g., x, y, x_ext, y_ext, color, shape, etc.). Bottom-up features can include, for example:

Color Contrast: Differences in color. For example, machine learning system 100 can deem objects with more unique red/green or blue/yellow contrast more salient.

Luminance Contrast: Differences in luminance. For example, machine learning system 100 can deem objects with more unique luminance contrast more salient.

Texture Contrast: Differences in texture. For example, machine learning system 100 can deem objects with more unique textures (e.g., as compared to a uniform background) more salient.

Motion Contrast: Differences in relative motion compared to other objects. For example, machine learning system 100 can deem objects more or less salient based on factors such as relative speed, direction, and movement patterns.

Appearance/Disappearance: For example, machine learning system 100 can deem objects that suddenly appear (or are associated with objects that disappeared) more salient.

Shape Changes: For example, machine learning system 100 can deem more unique alterations in shape more salient.

Size: Differences in relative size. For example, machine learning system 100 can deem larger objects more salient.

Gestalt Grouping Principles: The organization of visual elements based on principles such as proximity, similarity, continuity, closure, common fate, synchrony (e.g., blinking or flashing together), symmetry, common region, figure-ground, and connectedness. For example, machine learning system 100 can deem certain groups of objects more salient based on these principles.

As may be appreciated, salience can depend on a deviation from the typical. In some environments, such a deviation can depend on a magnitude of a contrast, luminance, textual difference, relative speed, or the like. But the magnitude of the contrast, luminance, textual difference, relative speed, or the like does not necessarily cause salience.

Top-down salience can depend on objectives, knowledge, and predictions (e.g., embedded in the state of the symbolic representation generator or memory network). Top-down factors include unexpectedness (e.g., inconsistency with predicted behavior), novelty, familiarity, task relevance, spatial location (e.g., image center or areas known to be important for a task), temporal factors (e.g., the timing and duration of exposure), previously learned associations (e.g., cause-and-effect relationships).

In some embodiments, inference component 120 can be configured to evaluate attention methods for determining salience individually, in combination, or in varying sequences. In some embodiments, inference component 120 can be configured to compare individual analogs in terms of set of features and prioritize features based on the relative diversity of features in the analog. Similarly, inference component 120 can be configured to compare different analogs' respective feature sets and prioritize analogs and analog features to analyze based on their relative diversities.

As described herein, machine learning system 100 can include a preprocessor that extracts features from input data. Salience may affect the priority of extracting certain features or affect the processing or evaluation of at least some of the extracted features. In a visual attention example, preprocessing might include tracking features (e.g., contours or contour features) that change over time (e.g., successive frames of gameplay) and how often/recently those features (e.g., contours or contour features) have changed. In some embodiments, such preprocessing can include generating a mapping that indicates absolute (e.g., yes/no) or relative dynamicity. In some embodiments, machine learning system 100 can be configured to preferentially analyze combinations of objects that have at least one dynamic object in the pairing (i.e., first evaluate pairings that have at least one dynamic object to learn relations between the objects). Examples of object dynamicity might include objects changing position, size, color, shape, appearing, disappearing, orientation, or texture. In another embodiment, the system might weight visual attention based on a combination of how recently an object was dynamic and how consistently the object was dynamic.

As described herein, in some embodiments, inference component 120 can update salience data 803 as environment 130 provides input 111 to machine learning system 100. In some embodiments, a decay mechanism can ensure that salience data 803 values revert to mean or typical values when structures stabilize, preventing past dynamicity signals from dominating learning priorities.

FIG. 8B depicts treatment effect estimates, in accordance with one or more aspects of this disclosure. In some embodiments, treatment effects 801 can include interactive and observational effect estimates. Interactive estimates can include predictive interactive estimates and reward interactive estimates. Predictive interactive estimates 815 can include estimates of the effect of providing commands to the environment on predictions made by symbolic representation generator 110. Reward interactive estimates 817 can include estimates of the effect of providing commands to the environment on the inputs 111, such as reward values, received from the environment. Observational effect estimates can include predictive observational estimates and reward observational estimates. Predictive observational estimates 811 can include estimates of the effect of perturbing components of memory network 310 on predictions made by symbolic representation generator 110. Reward observational estimates 813 can include estimates of the effect of perturbing components of memory network 310 on the inputs 111, such as reward values, received from the environment.

As may be appreciated, machine learning system 100 can maintain and update observational effect estimates without being able to interact with the environment. In some implementations, machine learning system 100 can maintain and update predictive observational estimates 811 and reward observational estimates 813 based on input 111 received from environment 130 while another entity interacts with environment 130. For example, when environment 130 is the computer game Breakout©, machine learning system 100 can receive the video game display data as a person or another system plays Breakout©. In this manner, machine learning system 100 can learn relationship(s) between entities in Breakout© (e.g., ball, bricks, paddle) without having to interact with Breakout©.

As may be appreciated, environment 130 may rarely provide rewards. Any rewards provided by environment 130 may occur following a potentially long sequence of non-reward-providing interactions. However, machine learning system 100 can maintain and update predictive effect estimates without receiving a reward signal. In some embodiments, machine learning system 100 can maintain and update predictive observational estimates 811 and predictive interactive estimates 815 based on non-reward input 111 received from environment 130. Such predictive estimates can map the effect of perturbing components of memory network 310 or providing commands to the environment on the ability of symbolic representation generator 110 to predict subsequent non-reward input 111 received from environment 130.

FIGS. 9 to 10C depict a method 900 of generating salience data, in accordance with one or more aspects of this disclosure. FIG. 9 depicts exemplary operations of method 900, while FIGS. 10A and 10B depict two images (frames 1010 and 1030) and corresponding memory network states (states 1020 and 1040) in accordance with method 900. The two images can be frames in a sequence of such frames obtained from environment 130. Frame 1030 can be acquired after frame 1010 and can depict a state of environment 130 at a later point in time. FIG. 10C depicts the application of an invariance circuit to a mapped pair of element units from the two images.

In accordance with one or more aspects of this disclosure, method 900 can generate salience data. In this example, the salience data can be dynamicity data that indicates raw perceptual changes associated with objects in the environment. Method 900 can include comparing such objects across sets of input data and updating the salience data associated with the objects based on the comparison. Method 900 can be performed by machine learning system 100 or a component thereof, such as symbolic representation generator 110, inference component 120, or another suitable component. For concision, method 900 is described herein as being performed by machine learning system 100.

Method 900 can be performed one or more times by machine learning system 100. In some embodiments, machine learning system 100 can perform method 900 upon beginning a task (e.g., playing a game of Breakout®). Machine learning system 100 can then use the salience data generated through performing method 900 to configure the experimentation performed by inference component 120. In some embodiments, machine learning system 100 can perform method 900 repeatedly. For example, machine learning system 100 can perform method 900 according to a schedule or when a condition is satisfied (e.g., as long as a condition is satisfied, or until the condition becomes unsatisfied, or the like). Such a condition can include a determination that the effectiveness of treatments is diminishing (e.g., as measured by comparing baseline experiment results against explore/exploit experiment results as described herein), instruction(s) received from a user of machine learning system 100, or another suitable condition.

In operation 910 of method 900, machine learning system 100 can obtain input 111 from environment 130, in accordance with disclosed embodiments. Input 111 can include a time sequence of input datasets. For example, frame 1010 and frame 1030 can be frames displayed in a video game). The pixel values of the image can constitute an input dataset.

In operation 920 of method 900, machine learning system 100 can detect objects in the input data, in accordance with disclosed embodiments. In some embodiments, preprocessor 320 of symbolic representation generator 110 can detect the objects. In accordance with one or more aspects of this disclosure, preprocessor 320 can generate element units corresponding to detected objects. The element units can be added to a memory network (e.g., memory network 310 or another, separate memory network). For concision, the memory network is described herein as being memory network 310.

Preprocessor 320 can be configured to connect the detected objects to metric and/or categorical distributed units. Such distributed units can indicate the x and y position, area, color, or other basic features associated with the detected objects. Multiple element units can connect to the same distributed units. As shown in FIG. 10A, preprocessor 320 can detect static element 1011 (e.g., a block in Breakout©) and dynamic element 1013 (e.g., the paddle in Breakout©) in frame 1010. Preprocessor 320 can create static element unit 1021 corresponding to static element 1011 and dynamic element unit 1023 corresponding to dynamic element 1013. Preprocessor 320 can link static element unit 1021 and dynamic element unit 1023 to distributed units in distributed units 1027. Similarly, as shown in FIG. 10B, preprocessor 320 can detect static element 1031 (e.g., the same block at a later time) and dynamic element 1033 (e.g., the same paddle at the later time) in frame 1030. Preprocessor 320 can create static element unit 1041 corresponding to static element 1031 and dynamic element unit 1043 corresponding to dynamic element 1033. Preprocessor 320 can link static element unit 1041 and dynamic element unit 1043 to distributed units in distributed units 1027.

As may be appreciated, static element unit 1021 and static element unit 1041 map to the same distributed units in distributed units 1027, while dynamic element unit 1023 and dynamic element unit 1043 map to overlapping, but not identical, distributed units in distributed units 1027.

In operation 930 of method 900, machine learning system 100 can map the objects detected in operation 920 to previously detected objects. In some embodiments, machine learning system 100 can perform mapping as described herein with regards to FIG. 4I. Symbolic representation generator 110 can place the objects detected in operation 920 into the driver (or the recipient) and place the previously detected objects into the recipient (or the driver). Symbolic representation generator 110 can then perform one or more phase sets of mapping. In a phase set, symbolic representation generator 110 can activate a unit in the driver and allow activation to flow through the distributed units into the units in the recipient. Symbolic representation generator 110 can generate mapping hypothesis for pairs of units (e.g., a unit in the driver and a unit in the recipient) based on the accumulated co-activation of the units. Once the phase set terminates, symbolic representation generator 110 can update mapping connections between units in the driver and recipient based on the mapping hypothesis.

In the example depicted in FIGS. 10A and 10B, machine learning system 100 can map the detected objects in frame 1030 to the detected objects in frame 1010. Symbolic representation generator 110 can place static element unit 1021 and dynamic element unit 1023 in the driver of memory network 310. Symbolic representation generator 110 can place static element unit 1041 and dynamic element unit 1043 in the recipient of memory network 310. Symbolic representation generator 110 can then perform one or more phase sets of mapping. As may be appreciated, symbolic representation generator 110 can form mapping connections between symbolic units in frame 1010 and frame 1030 that connect to similar distributed units. For example, symbolic representation generator 110 can form a mapping connection between static element unit 1021 and static element unit 1041, and between dynamic element unit 1023 and dynamic element unit 1043.

In operation 940 of method 900, machine learning system 100 can generate salience data for pairs of mapped objects. In some embodiments, machine learning system 100 can identify pairs of mapped objects that satisfy a mapping condition (e.g., pairs of mapped objects having a mapping connection value greater than a threshold). Machine learning system 100 can then generate salience data for pairs of mapped objects that satisfy the mapping condition. In this manner, machine learning system 100 can disregard spurious mappings.

In accordance with one or more aspects of this disclosure, machine learning system 100 can associate element units in mapped pairs with relational distributed units. As depicted in FIG. 10C (and similar to the description in FIG. 4F), machine learning system 100 can apply an invariance circuit to associate relational distributed units with elements. In this manner, memory network 310 can determine dynamicity based on a richer set of distributed units. In accordance with one or more aspects of this disclosure, machine learning system 100 can activate metric distributed units connected to the element units in the pair. As may be appreciated, the elements units will sequentially activate. The element units can contribute activation to a mapping component connected to one or more relational distributed units. The mapping component can map inputs received from the pair of element units to ones of the relational distributed units according to a temporally and/or spatially complex mapping function. The sequential activation of the element units, in combination with the temporally and/or spatially complex mapping function, can cause the activated relational distributed units to represent relational invariants, such as “greater-than,” “less-than” or the like. Symbolic representation generator 110 can then bind co-activated elements and relational distributed units using weights.

For example, as depicted in FIG. 10C, distributed units 1027 are activate, driving activation of the mapped pair of dynamic element units in frames 1010 and 1030. As described herein, the activation dynamics imposed by symbolic representation generator cause a pattern of activation in which first one dynamic element unit (e.g., dynamic element unit 1043) and then the other (e.g., dynamic element unit 1023) becomes active. Active element and distributed units are shaded, while inactive element and distributed units are unshaded.

As described herein, mapping component 431 is connected to relational distributed units through connections (e.g., connections 1051 and 1053). The activation of dynamic element unit 1023 flows through mapping component 431 and connection 1051 and activates “right-of” distributed unit 1057. Symbolic representation generator 110 can connect dynamic element unit 1023 and “right-of” distributed unit 1057 using learned weight 1055 based on the co-activation of these units. Previously, activation of dynamic element unit 1023 flowed through mapping component 431 and connection 1053 and activated “left-of” distributed unit 1058. Symbolic representation generator 110 connected dynamic element unit 1043 and “left-of” distributed unit 1058 using learned weight 1056 based on the co-activation of these units.

In accordance with some embodiments of the disclosure, machine learning system 100 can associate salience data with the mapped pairs. Machine learning system 100 can use retrieval processes as described herein to match the mapped pairs to templates. Depending on the matched template, machine learning system 100 may or may not identify the mapped pairs as corresponding to a dynamic object.

In some embodiments, machine learning system 100 can select a template representation from a set of candidate template representations using the mapped pairs and associated relational distributed units. Such template representations can include the analogs right-of(object1, object2), left-of(object1, object2), same(object1, object2). In various embodiments, memory network 310 can be preprogrammed with the candidate template representations, or can learn them using training data presented to machine learning system 100.

In some embodiments, machine learning system 100 can be configured to retrieve the template representation as described herein with regards to FIG. 4H. In some embodiments, both dynamic element unit 1023 and dynamic element unit 1043 can be placed in the driver. Symbolic representation generator can perform one or more phase sets of activation of the element units in the driver. Activation of these units can cause activation to flow to connected distributed units. Activation can flow from connected distributed units to template representations in memory network 310. A template representation can be chosen based on the activation of the template representation over the one or more phase sets. In some embodiments, the template representation can be chosen deterministically (e.g., the template representation with the greatest activation). In some embodiments, the template representation can be chosen stochastically (e.g., according to the activations of the candidate template representations using the Luce choice axiom). The activation of the template representation can be a function of the activations of one or more components of the template representation. For example, the activation of the template representation can be the average or maximum activation of the highest order symbolic unit in the template representation. In the example depicted in FIG. 10C, a right-of(object1, object2) template representation may be retrieved for the depicted element units.

In some embodiments, the salience data can indicate which template representation was retrieved. For example, when the template representation retrieved was the same (object1, object2) template representation, the salience data can be updated to mark the corresponding mapped pair of element units as corresponding to a static object in the environment. Otherwise, the salience data can be updated to mark the corresponding mapped pair of element units as corresponding to a dynamic object in the environment.

In some embodiments, machine learning system 100 can be configured to identify combinations of distributed units corresponding to static objects. In such embodiments, machine learning system 100 may subsequently identify representations corresponding to static objects based on the combinations of distributed unit connected into these representations. In this manner, machine learning system 100 can detect static objects and representations corresponding to static objects in subsequently obtained image data.

In some embodiments, machine learning system 100 can further perform relational generalization on the mapped pair of element units using the selected template representation. For example, symbolic relationship generator 110 can be configured to swap the retrieved template representation in the recipient with the element units in the driver. Symbolic relationship generator 110 can then perform relational generalization, identifying that elements in the driver lack mapped elements in the recipient, creating these elements and connecting them to the mapped pair of element units. For the element units depicted in FIG. 10C, the right-of(object1, object2) template representation can be used to create a right-of(dynamic element 1013, dynamic element 1033) analog through relational generalization. This newly created representation can be stored in memory network 310.

As described herein, inference component 120 can perform experiments to assess the effect of treatments on performance metrics (e.g., reward values received from environment 130, task performance or predictive ability of the symbolic representation generator 110, or the like). In accordance with one or more aspects of this disclosure, machine learning system 100 can be configured to use salience data to focus such experimentation on relevant relationships identified by the symbolic representation generator. In some embodiments, inference component 120 can be configured to use the salience data to bias experimentation towards objects exhibiting greater raw perceptual changes. As described herein, such salience data can be represented as dynamicity scores. In some embodiments, machine learning system 100 can be configured to exclude treatments from such experimentation based on salience data. For example, machine learning system 100 can exclude a treatment when the treatment corresponds to a representation in memory network 310 that satisfies a salience data criterion. A representation can satisfy the salience data criterion when a dynamicity score for the object is less than a threshold value, a statistic based on dynamicity scores for the object and other objects in the environment (e.g., a percentile value, or the like) is less than a threshold value, the salience data indicates that the object is static (e.g., as described above with regards to FIGS. 10A to 10C, or the like).

In some embodiments, symbolic representation generator 110 or another component of machine learning system 100 can exclude a treatment by limiting or filtering the representations available to inference component 120. In some embodiments, inference component 120 can exclude a treatment by limiting the representations included in causal model 530.

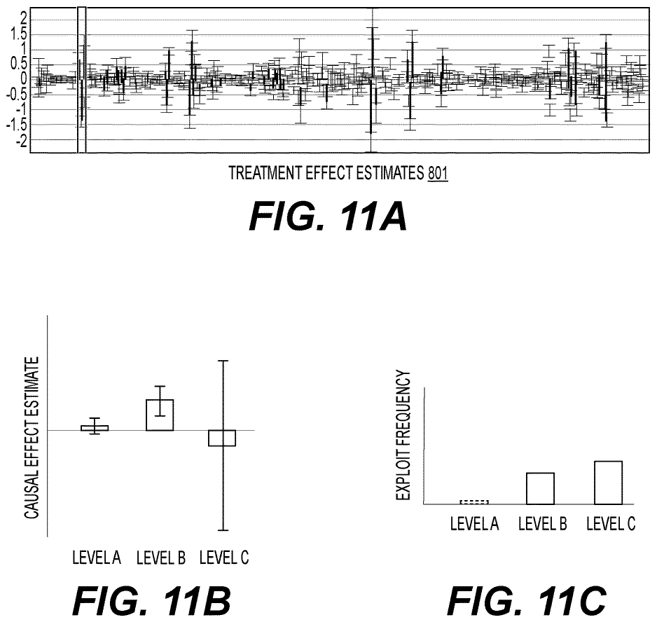

FIGS. 11A and 11B depict treatment effects 801, in accordance with one or more aspects of this disclosure. FIG. 11A depicts d-scores for numerous SRECs (and in some embodiments for experimental design parameters and/or perturbations of operations, parameters, or components of the symbolic representation generator). FIG. 11B depicts d-scores for treatment levels of a single exemplary SRECs. As shown, three treatment levels (e.g., actions, experimental design parameters, perturbations of operations, parameters, or components of the symbolic representation generator) can be associated with estimates of d-scores having varying confidence intervals. FIG. 11C depicts selection frequency of the treatment levels during explore/exploit experiments trials, in accordance with one or more aspects of this disclosure. As described herein, in some embodiments, selection frequency can depend on point and interval estimates. In this example, selection frequency can depend on point and interval estimates of d-score. In some embodiments, the selection frequency can depend on the magnitude and sign of the point estimate. For example, level B can have a higher estimated d-score than level A. Therefore, inference component 120 can select level B more frequently during explore/exploit experiments than level A. In some embodiments, the selection frequency can depend on the magnitudes of the confidence intervals. For example, level C can have a lower (negative) estimated d-score than level B. However, level C can have a wider confidence interval than level B. Accordingly, inference component 120 can select level C more frequently during explore/exploit experiments than level B. In some embodiments, selection frequency can depend on a probability that the effect of treatment is greater than some value (e.g., a p-value that the d-score is greater than zero, greater than the effect of treatment for another level, or the like). This probability can depend both on the estimated d-score and on the confidence interval for the d-score (and the estimated d-score and confidence interval for the d-score for another level, if estimating the p-value that this treatment effect is greater than the treatment effect for another level).

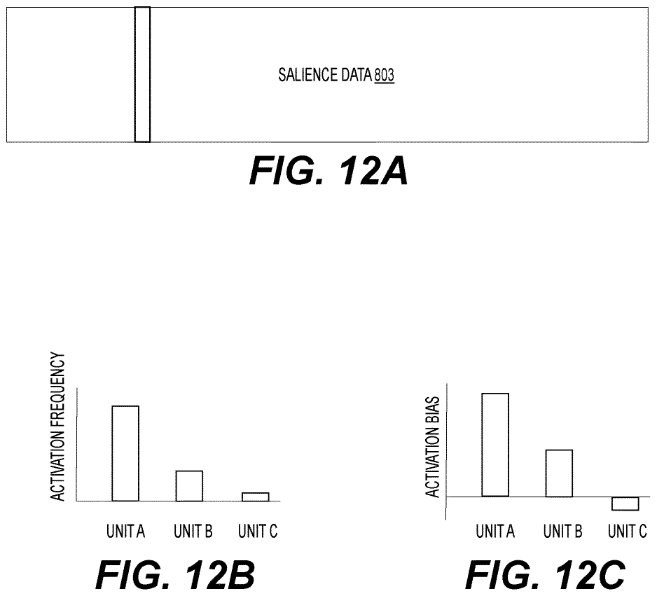

FIGS. 12A and 12B depict salience data 803, in accordance with one or more aspects of this disclosure. In this example, salience data 803 can include dynamicity data, based on changes in distributed units bound to mapped local units, as described herein. As may be appreciated, the disclosed embodiments are not limited to such dynamicity data. FIG. 12A depicts dynamicity scores for components of memory network 310. FIG. 12B depicts dynamicity scores for three localist units of memory network 310. As shown, the three localist units can be associated with differing dynamicity scores corresponding to differing activity levels. FIG. 12C depicts an exemplary mapping from dynamicity scores to activation bias, in accordance with one or more aspects of this disclosure. As described herein, inference component 120 can bias activation of localist units based on dynamicity scores. In this example, localist unit A is given a substantial excitatory bias, localist unit B is given a lesser excitatory bias, and localist unit C is given a minor inhibitory bias.

In some embodiments, inference component 120 can perturb the operation of symbolic representation generator 110. Inference component 120 can perturb symbolic representation generator 110 based on a causal model 530. As described herein, causal model 530 can include treatment effects 801. Inference component 120 can determine treatment effects 801 through experimentation (e.g., using process 600, or another suitable process). In some embodiments, causal model 530 can include salience data 803. In such embodiments, inference component 120 can perturb symbolic representation generator 110 based on salience data 803.

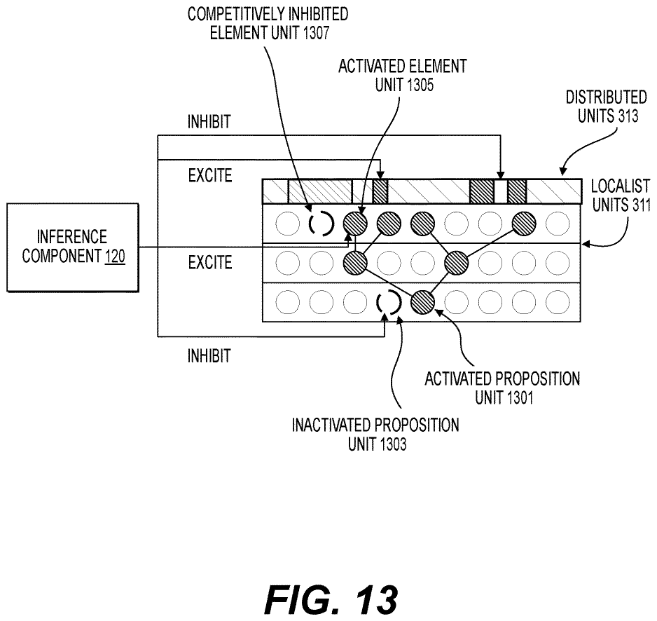

For example, inference component 120 can perturb the components, parameters, or operations of symbolic representation generator 110, as described herein with regard to FIGS. 4A to 4Q. Such perturbations can include perturbations to memory network 310, as depicted in FIG. 13, in accordance with one or more aspects of this disclosure. In some embodiments, inference component 120 can perturb memory network 310 by exciting or inhibiting one or more components of memory network 310. As depicted in FIG. 13, inference component 120 can perturb activation levels of one of more localist units or distributed units of memory network 310. For example, inference component 120 can add excitatory or inhibitory input to a localist unit or distributed unit. The excitatory or inhibitory input can then affect activation levels of the localist unit or distributed unit, in accordance with one or more aspects of this disclosure. As an additional example, inference component 120 can add excitatory or inhibitory activation directly, or clamp activation levels at a specified value (e.g., regardless of input to the localist unit or distributed unit).

In some embodiments, inference component 120 can perturb mappings between localist units of memory network 310. For example, inference component 120 can add excitatory or inhibitory values to mapping hypothesis between localist units. The excitatory or inhibitory input can then affect mappings between localist units, in accordance with one or more aspects of this disclosure. As an additional example, inference component 120 can directly add or remove mappings between localist units, or clamp mapping weights at a specified value (e.g., regardless of input to the localist unit or distributed unit).

In some embodiments, inference component 120 can perturb a mapping condition for mapping units. As described herein with reference to FIG. 4L, the mapping condition can control whether the symbolic representation generator performs relational refinement on a mapped pair of units. The inference component 120 can perturb the numerical threshold, increasing the numerical threshold to discourage formation of more abstract or generic relations, or decreasing the numerical threshold to encourage formation of more abstract or generic relations. In some embodiments, the symbolic representation generator 110 can be configured to maintain categories of analogs (e.g., based on salience data, or the like). In some embodiments, the inference component 120 can be configured to independently manage the mapping condition for different categories of analogs. For example, inference component 120 can be configured to maintain one (potentially lower) numerical threshold for determining whether to perform relational refinement on a mapped pair of static element units (thereby encouraging generalization of such static element units and analogs including such units). As an additional example, inference component 120 can be configured to maintain one (potentially higher) numerical threshold for determining whether to perform relational refinement on a mapped pair of dynamic element units (thereby encouraging the symbolic representation to maintain a distinct representation of such units).

In some embodiments, inference component 120 can perturb selection of analogs for driver 440. As depicted in FIG. 13, inference component 120 can add inhibitory input to one or more proposition units (e.g., inactivated proposition unit 1303). Accordingly, this proposition unit may remain inactive. As localist units of the same type competitively inhibit each other, a proposition unit that might otherwise remain inactive may become activated (e.g., activated proposition unit 1301). Similarly, inference component 120 can add excitatory input to one or more element units (e.g., activated element unit 1305). Accordingly, this element unit may become active. As localist units of the same type competitively inhibit each other, an element unit that might otherwise become active may remain inactivated (e.g., competitively inhibited element unit 1307). Similarly, inference component 120 can increase or decrease distributed unit activations, perturbing the values received from preprocessor 320. These perturbed values can then affect the activations of other localist units. As symbolic representation generator 110 can be configured to select analogs into the driver based on activation levels, the perturbations imposed by inference component 120 can affect which analogs are selected into the driver (thereby in turn affecting subsequent processing operations, such as retrieval of analogs into the recipient, mapping, and relational learning).

As disclosed herein, symbolic representation generator 110 can be configured to update weights and mappings based on co-activation. Accordingly, perturbations imposed by inference component 120 can have lasting effects on connections and mappings. For example, when inference component 120 determines that activation of an analog improves performance metrics, inference component 120 can add excitatory input to a proposition unit of that analog during selection of the driver, making symbolic representation generator 110 more likely to select that analog for the driver. As weights and mappings are updated based on co-activation, symbolic representation generator 110 can be more likely to select other analogs mapping to the activated analog for relational learning.

As may be appreciated, inference component 120 can perturb memory network 310 based on treatment effects 801 and/or salience data 803. In some embodiments, perturbations based on treatment effects 801 can vary between, and be consistent within, experimental units. In some embodiments, perturbations based on salience data 803 can vary as salience data is dynamically updated.

### Initialization Process

FIG. 14A depicts an exemplary process 1400 for initializing a machine learning system, in accordance with one or more aspects of this disclosure. Process 1400 can be performed using machine learning system 100 of FIG. 1A, or another suitable machine learning system. Process 1400 can be performed as part of process 600, part of another process, or as a stand-alone process. In some embodiments, process 1400 can be performed in part by a symbolic representation generator of the machine learning system and in part by an inference component of the machine learning system.

In operation 1401 of process 1400, the machine learning system can initialize the symbolic representation generator. In some embodiments, initializing the symbolic representation generator can include configuring a memory network (e.g., memory network 310) with suitable relational analogs. As may be appreciated, these relational analogs can depend on the type of input. In a visual processing example, such analogs can represent relational concepts along dimensions of location, size, height, width, x-position, y-position, color, shape, or the like of an object observed in a visual scene. Furthermore, such analogs can bind localist units representing objects observed in the visual scene to distributed units that represent relational invariants such as “bigger-than”, “smaller-than”, “same-as”, “cause-of”, “caused-by”, “higher-than”, “lower-than,” or the like. For example, such analogs can include role-binding units such as more(dim), same(dim), less(dim), different(dim), or the like, where dim is some dimension of variance, such as x coordinate extent, y coordinate extent, size, color or shape (e.g., for same( ) and different( )), area, brightness, or the like. As an additional example, such analogs can include proposition units such as bigger(obj₁,obj₂), smaller(obj₁,obj₂), same_color(obj₁,obj₂), or the like. Initialization of the symbolic representation generator can reduce the time or number of experiments necessary for the machine learning system to achieve a desired level of performance in a task by providing a set of relationships usable to form task-specific analogies as described herein.

In some embodiments, the machine learning system can configure the memory network by writing predetermined analogs into the memory network. In some embodiments, such predetermined analogs can be obtained from a memory or storage device accessible to the machine learning system (e.g., a local storage device or a storage device accessible over a network).

In some embodiments, the machine learning system can configure the memory network by providing configuration input data to the symbolic representation generator. In some embodiments, the configuration input data can be provided to the symbolic representation generator during initialization of the symbolic representation generator instead of, or in addition to, input obtained from the environment. In some embodiments, such configuration input data can be obtained from a memory or storage device accessible to the machine learning system (e.g., a local storage device or a storage device accessible over a network).

As described herein, the configuration input data can be provided to cause the symbolic representation generator to generate suitable relational analogs. In some embodiments, the configuration input data can therefore depict objects in relationships corresponding to the suitable relational analogs. As a visual processing example, the configuration input data can therefore depict objects in relationships along dimensions of location, size, height, width, x-position, y-position, color, shape, or the like of an object observed in a visual scene. For example, the configuration input data can depict objects of differing sizes, shapes, colors, and positions in different spatial relationships with each other. In some embodiments, the configuration input data could also train appropriate scaling factors for one or more distributed unit dimensions (e.g., thereby encoding categorical vs metric distinctions for that dimension). Consistent with the systems and methods described herein, the machine learning system can generate suitable relational analogs in response to the provision of the configuration input data. As may be appreciated, the configuration input data can be superior to randomly chosen input data (or input data representative of typical tasks) according to a suitable performance metric (e.g., amount of training data required, selectivity of resulting relational analogs, or another suitable performance metric).

In some embodiments, initialization can include the generation of abstracted objects, disentangled relations, and combinations thereof (e.g., “initialization analogs”). In some embodiments, abstracted objects can be generated from observed objects in the environment based on object salience. The symbolic representation generator can load element units representing objects in the environment into the symbolic representation. Each element unit may be mapped to another element unit in the symbolic representation. The symbolic representation generator can categorize each pair of element units as being dynamic or static with respect to each of a set of dimensions. The symbolic representation generator can then select, retrieve, match, and refine the objects corresponding to each category (e.g., each combination of dimension and dynamic or static). As described herein, dynamic and static categories can use different mapping conditions, to encourage abstraction of static objects while preserving the specificity of dynamic objects. In some embodiments, the symbolic representation generator can assign a refined object the category of the objects used to generate the refined object. For example, when a pair of objects that are dynamic in the x dimension are used to generate the refined object, the symbolic representation generator can assign the refined object the categorization of being dynamic in the x dimension. In some embodiments, the symbolic representation generator may only use an object once for a category. For example, when a pair of objects that are dynamic in the x dimension are used to generate a refined object, each of the pair of objects may not be used to generate further refined objects in the x dimension. However, the refined object generated from this pair may be used to create a further refined object in the x dimension.

In some embodiments, generation of the initialization analogs can include generation of disentangled relationships using objects in the environment. The symbolic representation generator can load element units representing objects in the environment into the symbolic representation. Each element unit may be mapped to another element unit in the symbolic representation. The symbolic representation generator can form analogs representing relationships based on the mappings. The symbolic representation generator can form refined analogs using a mapping condition with a low similarity threshold for mapping element units representing objects observed in the environment unit. This mapping condition can be selected to cause the loss of object-specific information, as described herein. The symbolic representation generator may use a higher similarity threshold for mapping element units representing single-argument relational predicate, or higher-order localist units (e.g., role-binding units, or proposition units). The resulting analogs can include dimensionally specific relational distributed units but may otherwise include little object specific information.

In some embodiments, generation of the initialization analogs can include the combination of abstract objects and disentangled relationships. The disentangled relationships in a dimension can be combined with abstract objects in the dimension to generate analogs for the same dimension. These analogs can take non-relational distributed unit connections from the abstract objects and relational distributed unit connections and logical unit bindings from the disentangled relationships. In some embodiments, this process can be used to generate hypothetical analogs that correspond to yet-unobserved relationships. As may be appreciated, these analogs can be used to generate SRECs assigned to a policy, as described herein.

In some embodiments, initializing the inference component can be performed as discussed above with regards to operations 610 and 620 of process 600, or another suitable method. For example, initializing the inference component can include obtaining at least one of performance metrics, treatment space, constraints, normative operational data, or experimental input scope and duration estimates. The inference component can then proceed to define experimental units and determine clusters, as described with regards to process 600 or according to another suitable method.

In operation 1403 of process 1400, the machine learning system (e.g., the inference component, or the like) can determine a mapping from action to representation. In some embodiments, the machine learning system (e.g., the inference component, or the like) can be configured with the ability to provide instructions to take actions in the environment. But the machine learning system may not originally have knowledge of what the actions “do.” For example, the machine learning system can be configured with the ability to provide instructions to perform a command in a computer program (e.g., “move-paddle-right” in Breakout®). But the machine learning system may not originally be configured with a mapping from instruction(s) to perform a command to a representation of the effect of the command on the environment.

In some embodiments, the machine learning system can learn this mapping in operation 1403, in accordance with one or more aspects of this disclosure. The machine learning system can learn this mapping empirically, for example by identifying analogs in the working memory (e.g., driver and/or recipient of the symbolic representation generator) that are statistically associated with taking an action. For example, the machine learning system can determine that the representation greater_than_x(pₜ₀, pₜ₁) corresponds to a “move-paddle-right” action in the environment, where pₜ₀ is the location of the paddle at t0 and pₜ₁ is the location of the paddle at t1. As may be appreciated, this representation may appear following issuance of a move-paddle-right instruction.

In some embodiments, the machine learning system can learn this mapping by observing the actions taken by another. For example, the machine learning system can be configured knowledge of the instructions provided to take actions in the environment. But, as described above, the machine learning system may lack knowledge of what these actions “do.” By identifying analogs in the working memory (e.g., driver and/or recipient of the symbolic representation generator) that are statistically associated with an action taken by another, machine learning system can determine that a representation in the environment corresponds to an action, even when the machine learning system does not take the action.

In operation 1405 of process 1500, the machine learning system (e.g., the inference component, or the like) can determine a mapping from rewards to analogs representing objects and relationships in the environment. In some embodiments, the machine learning system (e.g., the inference component, or the like) can be configured with the ability to detect reward signals received from the environment. But the machine learning system may not originally know what environmental states are associated with the receipt of reward signals. For example, the machine learning system can be configured with the ability to detect that a score has increased in a computer program (e.g., points have been awarded in Breakout®). But the machine learning system may not originally be configured with a mapping from an increase in points to a representation of such an increase in the environment.

In some embodiments, the machine learning system can learn this mapping in operation 1405, in accordance with one or more aspects of this disclosure. The machine learning system can learn this mapping empirically, for example by identifying analogs in the working memory (e.g., driver and/or recipient of the symbolic representation generator) that are statistically associated with receiving a reward. For example, the machine learning system can determine that the representation greater_than(scoreₜ₁, scoreₜ₀) corresponds to a detected award of points, where scoreₜ₀ is the displayed score at t0 and scoreₜ₁ is the displayed score at t1. As may be appreciated, this representation may appear in association with the receipt of a reward signal for an increase in score.

As may be appreciated, the mappings performed in operations 1403 and 1405 can be performed sequentially (in the displayed order or another order) or in parallel. In some embodiments, the experimental unit durations can vary substantially between mapping of instructions to representations and mapping of reward signals to representations. For example, for Breakout®, performance of the experimental unit length determination process described in FIGS. 7A and 7B may result in an experimental unit length of a few sequential frames of input for mapping instructions to representations. In contrast, the experimental unit length determined for mapping rewards to representations can be tens or hundreds of frames.

In some embodiments, similar to the initialization of the symbolic representation generator, the machine learning system (e.g., the inference component, or the like) can be configured to obtain the mappings of operations 1403 and 1405. The machine learning system can obtain such mappings from a memory or storage device accessible to the machine learning system (e.g., a local storage device or a storage device accessible over a network).

### Experimentation Process

As described herein, the machine learning system can perform a multi-level experimentation process. This experimentation process can include experimentation upon the configuration of the machine learning system (e.g., the symbolic representation generator or the inference component, or the like) the type and configuration of an experimental model, and/or the assignment of polices to sets of experimental units according to the experimental model (and optionally according to the causal model).

FIG. 14B describes a suitable experimental design, experimentation, and analysis process 1410 for determining treatment effects, in accordance with one or more aspects of this disclosure. Process 1410 can include the development of a causal model that reflects relationships observed in the environment and that guides future experimental design. In some embodiments, as described herein, the memory network can form a substrate for the causal model. The causal model can then be developed through the generation, refinement, and retrieval of relationship analogs, as described herein. Process 1410 can be performed as part of process 200 of FIG. 2 (e.g., operations 240 and 250), or another suitable process.

In accordance with one or more aspects of this disclosure, process 1410 can be performed using the machine learning system of FIG. 1A, or another suitable machine learning system. As described herein, the machine learning system can include an inference component (e.g., inference component 120) and a symbolic representation generator (e.g., symbolic representation generator 110). For convenience of description, the operations of process 1410 are attributed to the inference component, while the maintenance of a suitable symbolic representation (e.g., memory network 310) is attributed to the symbolic representation generator. However, the disclosed embodiments are not so limited.

In operation 1411 of process 1410, the inference component can design an experiment, in accordance with some disclosed embodiments. For convenience of description, FIG. 14B describes a single-level experiment that assigns policies to experimental units according to an experimental model. But this framework can be extended in a straightforward manner to multi-level experiments that involve experimentation upon the configuration of the machine learning system, or upon the type and configuration of the experimental model. In some embodiments, the machine learning system can begin performing process 1410 after determining suitable experimental unit durations (e.g., in an initiation phase), as described herein with regards to FIGS. 7C to 7E.

As may be appreciated, various experimental design methodologies can be implemented within the framework depicted in FIG. 14B. Without limitation, such methodologies can differ in how treatments are determined, how treatments are assigned to experimental units, and/or how experimental results are used to update the causal model. An exemplary methodology may operate on batches of experimental units: sets of treatments may be assigned to multiple corresponding experimental units and analysis and updating of the causal model deferred until completion of the multiple experimental units. Another exemplary methodology may operate incrementally: a set of treatments can be assigned to a single experimental unit and updating the causal model performed upon completion of that experimental unit. As may be appreciated, such batch or incremental results may still rely on previously acquired result data. For example, the machine learning system may determine the causal model (incrementally or batch-wise) using result data falling within a data inclusion window. Furthermore, different experimental design methodologies may be suitable for different experiment types (e.g., baseline experiments, explore/exploit experiments, or the like).

In accordance with some embodiments of the disclosure, generation of the experimental design can include generation of policies for use in experimental units. In some instances, the inference component can generate the policies based on the causal model. For example, an explore/exploit design may favor treatments likely to yield rewards, reduce interval estimates of effects, maximize an increase in mutual information arising from experimentation, or the like. As an additional example, the causal model can specify environmental states (e.g., as represented in the symbolic representation) with empirically determined causal significance. The inference component can then include these environmental states as factors in the experiment design.

As described herein, the policy can include a set of treatments. In some instances, the policy can specify preconditions for applying the treatments. A treatment can be applied when a state of the environment (e.g., as represented in the symbolic representation) matches the precondition for the treatment. In some instances, the policy can specify that the treatment be applied without preconditions. For example, higher-level treatments, such as perturbations of the symbolic representation generator or inference component, may be applied without reference to a state of the environment. In some embodiments, the inference component can determine an experimental design that disregards analogs representing objects or relationships in the environment, or performs clustering based on such analogs. The inference component can accordingly generate a policy including treatments that similarly disregard, or implement clustering based on, such analogs.

In accordance with some embodiments of the disclosure, generation of the experimental design can include assignment of the generated policies to experimental units. For example, assuming two treatments each having two treatment levels (e.g., two SRECs each including two actions or perturbations, or the like), the inference component can generate four policies, each with a different combination of the SRECs and actions. The inference component can assign these four policies to a set of four experimental units. These four experimental units may be the next four experimental units, or there may be other experimental units interleaved between them. For example, these four experimental units can be interleaved with experimental units assigned to other experiments (e.g., these four experimental units can be assigned to an explore/exploit hybrid experiment, while the interleaved experimental units can be assigned to a baseline experiment).

In operation 1413 of process 1410, the inference component can perform the experiment, in accordance with some disclosed embodiments. As described herein, an experiment can include multiple experimental units, which may be interleaved with other experimental units assigned to other experiments. Accordingly, performance of the experiment can stretch over multiple experimental units. During an experimental unit, the machine learning system can obtain input data from the environment. The symbolic representation generator can update the memory network using this input data. The machine learning system may then apply a treatment included in the policy if a condition for applying the treatment as satisfied (e.g., an SREC matches analogs in the working memory, a retrieved relationship group includes an analog mapped to an action, or the like). As may be appreciated, the machine learning system may repeatedly obtain input data during the experimental unit and apply treatments according to the policy for the experimental unit. The applied treatments may differ, depending on the obtained input data.

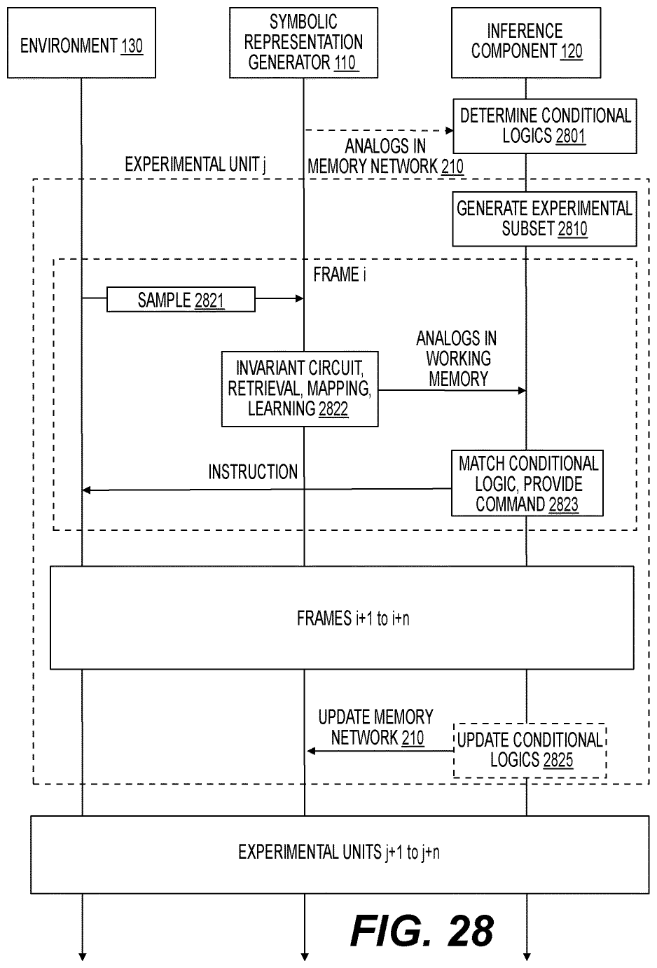

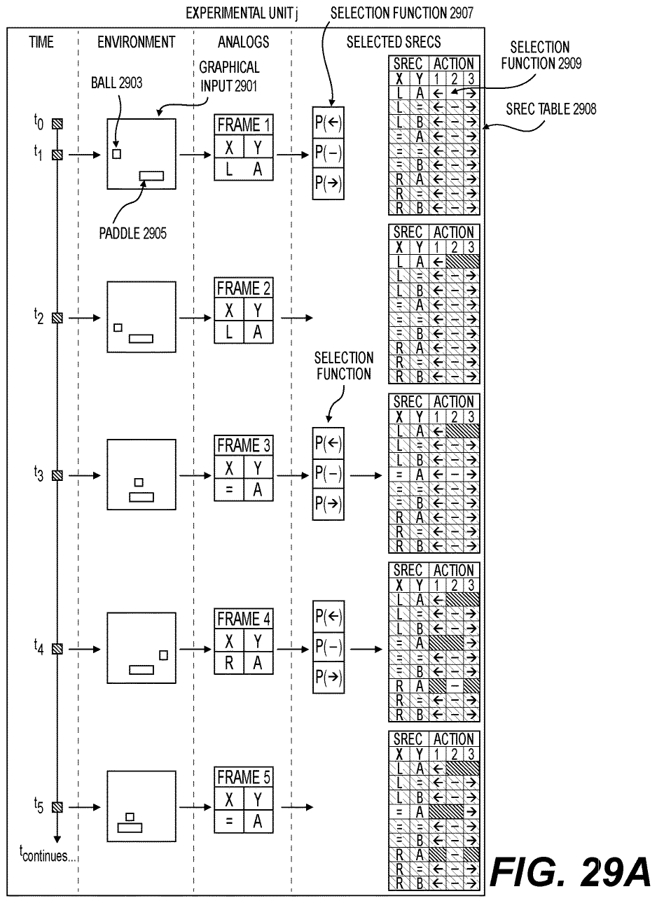

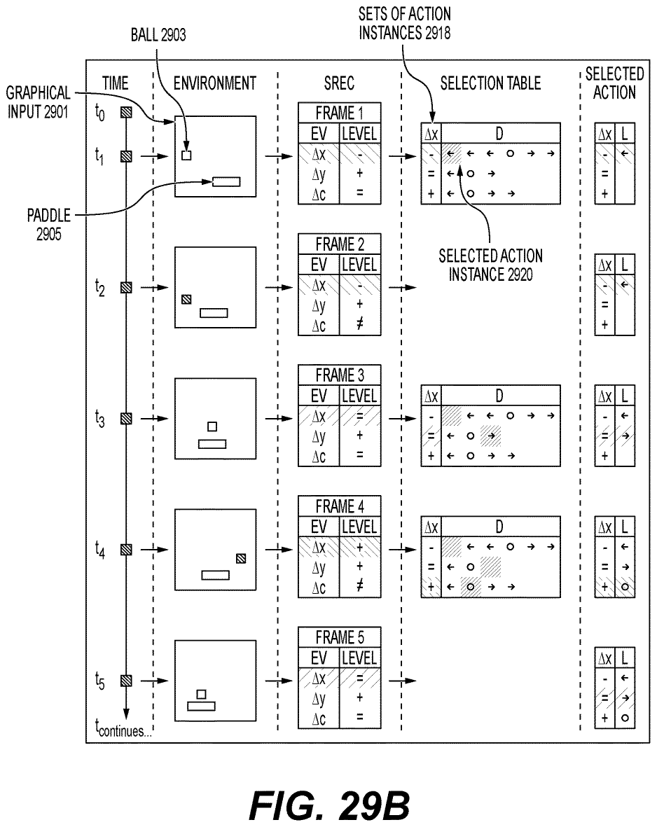

For example, as shown in FIGS. 28 to 29B, the inference component can determine an action to perform for a matched SREC. In some embodiments, the determination can depend on an experiment type associated with the experimental unit (e.g., explore/exploit experimental unit, a baseline experimental unit, or the like). For example, in a baseline experiment, actions can be selected with equal probability, or according to an initial or default distribution. In an explore/exploit experiment, actions can be selected based on treatment effect estimates for the actions. For example, the actions can be selected using probability matching, Thompson sampling, upper confidence bounds-based techniques, softmax, or another suitable technique. As an additional example, the actions can be selected using a set of action instances or selection function, as described herein.

In accordance with some disclosed embodiments, the input data obtained from the environment can include reward information. The machine learning system may use this reward information to update the causal model. Similarly, the input information can concern the results of predictions regarding the state of the environment. For example, the experiment may test whether taking an action when the environment is in a first state causes the environment to transition to a second state. The input information can indicate that the environment was in the first state, causing the machine learning system to provide instructions to take the action according to the policy, and then indicate that the environment transitioned (or did not transition) to the second state.

In operation 1415 of process 1410, the machine learning system can update the causal model, in accordance with some disclosed embodiments. In various embodiments and depending on the experimental design, the machine learning system may update the causal model after each experimental unit, or after a block of experimental units. As may be appreciated, the process for updating the causal model can depend on the experimental design. For example, the analysis of the result data and the updating of the causal model may differ between a fractional factorial experiment and a reinforcement learning design that maintains a state-action table. In some embodiments, the updates to the causal model can include estimated treatment effects for treatments. As described herein, these estimated treatment effects can include performance metric values (e.g., a reward value, task performance value, predictive accuracy value, or the like). The estimated treatment effects can replace or be combined with (e.g., averaged with, or the like) the existing estimated treatment effects for the treatments.

In some embodiments, process 1410 can then return to operation 1411, in which the machine learning system can design another experiment, in accordance with some disclosed embodiments. As may be appreciated, this subsequent experiment may be designed based on the updated causal model. Furthermore, in some embodiments, the machine learning system may be running multiple experiments in parallel. These experiments can be assigned interleaved experimental units and can be designed to target differing environmental states and/or treatments.

In some embodiments, this experimentation process can implement an adaptive experimental design (e.g., such as a experimental design adapted from or based on the Practical Adaptive & Novel Designs and Analysis (PANDA) toolkit, or the like). Such an experimental design can include an initial experimental design that specified an adaptation schedule and adaptation processes. The adaptation schedule can specify review points at which the results of the experiment are assessed and predetermined adaptations to the experimental protocol implemented. In the example depicted FIG. 14B, operation 1411 can be such a review point. The machine learning system may have previously determined an experimental protocol specifying an adaptation schedule and adaptation processes. At this review point, the machine learning system can adapt the experimental design according to this previously protocol. In some embodiments, this adaptation can depend on the current version of the causal model. For example, as described herein, the machine learning system can apply a treatment when the symbolic representation reflects a particular environmental state. The particular environmental states that trigger application of treatments can depend on the assessed predictiveness of those environmental states (e.g., akin to changing the enrollment of a population in a trial based on a changed assessment of the effectiveness of a treatment on the population). As described herein, the predictiveness of such environmental states can be reassessed as an aspect experimental design. As an additional example, as described herein, the machine learning system can assign a particular treatment when the symbolic representation reflects a particular environmental state. The chance of this assignment can depend on the causal model (which can be updated as described herein between iterations of process 1410). As a further example, certain treatments may be discarded and experimental units allocated to those treatments under previous experimental designs can be re-allocated to testing the effects of other treatments. As an additional example, multiple inference engines can generate predictions about suitable treatments for an environmental state. The machine learning system can switch between recommended treatments according to the pre-determined protocol. As may be appreciated, a statistical design of the overall protocol support such adaptations while preserving the validity of inferences drawn from the collected experimental data, thereby supporting more-rapid identification of causal effects and relationships observed in the environment.

### Online Explore/Exploit Experimental Design

FIG. 15A depicts exemplary experimental design process 1500, in accordance with one or more aspects of this disclosure. Process 1500 can be an incremental process, in which a policy is created, assigned to an experimental unit (which may or may not be the next experimental unit), and the experimental unit is performed. Result data obtained from performance of the experimental unit can then affect the generation of subsequent policies. The creation of the policy can depend on treatment effect estimates, predictive weights, and salience data.

For convenience of description, process 1500 describes the allocation of treatments that are instructions to take an action in the environment. However, the disclosed embodiments are not so limited. In some embodiments, the experimental design can concern treatments that include, at least in part, perturbations of the operations, components, or parameters of the symbolic representation generator.

FIG. 15A is described in combination with FIGS. 15B to 15D, which depict data structures associated with the selection of SRECs, in accordance with one or more aspects of this disclosure. Process 1500 can be performed using the machine learning system of FIG. 1A, or another suitable machine learning system. For convenience of description, process 1500 is described as being performed by an inference component (e.g., inference component 120 or the like) of the machine learning system. However, the disclosed embodiments are not so limited. Process 1500 can be performed as a stand-alone process, or as part of another process (e.g., operation 1411 of process 1410 or operations 220 and 230 of process 200).

In some embodiments, process 1500 can be initialized with analogs obtained from a symbolic representation generator (e.g., symbolic representation generator 110 or the like). The disclosed embodiments are not limited to any particular protocol for obtaining the analogs or format for the obtained analogs. In some embodiments, the inference component can obtain analogs stored in a memory network (e.g., memory network 310 or the like). In accordance with some embodiments of the disclosure, as described herein with regards to operation 220 of process 200, the inference component can obtain a subset of analogs stored in the memory network. In some embodiments, analogs can be obtained from the memory of the symbolic relationship generator based on salience data or extraneous analog information. For example, analogs corresponding to static relationships (e.g., between bricks in a game of Breakout®) may not be obtained. As an additional example, relationships determined by the inference component to lack an effect on the reward value may not be obtained. For example, the inference component may not obtain extraneous analogs. As may be appreciated, the input data obtained from the environment can concern objects extraneous to performance metrics. For example, the entire screen in a modified game of Breakout® could be surrounded by moving blocks that do not interact with the ball or paddle. The inference component can determine, based on the results of experimental units in the data inclusion window, that analogs concerning these moving blocks have no impact on performance metrics. Accordingly, these analogs may not be obtained by the inference component in this scenario. In some embodiments, the inference component can obtain all of the analogs stored in the memory network.

FIG. 15B depicts a table including analogs obtained from the memory network of a symbolic representation generator, in accordance with some embodiments of the disclosure. In this non-limiting example, the machine learning system is trained to play Breakout®. In this example, only eight analogs are retrieved from the memory network. These analogs are associated with three dimensions: x location, y location, and color. Such analogs can be implemented using combinations of localist and distributed units as described herein. For example, object localist units can be bound to metric distributed units of the appropriate dimension. The object localist units can be bound into role-binding units, which can be bound into propositions (e.g., more-x (ball, paddle), or the like). As may be appreciated, a real-world example could include tens to thousands or more analogs corresponding to single digit to hundreds or more dimensions. Furthermore, the analogs could include analogs of greater complexity, such as analogs including one or more proposition units acting as element units, as described herein.

In operations 1510 to 1530 of process 1500, the inference component can generate or update an experimental design. In this example, the experimental design can include a policy that assigns a set of treatments to an experimental unit. The set of treatments can depend on the obtained analogs. In accordance with some disclosed embodiments, the set of treatments can be implemented using a corresponding set of SRECs. The SRECs can include preconditions and associated actions. The preconditions can include combinations of the obtained analogs.

In operation 1510 of process 1500, the inference component can generate analog combinations, in accordance with some embodiments of the disclosure. The analogs combinations can specify potential preconditions usable to create SRECs. The preconditions can be specified in terms of one or more analogs. The inference component can be configured to determine the analog combinations according to predetermined rules, prior experimental results (e.g., as embodied in causal model), or the like. For example, a predetermined rule may specify that the analog combinations include analogs containing metric distributed units associated with a particular dimension (e.g., x distance, y distance, color, size, or the like). As an additional example, the inference component can determine based on an analysis of prior experimental results (e.g., using ANOVA, or the like, as described herein) that the expected reward for instructing the environment to take the action “move right” depends on whether the environment was in the state less-x(ball, paddle) or more-x(ball, paddle). As may be appreciated, moving the paddle away from the ball may be expected to decrease score, while moving the paddle towards the ball can be expected to increase score. As an additional example, when playing a modified version of the game of Breakout® that deducts points when 1) the ball contacts the paddle and 2) the ball and the paddle are different colors, the inference component can determine based on an analysis of prior experimental results that the combinations (less-x(ball, paddle), same-color(ball,paddle)), (more-x(ball, paddle), same-color(ball,paddle)), (less-x(ball, paddle), different-color(ball,paddle)), (more-x(ball, paddle), different-color(ball,paddle)) form four different combinations.

In some embodiments, the combinations can further be determined according to extraneous analog information learned by the inference component. As described above, the inference component can determine that certain analogs are extraneous. Such analogs can be disregarded when generating SRECs. For example, when playing a game of breakout in which color does not affect reward, the analogs same-color (ball, paddle) and different-color (ball, paddle) can be disregarded when performing clustering or otherwise generating SRECs (for example, such analogs may not be obtained in operation 1501).

FIG. 15C depicts a table including SRECs, in accordance with some embodiments of the disclosure. In this example, each combination of each dimension forms an SREC. Such a result may occur early in training, as the result of a predetermined rule, or when the inference component determines that a cluster corresponds to each combination of each dimension. As seen in the table, each SREC can include multiple actions and each action for each SREC can be associated with an estimated treatment effect (e.g., t_{1,2} or t_{18,3}, or the like). As may be appreciated, the combination preconditions and estimated treatment effects can constitute a portion of the causal model maintained by the inference component.

In operation 1520 of process 1500, the inference component can generate weight scores for SRECs, in accordance with some embodiments of the disclosure. The weight scores can be generated using prior experimental results. For example, as described herein with regards to FIGS. 8A to 10C and FIGS. 11A to 11C, the inference component can be configured to determine treatment effect estimates 1521 (such as those depicted in FIG. 15C) using result data obtained for prior experimental units. These treatment estimates can include point estimates and confidence intervals for reward values, or the like. In some embodiments, when an SREC includes one or more actions, the inference component can be configured to maintain an estimate of a treatment effect for each of the one or more actions. In some embodiments, when an SREC includes a null action, the inference component can be configured to maintain an estimate of a treatment effect for the SREC for taking the null action. In some embodiments, the weight scores can be generated using, at least in part, treatment effect estimates 1521. In some embodiments, the inference component can be configured to assign higher scores to SRECs based on an estimated distribution of the treatment effect, or a function thereof (e.g., a point or interval estimate of the treatment effect). For example, the inference component can be configured to assign higher scores to SRECs with more positive treatment effect estimates, more uncertainty in treatment effect estimates, or greater probabilities of positive treatment effect.

As an additional example, the inference component can be configured to determine predictive weights 1522 from the results of prior experimental units using a suitable statistical method. The predictive weights 1522 can reflect the probability that taking an action (or any action) when the environment is in a particular state affects a performance metric. Such a measure of predictive performance can be broader than a determined treatment effect. For example, an F-statistic, P-value, R-squared value, or similar statistical performance metric. In some embodiments, the weight scores can be generated using, at least in part, predictive weights 1522. In some embodiments, the inference component can be configured to assign higher weight scores to analogs having greater predictive weight.

As an additional example, inference component can be configured to determine salience data 1523 as described herein with regards to FIGS. 8A to 10C and 12A to 12C. Such salience data can include raw perceptual change or relational dynamicity. In some embodiments, the inference component can be configured to assign lower or zero weights to analogs involving relationships between static objects. In some embodiments, the inference component can be configured to assign higher weights to analogs involving relationships between more dynamic objects.

In operation 1530 of process 1500, the inference component can select a policy for the experimental unit, in accordance with some embodiments of the disclosure. In this example, selection of the policy can include selection of a set of SRECs for use in the experimental unit. The machine learning system can the set of SRECs based on one or more of predictive weights, salience data, and effect estimates. The machine learning system can select a predetermined number of SRECs or continue selecting SRECs until a selection condition is satisfied. As described herein, whether the inference component provides instructions to take actions in the environment (or perturb the components, operations, or parameters of the symbolic representation generator) can depend on whether environmental conditions during the experimental unit (e.g., as represented in the symbolic representation) match the preconditions of the SRECs.

In accordance with some embodiment of the disclosure, the selection of the SRECs can depend on the weight(s) associated with the SRECs. In some embodiments, the SRECs can be selected in a single step process. In such embodiments, a combined weight can be determined based on at least one of treatment effect estimates 1521, predictive weights 1522, or salience data 1523. As may be appreciated, the disclosed embodiments are not limited to a particular function for determining the combined weight. SRECs can then be deterministically (e.g., n-highest weighted) or probabilistically selected (e.g., using one or more of probability matching, Thompson sampling, upper confidence bounds-based techniques, softmax, or another suitable technique, or the like) based on the combined weight. The selected SRECs can be used during the experimental unit.

In some embodiments, the SRECs can be selected in a multi-step process. In such embodiments, the SRECs can be initially selected deterministically (e.g., n-highest weighted) or probabilistically (e.g., using one or more of probability matching, Thompson sampling, upper confidence bounds-based techniques, softmax, or another suitable technique, or the like) based on predictive weights 1522 or salience data 1523. For example, in some embodiments, the inference component can zero out or otherwise exclude SRECs from potential selection based on salience data 1523 (e.g., when salience data 1523 satisfies a condition, such as a threshold indicating a static object or relationship between static objects) or predictive weights 1522 (e.g., when predictive weights 1522 satisfies a condition, such as a threshold indicating insufficient predictive performance). The remaining SRECs can then be selected deterministically (e.g., n-highest weighted) or probabilistically selected (e.g., using one or more of probability matching, Thompson sampling, upper confidence bounds-based techniques, softmax, or another suitable technique, or the like) based on treatment effect estimates 1521. The selected SRECs can be used during the experimental unit.

In some embodiments, selection can be performed using only predictive weights 1522 or salience data 1523. For example, the inference component can exclude SRECs from selection deterministically or probabilistically based on salience data 1523, predictive weights 1522, or a combination or function thereof. The remaining SRECs can be included in the policy for the experimental unit.

FIG. 15D depicts a table including SRECs, weights, and a selection indicator for a subset of the SRECs depicted in FIG. 15C. In this example, SRECs are selected for use in the experimental unit with a probability based on the weight of the SREC. For example, an SREC with a weight of 0.44 has a higher chance of being selected than an SREC with a weight of 0.05. In this non-limiting example, selected SRECs indicated at “TRUE” while unselected SRECs are indicated as “FALSE.”

Upon completion of process 1500, the machine learning system can perform the experiment unit. In some embodiments, the inference component can match the SRECs included in the policy to analogs in the working memory during the experimental unit.

In this example, the machine learning system can obtain input from the environment (e.g., input 111, or the like). The machine learning system can generate a symbolic representation of the environment using a symbolic representation generator and the obtained input. The machine learning system can match the symbolic representation to SRECs in the policy for the experimental unit. In this example, the machine learning system can select one or more actions based on the matched SRECs. The machine learning system can provide output 113 to the environment. The output 113 can include instructions to perform the selected one or more actions in the environment. In some embodiments, when a selected action is a null action, no instructions may be provided (or instructions may be provided indicating that no action should be taken).

In some embodiments, once an SREC is matched and an action selected during an experimental unit, that action will be taken each time that SREC is matched during the remainder of the experimental unit. In some embodiments, the action can be reselected each time the SREC is matched during the experimental unit.

The results of the experimental unit can be used (in combination with the results of prior experimental units) to update the treatment effects for the matched SRECs. In some embodiments, the treatment effects for the selected and unselected actions can be updated based on the results of the experimental unit. In some embodiments, only treatment effects for selected actions can be updated based on the results of the experimental unit.

### Block Baseline Experimental Design

FIG. 16A depicts exemplary experimental design process 1600, in accordance with one or more aspects of this disclosure. In accordance with some embodiments of this disclosure, process 1600 can be a block design process, in which a set of policies are created according to an overall experimental design and assigned to a corresponding set of experimental units. These experimental units may be interleaved with other experimental units assigned to other experiments, as described herein. The experimental units can then be performed. Result data can be obtained during (or after) the performance of the experimental units. This result data can be analyzed, and the results of this analysis can affect subsequent experimental designs.

For convenience of description, process 1600 describes the allocation of treatments that are instructions to take an action in the environment. However, the disclosed embodiments are not so limited. In some embodiments, the experimental design can concern treatments that include, at least in part, perturbations of the operations, components, or parameters of the symbolic representation generator.

In accordance with some embodiments of this disclosure, process 1600 can be suitable for the design of baseline experiments. Treatments may be assigned to environmental states according to some predetermined frequency distribution or based on normative operational data. For convenience of disclosure, process 1600 is described herein with respect to actions, but treatments may include, without limitation perturbations of the operation, components, or parameters of the symbolic representation generator. As may be appreciated, process 1600 may be suitable for initializing the machine learning system, monitoring the continued performance of the machine learning system, or responding to changes in the causal relationships observed in the environment (e.g., as the result of rule changes in a game of Breakout© or the like).

FIG. 16A is described in combination with FIGS. 16B to 16E, which depict data structures associated with the experimental design and analysis. Process 1600 can be performed using the machine learning system of FIG. 1A, or another suitable machine learning system. For convenience of description, process 1600 is described as being performed by an inference component (e.g., inference component 120 or the like) of the machine learning system. However, the disclosed embodiments are not so limited. Process 1600 can be performed as a stand-alone process, or as part of another process (e.g., operation 1411 of process 1410 or operations 220 and 230 of process 200).

In operation 1601 of process 1600, the inference component can generate an initial design, in accordance with some embodiments of the disclosure. As described above with regards to process 1500, the initial design can be generated using analogs obtained from a symbolic representation generator (e.g., symbolic representation generator 110 or the like). The disclosed embodiments are not limited to any particular protocol for obtaining the analogs or format for the obtained analogs. In some embodiments, the inference component can obtain analogs stored in a memory network (e.g., memory network 310 or the like). In some embodiments, the inference component can obtain a subset of analogs stored in the memory network, which may depend on salience data or extraneous analog information.

In some embodiments, the initial design can include single-dimension-specific policies. As described herein, objects in the symbolic representation can be associated with distributed units that represent object attributes. These attributes can be grouped into dimensions (e.g., x position, y position, color, or the like). As may be appreciated, policies that explore combinations of attributes may quickly increase in complexity. Accordingly, in some embodiments, the initial policies can explore analogs involving a single dimension of object attributes. However, the disclosed embodiments are not so limited. With sufficient resources, or when the nature of the environment makes rapid experimentation possible, initial policies may explore combinations of object attributes.

In some embodiments, a policy for an attribute can cover a combination of environmental states (e.g., as represented in the symbolic representation) and treatments for that attribute. The environmental states and treatments may be predetermined or determined by the inference component based on the symbolic representation (e.g., during an initialization process as described herein, or the like). For example, the inference component can be configured to determine a set of analogs bound to distributed units of a particular dimension. The inference component can use these analogs in combination with a determined set of treatments to generate the policy. In some embodiments, the experimental design can include a number of repeats. The number of repeats can be specific to a combination of environmental state and treatment. In some embodiments, the number of repeats can be selected based on performance, resource, and statistical power requirements. In some embodiments, when a combination of environmental states and treatments is matched during an experimental unit, the number of repeats can be decremented.

FIG. 16B depicts an exemplary allocation table showing combinations of environmental states and treatments (actions in this example, though perturbations may be assigned similarly) for two attributes (x position and color). In this example, two environmental states are given for the X dimension (Left_of_X(ball, paddle) and Right_of_X(ball, paddle) and two other environmental states are given for the Y dimension (Same_Color(Ball, Paddle) and Different_Color(Ball, Paddle)). The given treatments can include three actions (move paddle left, move paddle right, or keep paddle in the same location). As shown in the allocation table, there are 12 possible combinations of attribute, environmental state, and treatment. In this example, there are 10 repeats specified for each combination of attribute, environmental state, and treatment.

In this example, hitting a brick with the ball provides a small reward (+3) when the ball and the brick are the same color. Hitting the ball with the paddle provides a large penalty (−7) when the ball and the brick are different colors. Missing the ball with the paddle provides a minor penalty when the ball is the same color (−1) and no penalty when the ball is a different color (0). As may be appreciated, moving the paddle towards the ball when the ball and the paddle are different colors can cause the ball and the paddle to touch, leading to the substantial penalty, while moving the paddle towards the ball when the ball and the paddle are the same color can cause the ball to bounce away and hit a brick, leading to a small reward.

In operation 1603 of process 1600, the inference component can assign policies to experimental units and obtain result data, in accordance with some embodiments of the disclosure. In some embodiments, the inference component can associate an attribute with an experimental unit. The inference combination can then select exclusive combinations of environmental states and treatments for the attribute. In some embodiments, when a repeat value for a combination of environmental states and treatments is zero, the inference component may not include that combination of environmental state and treatment in a policy. In accordance with some disclosed embodiments, when the environmental state during the assigned experimental unit matches an environmental state in the assigned policy, the inference component can be configured to provide instructions to take the corresponding action.

In accordance with disclosed embodiments, the environment may provide a reward signal during the experimental unit. Furthermore, additional environmental states may correlate with the environmental states included in the policy. The inference component can be configured to track the reward signal and the additional states associated with other attributes that correlate with the states included in the policy (e.g., observed correlates of the environmental states matched upon). In some embodiments, these additional states can be used to bootstrap identification of environmental states of causal significance.

FIG. 16C depicts the results of an experimental unit associated with the X position attribute. The policy associated with this experimental unit included two combinations of X position environmental state and treatment, as shown. When the environmental state during the experimental unit matched one of the environmental states in the assigned policy, the inference component provided instructions to perform the corresponding action. In this example, the ball hit a brick of the same color and the environment provided a reward of “3” during the experimental unit. The inference component also determined that the color environmental state Same_Color(Ball, Paddle) was correlated with the X position environmental state Left_Of_X(Ball, Paddle). In this example, the correlation was determined on basis of co-occurrence. Same_Color(Ball, Paddle) was the color environmental state most-commonly co-occurring with the X position environmental state Left_Of_X(Ball, Paddle). Similarly, Different_Color(Ball, Paddle) was the color environmental state most-commonly co-occurring with the X position environmental state Right_Of_X(Ball, Paddle). As may be appreciated, other techniques for determining correlation may also be used, without limitation.

FIG. 16D depicts the results of an experimental unit associated with the color attribute. The policy associated with this experimental unit included two combinations of color environmental state and treatment, as shown. When the environmental state during the experimental unit matched one of the environmental states in the assigned policy, the inference component provided instructions to perform the corresponding action. In this example, the ball missed the paddle when the ball and paddle were the same color, leading to a small penalty (−1), and the ball hit the paddle when the ball and paddle were the different colors, leading to a large penalty (−7). The total penalty the environment provided during the experimental unit was “−8”. The inference component also determined that the X position environmental state Left_Of_X(Ball, Paddle) was correlated with the color environmental state Same_Color(Ball, Paddle). As in FIG. 16C, this correlation was determined on basis of co-occurrence. Similarly, Right_Of_X(Ball, Paddle) was correlated with Different_Color(Ball, Paddle).

In some embodiments, the inference component can continue to assign policies to experimental units and obtain result data until a termination condition is satisfied. The termination condition can depend on at least one of the specified number(s) of repeats for each combination of environmental state and treatment. For example, the inference component can continue to assign policies to experimental units and obtain result data until each combination of environmental state and treatment in the experimental design has been matched (and the treatment performed) at least the specified number(s) of repeats. Additionally or alternatively, the termination condition can depend on the number of environmental units performed (e.g., less than some maximum number) or the duration of the experiment (e.g., less than some maximum duration). Additionally or alternatively, the termination condition can depend on a preliminary analysis of the result data. Should such a preliminary analysis show a significant difference in reward between combinations of environmental states and treatment, the termination condition may be satisfied.

In operation 1605 of process 1600, the inference component can analyze the results data obtained during performance of the experimental units, in accordance with some embodiments of the disclosure. The inference component can be configured to perform a statistical analysis of the results data. In accordance with some embodiments of the disclosure, the statistical analysis can be configured to treat each experimental unit as one or more observations. For example, an observation can be created for each combination of matched environmental state and treatment. In some embodiments, an observation associated with a matched environmental state and treatment can be associated with rewards received during the experimental unit. As may be appreciated, this allocation of rewards may, over a suitable number of trials, indicate associations between combinations of matched environmental states, treatments, and rewards.

In some embodiments, a combination of matched environmental state and treatment can be associated with a function of rewards received during the experimental unit and after the treatment is applied (e.g., after the treatment is applied the first time during the experimental unit). The function can be a maximum, an average, a sum, a weighted sum, or another suitable function. In some embodiments, when the function is a weighted sum, the weights can depend on a temporal or spatial distance between when the treatment is applied and when a reward was obtained. The shorter the time after the treatment was applied, the greater the weight.

As described herein, the inference component can be configured to identify additional states associated with other attributes that correlate with the states included in the policy. In some embodiments, an observation can include the additional states correlated with the states included in the policy. When performing the statistical analysis of the experiment, the inference component can treat these additional states as factors in determining the relationship between environmental states, treatments, and rewards. For example, the inference component may generate two observations from the experimental unit having the results depicted in FIG. 16C. One observation can include as factors the precondition (representing the environmental state) of “Left_Of_X(Ball, Paddle)”, the action of “Move Paddle Left”, and the associated analog (representing the additional environmental states) of “Same_Color(Ball, Paddle)”. This first observation can be associated with the reward “3” obtained during the experimental unit. The second observation can include as factors the precondition (representing the environmental state) of “Right_Of_X(Ball, Paddle),” the action of “Paddle Same,” and the associated analog (representing the additional environmental states) of “Different_Color(Ball, Paddle).” This second observation can also be associated with the same reward “3” obtained during the experimental unit.

The inference component can perform a suitable statistical analysis of the observation data collected during the experiment. In some embodiments, the statistical analysis can be an analysis of variance (e.g., a fixed-effects, random-effects, mixed-effects, or another suitable analysis of variance design). In some embodiments, the statistical analysis can be a regression, nonparametric, or generalized linear model. For each observation, the environmental states can be treated as levels of the corresponding object attributes (e.g., the X dimension attributed can be treated as having two levels: Right_Of_X(Ball, Paddle) and Left_Of_X(Ball, Paddle)). The actions can be treated as levels of the treatment (e.g., the treatment can be treated as having three levels: Paddle Same, Move Paddle Left, and Move Paddle Right). In some embodiments, the inference component can include additional observation data collected in prior experiments (and, for example, within an experimental window, as described herein).

In some embodiments, the statistical analysis can be performed with progressively more inclusive statistical models. For example, in an initial analysis, the response can be assumed to depend on main effects of the environmental variables and the treatment. Statistical tests can be used to determine whether any main effects are significant. In a second analysis, the response can be assumed to depend on main effects and first-order interactions of the environmental variables and the treatment. Statistical tests can be used to determine whether any of the main effects or interactions are significant. In a third analysis, the response can be assumed to depend on main effects, first-order interactions, and second-order interactions of the environmental variables and the treatment. Statistical tests can be used to determine whether any of the main effects or first- or second-order interactions are significant. As described above, in this example the third order interactions can be significant.

As may be appreciated, the disclosed embodiments are not limited to performing statistical analyses using progressively more inclusive statistical models. In some embodiments, multiple analysis using statistical models that include different combinations of effects and interactions. However, one such model need not include all the effects and interactions assumed in another model. Instead, for example, a first model may include some interactions absent from a second model, while the second model includes interactions absent from the first model. In some embodiments, a single model (including all interactions or certain predetermined interactions) may be analyzed.

As depicted in FIG. 16E, the inference component can identify groupings of analogs based on the results of the statistical analysis. For example, the inference component can generate a table of marginal means. The inference component can perform suitable statistical tests to identify environmental variables or combinations thereof for which different actions have significantly different means. For example, the inference component can identify Left_Of_X(Ball, Paddle) and Different_Color(Ball, Paddle) as such a grouping. As an additional example, the inference component can identify Right_Of_X(Ball, Paddle) and Same_Color(Ball, Paddle) as such a grouping.

In accordance with some embodiments, of the disclosure, the inference component may determine performance metric values based on the results of the statistical analysis. For example, for each identified environmental variable or combination thereof, the inference component may determine a D-score. In this example, the D-score may be the expected reward for taking an action when the identified environmental state is present, minus the result of not taking the action when the identified environmental state is present.

In operation 1607 of process 1600, the inference component can build an augmented design, in accordance with some embodiments of the disclosure. In some embodiments, in creating the augmented experimental design, the inference component can treat combinations of environmental variables identified in operations 1605 as representing particular environmental states. For example, the inference component can treat the combination of Right_Of_X(Ball, Paddle) and Same_Color(Ball, Paddle) as representing a particular environmental state. Future experimental designs can then investigate the effect of taking a particular action (e.g., Move Paddle Left versus Move Paddle Right) when the environment is in that particular state. In some embodiments, in creating the augmented experimental design, the inference component can disregard combinations of environmental variables for which different actions lack significantly different means.

In accordance with some embodiments of the disclosure, the augmented experimental design can be any suitable type. For example, the augmented experimental design can be a baseline design, an explore/exploit hybrid design, or the like. For example, the augmented experimental design can, in an explore/exploit hybrid experiment, allocate experimental units to combinations of environmental state (e.g., as represented by the identified combinations of analogs) and actions based on the expected rewards (or performance metric values, such as D-scores) associated with such combinations. As an additional example, the augmented experimental design can, in a baseline experiment, allocate experimental units to combinations of environmental state (e.g., as represented by the identified combinations of analogs) and actions according to a predetermined distribution (e.g., equally or with equal probability). Furthermore, the augmented experimental design can be an incremental design or a block design.

### Block Explore/Exploit Experimental Design

FIG. 17A depicts exemplary experimental design process 1700, in accordance with one or more aspects of this disclosure. In accordance with some embodiments of this disclosure, process 1700 can be a block design process, in which a set of policies are created according to an overall experimental design and assigned to a corresponding set of experimental units. These experimental units may be interleaved with other experimental units assigned to other experiments, as described herein. The experimental units can then be performed. Result data can be obtained during (or after) the performance of the experimental units. This result data can be analyzed, and the results of this analysis can affect subsequent experimental designs.

For convenience of description, process 1700 describes the allocation of treatments that are instructions to take an action in the environment. However, the disclosed embodiments are not so limited. In some embodiments, the experimental design can concern treatments that include, at least in part, perturbations of the operations, components, or parameters of the symbolic representation generator.

In accordance with some embodiments of this disclosure, process 1700 can be suitable for the design of explore/exploit experiments. Treatments may be assigned to environmental states according to a causal model. For convenience of disclosure, process 1700 is described herein with respect to actions, but treatments may include, without limitation perturbations of the operation, components, or parameters of the symbolic representation generator. As an example of treatment assignment, an action may be assigned to an environmental state (e.g., represented by a set of analogs being present in the working memory of a memory network, in accordance with some embodiments of the disclosure) based on an estimated reward for taking that action in that environmental state, as stored in the causal model. The assignment of treatments can depend on point or interval estimates stored in the causal model. For example, among multiple treatments available in an environmental state, the treatment having the highest estimate reward may be assigned to that environmental state. As an additional example, the treatment with the widest confidence interval may be assigned, or the treatment that maximizes an increase in mutual information, or the like. As depicted in this example, the assignment of actions to environmental states can be probabilistic. However, this depiction is not intended to be limiting, and the assignment may additionally or alternatively be deterministic.

The experimental design process of FIG. 17A is described in combination with FIGS. 17B and 17C. Application of the experimental design depicted in FIG. 17C to an experimental unit is depicted in FIGS. 29A and 29B, in accordance with some disclosed embodiments. Process 1700 can be performed using the machine learning system of FIG. 1A, or another suitable machine learning system. For convenience of description, process 1700 is described as being performed by an inference component (e.g., inference component 120 or the like) of the machine learning system. However, the disclosed embodiments are not so limited. Process 1700 can be performed as a stand-alone process, or as part of another process (e.g., operation 1411 of process 1410 or operations 220 and 230 of process 200).

In operation 1710 of process 1700, the inference component can select an analog grouping, in accordance with some embodiments of the disclosure. As described above with regards to process 1500, process 1700 can be performed using analogs obtained from a symbolic representation generator (e.g., symbolic representation generator 110 or the like). The disclosed embodiments are not limited to any particular protocol for obtaining the analogs or format for the obtained analogs. In some embodiments, the inference component can obtain analogs stored in a memory network (e.g., memory network 310 or the like). In some embodiments, the inference component can obtain a subset of analogs stored in the memory network, which may depend on salience data or extraneous analog information.

The inference component can select the analog grouping from a set of analog groups. As may be appreciated, the analog group may be a representation of an environmental state. In some instances, at least some of the analog groups may correspond to a single analog. For example, an analog group may correspond to the analog Right_of_X(ball, paddle). In some instances, at least some of the analog groups may correspond to a combination of analogs. For example, an analog group may correspond to the combination of the analog Right_of_X(ball, paddle) and the analog Same_Color(ball, paddle).

In accordance with some embodiments of the disclosure, the set of analog groups may be predetermined, or at least partially learned through prior experimentation. For example, the set of analog groups may include default analog groups, or analogs groups corresponding to analog(s) in a set of analogs used to initialize the symbolic representation generator. As an additional example, the set of analogs groups may include analogs learned through experimentation using any of the experimental design processes described herein. For example, the inference component can perform process 1600 to determine analog groups having statistically significant differences in means between actions. The inference component can then use these determined analog groups in the performance of process 1700. In this manner, information about the environment obtained through baseline experimental design process 1600 can influence explore/exploit experimental design process 1700.

In accordance with some disclosed embodiments, the inference component can select an analog grouping deterministically or at least partially randomly. For example, given a list of analog groups in a causal model, the inference component can select the first analog group (or next remaining analog group, when other analog groups were previously selected). As an additional example, the inference component can randomly select analogs groups without replacement from the list of analog groups.

In operation 1720 of process 1700, the inference component can generate an action distribution based on result data, in accordance with some embodiments of the disclosure. In accordance with some disclosed embodiments, the machine learning system can provide instructions to take an action when the analog group is observed in the symbolic representation generator (e.g., in the working memory of the memory network). The action distribution can specify a relative frequency for selecting different actions when the analog group is observed. The result data can include performance metric values (e.g., task performance, rewards, or another suitable performance metric). The result data can include data obtained in prior experimental units. The prior experimental units can include experiment units in which the environmental state corresponding to the selected analog group was observed (e.g., the working memory of the symbolic representation generator included the analog(s) corresponding to the analog group, or the like). The prior experimental units can include experimental units in which the inference component provided instructions to take action in the environment based on the observation of the environmental state corresponding to the selected analog group. The result data can indicate the action taken. In some embodiments, the prior experimental units can include experimental units limited to those within an experimental window, as described herein.

In accordance with some embodiments of the disclosure, the inference component can generate an action distribution through a Monte Carlo simulation process. First, the inference component can estimate performance value distributions for each action. Second, for each action, the inference component can estimate a likelihood that providing instructions to take that action would yield the greatest performance value over all potential actions. The action distribution can then be or depend upon the likelihoods for the actions.

The inference component can estimate performance value distributions for an action using performance metric values obtained in experimental units in which the machine learning system instructed the environment to take that action. For example, the inference component can select experimental units in which the machine learning system instructed the environment to take the action “Move Paddle Right.” The inference component can estimate a performance value distribution for the action “Move Paddle Right” using performance metric values for the selected experimental units. The disclosed embodiments are not limited to any particular method for estimating the distributions based on the performance metric values. Any suitable parametric or non-parametric method for estimate the distributions may be used.

FIG. 17B depicts exemplary estimated D-score distributions for the analog group Right_of_X(Ball, Paddle), in accordance with some embodiments of the disclosure. In this example, three actions (Move Left, No Move, Move Right) are possible. The inference component can generate the D-score distribution for an action based on D-score values for prior environmental units in which instructions to take that action were provided. In this example, the D-score distributions are best fit normal distributions, but the disclosure is not limited to such distributions.

The inference component can estimate the likelihood that providing instructions to take an action would yield the greatest performance value over all potential actions using the estimate performance value distributions. The inference component can generate observations by resampling the distributions. The number of observations can be selected to balance resource requirements and the desired precision of the action distribution. For example, the inference component can generate 1e2, 1e3, 1e4, 1e5, 1e6, or more observations. Each observation can include a performance value for each action, drawn from the estimated distribution for that action. The inference component can determine which action yielded the greatest performance value for each observation. The likelihood for each action can be the proportion of observations in which the action yielded the greatest performance value. Thus, this likelihood can be generated through Monte Carlo simulations based on results data.

In accordance with some embodiments of the disclosure, the action distribution can include a set of action instances. Each action instance can specify a corresponding action. The proportion of action instances in the set that specify a particular action can approximate the likelihood value for that action. In some embodiments, the set of action instances can be generated by multiplying the likelihoods by a scaling factor chosen such that the product of the lowest-valued likelihood and the scaling factor is approximately 1. For each action, the product of the scaling factor and the likelihood for that action can be rounded to the nearest counting number. This counting number can be the number of action instances specifying the action and included in the set of action instances. In some embodiments, the lowest-valued likelihood can be replaced by a minimum likelihood prior to scaling (e.g., a 10%, 5%, 1% or other suitable minimum likelihood).

The disclosed embodiments are not limited to action distributions including sets of action instances. In accordance with some embodiments of the disclosure, the action distribution can be a selection function. The selection function can be, or be based upon, the likelihood values. For example, the selection function can set the selection probability for an action as the maximum of some minimum likelihood and the likelihood value for that action. The selection probabilities for the remaining actions can be adjusted accordingly.

FIG. 17C depicts an exemplary table showing three action distributions including three set of action instances, in accordance with some embodiments of the disclosure. The table shows action distributions for analogs associated with the X-dimension. The top row of the table shows the action distribution for the analog group Left_Of_X(Ball, Paddle). The middle row of the table shows the action distribution for the analog group Same_X(Ball, Paddle). The bottom row of the table shows the action distribution for the analog group Right_Of_X(Ball, Paddle). Each row shows the action instances specifying each action. The bottom row shows one action instance specifying the action Move Left, one action instance specifying the action No Move, and two action instances specifying the action Move Right. In contrast, the top row shows three action instances specifying the action Move Left, one action instance specifying the action No Move, and two action instances specifying the action Move Right. During an experimental unit, when the environmental state matches one of the analog groups, the corresponding set of action instances can be sampled without replacement. Thus, the overall frequency of actions will match the likelihoods determined from the estimated probability distributions.

In operation 1725 of process 1700, the inference component can determine whether there exist additional analog groupings for which action distributions have not been generated, in accordance with some embodiments of the disclosure. If so, process 1700 can return to step 1710 and another analog grouping can be selected. If not, process 1700 can continue to step 1730.

In operation 1730 of process 1700, the inference component can assign actions during an experiment using the action distributions generated in operation 1720, in accordance with some embodiments of the disclosure. The inference component can determine that an environmental state (e.g., as represented by analogs in the symbolic representation, or the like) observed during an experimental unit matches an analog grouping. In response to this determination, the inference component can assign an action using the action distribution corresponding to the matched analog grouping.

In accordance with some embodiments of the disclosure, when the action distribution includes a set of action instances, the inference component can assign an action by selecting an action instance from the set of action instances. In some embodiments, the inference component can select the action instance without replacement from the set of action instances. In some embodiments, the inference component can select the action instance with replacement. The inference component can then provide instructions to perform the action specified by the selected action instance. Should the environmental state subsequently re-match the analog group during the experimental unit, the inference component can, in various embodiments, provide instructions to perform the same action, or re-select one of the remaining action instances without replacement and provide instructions accordingly.

In accordance with some embodiments of the disclosure, when the action distribution includes a selection function, the inference component can assign an action by selecting the action according to the selection function (e.g., the selection function may afford a first and second actions a 30% chance of selection, and a third action a 40% chance of selection). The inference component can then provide instructions to perform the action specified by the selected action instance. Should the environmental state subsequently re-match the analog group during the experimental unit, the inference component can, in various embodiments, provide instructions to perform the same action, or re-select an action according to the selection function and provide instructions accordingly.

In some embodiments, the inference component can continue performing experimental units until a condition has been satisfied. The condition can depend on at least one of duration, number of experimental units performed, change in effect estimates resulting from experimentation, or exhaustion of selectable action instances (e.g., all action instances for an action distribution have been selected). In some embodiments, when the condition depends on exhaustion of selectable action instances, the inference component can continue performing experimental units until at least one action distribution (or in some embodiments, all action distributions) has been exhausted. In some embodiments, when the experimental continues until multiple (or all) action distributions have been exhausted, the set of action instances for an exhausted action distribution can be reset. The inference component can then subsequently select actions instances from this reset action distribution.

In operation 1740 of process 1700, the inference component can process result data obtained during the performance of the experiment, in accordance with some embodiments of the disclosure. In some instances, the result data can include performance metric values. The inference component can attribute such performance metric values to combinations of analog groups and actions. For example, the inference component can attribute a performance metric value to a combination of analog group and action when the inference component provides instructions to take the action in the environment in response to an environmental state observed during the environment unit matching the analog group. Accordingly, as experimental units are performed, performance metric values can be attributed to combinations of combination of analog groups and actions. In some embodiments, the inference component can update the stored result data used to generate action distributions using the result data obtained during performance of the experimental units. In some embodiments, updating the stored result data can include discarding result data falling outside an experimental window, as described herein.

In some embodiments, the inference component can update effect estimates based on the acquired result data. For example, the inference component can perform a statistical analysis on the acquired result data (and optional on previously acquired result data). The statistical analysis can evaluate the significance of analog(s) and actions on the obtained performance metric values (e.g., similar to the statistical analysis described herein with respect to operation 1605 of process 1600). In some instances, the inference component can update the analog groups based on the results of the statistical analysis (e.g., similar to the construction of the augmented design described herein with respect to operation 1607 of process 1600).

After obtaining the result data (and in some embodiments updating effect estimates and/or analog groupings), process 1700 can return to step 1710. The inference component can re-select an analog group and generate, in operation 1720, an updated action distribution for that analog group based on the updated results data.

In some embodiments, the experiment can include counterfactual experimental units. For example, when the inference component selects an action using an action distribution in an experimental unit, the inference component may specify counterfactual experimental unit in which the action cannot be selected. For example, if the analog group Right_Of_X(Ball, Paddle) is matched during an experimental unit and the action Move Left selected, the inference component may specify that in the next experimental unit, if the analog group Right_Of_X(Ball, Paddle) is matched then the action Move Left cannot be selected. The results of the first experimental unit and the counterfactual experimental unit can be used to generate a d-score, as described herein.

In some embodiments, the experiment can include generating d-scores for actions using differences between performance metric values obtained in the experiment. The d-scores can be generated using a difference of means (e.g., for experimental units in which the action was matched, take the difference of the mean for all experimental units in which a particular action was taken and the mean of all experimental units in which that particular action was not taken) or mean of differences (e.g., for experimental units in which the action was matched, take the mean of differences between paired experimental units, one unit in the pair being an experimental unit in which the particular action was taken and one unit in the pair being an experimental unit in which the particular action was not taken). The d-scores can then be statistically analyzed as described herein and used to inform the design of subsequent experiments.

### Block Paired D-Score Design

FIG. 18A depicts exemplary experimental design process 1800, in accordance with one or more aspects of this disclosure. In accordance with some embodiments of this disclosure, process 1800 can be a block design process, in which a set of policies are created according to an overall experimental design and assigned to a corresponding set of experimental units. These experimental units may be interleaved with other experimental units assigned to other experiments, as described herein. The experimental units can then be performed. Result data can be obtained during (or after) the performance of the experimental units. This result data can be analyzed, and the results of this analysis can affect subsequent experimental designs.

For convenience of description, process 1800 describes the allocation of treatments that are instructions to take an action in the environment. However, the disclosed embodiments are not so limited. In some embodiments, the experimental design can concern treatments that include, at least in part, perturbations of the operations, components, or parameters of the symbolic representation generator.

In accordance with some embodiments of this disclosure, process 1800 can be suitable for the design of baseline experiments. Treatments may be assigned to environmental units to satisfy counterfactual experimentation requirements. For convenience of disclosure, process 1800 is described herein with respect to actions, but treatments may include, without limitation perturbations of the operation, components, or parameters of the symbolic representation generator.

The experimental design process of FIG. 18A is described in combination with FIG. 18B. Process 1800 can be performed using the machine learning system of FIG. 1A, or another suitable machine learning system. For convenience of description, process 1800 is described as being performed by an inference component (e.g., inference component 120 or the like) of the machine learning system. However, the disclosed embodiments are not so limited. Process 1800 can be performed as a stand-alone process, or as part of another process (e.g., operation 1411 of process 1410 or operations 220 and 230 of process 200).

In operation 1810 of process 1800, the inference component can select an analog grouping, in accordance with some embodiments of the disclosure. As described above with regards to process 1500, process 1800 can be performed using analogs obtained from a symbolic representation generator (e.g., symbolic representation generator 110 or the like). The disclosed embodiments are not limited to any particular protocol for obtaining the analogs or format for the obtained analogs. In some embodiments, the inference component can obtain analogs stored in a memory network (e.g., memory network 310 or the like). In some embodiments, the inference component can obtain a subset of analogs stored in the memory network, which may depend on salience data or extraneous analog information.

As described above with regards to process 1700, the inference component can select the analog grouping from a set of analog groups. As may be appreciated, the analog group may be a representation of an environmental state and may correspond to one or more analogs. In accordance with some embodiments of the disclosure, the set of analog groups may be predetermined, or at least partially learned through prior experimentation. In this manner, information about the environment obtained through prior experimentation can influence baseline experimental design process 1800. In accordance with some disclosed embodiments, the inference component can select an analog grouping deterministically or at least partially randomly.

In operation 1820 of process 1800, the inference component can determine a number of experimental units, in accordance with some embodiments of the disclosure. In some embodiments, the number of experimental units can be greater than or equal to the number of actions being assigned in the experiment.

In operations 1830 of process 1800, the inference component can select an action for assignment to experimental units. The disclosed embodiments are not limited to a particular method for selecting the action. For example, the action can be selected deterministically (e.g., next action on a list of actions) or randomly (e.g., through selecting an action from a set of actions without replacement).

In operations 1840 of process 1800, the inference component can assign levels for the selected action to available experimental units. The levels can include “on,” in which the policy for the experimental unit specifies provision of instructions to apply the action when the environmental state matches the analog group during the experimental unit. The levels can include “off,” in which the policy for the experimental unit specifies provision of instructions to apply a different action when the environmental state matches the analog group during the experimental unit. The levels can include “-,” in which the policy for the experimental unit is controlled by the requirements for other actions. For example, given two actions and an experimental unit in which the first action level is “-” and the second action level is “off,” the policy can specify provision of instructions to apply the first action when the environmental state matches the analog group during the experimental unit.

As may be appreciated, the inference component can be configured to determine experimental units for which assignment of a particular level is possible. For example, the levels for two mutually exclusive actions (e.g., Move Left and Move Right, or the like) cannot both be “on” for the same experimental unit. Instead, both may be “off” or “-,” or one may be “on” and the other either “off” or “-.” Similarly, an experimental unit assigned to a level cannot be reassigned to another level. In some embodiments, the inference component can select one of the possible experimental units for the “on” level and then select another experimental unit for the “off” level.

In accordance with some disclosed embodiments, the inference component can generate multiple blocks of experimental units in operations 1820 to 1840. Each block can include a number of experimental units greater than or equal to the number of actions being assigned in the experiment. The inference component may be configured to assign actions to experimental units within the blocks according to a design that attempts to control order effects or minimize confounding variables. For example, the inference component may be configured to assign actions to experimental units within the blocks according to a counterbalanced design, such as a full or partial Latin Square design.

In operations 1850 of process 1800, the inference component can determine whether there are additional actions to assign, in accordance with some embodiments of the disclosure. If so, process 1800 can return to operation 1830 and select another action. Otherwise, process 1800 can proceed to operation 1860.

FIG. 18B depicts an assignment of two levels for each of three actions for the analog group (Left_Of_Ball(Ball, Paddle), Same_Color(Ball, Paddle)). In this example, the inference component selects three experimental units for each of three blocks of experimental units. The inference component selects the first action (Move Paddle Right) and assigns the “off” level to the first experimental unit and the “on” level to the second experimental unit. The inference component selects the second action (Paddle Stay) and assigns the “on” level to the first experimental unit and the “off” level to the third experimental unit. The inference component selects the third action (Move Paddle Left) and assigns the “on” level to the third experimental unit and the “off” level to the third experimental unit. The inference component can make similar assignments in the remaining blocks to complete a counterbalanced experimental design.

In operations 1860 of process 1800, the inference component can provide instructions to take actions during the experiment according to the assigned levels, in accordance with some embodiments of the disclosure. For an experimental unit assigned the level “on” for an action, the policy for the experimental unit can specify that instructions to perform the action be provided to the environment when an observed state of the environment matches the analog group. Likewise, for an experimental unit assigned the level “off” for an action, the policy for the experimental unit can specify that instructions to perform a different action be provided to the environment when an observed state of the environment matches the analog group.

In operations 1870 of process 1800, the inference component can process result data obtained during the performance of the experiment, in accordance with some embodiments of the disclosure. In some instances, the result data can include performance metric values. Processing the result data can include generating d-scores by subtracting performance metric values for experimental units assigned “off” from performance metric values for experimental units assigned “on.” In some embodiments, additional d-scores can be generated using performance metric values for experimental units assign “-” in which performance of the action was instructed and performance metric values for experimental units assign “-” in which performance of the action was not instructed.

In some embodiments, the inference component can perform a statistical analysis on the generated d-scores (and optional on previously generated d-scores). The statistical analysis can evaluate the significance of analog(s) and actions on the obtained performance metric values (e.g., similar to the statistical analysis described herein with respect to operation 1605 of process 1600). In some instances, the inference component can update the analog groups based on the results of the statistical analysis (e.g., similar to the construction of the augmented design described herein with respect to operation 1607 of process 1600).

After obtaining the result data (and in some embodiments updating effect estimates and/or analog groupings), process 1800 can return to step 1810. The inference component can re-select an analog group and assign, in operations 1820 to 1850, levels of actions for that analog group to experimental units.

In accordance with some embodiments of the disclosure, the inference component can run multiple instances of process 1800 in parallel. For example, the inference component can select multiple analog groups. In some embodiments, the inference component may select analog groups assumed (e.g., based on prior experimentation, or the like) to be mutually exclusive. For example, based on prior experimentation, the inference component may assume that either one analog group or the other analog group, but not both, would match during an experimental unit. Alternatively, the inference component may only provide treatments during that experimental unit based on the first-matched of the multiple analog groups. In this manner, the inference component can assign policies for multiple different analog groups to the same experimental unit. As may be appreciated, such assignment may increase the likelihood that one of the analog groups is matched during the experimental unit. In some embodiments, the experimental unit can count towards the experimental design for the matched analog group. The experimental unit may not count towards the experimental designs for the unmatched analog groups. Instead, the policies originally assigned to the current experimental unit can be deferred to the next experimental unit. In this manner, the inference component can collect experimental data for multiple experiments concerning different analog groups as that experimental data becomes available (e.g., as analog groups are matched), speeding experimentation.

### Incremental Reward and Selection Based-Design

In some embodiments, inference component 120 can select SREC actions according to the results of prior experiments and the number of prior selections of the SREC action. For example:

$${Q}_{t} ( a ) = \frac{{R}_{t} ( a )}{{N}_{t} ( a )}$$

In this example, Rₜ(a) can be the sum of the rewards when action (a) was taken in experimental units prior to time (t) for the SREC and Nₜ(a) can be the number of times action (a) was taken in experimental units prior to time (t) for the SREC. Accordingly, Qₜ(a) can approximate the expected reward at time (t) of taking the action (a) in the next experimental unit when the SREC is matched. Furthermore,

$${V}_{t}^{2} ( a ) = {\sum }_{i} \frac{{( {R}_{i} ( a ) - {Q}_{t} ( a ) )}^{2}}{{N}_{t} ( a ) - 1}$$

In this example, Vₜ(a) can be the variance in the rewards when action (a) was taken in experimental units prior to time (t). In such embodiments, in explore/exploit trials, actions can be selected according to the following:

$${p}_{t} ( a ) = f ( {Q}_{t} ( a ) , {V}_{t} ( a ) , {Q}_{t} ( j \neq a ) , {V}_{t} ( j \neq a ) )$$

In this example, Pₜ(a) can be the probability of selecting action (a) at time t, which can depend on the expected value and variance of rewards for selecting action (a) at time t (e.g., the upper confidence interval value). Pₜ(a) can further depend on the expected values and variances of rewards for selecting other actions at time t (e.g., action (j) not equal to action (a)). For example, in some embodiments, Pₜ(a) can be probability matching.

In some embodiments, Pₜ(a) can depend only on the expected values of the rewards for selecting actions at time t. For example, in some embodiments, Pₜ(a) can be a softmax function.

In some embodiments, inference component 120 can select SREC actions according to the results of prior experiments and the number of assignments of a specific SREC to prior experimental units as of time t (e.g., Mₜ(a)). In some embodiments, in explore/exploit trials, actions can be selected according to the following:

$${A}_{t} = {arg max}_{a} ( {Q}_{t} ( a ) + c \cdot f ( t , {M}_{t} ( a ) ) )$$

where ƒ(t, Mₜ(a)) is an increasing function of time (t) and a decreasing function of Mₜ(a). In this example, c can be a hyperparameter chosen to balance exploration and exploitation over time. Accordingly, in this example, actions can be selected to maintain an appropriate balance of exploration and exploitation over time. In some embodiments, the above formulas can be used with a d-score (e.g., [symbol] E(R [symbol] ₜ(a))− [symbol] E(R [symbol] ₜ(j≠a))) in place of Rₜ(a).

As may be appreciated, other suitable approaches may be used (e.g., deterministic or probabilistic, arithmetic or statistical or machine-learning, or the like) for selecting actions based on previous empirical results of taking such actions (or other actions). As a non-limiting example, approaches for selecting actions based on previous empirical results, as disclosed in U.S. Pat. Nos. 11,853,018, 11,927,926, and 11,966,204 and incorporated herein by reference, may be used.

### Exemplary Reward-Based Learning Using Causal Analogs

FIGS. 19A to 27D depicts processes for performing reward-based learning, in accordance with one or more aspects of this disclosure. In these depicted processes, a machine learning system can implement a causal model using the symbolic representation generator. The symbolic representation generator can represent the causal model using causal relationship analogs (also referred to herein as “explanations”). Through the processes depicted in FIGS. 19A to 27D, such analogs can represent causal relationships varying from mere associations to empirically validated cause and effect relationships. In some embodiments, the analogs can represent estimated treatment effect distributions, or functions thereof (e.g., a point or interval estimate of the treatment effect) using metadata associated with localist units or connections between units (e.g., between localist units or between localist units and distributed units). In such embodiments, the inference component of the machine learning model may continue to determine experimental unit lengths (and may continue to take actions based on retrieved analogs). In some embodiments, the inference component can determine which analogs present in the working memory of the symbolic representation generator are used in selecting and matching SRECs. For example, the inference component can omit analogs present in the working memory from accumulation during an experimental unit based on predictive weights or salience data associated with the analogs. However, the selection of SRECs and matching of SRECs during an experimental unit can be integrated at least in part into the symbolic representation generator.

As may be appreciated, embodiments of the machine learning system that integrate the causal model into the memory network may require less memory or storage than embodiments that implement the causal model using separate data structures.

As described herein, the machine learning system can be configured to implement interaction and observational reward-based learning. FIGS. 19A to 23B depict a process 1900 for performing reward-based observational learning, in accordance with one or more aspects of this disclosure. Process 1900 can be performed using the machine learning system of FIG. 1A, or another suitable machine learning system. Process 1900 can be performed across multiple experimental units, in accordance with some embodiments of the disclosure. For example, operations 1910 and 1920 can be performed in one experimental unit, with operation 1930 performed over several subsequent experimental units.

In some embodiments, analogs accumulated in the course of performing process 1900 can be stored by one or more components of the machine learning system in a memory or storage device accessible to the machine learning system (e.g., a local storage device or a storage device accessible over a network). In some embodiments, the accumulated analogs can be retained in memory network 310 (e.g., in the working memory of memory network 310). In some embodiments, the accumulated analogs can be retained in a memory or storage device accessible to the inference component.

As may be appreciated, analogs can be generated or retrieved into the memory network with each frame of input data from the environment. In operation 1910 of process 1900, the machine learning system (e.g., the inference component, the symbolic representation generator, or the like) can accumulate such analogs in or from working memory as they are generated or retrieved. In some embodiments, the symbolic representation generator (or the inference component) can accumulate the analogs subject to one or more conditions. In some embodiments, the conditions can involve whether the analogs are non-extraneous, salience data concerning the analogs, and predictive weights associated with the analogs. The conditions can be deterministic (e.g., categorizations or labels, thresholds, rankings, or the like) or probabilistic (e.g., probability matching, Thompson sampling, softmax, or another mapping to selection probabilities suitable for selecting analogs). For example, analogs categorized as non-extraneous or non-static can be probabilistically selected for accumulation based on predictive weights.

FIGS. 19B and 19C provide two equivalent depictions of an analog, in accordance with one or more aspects of this disclosure. The analog may be one copied in accordance with process 1900. As depicted in FIG. 19B, the two analogs can include ones of distributed units 313 connected to element units (e.g., element unit 1965). The element units can in turn be connected to role-binding units (e.g., role binding unit 1963). The role binding units can be connected to proposition units (e.g., proposition unit 1961). As may be appreciated, in some instances, the proposition units may serve as element units for other proposition units. FIG. 19C depicts an equivalent depiction in which the set of connected-to distributed units for each element unit is represented by a single graphical element (e.g., distributed unit set 1970). As may be appreciated, the sets of connected-to distributed units represented by these graphical elements may be overlapping. A single unit represents each role binding unit and the element units connected to that role binding unit (e.g., role binding and element units 1966). In this manner, the depiction of each analog is simplified.

In operation 1920 of process 1900, the machine learning system (e.g., the inference component, the symbolic representation generator, or the like) can determine an observed treatment and an observed outcome. In some embodiments, the machine learning system can determine the observed treatment and the observed outcome based on a mapping between analogs and rewards (e.g., determined in operation 1405 of process 1400). The observed treatment can include analogs not mapped to rewards. For example, the observed treatment can include analogs mapped to actions or environmental relationships (e.g., non-reward relationships uncontrolled by the machine learning system, or the like). As may be appreciated, the analogs mapped to actions need not represent actions caused by the machine learning system. Instead, the machine learning system can observe the consequences of actions taken by another. The machine learning system can observe such consequences during an initialization process (e.g., operation 1401 of process 1400, or the like).

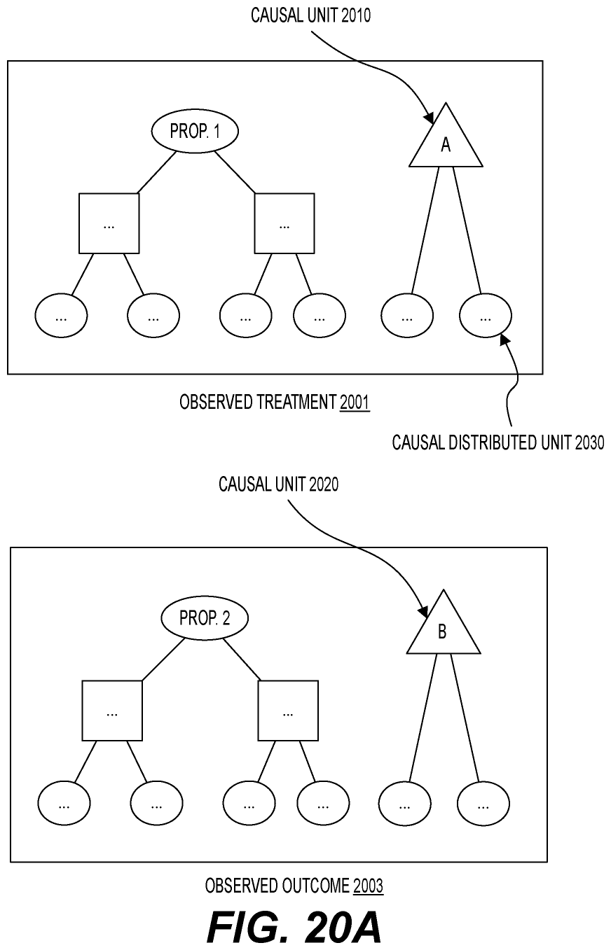

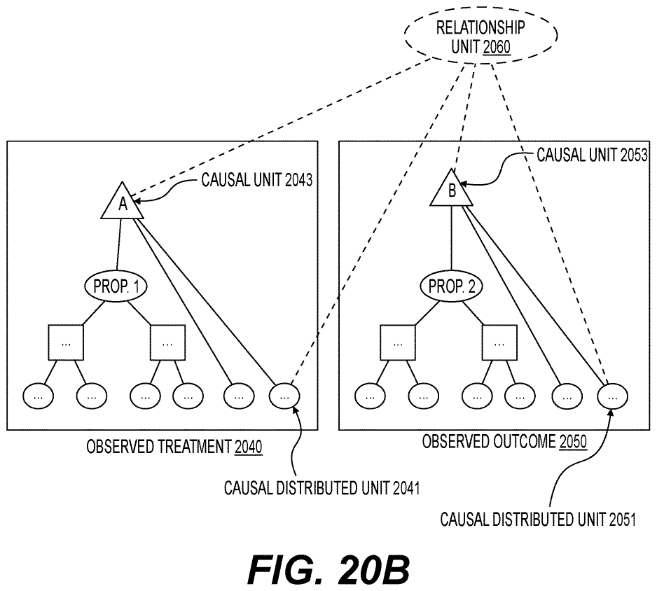

FIG. 20A depicts an exemplary implementation of causal localist units, showing an observed treatment analog (prop. 1) and observed outcome analog (prop. 2), in accordance with one or more aspects of this disclosure. In accordance with some embodiments of the disclosure, the machine learning system can associate the observed treatment with a causal localist unit (e.g., causal unit 2010) connected to causal distributed units (e.g., causal distributed unit 2030). In some embodiments, the machine learning system can add the causal localist units to the working memory (e.g., the driver) and connect them to the causal distributed units. The causal distributed units can be associated with a “causal” dimension (e.g., similar to the x-location, y-location, color, size, or other dimensions of distributed units in distributed units 313). The causal distributed units represent causal relationships like “causes,” “does not cause,” “is effect of,” and “is not effect of,” similar to the relational relationships like “left-of,” “right-of,” “larger-than,” “smaller-than,” encoded by the relational distributed units in distributed units 313. The causal localist unit can indicate a causal role, similar to the relational role indicated by right_of( ), different_color( ), or similar localist units.

In accordance with some embodiments of the disclosure, the association between the observed treatment and the associated causal localist unit can cause the symbolic representation generator to store and retrieve these units together. The disclosed embodiments are not limited to a particular implementation of this association. In some embodiments, the proposition unit and the causal localist unit for the observed treatment can both connect to the same causal distributed unit. Similarly, in some embodiments, the proposition unit and the causal localist unit for the observed outcome can both connect to the same causal distributed unit.

In some embodiments, the strength of a relationship embodied by an analog can be implemented using metadata associated with a causal localist unit (e.g., through an interval estimate, a sample size or n-value, distribution parameters, or the like) or pair of causal localist units. In some embodiments, the strength of a relationship embodied by an analog can be implemented using connection weights for connections between causal distributed units and causal localist units (e.g., a greater connection weight can indicate a larger effect, narrower confidence interval, or greater probability of a positive treatment effect; or otherwise be analogous to a confidence interval, p-value, or the like). In some embodiments, a localist unit can bind to other distributed units that indicate a strength of the relationship (e.g., distributed units representing values, ranges of values, categories such as “significant” or “insignificant,” or the like). In some embodiments, when the localist and distributed causal units are associated with the observed treatment and observed outcome, the relationship embodied by these analogs can be initialized to a default value. The default value can indicate a minimal causal relationship.

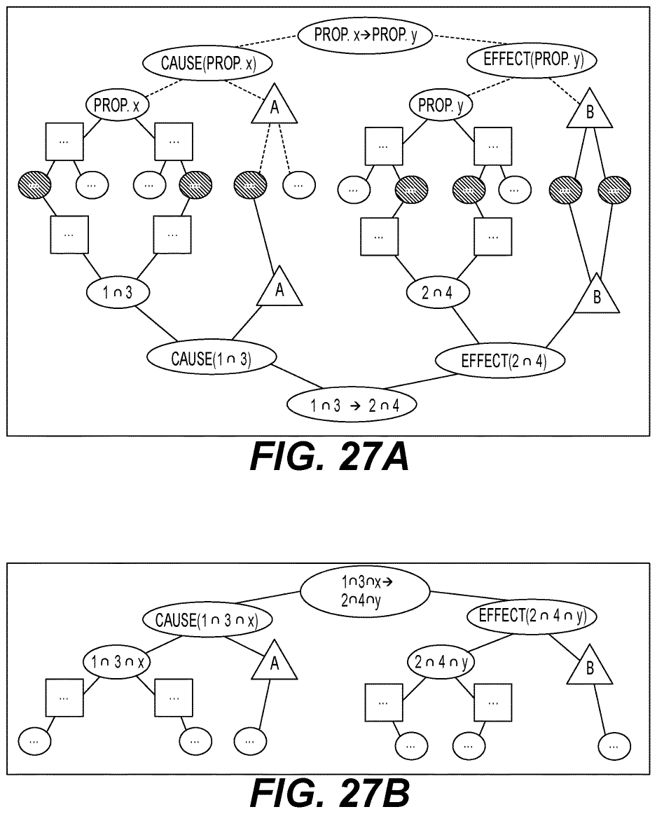

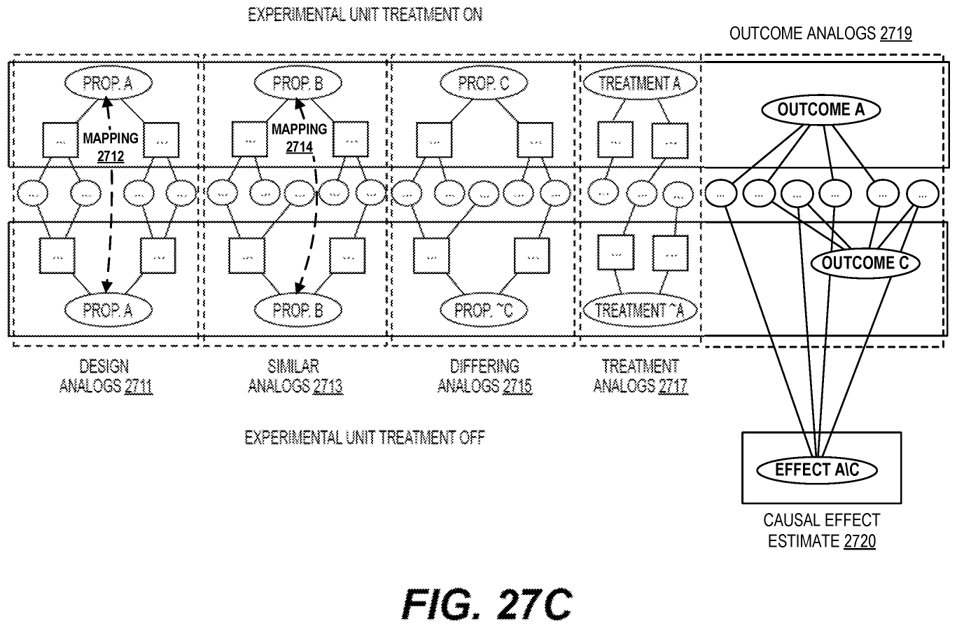

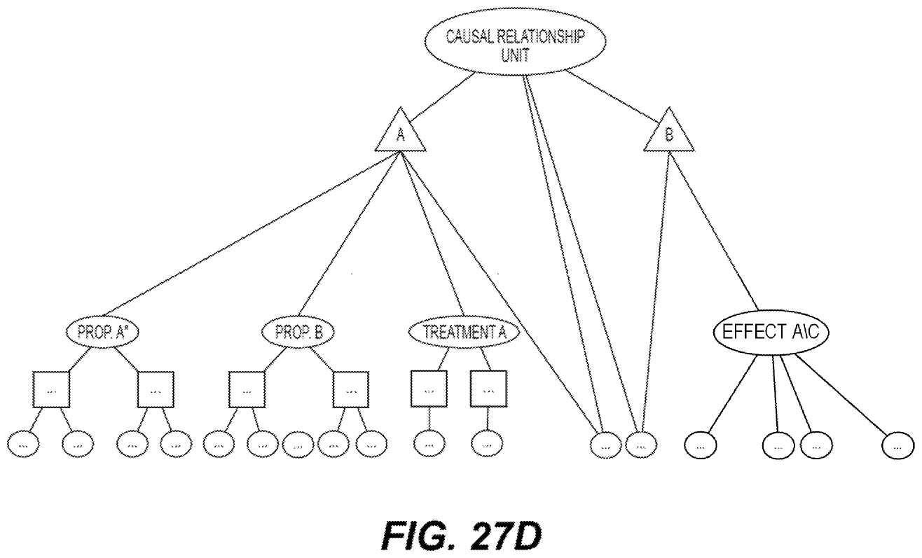

Relationships, including causal relationships, are depicted herein using the implementation of FIG. 20A. However, this depiction is not intended to be limiting. For example, FIG. 20B depicts an alternative exemplary implementation of causal localist units, showing an observed treatment analog and observed outcome analog, in accordance with one or more aspects of this disclosure. This alternative implementation is also used in FIG. 27D. Other relationships depicted herein (e.g., in FIGS. 21-23B and 25-27B) can be implemented using this, or other, alternative implementations. In the implementation depicted in FIG. 20B, proposition units (e.g., the “Prop. 1” and “Prop. 2” units) are connected to causal localist units (e.g., causal units 2043 and causal units 2053). Multiple such proposition units, collectively representing multiple associations between objects and roles, may be connected to a single causal localist unit. As may be appreciated, the ability to connect multiple propositions can distinguish the implementation depicted in FIG. 20B from the implementation depicted in FIG. 20A, in which causal units bind pairs of units, each pair including a proposition unit and another causal localist unit (e.g., as depicted in FIG. 21). Furthermore, this alternative implementation can reduce memory and computational requirements, as N proposition units can be bound to a single causal unit.

In this alternative implementation, causal localist units corresponding to cause and effect (e.g., causal units 2043 and 2053) can be bound into analogs by relationship units (e.g., relationship unit 2060, or the like), as described herein. Furthermore, such causal localist units (and the relationship units) can be bound to causal distributed units (e.g., causal distributed units 2041 and 2051, or the like). As described herein, a strength of a relationship embodied by an analog can be implemented using metadata associated with a causal localist unit (e.g., causal units 2043 and 2053, relationship unit 2060, or the like) or pair of causal localist units (e.g., causal units 2043 and 2053), connection weights for connections between causal distributed units and causal localist units, or distributed units that indicate a strength of the relationship (e.g., causal distributed unit 2041 and 2051).

In accordance with some embodiments of the disclosure, the relationship represented by an analog including cause and effect localist units may be a causal relationship, or an association or correlation. A causal relationship may be generated through a process of counterfactual experimentation. According to some experimental design (e.g., as described in process 1700 and 1800, or the like), results data for experimental units in which treatments were applied can be compared to results data for experimental units in which the same treatments were not applied. The inference component can generate an effect based on this comparison. An effect analog can bind the effect to a causal localist unit (e.g., as depicted in FIG. 20A or 20B). A cause analog can bind analog groups specified in the experimental design (or otherwise present in the experimental units) to a causal localist unit. An associational or correlational relationship may arise in the absence of counterfactual experimentation. For example, when analogs representing environmental variables are present in the symbolic representation together with analogs representing actions and rewards, those actions may be bound into a relationship using causal localist units, even though the relationship is merely associational or correlative.

In operation 1930 of process 1900, the machine learning system can generate a relationship analog based on the observed treatment and the observed outcome. In some embodiments, as depicted in FIG. 21, the machine learning system can obtain another observed treatment analog (prop. 3) and another observed outcome analog (prop. 4) in a subsequent experimental unit. The prior observed treatment analog (prop. 1) and observed outcome analog (prop. 2) can be retrieved into the working memory (e.g., into the recipient as described with regards to FIG. 4H, or another suitable method). Through one or more operations of representation learning (e.g., as described with regards to FIG. 4K, or another suitable method), the symbolic representation generator can recruit additional localist units. In some embodiments, these localist units can represent role bindings (e.g., new causal unit 2113 binding “prop. 1” to the role of “cause”) and propositions (e.g., new causal relationship unit 2115 binding cause (prop. 1) to effect (prop. 2)). In some embodiments, effect (prop. 2) can be appreciated as an average effect estimate of doing the treatment represented by the cause unit versus not doing the treatment (e.g., as estimated using a differentiation component as shown in FIGS. 4M and 4N). In some embodiments, these localist units can create relationship groups through bi-directional connections between causes (or effects) and proposition units. These new localist units can be connected to each other and to distributed units by new connections (e.g., new connection 2111).

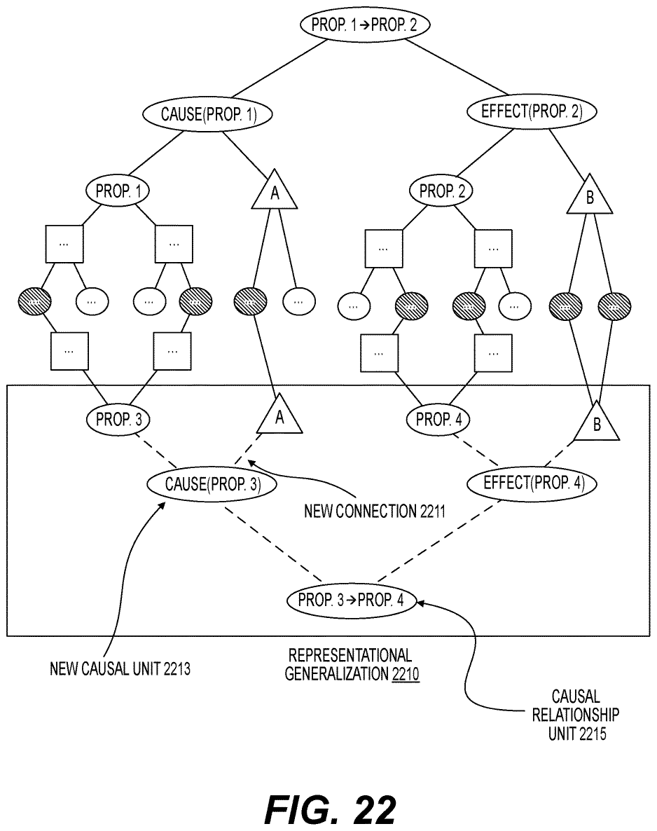

In operation 1940 of process 1900, the machine learning system can perform representational generalization, using the relationship analog generated in operation 1930. In some embodiments, as depicted in FIG. 22, the machine learning system can swap the driver and recipient and retrieve the observed treatment analog (prop. 3) and observed outcome analog (prop. 4) (e.g., into the recipient as described with regards to FIG. 4H, or another suitable method). As may be appreciated, the retrieved observed treatment and outcome analogs need not be (prop. 3) and (prop. 4) but may instead be other previously or subsequently obtained observed treatment and outcome analogs. The machine learning system can then perform representational generalization (e.g., as described with regards to FIG. 4J, or another suitable method). The symbolic representation generator can recruit additional localist units to represent role bindings (e.g., new causal unit 2213 binding “prop. 3” to the role of “cause”) and propositions (e.g., new causal relationship unit 2315 binding cause (prop. 3) to effect (prop. 4)). These new localist units can be connected to each other and to distributed units by new connections (e.g., new connection 2211). As may be appreciated, representational generalization can differ from the representation learning depicted in FIG. 21 in that the new connections depicted in FIG. 22 can inherit the weights of corresponding connections in the mapped analog. For example, the weight of new connection 2211 can match the weight of new connection 2111.

In operation 1950 of process 1900, the machine learning system can perform comparison-based representational refinement 2301 (e.g., as described with respect to FIG. 4L, or another suitable method like), using the relationship analogs generated in operations 1830 and 1840. As may be appreciated, representational refinement need not be performed using these analogs, but could instead be performed using other previously or subsequently created matching relationship analogs (e.g., relationship analogs with sufficient similar patterns of distributed unit activation such that activation of one in the driver can retrieve the other to working memory).

In some embodiments, as depicted in FIG. 23A, the two relationship analogs share mutual patterns of distributed unit activation (e.g., mutual distributed unit activation 2303) but also differing patterns of non-mutual distributed unit activation (e.g., non-mutual distributed unit activation 2305). These differences in activation may arise from the relationship analogs being “entangled” combinations of multiple different concepts.

In some embodiments, as depicted in FIG. 23B, the refined relationship analog can approximate the intersection of the multiple different concepts represented by the original relationship analogs. For example, the non-mutual distributed unit activations can be reduced or eliminated (as depicted), while the mutual distributed unit activations can be retained. In particular, distributed unit connections to analogs unrelated to the underlying relationship may attenuate over multiple cycles of refinement, as such unrelated analogs may not share distributed units with analogs in other relationship analogs. In some embodiments, the machine learning system may prune such unrelated analogs from the relationship analog based on the attenuated status of these connections.

In some embodiments, comparison-based representational refinement may exclude non-mutual localist units (and distributed units connected only to such non-mutual localist units). For example, a relationship analog may include multiple proposition units representing different associations. These proposition units may be bound to a causal localist unit (e.g., as depicted in FIG. 20B). In this example, the entire relationship analog may be retrieved into working memory because one or more (but not all) of these proposition units (or similar proposition units) are present in the driver. As may be appreciated, the proposition units present in the driver may map to corresponding proposition units present in the working memory (e.g., mutual proposition units). The remaining, non-mutual proposition units present in working memory may lack mapped counterparts in the driver. In some embodiments, when the machine learning system performs comparison-based representational refinement, these non-mutual propositions may be omitted from the resulting refined relationship analog. In some embodiments, the non-mutual propositions may be included in the resulting refined relationship analog (but distributed unit connections to these analogs may be weakened, or the like).

As may be appreciated, greater evidence supports the refined relationship analog than either of the original relationship analogs. In some embodiments, this greater evidentiary support can be shown by the metadata associated with the causal localist and distributed units connected into the refined relationship analog. In the example depicted in FIG. 23B, the connections between the causal localist units and causal distributed units (e.g., strengthened connection 2311 and 2313) have greater weights than the corresponding connections in the two original relationship analogs.

As may be appreciated, process 1900 can begin with mere association, as non-reward analogs may be assumed to be associated or correlated with outcome analogs with which they co-appear within an experimental unit. However, over multiple experimental units, these “entangled” causal analogs can be refined into “disentangled” representations of the underlying associational relationships. Furthermore, such relationships can be incorporated into subsequent experimental designs, as described herein with regards to FIGS. 15A to 18B. For example, the analogs bound to “cause” localist units and representing environmental variables can be used as analog groups in designing experiments. The inference component can then perform counterfactual experimentation on these environmental variables.

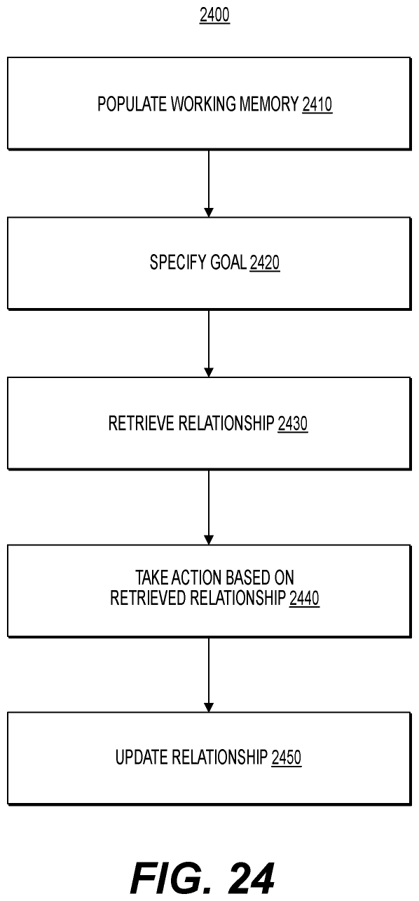

FIGS. 24 to 27D depict process 2400 for performing reward-based interactive learning. Process 2400 can be performed using the machine learning system of FIG. 1A, or another suitable machine learning system. In contrast with process 1800, which concerns observational learning, process 2400 can involve interactive learning. For example, process 2400 can involve providing instructions to take actions in the environment over one or more experimental units. In this example, process 2400 makes use of the exemplary relationship analog generated through process 1800, demonstrating how the machine learning system can combine and refine relationships generated through observation with relationships generated through experimentation. However, in some embodiments, relationship analogs created through observation can be distinguished from relationship analogs created through interactions. Similarly, relationship analogs reflecting mere association or correlation may be distinguished from causal relationship analogs generated through counterfactual experimentation.

In some embodiments, analogs accumulated in the course of performing process 2400 can be stored by one or more components of the machine learning system in a memory accessible to the one or more components of the machine learning system. In some embodiments, the accumulated analogs can be retained in memory network 310 (e.g., in the working memory of memory network 310). In some embodiments, the accumulated analogs can be retained in storage accessible to the inference component.

As may be appreciated, analogs can be generated or retrieved into memory with each frame of input data from the environment. In operation 2410 of process 2400, the machine learning system (e.g., the inference component, the symbolic representation generator, or the like) can accumulate analogs in or from working memory as they are generated or retrieved. As in the example of process 1800, the accumulation of analogs can be limited to non-extraneous analogs. In some embodiments, the machine learning system can limit the copies to analogs retrieved or created in a single frame (e.g., the first frame in an experimental unit) or a predetermined set of frames (e.g., the first n frames in an experimental unit). In some embodiments, the machine learning system can accumulate analogs in or from working memory until a matching analog is retrieved from memory network 310. In some embodiments, the accumulated analogs can be deleted from the memory network once the matching analog is retrieved. In some embodiments, the accumulated analogs can be retained (e.g., until the end of the experimental unit).

In operation 2420 of process 2400, the machine learning system (e.g., the inference component, the symbolic representation generator, or the like) can specify a goal in the form of a mapped representation of a reward (e.g., as determined in operation 1505 of process 1500). The machine learning system can accumulate a copy of the mapped representation together with the analogs accumulated in or from the working memory. In some embodiments, the machine learning system can accumulate causal localist units and connected causal distributed units together with the goal representation and the analogs in or from working memory.

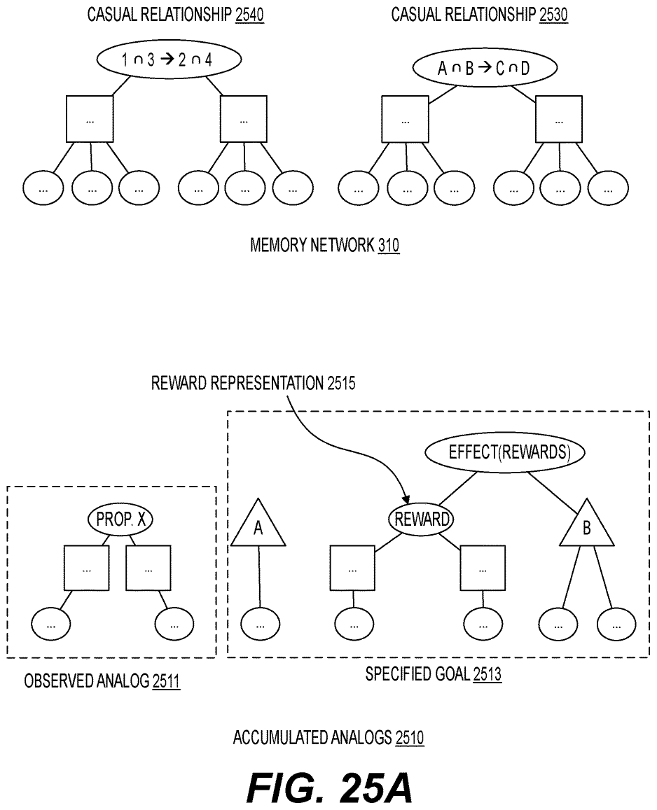

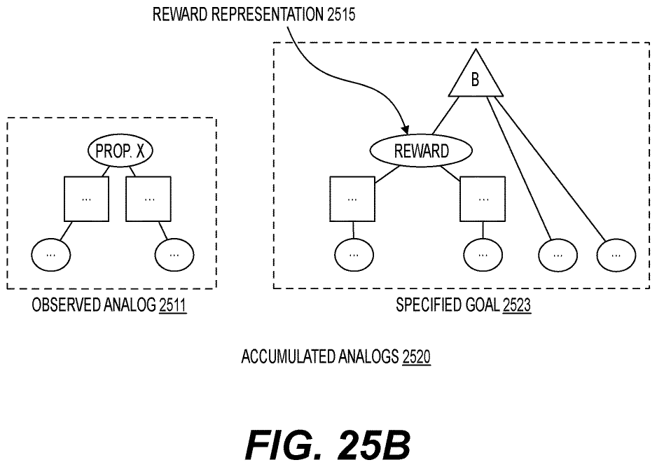

FIG. 25A depicts stored and accumulated analogs, in accordance with one or more aspects of this disclosure. In some embodiments, the stored analogs in memory network 310 represent the learned relationships that the machine learning system can draw upon in determining suitable actions. In this example, memory network 310 contains the relationship analog 2540, generated through process 1900, as depicted in FIGS. 18 to 23B, and another relationship analog 2530.

In some embodiments, the accumulated analogs 2510 represent both the current environmental state and the desired effect of any action. In accordance with some embodiments of the disclosure, accumulated analogs 2510 includes the observed analog 2511 copied from the working memory of the symbolic representation generator in operation 2410. Accumulated analogs 2510 further include the specified goal 2513 added in operation 2420. The specified goal 2513 analog includes a reward representation 2515 (e.g., a previously learned mapping from rewards to an analog). The reward representation 2515 is bound together with a causal localist unit (unit “B”) into a role binding (e.g., effect (rewards)). In this example, the causal localist unit is further connected to causal distributed units. In some embodiments, as depicted in FIG. 25A, the machine learning system can further provide an additional causal localist unit (causal unit “A”) bound to additional causal distributed units. This additional causal localist unit can be provided for binding together with the observed analogs into a role binding (e.g., cause (prop. X)). In this manner, the machine learning system may bias retrieval of analogs towards analogs shown to effectuate generation of rewards. However, in some embodiments, the machine learning system may omit the additional causal localist unit. Instead, the symbolic representation generator can create the necessary causal localist units and bindings using relational learning, similar to the examples provided herein.

FIG. 25B depicts stored and accumulated analogs using an alternative exemplary implementation of causal localist units, in accordance with one or more aspects of this disclosure. As in FIG. 25A, the accumulated analogs 2520 may represent both the current environmental state and the desired effect of any action. In accordance with some embodiments of the disclosure, accumulated analogs 2520 includes the observed analog 2511 copied from the working memory of the symbolic representation generator in operation 2410. The specified goal 2523 analog includes the reward representation 2515, bound to a causal localist unit (unit “B”). In this example, the causal localist unit is further bound to causal distributed units. As may be appreciated, multiple proposition units, collectively representing multiple associations between objects and roles, may be connected to the causal localist unit.

In operation 2430 of process 2400, the machine learning system (e.g., the inference component, the symbolic representation generator, or the like) can retrieve a relationship analog from memory network 310. In some embodiments, the relationship analog can be retrieved based at least in part on activations of the stored relationship analogs. For example, as described herein with regards to FIG. 4H, the symbolic representation generator can sequentially activate the highest-level units among each of the accumulated analogs, causing activation to flow through lower-level localist unit into distributed units and back up into the stored causal relationship analogs. In some embodiments, activation can also flow along mapping connections between localist units among the accumulated analogs and corresponding localist units stored in memory network 310. In some embodiments, the symbolic representation generator can calculate activation values for the stored analogs based on such activation as described herein with regards to FIG. 4H.

In some embodiments, the machine learning system (e.g., the inference component, the symbolic representation generator, or the like) can convert the calculated activation values into a selection probability for the stored relationship analogs. In some embodiments, as described with regards to process 1500 of FIG. 15A, predictive weights and salience data can further influence selection of the stored analogs. For example, in some embodiments, prediction weights and salience data can be associated with each of the stored relationship analogs. The machine learning system can use the prediction weights and salience data to screen the stored relationship analogs. The machine learning system can limit activation to relationship analogs satisfying the screening criteria. As an additional example, the machine learning system can use the prediction weights or salience data, in addition to activation values, in determining the selection probability for the stored relationship analog.

As may be appreciated, the use of activation values in determining selection probabilities can cause the machine learning system to favor retrieval of a relationship analog similar to the accumulated analogs. For example, the greater the overlap between the distributed units connected to the accumulated analogs and the distributed units connected to the stored relationship analog, the greater the flow of activation from the accumulated analogs to the stored relationship analog, and the greater the activation value.

In some embodiments, connection weights in the relationship analog can reflect the evidentiary support for the relationship. For example, the weights associated with such connections (e.g., between the distributed causal units and the localist causal units, the localist causal units and the role-binding causal units, the role binding causal units and the causal proposition units, or the like) can be greater the more evidence supporting the relationship. In such embodiments, the use of activation values in determining selection probabilities can cause the machine learning system to favor retrieval of relationship analogs having greater evidentiary support.

In some implementations, the machine learning system can be configured to directly affect or determine the selection probability based on the evidentiary support for the relationship. For example, the machine learning system can extract treatment effect distribution, point estimate, or interval estimate values from metadata stored in the relationship analog. The machine learning system can then deterministically (e.g., using categorizations or labels, thresholds, rankings, or the like) or probabilistically (e.g., using probability matching, Thompson sampling, softmax, or another mapping to selection probabilities suitable for selecting analogs) select a relationship analog for retrieval based on this extracted data (or in combination with prediction weights and salience data).

In some embodiments, the analogs accumulated from or in the working memory of the symbolic representation generator can be selected based on prediction weights or salience data. For example, the machine learning system (e.g., the inference component, the symbolic representation generator, or the like) can accumulate such analogs in or from working memory as they are generated or retrieved. In some embodiments, the symbolic representation generator (or the inference component) can accumulate the analogs subject to one or more conditions. In some embodiments, the conditions can involve whether the analogs are non-extraneous, salience data concerning the analogs, and predictive weights associated with the analogs. The conditions can be deterministic (e.g., categorizations or labels, thresholds, rankings, or the like) or probabilistic (e.g., probability matching, Thompson sampling, softmax, or another mapping to selection probabilities suitable for selecting analogs). For example, analogs categorized as non-extraneous or non-static can be probabilistically selected for accumulation based on predictive weights. The accumulated analogs (e.g., the selected analogs) can then be used to retrieve a causal relationship analog based on activation, as described herein. In various embodiments, causal relationship strength can be encoded into the calculation of activation or considered separately by the machine learning system (e.g., the inference component, the symbolic representation generator, or the like), as described herein.

In operation 2440 of process 2400, the machine learning system (e.g., the inference component, the symbolic representation generator, or the like) can provide instructions to take an action based on the relationship analog retrieved in operation 2430. As described herein, the machine learning system can learn a mapping from actions to analogs (e.g., in operation 1503 of process 1500). In response to retrieval of a relationship including a mapped analog, the machine learning system output instructions to the environment to perform the corresponding mapped action. As may be appreciated, in the next frame(s) the mapped analog can appear in the working memory as a result of the performance of the action. A copy of the mapped analog can then be accumulated.

In operation 2450 of process 2400, the machine learning system (e.g., the inference component, the symbolic representation generator, or the like) can update the relationship. In some embodiments, the machine learning system can update the relationship following the end of the experimental unit.

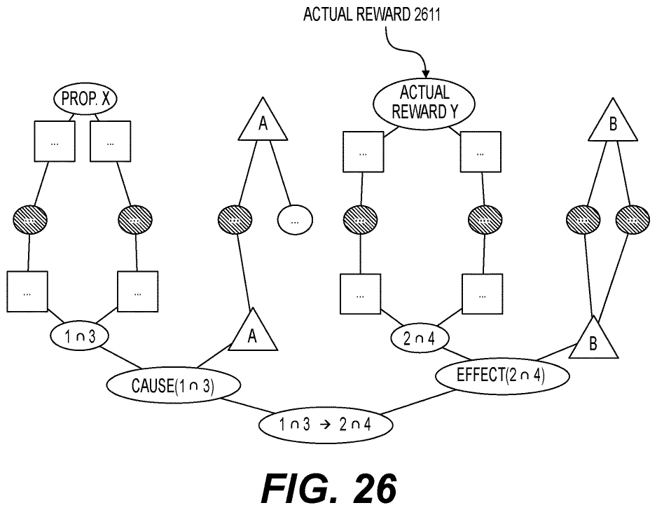

In a first step, the machine learning system can replace the goal analog with any actual reward analog (positive or negative) obtained during the experimental unit. The actual reward analog can be or include a representation of the rewards provided by the environment during the experimental unit (and in some embodiment, after provision of a treatment during the experimental unit). For example, the actual reward analog can be an element unit bound to metric distributed unit(s). The metric distributed units can represent an amount of reward received from the environment. In some embodiments, a distributed unit bound to the actual reward analog can indicate that it represents a reward. As an additional example, the actual reward analog can be a proposition representing a temporal change in a total reward amount. Replacement of the goal analog with any actual reward analog may or may not include removing the local causal unit bound to the goal analog. FIG. 26 depicts matching a retrieved analog to the accumulated analogs, in accordance with one or more aspects of this disclosure. In this example, the machine learning system retrieved causal relationship analog 2540 and replaced reward representation 2515 with actual reward 2611 (while retaining the local causal units). As may be appreciated, actual reward 2611 can differ in distributed unit connections and weights from reward representation 2515.

In a second step, the machine learning system can perform representational generalization, comparison-based refinement, and optionally difference encoding, as discussed herein with respect to FIGS. 4J, 4L, 4M and 4N. FIG. 27A depicts an exemplary result of representational generalization of the matched relationship analogs depicted in FIG. 26. Newly added connections to newly added localist units are indicated with broken lines. FIG. 27B depicts an exemplary result of comparison-based refinement of the matched relationship analogs depicted in FIG. 27A.

As may be appreciated, the application of the retrieval, representational generalization, and comparison-based refinement processes depicted in FIGS. 4A to 4N can enable efficient cross-domain transfer of knowledge. For example, relationship analog 2540 can be learned in a first domain and then retrieved for use in a second domain. The symbolic representation generator can retrieve relationship analog 2540 when that analog is more analogous (e.g., on the basis of distributed unit activation and optionally relationship strength) to the analogs accumulated in or from the working memory than other stored relationship analogs. The symbolic representation generator can then build a refined relationship analog that reflects the experimental results obtained in the second domain.

For example, the machine learning system can learn relationship analog 2540 while playing Breakout®. Relationship analog 2540 can describe a relationship between paddle movement commands and relative ball and paddle position. The machine learning system can then apply relationship analog 2540 while playing Pong®. As may be appreciated, the paddle in Breakout® moves left and right, while the paddle in Pong® moves up and down. However, despite this difference, the machine learning system may retrieve relationship analog 2540 as the most relevant stored analog and use this analog in playing Pong®. As the machine learning system continues to refine this analog through multiple trials, the resulting refined analog may be applicable in both domains (e.g., Breakout® and Pong®). For example, while relationship analog 2540 might be textually expressed as “move paddle left when the ball is to the left to maximize reward,” the refined relationship be textually expressed as the more general relation “move paddle towards ball to maximize reward.”

As described herein, the machine learning system can operate in, in some embodiments, interactive and non-interactive modes (also referred to herein as interactive and non-interactive learning). In an interactive mode, the machine learning system may provide instructions to take action in the environment. In a non-interactive mode, the machine learning system may not provide instructions to take action in the environment (e.g., because it is unable to provide such instructions). In some embodiments, the machine learning system can include reward-based and prediction-based outcomes. Accordingly, the machine learning system can exhibit four combinations of operation mode and outcome. In some embodiments, as the symbolic relationship generator and inference component continue to interact, selection of less-complicated analogs can decrease in favor of newer and more complex analogs as the machine learning system builds a more elaborate representation of causal relationships present in the environment.

As depicted in FIG. 27C, in addition to or as an alternative to generating relationship analogs representing associations or correlations, the machine learning system can generate causal relationship analogs that represent empirically identified causal relationships in the environment, in accordance with some disclosed embodiments. The inference component can generate these causal relationship analogs through counterfactual experimentation. As may be appreciated, such counterfactual experimentation can be implemented using a suitable experimental design, such as a fractional factorial design, response surface design, blocked design, or combination thereof. For convenience of description, FIG. 27C illustrates operations in the analysis of an exemplary randomized blocked design. In this example, the inference component can compare analogs obtained during an experimental unit in which a particular treatment was applied to the analogs obtained during an experimental unit in which a different treatment was applied (e.g., a counterfactual experimental unit). As may be appreciated, the inference component may be applying the treatment in an interactive mode, or observing application of the treatment in a non-interactive mode. In either case, the inference component may be configured to associate experimental unit(s) in which the treatment was applied with experimental unit(s) in which the treatment was not applied according to an experimental design.

In the example depicted in FIG. 27C, the inference component can compare design analogs 2711, treatment analogs 2717, and outcome analogs 2719 in the symbolic representation during the “Experimental Unit Treatment ON” and “Experimental Unit Treatment OFF” experimental units, in accordance with some disclosed embodiments. In some embodiments, the inference component can further compare similar analogs 2713 and differing analogs 2715.

Design analogs 2711 include analogs considered in designing the experiment (e.g., the analogs “blocked on” in the experimental design, or the like), in accordance with some disclosed embodiments. In this example, an experimental design can assign two policies to two experimental units. One policy, assigned to the “Experimental Unit Treatment ON” experimental unit, would specify application of the treatment when an analog group matching design analogs 2711 is present the symbolic representation (e.g., in the working memory of a memory network) during that experimental unit. Another policy, assigned to the “Experimental Unit Treatment OFF” experimental unit, would specify application of another treatment when an analog group matching design analogs 2711 is present in the symbolic representation during that experimental unit. Accordingly, design analogs 2711 are in both the treatment and non-treatment experimental units. Here, these analogs include proposition units labeled “Prop. A” and “Prop. A′”. As may be appreciated, in some embodiments “Prop. A” and “Prop. A” may be identical, while in some embodiments “Prop. A” and “Prop. A” may differ, while both matching the analog group specified in the policies. As shown in FIG. 27C, “Prop. A” and “Prop. A′” may map to each other. For example, through a mapping process (e.g., as described with regards to FIG. 4I) a mapping connection (e.g., mapping 2712) can be formed between “Prop. A” and “Prop. A′”. Such mapping can later trigger or enable relational refinement (e.g., as described herein with regards to FIG. 4L).

Similar analogs 2713 and differing analogs 2715 can include analogs not considered in designing the experiment, in accordance with some disclosed embodiments. However, these analogs may be present the symbolic representation (e.g., in the working memory of a memory network) during that experimental unit. Accordingly, these analogs may represent useful phenomena related to the measured outcomes. In some embodiments, the inference component can limit similar analogs 2713 and differing analogs 2715 to analogs observed before, or contemporaneously with, the design analogs 2711 in the experimental unit (e.g., within a time interval or number of frames of the frame including the design analogs 2711, or the like). Limiting consideration of potentially causal analogs in this manner can focus future experimental design on analogs co-occurring with the design analogs 2711 (and therefore potentially representing useful phenomena in the environment).

As may be appreciated, similar analogs 2713 may represent the same or similar phenomena in the environment (e.g., the same object seen in different frames, the same causal factor present in two different metric dimensions, or the like). Here, these analogs include proposition units labeled “Prop. B” and “Prop. B′”. In accordance with some disclosed embodiments, these analogs may form mappings (e.g., mapping 2714) as described herein with regards to FIG. 4I. As described herein, such mapping does not necessarily imply identity, but rather that the similar analogs correspond to each other and not to other analogs being mapped. Such mapping can later trigger or enable relational refinement (e.g., as described herein with regards to FIG. 4L). In contrast, differing analogs 2715 can represent differing phenomena in the environment (e.g., dissimilar objects, environmental variables lacking causal relationship, or the like). Here, these analogs include proposition units labeled “Prop. C” and “Prop. ~ C.” In this example, no mapping is formed between these analogs. In the example depicted in FIG. 27C, similar analogs 2713 and differing analogs 2715 are expressly labeled. However, in practice, relational refinement may reveal the similar and the differing analogs, as only the similar analogs may contribute to generation of a refined analog (e.g., as the differing analogs may not map to each other or may lack overlapping distributed unit activations).

Treatment analogs 2717 can include the particular treatment present in the “Experimental Unit Treatment ON” experimental unit and represented in the symbolic representation as “Prop. B.” Treatment analogs 2717 can also include the other treatment present in the “Experimental Unit Treatment OFF” experimental unit and represented in the symbolic representation as “Prop. ~B.” As described herein, analogs corresponding to treatments may be identified during an initialization process. In this example, no mapping is formed between these analogs.

Outcome analogs 2719 can include the outcome(s) identified in the “Experimental Unit Treatment ON” experimental unit (“Outcome A”) and the “Experimental Unit Treatment OFF” experimental unit (“Outcome C”). In this example, no mapping is formed between these analogs. In some embodiments, the outcomes can be or indicate performance metric values obtained from the environment. Such analogs may be predetermined or identified during an initialization process. In this example, the outcomes can be element units bound to metric distributed units that indicate the magnitude and direction of the outcome. However, the disclosed embodiments are not so limited. In some embodiments, the outcomes can include analog(s) comprising role-binding units, proposition units, or the like. In some embodiments, the inference component can limit outcome analogs 2719 to outcome analogs observed after, or contemporaneously with, the treatment analogs 2717 in the respective experimental units. For example, within a time interval or number of frames of the frame including treatment analogs 2717, or the like. Such a limitation can prevent outcomes received before the treatment was applied from contaminating the experiment.

In accordance with some embodiments of the disclosure, the inference component can generate a causal relationship analog using the analogs obtained in the two experimental units. FIG. 27D depicts an example of such a causal relationship analog. In some embodiments, the inference component can perform relational refinement using design analogs 2711, similar analogs 2713, and differing analogs 2715. As may be appreciated, such relational refinement may generate a more-disentangled version “Prop. A″” of the design analogs 2711 and a more-disentangled version “Prop. B″” of the similar analogs 2713. The differing analogs may not contribute to the relational refinement, as they may not map to each other or may lack overlapping distributed unit activations. These more-disentangled propositions may more generally represent the phenomena of interest in the experiment. Alternatively, in some embodiments, the inference component can copy the design analogs 2711 to the causal relationship analog.

In some embodiments, the inference component can copy the treatment analogs 2717 to the causal relationship analog. As may be appreciated, the analogs representing the other, different treatment may not be included in this causal relationship analog, as they concern other treatments.

In some embodiments, the inference component can generate a causal effect estimate “EFFECT A\C” (causal effect estimate 2720) using the outcomes obtained in the two experimental units. In some embodiments, when the outcome measure is represented using an element unit bound to metric distributed units, as depicted in FIG. 27D, the inference component can generate the causal effect estimate using a difference-encoding implementation as described herein with regards to FIGS. 4M and 4N. In some embodiments, when the representation of the outcome measure includes role-binding or proposition units, the inference component can generate the causal effect estimate from those outcome analogs 2719 that were unmapped between the “Experimental Unit Treatment ON” experimental unit and the “Experimental Unit Treatment OFF” experimental unit. For example, causal effect estimate 2720 can include the collection of outcome analogs 2719 in the “Experimental Unit Treatment ON” experimental unit that lack mapped corresponding analogs in the “Experimental Unit Treatment OFF” experimental unit. The use of such difference-encoding, in the context of counterfactual experimentation, can transform relationship analogs that encode associational or correlative relationships into causal relationship analogs that encode empirically determined causal relationships present in the environment.

Consistent with disclosed embodiments, the causal relationship analog can include a cause analog including “Prop A″”, “Prop B″”, and “Treatment A” bound to a causal localist unit “A” and an effect analog including the “Diff A\C” bound to causal localist unit “B.” The “Causal Relationship” localist unit (e.g., a proposition unit or another causal localist unit) can bind the cause and effect analogs into a causal relationship analog.

As may be appreciated, in some experimental designs, sets of outcome measurements (or distributions, moments, or statistics thereof) acquired over multiple treatment ON experimental units can be compared to sets of outcome measurements (or distributions, moments, or statistics thereof) acquired over multiple treatment OFF experimental units. For example, means of such sets of outcome measures can be compared according to known statistical methods. The resulting difference in outcome measure means can be expressed as an analog bound into the resulting causal relationship group, in accordance with some embodiments of the disclosure.

In accordance with some disclosed embodiments, multiple causal relationship analogs can be combined to better estimate treatment effects. For example, the generalization and refinement operations of process 1900 (e.g., operations 1940 and 1950) or process 2400 (e.g., operation 2450) can be performed with causal relationship analogs. The inference component can generate new causal relationship analogs having metadata associated with localist units or connections between units (e.g., between localist units or between localist units and distributed units). This metadata can represent the estimated effect of the treatment. As may be appreciated, the more causal relationship analogs combined to generate the new causal relationship analog, the better the estimate of the effect of the treatment.

### Exemplary Interactions Between Machine Learning System and Environment

FIG. 28 depicts interactions between an environment and components of a machine learning system during reward-based interactive learning, in accordance with one or more aspects of this disclosure. In this example, the inference component has learned mappings from analogs representing objects and relationships in the environment to predetermined actions. As may be appreciated, the particular relationship between the symbolic representation generator 110 and inference component 120 is not intended to be limiting. Other implementations are envisioned and disclosed herein.

As described herein, the machine learning system can maintain a causal model. In some embodiments, this causal model can be or include mappings between SRECs and estimated treatment effects. In some embodiments, the inference component can include data structures that implement this mapping (e.g., tables, lists, or other suitable data structures). The inference component can generate (and potentially periodically update) such data structures based on the analogs present in the memory network of the symbolic representation generator. In some embodiments, the causal model can be implemented using causal relationship analogs stored in the memory network of the symbolic representation generator.

As described herein, in some embodiments an SREC can include a precondition and can be associated with one or more actions. In some embodiments, each combination of SREC and action can be associated with an estimated treatment effect. In some embodiments, the machine learning system can select an SREC when analogs accumulated in or from the working memory of memory network 310 match the precondition. The machine learning system can then select an action based on an estimated treatment effect for the action and provide instructions to perform the action.

In some embodiments, the estimated treatment effect can depend on rewards obtained in prior experimental units in which the machine learning system selected the SREC. The estimated treatment effect for an action can depend on the rewards obtained when the machine learning system selected the SREC and selected the action. In some embodiments, the estimated treatment effect for an action can further depend on the rewards obtained when the machine learning system selected the SREC and selected another action.

As depicted in FIG. 28, in operation 2801, inference component 120 can determine SRECs based on analogs obtained from memory network 310 of symbolic representation generator 110. In some embodiments, inference component 120 can generate a set of SRECs including combinations of these analogs. As described herein, such combinations can be generated using clustering information and extraneous analogs information.

In operation 2810, inference component 120 can select a subset of the SRECs for application during experimental unit j (the “experimental subset”). In some embodiments, inference component 120 can select the experimental subset according to an experimental design (e.g., according to the experimental design processes 1500, 1600, 1700, 1800, or another suitable experimental design process). While operation 2810 is depicted as occurring within the experimental unit, the disclosed embodiments are not so limited. In some embodiments, as described herein inference component 120 can assign policies to experimental units in advance of performing the experimental units. The policies can specify the experimental subset.

In some embodiments, inference component 120 can select SRECs for inclusion in the experimental subset based on treatment effect distributions, point estimates, or confidence interval estimates for the treatment effects associated with the actions for the SREC.

In some embodiments, the SREC can be included in the experimental subset based on a characteristic of the SREC. As described above, an SREC can map from an analog to one or more actions. The SREC can be included in the experimental subset based on characteristics of the analogs. Such characteristics can include the complexity of the analog (e.g., number of local units, number of levels of local units, number of distributed units mapped to by element units), localist units included in the analog (e.g., whether the analog includes local causal units, whether the analog includes analogs mapped to an action, whether the analog includes proposition units, or the like), salience data associated with the SREC (e.g., dynamicity scores based on distributed units connected to element units, such as collections of distributed units identified as indicating a static object; a frequency with which an analog is retrieved into working memory; or the like), and whether an analog is a subset of another analog (e.g., right_of(ball, paddle) may be a subset of align_right(ball, paddle), which may in turn be a subset of align(ball, paddle)).

During the experimental unit, inference component 120 can accumulate analogs in or from the working memory of the symbolic representation generator 110. In frame i of experimental unit j, sample 2821 can be obtained from environment 130. In operation 2822, the symbolic representation generator 110 can generate analogs using sample 2821. In some embodiments, a preprocessor of symbolic representation generator 110 can generate element and distributed unit(s) using sample 2821. As described herein, the symbolic representation generator 110 can then create and refine analogs using these element unit(s) and distributed unit(s). Inference component 120 can accumulate analogs in or from the working memory of symbolic representation generator 110 during or after the creation and refinement of the analogs. In operation 2823, inference component 120 can match the accumulated analogs to a precondition of an SREC included in the experimental subset. Inference component 120 can select a corresponding action (e.g., based on the treatment effects associated with the selected SREC) and provide instruction(s) to perform the action to environment 130.

In some embodiments, the match can be exact. For example, the accumulated analogs and the precondition can include the same analogs. In some embodiments, the match can be inexact, for example, the accumulated analogs and the precondition can include overlapping sets of analogs. In some embodiments, the match can depend on an activation value associated with the analogs comprising the precondition, as described herein.

In some embodiments, symbolic representation generator 110 and inference component 120 can interact to match the accumulated analogs to an SREC. In some embodiments, inference component 120 can perturb memory network 310, biasing SREC selection towards causal relationship analogs relevant to a goal. For example, inference component 120 can include in the accumulated analogs a representation of a goal (e.g., in the form of an analog). The machine learning system may have received the goal from a user or another system. The goal representation, in combination with other accumulated analogs (e.g., resulting from the actions of the preprocessor, the invariance circuit, and any learning process) can then cause retrieval (e.g., activation can flow from the analogs in the working memory into the feature units, and from the feature units into the analogs in the long-term memory) of a causal relationship analog corresponding to an SREC. The inference component can match the retrieved analog to the accumulated analogs.

In some embodiments, inference component 120 can select an action to perform based on the matched SREC. In some embodiments, when experimental unit j is a baseline experimental unit, inference component 120 can stochastically select the action according to some predetermined distribution. Inference component 120 can select each action with the same probability or may select different actions with different probabilities. In some embodiments, when experimental unit j is an explore/exploit experimental unit, inference component 120 can select the action using a selection function that trades off reward maximization against exploration. In some embodiments, the selection function can select actions according to expected rewards, the duration of the experiment, and the number of times the action has been selected. In some embodiments, inference component 120 can determine whether the experimental unit is a baseline unit or an explore/exploit unit according to a parameter maintained by inference component 120. In such embodiments, when explore/exploit is selected, inference component 120 can select actions according to an experimental design based on the causal model. For example, inference component 120 may select actions according to probability matching, Thompson sampling, upper confidence bounds-based techniques, softmax, or another suitable technique in selecting treatments, as described herein. When baseline is selected, inference component 120 can select actions according to an experimental design that does not depend on the causal model. Instead, the experimental design may allocate actions according to a predetermine probability distribution or obtained normative operational data.

As depicted in FIG. 28, experimental unit j can include multiple frames. At the end of experimental unit j, inference component 120 can associate rewards received from the environment during the experimental unit with SRECs matched and actions taken during the experimental unit. A reward can be associated with any SREC matched and action taken in the experimental unit before receiving the reward.

In some embodiments, in operation 2825, inference component 120 can determine updated effect estimates for SRECs based on rewards associated with those logics. As described herein, inference component 120 can estimate effects for taking actions using the results of a set of experimental units. These experimental units can be clustered or blocked to account for environmental factors. After one or more experimental units, inference component 120 can update estimates for the actions based on the results associated with the matched SRECs in the experimental unit.

In some embodiments, inference component 120 may not update treatment effect estimates associated with an SREC when the SREC is not matched during an experimental unit. However, inference component 120 can update treatment effect estimates for all actions associated with the condition logic when the SREC is matched. In some embodiments, the treatment effect estimate for an action can depend on the treatment effect estimates for other actions, so all treatment effect estimates for a matched SREC can be updated when any one of the actions is taken.

In contrast with the reward-based learning depicted in FIG. 28, prediction-based learning can involve refining interval estimates for cause-and-effect relationships. As described above, the machine learning system (e.g., the symbolic representation generator or the inference component) can maintain a set of SRECs. In some embodiments, in the predictive context, the SRECs can include treatment effect estimates concerning another analog in memory network 310. The effect estimates can be or depend upon an activation value of the other analog (e.g., activation level, activation probability, likelihood of retrieval into working memory, or the like). In some embodiments, the machine learning system can be configured to refine posterior probability distributions of the effect estimates. Such posterior probability distributions can be expressed as interval estimates.

As described herein, the machine learning system can generate an experimental subset of the SRECs for application during an experimental unit. In some instances, an SREC can be included in the experimental subset based on an experimental design or based on characteristics of the SREC. In some embodiments, the machine learning system can be configured to include SRECs in the experimental subset based on treatment effect estimates (e.g., the interval estimates corresponding to different actions). For example, the machine learning system can be configured to select SRECs having broader interval estimates for inclusion in the experimental subset.

During the experimental unit, the machine learning system can match accumulated analogs copied from the working memory of the symbolic representation generator to preconditions of SRECs included in the experimental subset. As frames of input are received from the preprocessor, analogs can be retrieved, created, and refined by the symbolic representation generator. At any step in this process, the machine learning system can match the precondition of an SREC to the accumulated analogs. As described herein, such a match can be exact or inexact.

The machine learning system can select an action to perform based on the matched SREC. The selection of the action can depend on experimental unit type (e.g., baseline, explore/exploit, or the like). At the end of the experimental unit, the machine learning system can determine which SRECs matched and which actions were taken. The machine learning system can also determine a treatment effect value based on the activation value of the other analog. The treatment effect value can be associated with any SREC matched and action taken in the experimental unit before the other analog was activated/retrieved into working memory, or the like.

In some embodiments, treatment effect value can determine updated treatment effect estimates for SRECs based on the determined treatment effect values. As described herein, the machine learning model can estimate effects for taking actions using the results of a set of experimental units. These experimental units can be clustered or blocked to account for environmental factors. After one or more experimental units, the machine learning model can update treatment effect estimates for actions based on the results associated with the matched SRECs in the experimental unit(s).

In some embodiments, when an SREC is not matched during an experimental unit, the effect estimates for the SREC are not updated. However, when an SREC is matched during an experimental unit, the effect estimates for all actions associated with the experimental unit can be updated. As the effect estimate for an action can depend on the rewards for other actions, all effect estimates for a matched SREC can be updated when any one of the actions is taken.

Similar to the interactive modes, the non-interactive operation modes can involve constructing a set of SRECs, as described herein. The machine learning system can then subsequently generate an experimental subset of SRECs for consideration in an experimental unit. An SREC can be included in the experimental subset based on an experimental design or based on characteristics of the SREC. The machine learning system can determine matched SRECs in the experimental set based on analogs accumulated in or from the working memory of memory network 310 during an experimental unit. The machine learning system can track rewards received from the environment in a reward-based mode, or interval estimates of activity levels in a predictive mode.

In some embodiments, the machine learning system can have knowledge of actions taken in the environment, even when operating in a non-interactive mode. Accordingly, the machine learning system can determine that an SREC was matched and an action was taken. The machine learning system can be configured to associate the combination of matched SREC and action with any reward values obtained from the environment after the action was taken. The machine learning system can then update effect estimates for the matched SREC based on the obtained reward value.

In some embodiments, the machine learning system can lack knowledge of actions taken in the environment when operating in a non-interactive mode. Accordingly, the machine learning system can determine treatment effect estimates for analogs that are associated with actions taken. For example, the working memory in frame (t) can be {right_of(b,p)} and a user may take the action to move the paddle to the right. The machine learning system can lack knowledge that the user took an action causing the paddle to move to the right. However, the working memory in frame (t+1) may then be {same(b,p), right_of(p2,p1)}, due to the action causing the paddle to move right. The machine learning system can determine an association between {same(b,p), right_of(p2,p1)} and a reward value received from the environment after {same(b,p), right_of(p2,p1)} appears in working memory. In such embodiments, rather than estimating an effect for each action, the machine learning system can estimate an effect for the overall SREC.

In some embodiments, non-interactive experimentation can include re-examining relationships between predicates and effects. Previously obtained experimental units (or sets of experimental units) can be “re-run” with different experimental subsets to identify whether alternative SRECs have greater explanatory power than the SRECs originally used for the experimental units. For example, an analog can be removed from the predicates of a set of SRECs associated with a set of experimental units. The mapping of working memory to the SREC(s) in the set of SRECs, and the association of reward values with the mapped SRECs, can then be repeated for the experimental unit(s) in the set of experimental units. In effect, the machine learning system can experiment on whether the removed analog in the predicate is causally related to the reward value or is just confounding noise.

As may be appreciated, such retrospective re-analysis can be performed using the results of prior experimental units in which the machine learning system interacted with the environment, in addition to experimental units in which the machine learning system observed another user or system interacting with the environment.

In some embodiments, the machine learning system can update memory network 310 based on the results of the non-interactive experimentation.

### Exemplary Selection of Actions and Attribution of Rewards

FIG. 29A depicts exemplary selection of actions based on analogs using a selection function during an experimental unit, in accordance with one or more aspects of this disclosure. The actions can be selected by a machine learning system (e.g., machine learning system 100). The machine learning system can then provide commands to perform the actions in the environment. The machine learning system can generate the analogs using input (e.g., input 111) obtained from the environment (e.g., environment 130) during the experimental unit. In this example, the environment is a computer system playing a game of Breakout®. As depicted in this example, the machine learning system repeatedly obtains the state of the environment (e.g., at times points t₁, t₂, etc.). The state of the environment includes graphical input 2901, which captures the state of the game of Breakout®. In particular, graphical input 2901 captures the ball (e.g., ball 2903) and the paddle (e.g., paddle 2905). In this example, the relative position of the ball and the paddle are different each time the machine learning system obtains the state of the environment. For example, at t₁ the ball is to the left of the paddle, while at t₄ the ball is to the right of the paddle. At all time points, the ball is above the paddle.

At each time point, a symbolic representation generator of the machine learning system (e.g., symbolic representation generator 110) generates analogs using graphical input 2901. In this example, the analogs can include an analog describing the relationship between the ball and the paddle in the x-dimension and an analog describing the relationship between the ball and the paddle in the y-dimension. Generation of the analogs can include creation (e.g., using a preprocessor of the symbolic representation generator, such as preprocessor 320 or the like) of the analogs, or components of the analogs, such as element units bound to distributed units. Generation of the analogs can include one or more of the processes of analog retrieval, mapping, generalization, predicate learning, relational refinement, and difference encoding as described herein in FIGS. 4G to 4N.

As described herein, an inference component of the machine learning system (e.g., inference component 120) can be configured to select a set of SRECs for use during the experimental unit (e.g., the SRECs depicted in SREC Table 2908). In this example, the experimental unit is an explore/exploit experimental unit. In this example, the inference component can select actions for SRECs according to a selection function (e.g., selection function 2907). As may be appreciated, the selection function can be determined as part of an experimental design (e.g., as described in process 1410, or another suitable manner) and may depend on a causal model. The disclosed embodiments are not limited to such a selection function. In some embodiments, the inference component can select actions for SRECs in other manners for other types of experimental units. For example, in a baseline experimental unit the inference component can predetermine actions for SRECs according to an experimental design (e.g., a fractional factorial design, Latin square, full factorial design, or the like) without regard to a causal model.

As described herein, each SREC can include a precondition and one or more action. In this example, each row of SREC Table 2908 corresponds to an SREC including a precondition (defined in terms of the analogs A1 and A2) and three actions (e.g., move paddle left: “←”, null action: “-”, move paddle right: “→”). For each SREC, each action can be associated with a reward estimate. In some embodiments, the reward estimate can be a d-score.

In accordance with some embodiments, the inference component can be configured to select an SREC when the symbolic representation generator generates analogs matching preconditions for the SREC. For example, the symbolic representation generator can generate at time t₁ an x-dimension analog (“L)” indicating that the ball is left of the paddle and a y-dimension analog (“A”) indicating that the ball is above the paddle. This combination of analogs can match the precondition of the first SREC in SREC Table 2908.

In accordance with some embodiments, the inference component can be configured to select an action for the SREC when the SREC is selected for the first time during the experimental unit. The inference component can then provide instructions (e.g., output 113) to take the selected action. As depicted in FIG. 29A, the selection of the action can depend on a selection function (e.g., selection function 2907). The selection function can depend at least in part on the selection function. For example, the selection function can convert a reward estimate for the SREC action into a selection probability for the action (e.g., P(→) can be the probability of moving right, P(-) can be the probability of taking a null action, and P(←) can be the probability of moving left). The sum of these probabilities may be the same between SRECs, but the values for each probability can differ between SRECs. For example, P(←) for the SREC in row one of SREC Table 2908 can be greater than P(←) for the SREC in row four of SREC Table 2908. Thereafter, during the experimental unit, the inference component can be configured to provide instructions to take the same selected action.

For example, as depicted in FIG. 29A, the inference component selects action 1 (move left) at time t₁, action 3 (move right) at time t₃, and action 2 (null action) at time t₄ based on the selection functions for those SRECs. The inference component selects action 1 at time t₂ based on the prior selection of action 1 at time t₁. And the inference component selects action 3 at time t₅ based on the prior selection of action 3 at time t₃.

At the end of the experimental unit, the inference component can update treatment effect estimates for the SRECs. As may be appreciated, only some SRECs may match during the experimental unit. In some embodiments, reward(s) received during the experimental unit can be attributed only to these matched SRECs.

In accordance with some disclosed embodiments, the treatment effect estimates for the matched SRECs can be updated based on the received reward(s). In some embodiments, a reward can be attributed to matched SRECs satisfying a proximity condition. Such proximity conditions include the SREC was matched: before receipt of the reward, within a certain number of matched SRECs of the receipt of the reward, within a certain time of the receipt of the reward, or other suitable conditions. In some embodiments, an incremental increase or decrease in the treatment effect estimate for an action for a matched SREC can be scaled according to a proximity function. For example, the incremental increase or decrease in the treatment effect estimate for the action can be scaled as 1/n (where n is the number of matched SRECs between when the reward was received and the matched SREC being updated) or 1/t (where t is the elapsed duration between when the reward was received and when the SREC being updated was matched), or another suitable function.

In accordance with some disclosed embodiments, the inference component can maintain a treatment effect estimate for the policy (or for the combination of policy and selected actions). The inference component can update this treatment effect estimate based on the received reward(s). As may be appreciated, attributing the reward to the policy as a whole may avoid difficulties attributing the reward to individual SRECs (or combinations of SRECs and actions). However, the space of policies may be larger and more complicated than the space of individual SRECs.

FIG. 29B depicts exemplary selection of actions based on analogs using a set of action instances during an experimental unit, in accordance with one or more aspects of this disclosure. As in FIG. 29A, the actions can be selected by a machine learning system which can provide commands to perform the actions in the environment. The machine learning system can generate the analogs using input (e.g., input 111) obtained from the environment (e.g., environment 130) during the experimental unit. The machine learning system repeatedly obtains the state of the environment (e.g., at times points t₁, t₂, etc.). The state of the environment includes graphical input 2901, which captures the ball (e.g., ball 2903) and the paddle (e.g., paddle 2905). A symbolic representation generator of the machine learning system (e.g., symbolic representation generator 110) generates analogs using graphical input 2901 at each time point.

An inference component of the machine learning system (e.g., inference component 120) can be configured to select a set of SRECs for use during the experimental unit. In this example, the SRECs are associated with sets of action instances 2918. The actions instances can specify the action to take and sets of actions instances can be generated as described with regards to process 1410.

As described herein, each SREC can include a precondition and the inference component 120 can be configured to select an SREC when the symbolic representation generator generates analogs matching the precondition for the SREC. In this example, the inference component 120 can select an action instance for an SREC the first time the SREC is matched during the experimental unit (e.g., selected action instance 2920). The inference component can then provide instructions (e.g., output 113) to take the action specified by selected action instance 2920. Thereafter, during the experimental unit, the inference component can be configured to provide instructions to take the same selected action. The inference component can select the action instance without replacement. Accordingly, the selection of selected action instance 2920 can specify an action to take in this experimental unit can decrease the likelihood of taking that action in subsequent experimental units.

At the end of the experimental unit, the inference component can update treatment effect estimates for the SRECs as described herein with regards to FIG. 29A.

### Example: Breakout®

FIGS. 35A to 35D, 36A and 36B, and 37A to 37D concern the performance of a machine learning system in accordance with one or more aspects of this disclosure at playing Breakout®, a well-known benchmark for artificial intelligence. This video game challenges the machine learning system to control a paddle to deflect a ball and break bricks, accumulating points. As described herein, in some embodiments, the symbolic representation generator can build structured symbolic representations from pure pixel-based input, self-supervised architecture without trials or feedback. The symbolic representation generator can build this representation using input obtained from the preprocessor and the invariance circuit. Image input from the environment can be segmented into objects that can be represented by elements in the memory network. Relations between elements (and single-argument predicates involving objects) can be encoded in localist unit units or relational distributed units. As described herein, in some embodiments, this structured representation can be built with self-supervised processes from “simply” viewing the game (no performance feedback required) and can form the foundation for relational reasoning and subsequent learning.

FIG. 35A depicts the environment, including the bricks (patterned blocks), the paddle (black bar), and the ball (black dot), and the walls (in grey). The ball can bounce off the bricks, the paddle, or the walls. The paddle can slide left to right. FIG. 35B depicts the input from the environment in terms of objects detected by preprocessor 320. As described herein, in some embodiments, preprocessor 320 can create element units in memory network 310 corresponding to the detected objects. These element units could be connected to distributed units representing metric and relational attributes of the detected objects. FIG. 35C depicts a subset of relationships between detected objects (the relationships between the top left block and other observed objects in the scene, represented by broken lines, and the relationships between the ball and other observed objects in the scene, represented by solid lines). These relationships can be determined by symbolic representation generator 110 and included as localist units in memory network 310. As described herein, in some embodiments, inference component 120 can work with representation generator 110 to determine the important relationships (e.g., the relationship between the ball and the paddle, as depicted in FIG. 35D).

FIGS. 36A and 36B depict an extended version of Breakout® that introduces dynamic scoring rules based on the color alignment of the paddle and ball, which change after specific events. Points are scored only when the paddle and ball share the same color (represented by patterns) at the moment of contact, and their colors change randomly after the ball hits a brick or passes the paddle without being hit (e.g., as shown in the transition from FIG. 36A to FIG. 36B).

FIGS. 37A and 37B depict the performance of a machine learning system operating in interactive mode in accordance with one or more aspects of this disclosure at both the conventional version of Breakout® (FIG. 37A) and the extended version of Breakout® (FIG. 37B). Together, these tasks assess the ability of the machine learning system to generalize across levels of complexity while learning efficiently from raw observations. As shown in FIG. 37A, the machine learning system was capable of mastering conventional Breakout® within a single game, and over all trials, achieved mastery of Breakout® in fewer than 20 trials. The y-axis depicts the points awarded, while the x-axis depicts the number of trials (where a game includes 5 trials). While performance varied between experiments, the machine learning system attained the maximum number of points within 20 trials. As shown in FIG. 37B, the machine learning system similarly achieved scores in the extended version of Breakout® that were greater than 80% of the maximum possible score in fewer than 20 games (with minor regressions in some trials). The y-axis depicts the fraction of the maximum points awarded, while the x-axis depicts the number of games (where a game includes 5 trials). In comparison, conventional sub-symbolic methods may require thousands of games to achieve mastery of conventional Breakout® and may be unable to master the extended version of Breakout®.

FIGS. 37C and 37D depict the performance of a machine learning system operating in interactive mode, following pre-training in observational mode in accordance with one or more aspects of this disclosure at the conventional version of Breakout®. As depicted in these figures, the machine learning system is capable of learning from observation, without controlling the game. In observational mode, the machine learning system observed the screen and the reward signal while a person played Breakout®. As may be appreciated, the observational trials offered better training data than random experimentation. The more trials observed, the more learning, reflected in the decreased number of trials requires to attain mastery. For example, after observing six trials, the machine learning system was able to achieve mastery of conventional Breakout® within three trials (as compared to within 20 trials in purely interactive learning). As an additional example, the machine learning system was able to achieve mastery of conventional Breakout® within two trials after observing 12 trials.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. Similarly, while the clauses below generally describe embodiments in terms of systems, the disclosed subject matter is not so limited. The disclosed subject matter further includes methods performing the operations of the described systems of the clauses. The disclosed subject matter further includes computer-readable media, (including non-transitory, computer-readable media) containing instructions for performing the operations of the described systems of the clauses. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The features in the claims are to be interpreted broadly based on the language employed in the claims and not limited to examples described in the present specification or during the prosecution of the application, which examples are to be construed as nonexclusive. Further, the operations of the disclosed methods can be modified in any manner, including reordering operations or inserting or deleting operations.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

### CLAUSES

The disclosed embodiments may further be described using the following clauses:

1. A system that receives information about observed objects, the system comprising: a symbolic representation generator that repeatedly receives inputs associated with observed objects and computes a symbolic memory network representative of associations involving the observed objects; an inference component, which repeatedly perturbs components, operations, or parameters of the symbolic representation generator and computes a causal model of effects of the perturbations; and an interface component, which outputs signals generated based on the causal model and concerning the associations involving the observed objects.

2. A system that receives information about observed objects and how the observed objects change state, the system comprising: means for computing a symbolic memory network representative of associations between observed objects and their states using repeatedly received inputs associated with the observed objects; means for computing a causal model of effects of perturbations of the symbolic memory network by repeatedly perturbing the symbolic memory network; and interface means for outputting signals concerning the associations involving the observed objects.

3. The system of one of clauses 1 to 2, wherein the observed objects include regions in a visual scene.

4. The system of one of clauses 1 to 3, wherein the observed objects include linguistic objects.

5. The system of any one of clauses 1 to 4, wherein the causal model models the perturbation effects using point estimates and confidence intervals.

6. The system of any one of clauses 1 to 5, wherein the symbolic memory network comprises a symbolic connectionist neural network.

7. The system of any one of clauses 1 to 6, wherein the symbolic memory network comprises a hierarchy of localists units, the hierarchy including localist units connected to distributed units.

8. The system of any one of clauses 1 to 7, wherein the information about objects comprises pixel information.

9. The system of any one of clauses 1 to 8, wherein the inference component is configured to compute the causal model by performing repeated experimentation to determine the effects of the perturbations.

10. The system of clause 9, wherein performing repeated experimentation comprises performing a randomized controlled experiment, the perturbations being treatment variables in the randomized controlled experiment.

11. The system of any one of clauses 1 to 10, wherein: the symbolic representation generator comprises a preprocessor configured to identify the observed objects in the inputs and features of the observed objects; and the inference component is configured to determine parameters for the preprocessor by performing repeated experimentation.

12. The system of any one of clauses 1 to 11, wherein the effects of the perturbations comprise effects of the perturbations on components of the symbolic memory network that represent the observed objects and causal relationships between the observed objects.

13. The system of any one of clauses 1 to 12, wherein the perturbations are limited in scope or duration.

14. The system of any one of clauses 1 to 13, wherein the perturbations occur during the operation of the system.

15. The system of any one of clauses 1 to 14, wherein the symbolic memory network forms a substrate for the causal model.

16. A machine learning system for modifying states of objects in relation to a reward signal, the system comprising: a symbolic representation generator, which repeatedly receives pixel information associated with observed objects and computes, as states of the observed objects change, a symbolic memory network representative of associations involving the observed objects; an inference component, which monitors the symbolic memory network and determines, as the states of the observed objects change, causal relationships among the observed objects, and provides commands causing additional changes in the states of one or more of the observed objects; and wherein the additional changes maximize or minimize reward signals concerning the associations involving the observed objects.

17. A system for modifying states of observed objects in relation to a reward signal, the system comprising: means for computing, as states of the observed objects change, a symbolic memory network representative of associations involving the observed objects based on repeatedly received pixel information associated with the observed objects; means for analyzing the symbolic memory network; means for computing, as the states of the observed objects change, a causal model of the associations involving the observed objects; and means for providing commands causing additional changes in the states of one or more of the observed objects; and wherein the additional changes maximize or minimize reward signals concerning the associations involving the observed objects.

18. The system of any one of clauses 16 to 17, wherein object states comprise position, orientation, color, lighting, acceleration, velocity, movement path, size, texture, or identity or exemplar.

19. The system of any one of clauses 16 to 18, wherein the states of the observed objects change over time or space.

20. The system of any one of clauses 16 to 19, wherein the inference component is configured to determine the causal relationships among the observed objects by performing repeated experimentation.

21. The system of clause 20, wherein performing repeated experimentation comprises performing a randomized controlled experiment, perturbations of the symbolic memory network being treatment variables in the randomized controlled experiment.

22. The system of any one of clauses 16 to 21, wherein the symbolic memory network comprises a symbolic connectionist neural network.

23. The system of any one of clauses 16 to 22, wherein monitoring the symbolic memory network comprises repeatedly performing experiments on components, operations, or parameters associated with the symbolic memory network.

24. The system of any one of clauses 16 to 23, wherein the inference component is configured to represent the causal relationships among the observed objects using a causal model that estimates an effect of perturbing a component, operation, or parameter associated with the symbolic memory network on a reward signal or task performance.

25. The system of any one of clauses 16 to 24, wherein the perturbations are limited in scope or duration.

26. The system of any one of clauses 16 to 25, wherein the perturbations occur during the operation of the system.

27. The system of any one of clauses 16 to 26, wherein the symbolic memory network forms a substrate for the causal model.

28. A machine learning system comprising: at least one processor; and at least one non-transitory, computer-readable medium containing instructions that, when executed by the at least one processor, cause the system to perform operations comprising: receiving visual data inputs associated with a first scene having first objects, each first object having a state defined by first scene attributes of the first object, and a reward signal associated with a first state of at least one of the first objects; updating, by applying the visual data inputs associated with the first scene to a symbolic representation generator, a first symbolic memory network representative of associations involving the first objects; receiving visual data inputs associated with a second scene having second objects, one of the second objects being one of the first objects, wherein second scene attributes of the one of the second objects differ from the first scene attributes of the one of the second objects; updating, by applying the visual data inputs associated with the second scene to the symbolic representation generator, a second symbolic memory network representative of associations involving the second objects; developing, using an inference component and the first and second symbolic memory networks, causal effect estimates concerning causal relationships in the second scene; and outputting, based on the causal effect estimates, a command to modify the second scene attributes of the one of the second objects.

29. The system of clause 28, wherein the inference component develops the causal effect estimates by performing recursive experimentation.

30. The system of any one of clauses 28 to 29, wherein a single symbolic memory network comprises the first symbolic memory network and the second symbolic memory network.

31. The system of any one of clauses 28 to 30, wherein at least one of the first symbolic memory network or the second symbolic memory network comprises a symbolic connectionist neural network.

32. The system of any one of clauses 28 to 31, wherein developing the causal effect estimates comprises repeatedly performing experiments on components, operations, or parameters associated with the symbolic representation generator.

33. The system of any one of clauses 28 to 32, wherein the causal effect estimates concerning causal relationships in the second scene include estimates of an effect of perturbing a component, operation, or parameter associated with symbolic representation generator on a reward signal or task performance.

34. A system, comprising: at least one processor; and at least one non-transitory, computer-readable medium containing instructions that, when executed by the at least one processor, cause the system to perform operations for generating a symbolic memory network corresponding to an environment using self-supervised learning, the operations comprising: determining an experiment based on a causal model of the symbolic memory network; performing the experiment by perturbing the symbolic memory network; obtaining, while perturbing the symbolic memory network, input data concerning the environment; determining an experimental result based on the input data; and updating the causal model based on the experimental result.

35. The system of clause 34, wherein: the experimental result concerns a predictive performance of the symbolic memory network, or the operations further include interacting with the environment based on the perturbed symbolic memory network and the experimental result concerns a task performance of the symbolic memory network.

36. The system of any one of clauses 34 to 35, wherein: the symbolic memory network comprises localist units representing elements, role bindings, or propositions.

37. The system of any one of clauses 34 to 36, wherein the symbolic memory network comprises a symbolic connectionist neural network.

38. The system of any one of clauses 34 to 37, wherein perturbing the symbolic memory network comprises repeatedly performing experiments on components, operations, or parameters associated with the symbolic memory network.

39. The system of any one of clauses 34 to 38, wherein: perturbing the symbolic memory network comprises perturbing at least one of an activation level of one or more localist units, a weight of a mapping between localist units in one or more pairs of localist units, or a weight of an inhibition between a localist unit and a corresponding set of localist units.

40. The system of any one of clauses 34 to 39, wherein: the experiment is determined based on the causal model according to an adaptive trial design.

41. The system of clause 40, wherein: the adaptive trial design adapts an assignment of perturbations to states of the symbolic memory network.

42. The system of any one of clauses 34 to 41, wherein the perturbations are limited in scope or duration.

43. The system of any one of clauses 34 to 42, wherein the perturbations occur during the operation of the system.

44. The system of any one of clauses 34 to 43, wherein the causal model is implemented by the symbolic memory network using causal effect groups incorporated into the symbolic memory network.

45. The system of any one of clauses 34 to 44, wherein the causal model is implemented using mappings between collections of analogs in the symbolic memory network and commands to take actions in the environment, the mappings being associated with estimates of effects of taking the actions.

46. The system of any one of clauses 34 to 45, wherein determining the experiment comprises assigning sets of perturbations to sets of experimental units.

47. The system of any one of clauses 34 to 46, wherein the experiment is a randomized controlled experiment and the perturbations correspond to treatment levels in the randomized controlled experiment.

48. A system, comprising: at least one processor; and at least one non-transitory, computer-readable medium containing instructions that, when executed by the at least one processor, cause the system to perform operations for generating a symbolic memory network corresponding to an environment using self-supervised learning, a continuous-valued relationship binding two units in the symbolic memory network, the operations comprising: controlling, based on a causal model, a parameter of the continuous-valued relationship; obtaining, while controlling the parameter, input data concerning the environment; determining an experimental result based on the input data; and updating the causal model of the symbolic memory network based at least in part on the experimental result.

49. The system of clause 48, wherein: the experimental result concerns a predictive performance of the symbolic memory network, or the operations further include interacting with the environment based on the symbolic memory network while controlling the parameter and the experimental result concerns a task performance of the symbolic memory network.

50. The system of any one of clauses 48 to 49, wherein: the symbolic memory network comprises localist units representing elements, role bindings, or propositions.

51. The system of any one of clauses 48 to 50, wherein the symbolic memory network comprises a symbolic connectionist neural network.

52. The system of any one of clauses 48 to 51, wherein the symbolic memory network comprises a hierarchy of localists units, the hierarchy including localist units connected to distributed units.

53. The system of any one of clauses 48 to 52, wherein the continuous-valued relationship comprises a logistic function.

54. The system of any one of clauses 48 to 53, wherein the parameter is adjustable to encode both categorical and metric relationships in the continuous-valued relationship.

55. The system of any one of clauses 48 to 54, wherein the symbolic memory network comprises at least one localist unit or distributed unit represented using a parameterized function.

56. The system of clause 55, wherein the function is a logistic function.

57. The system of any one of clauses 48 to 56, further comprising: generating an experimental design based on the causal model; and assigning, for a set of experimental units, values to the parameter in accordance with the experimental design.

58. The system of any one of clauses 48 to 57, wherein: controlling the parameter comprises assigning a value to the parameter corresponding to a level of an independent variable in a randomized controlled experimental design.

59. A system, comprising: at least one processor; and at least one non-transitory, computer-readable medium containing instructions that, when executed by the at least one processor, cause the system to perform operations for generating a symbolic memory network corresponding to an environment using self-supervised learning, the symbolic memory network including at least one localist unit associated with salience data, the operations comprising: perturbing, based on a causal model including the salience data, at least one of an activation level of the localist unit, a weight of a mapping between the localist unit and another localist unit in the symbolic memory network, or an inhibition level between the localist unit and a corresponding set of localist units in the symbolic memory network; obtaining, during the perturbation, input data concerning the environment; determining an experimental result based on the input data; and updating the causal model based on the experimental result.

60. The system of clause 59, wherein: the experimental result concerns a predictive performance of the symbolic memory network, or the operations further include interacting the environment based on the symbolic memory network during the perturbation and the experimental result concerns a task performance of the symbolic memory network.

61. The system of any one of clauses 59 to 60, wherein: the symbolic memory network comprises localist units representing elements, role bindings, or propositions.

62. The system of any one of clauses 59 to 61, wherein the symbolic memory network comprises a symbolic connectionist neural network, the symbolic connectionist neural network comprising a hierarchy of localists units, the hierarchy including element localist units connected to distributed units and role-binding units connected to the element localist units.

63. The system of any one of clauses 59 to 62, wherein perturbing the symbolic memory network comprises repeatedly performing experiments on components, operations, or parameters associated with the symbolic memory network.

64. The system of any one of clauses 59 to 63, wherein the salience data concerns observed objects in the environment, object attributes of the observed objects, or relationships between the objects and the object attributes.

65. The system of any one of clauses 59 to 64, wherein the object attributes comprise at least one of contrast, color, brightness, texture, motion, or orientation; or a metric dimension of object attributes.

66. The system of any one of clauses 59 to 65, wherein the salience data comprises dynamicity data; predictive power data; or frequency of selection, retrieval, or SREC matching.

67. A system for controlling a symbolic representation generator, the system comprising: at least one hardware processor; and at least one computer-readable medium storing instructions that, when executed by the at least one hardware processor, cause the system to perform operations comprising: determining, for a first experimental unit, a first treatment set including a first perturbation of a symbolic memory network, the determination based on: a first state of the symbolic memory network, the first state being dependent on input obtained from an environment by the symbolic representation generator, and an estimated effect of the first perturbation of the symbolic memory network; applying the first treatment set during the first experimental unit, application of the first treatment set including the first perturbation of the symbolic memory network; and updating, based on a first set of experimental units including the first experimental unit, the estimated effect of the first perturbation of the symbolic memory network to form an updated estimated effect.

68. The system of clause 67, wherein the symbolic memory network includes distributed units, localist units, weights, and mappings.

69. The system of clause 68, wherein the first perturbation of the symbolic memory network comprises: a selection of an analog in the symbolic memory network for experimentation; or a perturbation of a characteristic of at least one of the distributed units, localist units, weights, or mappings.

70. The system of any one of clauses 67 to 69, wherein the updated estimated effect of the first perturbation of the symbolic memory network comprises an updated estimated change to a characteristic of at least one of the distributed units, localist units, weights, or mappings resulting from the first perturbation of the symbolic memory network.

71. The system of any one of clauses 67 to 70, wherein: the operations further comprise maintaining a mapping from a combination of the first state and the first perturbation to an estimated effect of the first perturbation.

72. The system of any one of clauses 67 to 71, wherein the operations further comprise: determining, for a second experimental unit, a second treatment set including provision of a command to take an action in the environment; applying the second treatment set during the second experimental unit, application of the second treatment set including providing the command to take the action in the environment; and updating, based on a second set of experimental units including the second experimental unit, an estimated effect of the second treatment.

73. The system of any one of clauses 67 to 72, wherein: the estimated effect of the first perturbation of the symbolic memory network comprises a first interval estimate; and the first treatment set is determined based on a comparison of the first interval estimate and second interval estimates associated with estimated effects of second perturbations of the symbolic memory network.

74. The system of any one of clauses 67 to 73, wherein the symbolic memory network comprises a symbolic connectionist neural network.

75. The system of any one of clauses 67 to 74, wherein applying the first treatment set comprises providing instructions to the symbolic representation generator to implement the first perturbation of the symbolic memory network.

76. The system of any one of clauses 67 to 75, wherein a causal model includes the estimated effect.

77. The system of clause 76, wherein the causal model is incorporated into the symbolic memory network.

78. The system of any one of clauses 67 to 77, wherein the first treatment set is determined according to a randomized experimental design.

79. A system for generating a symbolic memory network, the system comprising: at least one hardware processor; and at least one computer-readable medium storing instructions that, when executed by the at least one hardware processor, cause the system to perform operations comprising: providing or exposing a state of a symbolic memory network to at least an inference component to enable generation of perturbation data; and obtaining input data from an environment; obtaining the perturbation data from the inference component; and updating, using the input data and the perturbation data, the state of the symbolic memory network by creating or modifying a first analog stored in the symbolic memory network.

80. The system of clause 79, wherein the symbolic memory network includes at least one of distributed units, localist units, weights, or mappings.

81. The system of clause 80, wherein updating the state of the symbolic memory network comprises: applying the input data to a preprocessor configured to generate localist units and to activate distributed units; and updating the at least one of distributed units, localist units, weights, or mappings of the symbolic memory network using the generated localist units and activated distributed units and the perturbation data from the inference component.

82. The system of any one of clauses 79 to 81, wherein: a unit in the symbolic memory network is mapped to providing a command to take an action in the environment; and updating the state of the symbolic memory network comprises: selecting the unit; and providing the mapped command to take the action in the environment.

83. The system of any one of clauses 79 to 82, wherein the symbolic memory network comprises a symbolic connectionist neural network.

84. The system of any one of clauses 79 to 83, wherein the operations further comprise updating the state of the memory network by receiving a second analog from the inference component and storing the second analog in the symbolic memory network.

85. The system of clause 84, wherein the second analog encodes relationship strength information concerning a relationship represented by the second analog.

86. The system of any one of clauses 79 to 85, wherein creating or modifying the first analog comprises performing relational refinement using a similarity condition specified in the perturbation data.

87. A system for symbolic machine learning, comprising: at least one hardware processor; and at least one computer-readable medium storing instructions that, when executed by the at least one hardware processor, cause the system to perform operations comprising: selecting, by an inference component and based on a state of a symbolic representation generator, a perturbation of a symbolic memory network from candidate perturbations; and updating, by the symbolic representation generator, a state of the symbolic memory network using the selected perturbation and input data obtained from an environment.

88. The system of clause 87, wherein the operations further comprise selecting, by the inference component, the candidate perturbations according to an experimental design.

89. The system of any one of clauses 87 to 88, wherein the operations further comprise assigning, by the inference component, sets of candidate perturbations to corresponding sets of experimental units.

90. The system of clause 89, wherein the experimental units include baseline and explore/exploit experimental units.

91. The system of any one of clauses 87 to 90, wherein: the perturbation is selected from the candidate perturbations based on an estimated effect of using each of the candidate perturbations in updating the state of the symbolic memory network; and the operations further comprise updating the estimated effect of using the selected perturbation based on the updated state to form an updated estimated effect.

92. The system of clause 91, wherein the estimated effects of the candidate perturbations comprise estimates of reward values received from the environment when using each of the candidate perturbations in updating the state of the symbolic memory network.

93. The system of clause 91, wherein the estimated effects of the candidate perturbations comprise estimated changes to a characteristic of a distributed unit, localist unit, weight, or mapping of the symbolic memory network.

94. The system of any one of clauses 91 to 93, wherein the estimated effects of the candidate perturbations comprise interval estimates and the perturbation is selected based on magnitudes of the interval estimates.

95. The system of any one of clauses 91 to 93, wherein the estimated effects of the candidate perturbations comprise point and interval estimates and the perturbation is selected based on at least one of magnitudes and signs of the point estimates and magnitudes of the interval estimates.

96. The system of any one of clauses 87 to 95, wherein the selected perturbation comprises a perturbation of a characteristic of a distributed unit, localist unit, weight, or mapping of the symbolic memory network.

97. A system comprising: at least one hardware processor; and at least one computer-readable medium storing instructions that, when executed by the at least one hardware processor, cause the system to perform operations comprising: selecting, by an inference component and based on a state of a symbolic representation generator, a command to take an action in an environment from candidate commands; providing the command to take the action in the environment; and updating, by the symbolic representation generator and after providing the command, the state of the symbolic representation generator using input data obtained from the environment.

98. The system of clause 97, wherein the operations further comprise selecting, by the inference component, the candidate commands according to an experimental design.

99. The system of any one of clauses 97 to 98, wherein the operations further comprise assigning, by the inference component, sets of candidate commands to corresponding sets of experimental units.

100. The system of clause 99, wherein the experimental units include baseline and explore/exploit experimental units.

101. The system of any one of clauses 97 to 100, wherein: selecting the command from the candidate commands comprises selecting, by the inference component, the command from the candidate commands based on an estimated effect of providing the command; and the operations further comprise updating the estimated effect of providing the command.

102. The system of clause 101, wherein the estimated effects of the candidate commands comprise: estimates of reward values received from the environment when providing each of the candidate commands to the environment, or interval estimates and the command is selected based on magnitudes of the interval estimates.

103. The system of clause 101, wherein the estimated effects of the candidate commands comprise: estimated changes to a characteristic of a distributed unit, localist unit, weight, or mapping of a symbolic memory network of the symbolic representation generator, or point and interval estimates and the command is selected based on at least one of magnitudes and signs of the point estimates and magnitudes of the interval estimates.

104. A system, comprising: at least one hardware processor; and at least one computer-readable medium storing instructions that, when executed by the at least one hardware processor, cause the system to perform operations comprising: selecting, by an inference component, a treatment including a perturbation of components, operations, or parameters of a symbolic representation generator and a provision of a command to take action in an environment, the selection based on: a state of the symbolic representation generator, an estimated effect of the perturbation, and an estimated effect of the command; perturbing the components, operations, or parameters of the symbolic representation generator in accordance with the selected perturbation and providing the command to the environment; and updating, by the symbolic representation generator after the perturbation and the provision of the command, the state of the symbolic representation generator using input data obtained from the environment.

105. The system of clause 104, wherein the estimated effect of the perturbation comprises an estimated change to a distributed unit, localist unit, weight, or mapping characteristic of a symbolic memory network of the symbolic representation generator resulting from the perturbation of the components, operations, or parameters of the symbolic representation generator.

106. The system of any one of clauses 104 to 105, wherein the estimated effect of the perturbation comprises an estimated reward value obtained from the environment resulting from the perturbation of the components, operations, or parameters of the symbolic representation generator.

107. The system of any one of clauses 104 to 106, wherein the estimated effect of the command comprises an estimated change to a distributed unit, localist unit, weight, or mapping characteristic of a symbolic memory network of the symbolic representation generator resulting from the provision of the command.

108. The system of any one of clauses 104 to 107, wherein the estimated effect of the command comprises an estimated reward value obtained from the environment resulting from providing the command.

109. The system of any one of clauses 104 to 108, wherein the operations further comprise assigning, by the inference component, sets of treatments to each experimental unit in a set of experimental units.

110. The system of clause 109, wherein the experimental units include baseline and explore/exploit experimental units.

111. The system of clause 109, wherein the inference component is configured to assign the sets of treatments according to a randomized controlled experimental design.

112. The system of any one of clauses 104 to 111, wherein the perturbation is limited in scope or duration.

113. The system of any one of clauses 104 to 112, wherein the perturbation occurs during operation of the system.

114. A system, comprising: at least one hardware processor; and at least one computer-readable medium storing instructions that, when executed by the at least one hardware processor, cause the system to perform operations comprising: accumulating analogs in or from a working memory of a symbolic representation generator; determining, in the accumulated analogs, an observed correlate and an observed outcome; associating the observed correlate and the observed outcome with causal localist units; and binding the observed correlate, the observed outcome, and the causal localist units into a relationship analog, wherein at least one of connection weights or metadata associated with the causal localist units specifies a relationship strength.

115. The system of clause 114, wherein the operations further comprise: retrieving the relationship analog into the working memory; and providing instructions to take an action in an environment based on the retrieval of the relationship analog.

116. A system, comprising: means for accumulating analogs in or from a working memory of a symbolic representation generator; means for determining, in the accumulated analogs, an observed correlate and an observed outcome; means for associating the observed correlate and the observed outcome with causal localist units; and means for binding the observed correlate, the observed outcome, and the causal localist units into a relationship analog, wherein at least one of connection weights or metadata associated with the causal localist units specifies a relationship strength.

117. The system of clause 116, further comprising: means for retrieving the relationship analog into the working memory; and means for providing instructions to take an action in an environment based on the retrieval of the relationship analog.

118. The system of any one of clauses 114 to 117, wherein: the observed outcome is determined based on a learned mapping between rewards and analogs.

119. The system of any one of clauses 114 to 118, wherein: the analogs are accumulated during an experimental unit specified by an inference component and the observed correlate and the observed outcome are associated with the causal localist units upon completion of the experimental unit.

120. The system of any one of clauses 114 to 119, wherein: binding the observed correlate, the observed outcome, and the causal localist units into the relationship analog comprises: matching the observed correlate and the observed outcome to a second observed correlate and a second observed outcome obtained during a second experimental unit; and performing at least one of relational learning or comparison-based refinement using the matched second observed correlate and the second observed outcome.

121. The system of any one of clauses 114 to 120, wherein: the connection weights between the causal localist units and causal distributed units specify, at least in part, the relationship strength.

122. The system of any one of clauses 114 to 121, wherein: accumulating the analogs comprises storing the analogs in a memory accessible to the symbolic representation generator.

123. The system of any one of clauses 114 to 122, wherein: the symbolic representation generator is configured to compute a symbolic connectionist neural network, the symbolic connectionist neural network including the working memory.

124. The system of any one of clauses 114 to 123, further comprising constructing a causal relationship analog using the relationship analog and a second relationship analog, wherein the relationship analog corresponds to a treatment and the second relationship analog corresponds to an absence of the treatment, the causal relationship analog including a treatment analog based on the observed correlate and an effect analog based on the observed outcome and a second observed outcome of the second relationship analog.

125. The system of clause 124, wherein constructing the causal relationship analog comprises determining the effect analog using difference encoding.

126. The system of clause 124, wherein constructing the causal relationship analog comprises determining that the treatment was applied prior to obtaining the observed outcome.

127. A system, comprising: at least one hardware processor; and at least one computer-readable medium storing instructions that, when executed by the at least one hardware processor, cause the system to perform operations comprising: accumulating analogs in or from a working memory of a symbolic representation generator; accumulating a goal analog, the goal analog comprising a reward analog bound to a causal localist unit; retrieving, based on the analogs accumulated in or from the working memory and the goal analog, a relationship analog; and providing instructions to take an action in an environment based on the retrieved relationship analog.

128. The system of clause 127, wherein the operations further comprise: matching the analogs accumulated in or from the working memory and a replacement reward analog to the retrieved relationship analog; and performing at least one of relational learning or comparison-based refinement using the matched analogs accumulated in or from the working memory and the replacement reward analog.

129. The system of clause 127, wherein the operations further comprise: generating a causal relationship analog using: the analogs accumulated in or from the working memory and a replacement reward analog, second analogs accumulated in or from the working memory and a second replacement reward analog, and wherein the analogs accumulated in or from the working memory correspond to a treatment and the second analogs accumulated in or from the working memory correspond to an absence of the treatment.

130. A system, comprising: means for accumulating analogs in or from a working memory of a symbolic representation generator; means for accumulating a goal analog, the goal analog comprising a reward analog bound to a causal localist unit; means for retrieving, based on the analogs accumulated in or from a working memory and the goal analog, a relationship analog; and means for providing instructions to take an action in an environment based on the retrieved relationship analog.

131. The system of clause 130, further comprising: means for matching the analogs accumulated in or from the working memory and a replacement reward analog to the retrieved relationship analog; and means for performing at least one of relational learning or comparison-based refinement using the matched analogs accumulated in or from the working memory and the replacement reward analog.

132. The system of clause 130, further comprising: means for generating a causal relationship analog using: the analogs accumulated in or from the working memory and a replacement reward analog, second analogs accumulated in or from the working memory and a second replacement reward analog, and wherein the analogs accumulated in or from the working memory correspond to a treatment and the second analogs accumulated in or from the working memory correspond to an absence of the treatment.

133. The system of any one of clauses 127 to 132, wherein: the relationship analog is a causal relationship analog.

134. The system of any one of clauses 127 to 133, wherein: the analogs accumulated in or from the working memory are accumulated during an experimental unit specified by an inference component and the matching and the performance of the at least one of relational learning or comparison-based refinement are performed upon completion of the experimental unit.

135. The system of any one of clauses 127 to 134, wherein: performing the at least one of the relational learning or the comparison-based refinement includes updating a relationship strength based at least in part on the replacement reward analog.

136. The system of any one of clauses 127 to 135, wherein: the retrieved relationship analog comprises an analog mapped to an action; and the instructions to take the action are provided based on the mapped analog being in the retrieved relationship analog.

137. The system of any one of clauses 127 to 136, wherein: accumulating the analogs comprises storing the analogs in a memory accessible to the symbolic representation generator.

138. The system of any one of clauses 127 to 137, wherein: the symbolic representation generator is configured to compute a symbolic connectionist neural network, the symbolic connectionist neural network including the working memory.

139. A machine learning system, comprising: at least one hardware processor; and at least one computer-readable medium storing instructions that, when executed by the at least one hardware processor, cause the system to perform operations comprising: generating a first relationship analog through non-interactive learning; and generating, by a symbolic representation generator, a second relationship analog through interactive experimentation using the first relationship analog, the interactive experimentation comprising: accumulating analogs during an experimental unit and specifying a goal; retrieving the first relationship analog based on the specified goal and the accumulated analogs; and generating the second relationship analog using at least one of relational learning or comparison-based refinement, the generation using the first relationship analog and the accumulated analogs.

140. The system of clause 139, wherein the operations further comprise: providing instructions to take an action in an environment based on the retrieved first relationship analog.

141. The system of any one of clauses 139 to 140, wherein the operations further comprise: storing the first relationship analog and the second relationship analog in a symbolic connectionist neural network.

142. A system, comprising: means for generating a first relationship analog through non-interactive learning; and symbolic representation generator means for generating a second relationship analog through interactive experimentation using the first relationship analog, the interactive experimentation comprising: accumulating analogs during an experimental unit and specifying a goal; retrieving the first relationship analog based on the specified goal and the accumulated analogs; and generating the second relationship analog using at least one of relational learning or comparison-based refinement, the generation using the first relationship analog and the accumulated analogs.

143. The system of clause 142, further comprising: means for providing instructions to take an action in an environment based on the retrieved first relationship analog.

144. The system of any one of clauses 142 to 143, further comprising: means for storing the first relationship analog and the second relationship analog in a symbolic connectionist neural network.

145. The system of any one of clauses 139 to 144, wherein: generating the second relationship analog further comprises updating the specified goal with an actual reward analog, and the second relationship analog is generated further based on the updated specified goal.

146. The system of any one of clauses 139 to 145, wherein: the non-interactive learning is performed in a first domain and the interactive learning is performed in a second domain.

147. The system of any one of clauses 139 to 146, wherein: generating the second relationship analog further comprises specifying, in the second relationship analog, a relationship strength.

148. The system of any one of clauses 139 to 147, wherein: the retrieval of the first relationship analog is further based on a relationship strength of the first relationship analog.

149. The system of clause 148, wherein: wherein at least one of connection weights or metadata associated with causal localist units included in the first relationship analog specifies the relationship strength.

150. The system of any one of clauses 139 to 149, wherein: the retrieval of the first relationship analog is further based on a relationship strength of the first relationship analog.

151. The system of any one of clauses 139 to 150, wherein: the first relationship analog and the second relationship analog are causal relationship analogs, the experimental unit corresponds to a treatment, and the generation of the second relationship analog uses: a first actual reward analog obtained during the experimental unit and a second actual reward analog obtained during a second experimental unit corresponding to the absence of the treatment.

152. The system of clause 151, wherein generation of the second relationship analog comprises: generation of a third causal relationship analog including a cause analog based on the accumulated analogs and an effect analog generated using difference encoding of the first and second actual reward analogs; and relational learning or comparison-based refinement of the first relationship analog and the third causal relationship analog.

153. A system, comprising: at least one hardware processor; and at least one computer-readable medium storing instructions that, when executed by the at least one hardware processor, cause the system to perform operations comprising: determining symbolic representation experimental conditions (SRECs) based on analogs contained in a symbolic representation generated by a symbolic representation generator; assigning at least some of the SRECs to a policy in accordance with an experimental design; and during an experimental unit: matching a first SREC assigned to the policy to analogs in the symbolic representation; and providing instructions to take actions in an environment based on the matched first SREC.

154. The system of clause 153, wherein the operations further comprise: after the experimental unit, updating treatment effect estimates for the first SREC or updating a treatment effect estimate for the policy.

155. The system of any one of clauses 153 to 154, wherein the operations further comprise: during the experimental unit, matching a second SREC assigned to the policy to analogs in the symbolic representation and providing instructions to perturb one or more components, parameters, or operations of the symbolic representation generator based on the matched second SREC.

156. The system of any one of clauses 153 to 155, wherein the operations further comprise: after the experimental unit, updating results data; and updating a causal model according to the experimental design using the results data.

157. The system of clause 156, wherein the operations further comprise: generating an alternative causal model using the results data according to an alternative configuration of the experimental design or an alternative experimental design; comparing the causal model and the alternative causal model; and selecting, based on the comparison, the alternative configuration of the experimental design or the alternative experimental design for future assignment of SRECs to polices.

158. The system of any one of clauses 153 to 157, wherein determining the SRECs based on the analogs comprises: filtering the analogs in the symbolic representation based on salience attributed to analogs representing objects, or to object dimensions in the symbolic representation; or configuring the symbolic representation generator to generate analogs based on the attributed salience.

159. The system of any one of clauses 153 to 158, wherein the operations further comprise: configuring the one or more components, parameters, or operations of the symbolic representation generator prior to determining the SRECS; and reconfiguring the components, parameters, or operations of the symbolic representation after the experimental unit based on a result of the experimental unit.

160. The system of clause 159, wherein configuring the components, parameters, or operations of the symbolic representation generator comprises: specifying at least one of a preprocessor or preprocessor configuration for processing an input obtained from the environment; specifying a matching condition for performing relational refinement on the symbolic representation; or specifying at least one dimension of object characteristics as being salient.

161. The system of any one of clauses 153 to 160, wherein the symbolic representation comprises a symbolic connectionist neural network.

162. The system of any one of clauses 153 to 161, wherein the symbolic representation comprises a hierarchy of localists units, the hierarchy including localist units connected to distributed units.

163. A system comprising: at least one hardware processor; and at least one computer-readable medium storing instructions that, when executed by the at least one hardware processor, cause the system to perform operations comprising: determining symbolic representation generator parameters; selecting and configuring an experimental design; assigning symbolic representation experimental conditions (SRECs) to a policy according to the experimental design; during an experimental unit, matching SRECs assigned to the policy to analogs in a symbolic representation generated by the symbolic representation generator using input obtained from an environment according to the symbolic representation generator parameters, and providing instructions to take actions in the environment based on the matched SRECs; and providing instructions to update the symbolic representation generator parameters based on a result of the experimental unit.

164. The system of clause 163, wherein: the symbolic representation generator parameters include at least one of: a mapping condition for performing relational refinement on analogs in the symbolic representation; a specification of a preprocessor or preprocessor configuration for processing an input obtained from the environment; or a specification of at least one dimension of object characteristics as being salient.

165. The system of any one of clauses 163 to 164, wherein: providing instructions to update the symbolic representation generator parameters based on the result of the experimental unit comprises: comparing a causal model generated using results data obtained using the symbolic representation generator parameters, the results data including the result of the experimental unit, to an alternative causal model generated using prior results data obtained using prior symbolic representation generator parameters.

166. The system of any one of clauses 163 to 165, wherein: assigning SRECs to the policy according to the experimental design comprises determining the SRECs using salience attributed to: analogs in the symbolic representation that represent objects, or object dimensions in the symbolic representation.

167. The system of any one of clauses 163 to 166, wherein the salience is attributed to analogs representing objects and depends on a dynamicity of the represented objects.

168. The system of any one of clauses 163 to 167, wherein the symbolic representation comprises a symbolic connectionist neural network.

169. The system of any one of clauses 163 to 168, wherein the symbolic representation comprises a hierarchy of localists units, the hierarchy including localist units connected to distributed units.

170. A system comprising: at least one hardware processor; and at least one computer-readable medium storing instructions that, when executed by the at least one hardware processor, cause the system to perform operations comprising: retrieving a trace from a secondary memory network; generating an analog by reprocessing the trace using: at least one of input data obtained from an environment, and at least one analog obtained from a symbolic memory network; determining that the generated analog satisfies a storage condition for the symbolic memory network; and providing instructions to take an action in the environment based on subsequent retrieval of the generated analog from the symbolic memory network.

171. The system of clause 170, wherein the operations further comprise: attempting generation of an initial analog using input data; determining that the attempted generation of the initial analog was unsuccessful or that the initial analog satisfies a secondary storage condition; and storing the trace in the secondary memory network, wherein the trace corresponds to the initial analog, prior to the retrieval of the trace.

172. The system of any one of clauses 170 to 171, wherein the trace includes at least one of the initial analog, items of the input data, or preprocessor outputs generated using the input data.

173. The system of any one of clauses 170 to 172, wherein the trace includes metadata and the determination that the generated analog satisfies a storage condition for the symbolic memory network depends at least in part on the metadata.

174. The system of any one of clauses 170 to 173, wherein the determination that the generated analog satisfies a storage condition for the symbolic memory network depends at least in part on a selectivity of the generated analog.

175. The system of clause 174, wherein the selectivity of the generated analog depends on connection weights between an element unit included in the generated analog and two or more distributed units.

176. The system of any one of clauses 170 to 175, wherein the determination that the generated analog satisfies a storage condition for the symbolic memory network depends at least in part on a hyperparameter monitored by an inference component.

177. The system of any one of clauses 170 to 176, wherein the symbolic memory network comprises a symbolic connectionist neural network.

178. The system of any one of clauses 170 to 177, wherein the symbolic memory network comprises a hierarchy of localists units, the hierarchy including localist units connected to distributed units.

179. A system comprising: at least one hardware processor; and at least one computer-readable medium storing instructions that, when executed by the at least one hardware processor, cause the system to perform operations comprising: generating multiple candidate actions using corresponding experimentation engines, the experimentation engines generating the multiple candidate actions using a symbolic memory network; determining information metric values for respective candidate actions; selecting one of the multiple candidate actions based on the determined information metric values; and providing instructions to perform the selected candidate action in an environment.

180. The system of clause 179, wherein one of the experimentation engines generates a causal analog using abduction, and a corresponding one of the multiple candidate actions is associated with the causal analog.

181. The system of any one of clauses 179 to 180, wherein: the selected one of the multiple candidate actions is associated with a causal analog generated by a one of the experimentation engines; and the operations further comprise storing the causal analog in the symbolic memory network.

182. The system of any one of clauses 179 to 181, wherein: the causal analog incorporates or is stored with evidentiary metadata.

183. The system of any one of clauses 179 to 182, wherein: the information metric values for the candidate actions depend on estimated prediction utility and explanatory power of the candidate actions.

184. The system of any one of clauses 179 to 183, wherein: the selection of the one of the multiple candidate actions based on the determined information metric values comprises probabilistic selection of the one of the multiple candidate actions according to selection probabilities dependent on the determined information metric values.

185. The system of any one of clauses 179 to 184, wherein the symbolic memory network comprises a symbolic connectionist neural network.

186. The system of any one of clauses 179 to 185, wherein the symbolic memory network comprises a hierarchy of localists units, the hierarchy including localist units connected to distributed units.

187. A system comprising: at least one hardware processor; and at least one computer-readable medium storing instructions that, when executed by the at least one hardware processor, cause the system to perform operations comprising: identifying an analog in a symbolic memory network of a symbolic representation generator as being entangled based on a selectivity threshold monitored by an inference component, monitoring the selectivity threshold comprising experimenting on the selectivity threshold to determine a causal relationship between the selectivity threshold and at least one effect estimate; identifying a disentangled version of the identified entangled analog in the symbolic memory network of the symbolic representation generator using the identified entangled analog; in response to the identification of the disentangled version of the identified entangled analog, releasing the identified entangled analog from the symbolic memory network; and providing instructions to take an action in an environment based on the disentangled version of the identified entangled analog.

188. The system of clause 187, wherein: releasing the identified entangled analog from the symbolic memory network comprises transferring the identified entangled analog to a secondary memory, flagging the identified entangled analog as inactive, or deleting the identified entangled analog.

189. The system of any one of clauses 187 to 188, wherein: the identified entangled analog is released based on a configuration value monitored by the inference component.

190. The system of any one of clauses 187 to 189, wherein: the identification of the identified analog as being entangled depends on weights connecting a localist unit of the identified analog to two or more distributed units in the symbolic memory network.

191. The system of any one of clauses 187 to 190, wherein: the effect estimate is a point or interval estimate of a reward value.

192. The system of any one of clauses 187 to 191, wherein: at least one of the identification of the identified analog, the identification of the disentangled version of the identified analog, or the releasing of the identified analog from the symbolic memory network are performed according to a schedule or in response to an event or determination.

193. The system of any one of clauses 187 to 192, wherein the disentangled version of the identified analog is a causal analog and providing instructions to take the action in the environment based on the disentangled version of the identified analog comprises: retrieving the disentangled version of the identified analog to a working memory based on a reward representation present in the working memory.

194. The system of clause 193, wherein the retrieval of the disentangled version of the identified analog depends on activation flowing from the reward representation in the working memory.

195. The system of any one of clauses 187 to 194, wherein: providing instructions to take the action in the environment based on the disentangled version of the identified analog from the symbolic memory network further comprises: retrieving the disentangled version of the identified analog to a working memory and matching the disentangled version of the identified analog to a symbolic representation experimental condition (SREC).

196. The system of clause 195, wherein the disentangled version of the identified analog is an inexact match of the SREC.

197. The system of clause 195, wherein: the disentangled version of the identified analog is retrieved to the working memory during an experimental unit; and providing instructions to take the action in the environment based on the disentangled version of the identified analog from the symbolic memory network further comprises: determining that the SREC was previously matched during the experimental unit and that the action was selected in response to the previous matching of the SREC.

198. A system comprising: at least one hardware processor; and at least one computer-readable medium storing instructions that, when executed by the at least one hardware processor, cause the system to perform operations comprising: retrieving an entangled analog to a working memory from a secondary memory network in accordance with a retrieval probability, the retrieval probability based at least in part on decay function metadata associated with the entangled analog; generating an analog in the working memory using the retrieved entangled analog and input data or an analog retrieved to the working memory from a symbolic memory network; storing, based on a strength of the generated analog and a strength threshold, the generated analog in the symbolic memory network; and providing instructions to take an action in an environment based on a subsequent retrieval of the generated analog from the symbolic memory network.

199. The system of clause 198, wherein the retrieval probability is further based on an activation of the entangled analog.

200. The system of clause 199, wherein the activation of the entangled analog depends on the activation flowing from at least one analog in the working memory.

201. The system of any one of clauses 198 to 200, wherein the operations further comprise: experimentally monitoring, using an inference component, the strength threshold.

202. The system of any one of clauses 198 to 201, wherein a decay function implemented using the decay function metadata decreases the retrieval probability as time, number of input data sets received, or number of retrieval operations performed since the entangled analog was stored in the secondary memory network or last retrieved increases.

203. The system of clause 202, wherein the decay function depends on an input modality associated with the entangled analog, the input modality being one of textual information, sensor information, or data.

204. A computer-implemented method that includes the operations of the system of any one of clauses 1 to 203.

205. A non-transitory, computer-readable medium containing instructions that, when executed by at least one processor of a system, cause the system to perform the operations of a system of any one of clauses 1 to 203.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as exemplary only, with a true scope and spirit of the disclosed embodiments being indicated by the following claims.

1.-14. (canceled)

15. A machine learning system for modifying states of objects in relation to a reward signal, the system comprising at least one processor configured to implement:
a symbolic representation generator, which repeatedly receives pixel information associated with observed objects and computes, as states of the observed objects change over time, a symbolic memory network representative of associations involving the observed objects;
an inference component, which monitors the symbolic memory network and determines causal relationships among the observed objects by performing repeated randomized controlled experiments on the symbolic memory network, the randomized controlled experiments including limited-duration perturbations of the symbolic memory network as the states of the observed objects change over time, the limited-duration perturbations of the symbolic memory network being treatment variables in the randomized controlled experiment, and provides commands causing additional changes in the states of one or more of the observed objects; and
wherein the additional changes depend on reward signal or task performance estimates concerning the associations involving the observed objects.

16. The system of claim 15, wherein object states comprise position, orientation, color, lighting, acceleration, velocity, movement path, size, texture, or identity or exemplar.

17. The system of claim 15, wherein the states of the observed objects further change over space.

18. (canceled)

19. (canceled)

20. The system of claim 15, wherein the symbolic memory network comprises a symbolic connectionist neural network.

21. The system of claim 15, wherein monitoring the symbolic memory network comprises repeatedly performing experiments on components, operations, or parameters associated with the symbolic memory network.

22. The system of claim 15, wherein the inference component is configured to represent the causal relationships among the observed objects using a causal model that estimates effects of the limited-duration perturbations on the reward signal or task performance.

23.-32. (canceled)

33. The system of claim 15, wherein: the symbolic representation generator comprises a sub-symbolic preprocessor configured to identify the observed objects in the pixel information, extract features of the observed objects and create components in the symbolic memory network corresponding to the observed objects and extracted features of the observed objects.

34. The system of claim 33, wherein the created components comprise localist units and distributed units.

35. A method comprising:
repeatedly receiving, at a symbolic representation generator, pixel information associated with observed objects and computing, as states of the observed objects change, a symbolic memory network representative of associations involving the observed objects, the symbolic memory network including sets of connected localist and distributed units;
monitoring, with an inference component, the symbolic memory network and updating a causal model that represents causal relationships among the observed objects by repeatedly perturbing a mapping condition of the symbolic memory network as the states of the observed objects change, a relational refinement operation of the symbolic memory network being dependent on whether pairs of the sets of connected localist and distributed units satisfy the mapping condition, the causal model including an estimated effect on a reward signal of perturbing the mapping condition, and providing commands causing additional changes in the states of one or more of the observed objects; and
wherein the additional changes depend on reward signal or task performance estimates included in the causal model and concerning the associations involving the observed objects.

36. The method of claim 35, wherein object states comprise position, orientation, color, lighting, acceleration, velocity, movement path, size, texture, or identity or exemplar.

37. The method of claim 35, wherein the states of the observed objects change over time or space.

38. The method of claim 35, wherein the inference component is configured to determine the causal relationships among the observed objects by performing repeated experimentation.

39. The method of claim 38, wherein performing the repeated experimentation comprises performing a randomized controlled experiment, the repeated perturbations of the mapping condition being treatment variables in the randomized controlled experiment.

40. The method of claim 35, wherein the symbolic memory network comprises a symbolic connectionist neural network.

41. The method of claim 35, wherein updating the causal model further comprises repeatedly perturbing components or parameters associated with the symbolic memory network.

42. (canceled)

43. The method of claim 35, wherein: the symbolic representation generator comprises a sub-symbolic preprocessor configured to identify the observed objects in the pixel information, extract features of the observed objects and create components in the symbolic memory network corresponding to the observed objects and extracted features of the observed objects.

44. The method of claim 43, wherein the created components comprise localist units and distributed units.

45. A non-transitory computer-readable medium encoded with instructions that, when executed by at least one processor of a system, cause the system to perform operations including:
repeatedly receiving, at a symbolic representation generator, pixel information associated with observed objects and computing, as states of the observed objects change, a symbolic memory network representative of associations involving the observed objects, the symbolic representation generator comprising a sub-symbolic preprocessor configured to identify the observed objects in the pixel information, extract features of the observed objects and create components in the symbolic memory network corresponding to the observed objects and extracted features of the observed objects;
monitoring, with an inference component, the symbolic memory network and updating a causal model that represents causal relationships among the observed objects by repeatedly perturbing at least one parameter of the sub-symbolic preprocessor, the causal model including an estimated effect on a reward signal of perturbing the at least one parameter of the sub-symbolic preprocessor, and providing commands causing additional changes in the states of one or more of the observed objects; and
wherein the additional changes depend on reward signal or task performance estimates included in the causal model and concerning the associations involving the observed objects.

46. The non-transitory computer-readable medium of claim 45, wherein object states comprise position, orientation, color, lighting, acceleration, velocity, movement path, size, texture, or identity or exemplar.

47. The non-transitory computer-readable medium of claim 45, wherein the states of the observed objects change over time or space.

48. The non-transitory computer-readable medium of claim 45, wherein the inference component is configured to determine the causal relationships among the observed objects by performing repeated experimentation.

49. The non-transitory computer-readable medium of claim 48, wherein performing the repeated experimentation comprises performing a randomized controlled experiment, the repeated perturbations of the at least one parameter of the sub-symbolic preprocessor being treatment variables in the randomized controlled experiment.

50. The non-transitory computer-readable medium of claim 45, wherein the symbolic memory network comprises a symbolic connectionist neural network.

51. The non-transitory computer-readable medium of claim 45, wherein monitoring the symbolic memory network comprises repeatedly performing experiments on components or operations associated with the symbolic memory network.

52. (canceled)

53. (canceled)

54. (canceled)

55. The system of claim 15, wherein the limited-duration perturbations include a perturbation of a component, operation, or parameter associated with the symbolic memory network.
